(19) United States
(12) Patent Application Publication
(10) Pub. No.: US 2023/0118892 A1
(43) Pub. Date: Apr. 20, 2023

(54) DOCKING UNIT AND SURFACE CLEANING APPARATUS

(71) Applicant: Omachron Intellectual Property Inc., Hampton (CA)

(72) Inventor: Wayne Ernest Conrad, Hampton (CA)

(21) Appl. No.: 18/084,740

(22) Filed: Dec. 20, 2022

Related U.S. Application Data
(63) Continuation-in-part of application No. 17/569,622, filed on Jan. 6, 2022.
Application No. 17/569,622 is a continuation of application No. 16/584,013, filed on Sep. 26, 2019.
Application No. 16/584,013 is a continuation of application No. 15/393,003, filed on Dec. 28, 2016, now Pat. No. 10,464,746.
Application No. 15/393,003 is a continuation-in-part of application No. 17/157,608, filed on Jan. 25, 2021.

(51) Int. Cl. B65F 1/14; A47L 9/16; A47L 9/10; A47L 9/12; B65F 1/10; B65F 1/16

(52) U.S. Cl. CPC B65F 1/14; A47L 9/16; A47L 9/106; A47L 9/1683; A47L 9/12; B65F 1/105; B65F 1/1607; B65F 2210/129

(57) ABSTRACT

A docking station for a surface cleaning apparatus has a floor standing base unit with a docking station dirt collection chamber, and upflow and down flow ducts that are connectable with the surface cleaning apparatus.

### CROSS-REFERENCE TO RELATED APPLICATIONS

This application is
(a) a continuation-in-part of co-pending U.S. patent application Ser. No. 17/569,622, filed on Jan. 6, 2022, which itself is a continuation of co-pending U.S. patent application Ser. No. 16/584,013, filed on Sep. 26, 2019, which itself is a continuation U.S. patent application Ser. No. 15/393,003, filed on Dec. 28, 2016 and issued as U.S. Pat. No. 10,464,746 on Nov. 5, 2019;
(b) a continuation-in-part of co-pending U.S. patent application Ser. No. 17/157,608, filed on Jan. 25, 2021,
   the entirety of each of which is hereby incorporated by reference.

### FIELD

This application relates to the field of surface cleaning apparatus and docking units for use with the same.

### INTRODUCTION

The following is not an admission that anything discussed below is part of the prior art or part of the common general knowledge of a person skilled in the art.

Various types of surface cleaning apparatus are known, including upright surface cleaning apparatus, canister surface cleaning apparatus, stick surface cleaning apparatus, central vacuum systems, and hand carriable surface cleaning apparatus such as hand vacuums. Further, various designs for cyclonic hand vacuum cleaners, including battery operated cyclonic hand vacuum cleaners, are known in the art.

Various types of docking units are known which include one or more surface cleaning apparatus. The dirt collection regions of a docking unit may be internal to the docking unit. The docking units may also include a suction motor and fan system used to empty the surface cleaning apparatus while the surface cleaning apparatus is in communication with the docking system.

### SUMMARY

In accordance with one aspect of this disclosure there is a provided a surface cleaning apparatus having an emptying port and valve that is slidably movable between an open and a closed position. An advantage of this design is that the surface cleaning apparatus may be easily opened for emptying when in a dirt emptying mode of operation. Another advantage is that the surface cleaning apparatus may be docked at a docking unit for emptying without requiring a complex opening mechanism for the dirt emptying mode of operation. For example, the docking unit may have a non-moveable engagement member that engages the valve or a linkage drivingly connected to the valve whereby the valve is moved as the surface cleaning is docked.

In accordance with this aspect, there is provided: a surface cleaning apparatus comprising an emptying air flow path extending from an air inlet port to a first emptying port, and a first emptying port valve that is moveable between an open position in which the first emptying port is open and a closed position in which the first emptying port is closed, the first emptying port valve is slideably moveable between the open position and the closed position.

In accordance with another aspect of this disclosure, a portion of a surface cleaning apparatus may be disinfected, e.g., by UV light, when the surface cleaning apparatus, or a portion thereof such as an air treatment assembly, is docked at a docking unit. The disinfection source may be in the docking unit. An advantage of this design is that an air treatment assembly and/or another portion of the surface cleaning apparatus may be disinfected concurrently or sequentially while the air treatment assembly is emptied. Alternately, the disinfection source may be in the surface cleaning apparatus.

In accordance with this aspect, there is provided a docking station for at least a portion of a surface cleaning apparatus comprising a first dirt collection region of the surface cleaning apparatus, wherein the docking station is operable to disinfect the dirt collection region with a disinfection agent when the at least a portion of the surface cleaning apparatus is docked at the docking station.

In accordance with this aspect, there is also provided a surface cleaning apparatus comprising a UV light emitting member that is located interior of the surface cleaning apparatus and is operable to disinfect a portion of an exterior surface of the surface cleaning apparatus wherein the UV light emitting member is activated while the surface cleaning apparatus is docked at a docking station.

In accordance with this aspect, there is also provided a surface cleaning apparatus comprising a UV light emitting member and a portion of an exterior surface of the surface cleaning apparatus that is transparent to UV light wherein the UV light emitting member is operable to emit UV light at a location interior of the surface cleaning apparatus whereby, when the UV light emitting member is operated and the portion of an exterior surface is positioned within a docking station, the portion of an exterior surface of the surface cleaning apparatus is treated with UV light and the docking station inhibits the UV light radiating outwardly of the docking station.

In accordance with this aspect, there is also provided an apparatus comprising a portion of an exterior surface of a surface cleaning apparatus that is transparent to UV light, a UV light emitting member and a light pipe whereby, when the UV light emitting member is activated, the light pipe transmits UV light from the UV light emitting member to a location that is interior of the exterior surface of the surface cleaning apparatus whereby, when the UV light emitting member is operated, the portion of an exterior surface of the surface cleaning apparatus is treated with UV light.

In accordance with another aspect of this disclosure, there is provided a docking unit for emptying a surface cleaning apparatus having two dirt collection regions. When in the dirt emptying mode of operation, the first dirt collection region is emptyable prior to emptying the second dirt collection region. An advantage of this design is that, if coarser dirt is collected in the first dirt collection region and finer dirt is collected in the second dirt collection region, then coarser dirt may be collected in the first dirt collection region and emptying this region first may provide an additional filter barrier in the docking unit for when finer dirt is emptied from the second dirt collection region. For example, if the docking unit uses a filter bag, or other porous collection member, or even a screen outlet from a dirt collection region, the coarser dirt may partially block some of the pores in the bag or the like and thereby increase the filtration ability of the filter bag or the like for when the finer dirt is emptied from the second dirt collection region. Accordingly, the efficiency of dirt retention within the docking unit may be improved.

In accordance with this aspect, there is provided a docking unit for emptying first and second dirt collection regions of a surface cleaning apparatus, the surface cleaning apparatus having a motor and fan assembly, the docking unit comprising:
a) a docking unit dirt collection chamber; and,
b) a docking unit air flow path extending from a docking unit inlet port to a docking unit outlet port, wherein a docking unit dirt collection chamber is provided in the docking unit dirt air flow path,
   wherein, when at least a portion of the surface cleaning apparatus comprising the first and second dirt collection regions is docked at the docking unit and the docking unit is in a dirt emptying mode of operation, dirt is transferred from the first dirt collection region into the docking unit dirt collection chamber prior to dirt being transferred from the second dirt collection region into the docking unit dirt collection chamber.

In accordance with another aspect of this disclosure, a downstream portion of the surface cleaning apparatus is closed during a dirt emptying mode of operation and an evacuation air inlet is opened, thereby altering the air flow path through part or all of the air treatment member or members of the surface cleaning apparatus during the dirt emptying mode of operation. An advantage of this design is that the suction motor in the surface cleaning apparatus may be used to provide a motive force for emptying the dirt collection region, thereby improving the efficiency of the emptying process. Further, dirt may be pushed from the air outlet end of the air treatment member or members to an evacuation air inlet port which may be at an end opposed to the air outlet end of the air treatment member or members thereby assisting is emptying the air treatment member or members.

In accordance with this aspect, there is provided a surface cleaning apparatus comprising:
a) an air flow path from a dirty air inlet to a clean air outlet; and,
b) an air treatment chamber positioned in the air flow path, the air treatment chamber having a first end, an opposed second end, an air treatment chamber air inlet and an air treatment chamber air outlet, the air treatment chamber air outlet is provided at the outlet end,
c) a suction motor positioned in the air flow path downstream of the air treatment chamber air outlet and upstream of the clean air outlet wherein a downstream part of the air flow path extends between the air treatment chamber air outlet and a suction motor air inlet,
   wherein the surface cleaning apparatus is operable in a cleaning mode in which air to be treated enters the surface cleaning apparatus from the dirty air inlet, the air then enters the air treatment chamber and exits the air treatment chamber though the air treatment chamber air outlet, passes through the downstream part of the air flow path to the suction motor and subsequently exits the surface cleaning apparatus by the clean air outlet and
   wherein, during a dirt emptying mode of operation, at least a portion of the downstream part of the air flow path is closed and an evacuation air inlet port is opened whereby air is inhibited from travelling to the suction motor air inlet and an evacuation air inlet port is opened whereby air travels from the evacuation air inlet port through a dirt evacuation port to a docking unit.

In accordance with another aspect of this disclosure, the air treatment chamber of the surface cleaning apparatus includes a porous member with a moveable portion. An advantage of this design is that, during the dirt emptying mode of operation, the moveable portion may be moved to open the porous member, thereby allowing dirt and/or debris within the porous member to be removed. Further, during an emptying mode of operation, air may be directed through the porous member thereby removing dirt accumulated thereon and, subsequently, the moveable portion may be moved to an open position whereby less air may be forced through the porous member and a higher flow of air may travel through an air treatment chamber in which the porous member is located, thereby assisting in emptying the air treatment chamber.

In accordance with this aspect, there is provided a surface cleaning apparatus comprising:
a) an air flow path from a dirty air inlet to a clean air outlet; and,
b) an air treatment chamber positioned in the air flow path, the air treatment chamber having an air treatment chamber air inlet and an air treatment chamber air outlet, the air treatment chamber air outlet comprises a porous member, that extends into the air treatment chamber from a wall of the air treatment chamber, the porous member has an outlet end that is located at the wall, an opposed inner end and a porous section, the porous member has a moveable portion that is moveable to an open position,
   wherein the surface cleaning apparatus is operable in a cleaning mode in which air to be treated enters the surface cleaning apparatus from the dirty air inlet, the air then enters the air treatment chamber and exits the air treatment chamber though the porous member and subsequently exits the surface cleaning apparatus by the clean air outlet and
   wherein, during a dirt emptying mode of operation, a flow of air enters the air treatment chamber through the porous member and, during at least a portion of the dirt emptying mode of operation, the moveable portion is in the open position whereby at least some of the flow of air exits the porous member without passing through the porous section of the porous member.

In accordance with another aspect of this disclosure, the surface cleaning apparatus emptying port is in flow communication with the docking unit during the dirt emptying mode of operation such that air flows through the dirty air inlet, through an emptying port, which may be at an end of end of an air treatment chamber opposed to the inlet port of the air treatment chamber, and into the docking unit. An advantage of this design is that the air flow path from the dirty air inlet of the surface cleaning apparatus to the air inlet of an air treatment chamber need not be closed, thereby simplifying the design of the air treatment chamber.

In accordance with this aspect, there is provided a surface cleaning apparatus comprising:
a) a surface cleaning head having a dirty air inlet;
b) an upper upright section that is mounted to the surface cleaning head and is moveable between an upright storage position and a reclines floor cleaning position;
c) an air flow path extending from the dirty air inlet to a clean air outlet;
d) an air treatment chamber positioned in the air flow path, the air treatment chamber having an air treatment chamber air inlet, an air treatment chamber air outlet and an emptying port; and,
e) a suction motor provided in the air flow path,
   wherein, when the surface cleaning apparatus is docked at a docking unit and is in a dirt emptying mode of operation, the emptying port is in flow communication with a dirt collection region of the docking unit and a flow of air enters the air treatment chamber through the dirty air inlet and exits through the emptying port.

In accordance with another aspect of this disclosure, the air treatment chamber of the surface cleaning apparatus includes a closure flap that is moveable to close an air inlet, such as the air inlet to an air treatment chamber. An advantage of this design is that the closure flap may prevent collected dirt from exiting the surface cleaning apparatus when not in use but open to allow air to flow through the air inlet during an emptying mode of operation. For example, during an emptying mode of operation, air may be directed in a reverse direction out the air inlet of the air treatment chamber. Opening the flap, such as during a docking operation, allows such a reverse flow of air.

In accordance with this aspect, there is provided a surface cleaning apparatus comprising:
a) an air flow path extending from a dirty air inlet to a clean air outlet;
b) an air treatment chamber positioned in the air flow path, the air treatment chamber having an air treatment chamber air inlet, an air treatment chamber air outlet and a closure flap associated with the air treatment chamber air inlet, the closure flap is moveable between a closed position in which the air treatment chamber air inlet is closed and an open position wherein, during a surface cleaning mode of operation, the closure flap is open; and,
c) a suction motor provided in the air flow path, wherein, when the surface cleaning apparatus is docked at a docking unit and is in a dirt emptying mode of operation, the air treatment chamber air inlet is in flow communication with a dirt collection region of the docking unit and the closure flap is in the open position whereby a flow of air enters travels through the air treatment chamber air inlet to the docking unit.

In accordance with another aspect of this disclosure, an air treatment chamber of the surface cleaning apparatus includes, in addition to an air inlet and an air outlet, an evacuation air inlet port and a dirt evacuation port, whereby during the dirt emptying mode of operation, air flows into the air treatment chamber through the evacuation air inlet port and out the dirt evacuation port. An advantage of this design is that the evacuation air inlet port may operate as a bleed valve to introduce air into the air treatment chamber during the dirt emptying mode, thereby modifying the air flow path.

In accordance with this aspect, there is provided a surface cleaning apparatus comprising:
a) an air flow path extending from a dirty air inlet to a clean air outlet;
b) an air treatment chamber positioned in the air flow path, the air treatment chamber having an air treatment chamber air inlet, an air treatment chamber air outlet, a first end, an axially opposed second end, a sidewall extending between the first and second ends, a dirt evacuation port and a first evacuation air inlet port, wherein each of the evacuation port and the first evacuation air inlet port has an openable door and the openable door of the first evacuation air inlet port is part of the sidewall; and,
c) a suction motor provided in the air flow path,
   wherein, when the surface cleaning apparatus is docked at a docking unit and is in a dirt emptying mode of operation, the openable door of the first evacuation air inlet port is opened and the dirt evacuation port is in flow communication with a dirt collection region of the docking unit whereby air enters the air treatment chamber via the first evacuation air inlet port and exits the air treatment chamber via the dirt evacuation port.

In accordance with another aspect of this disclosure, during the dirt emptying mode of operation, an air treatment chamber air inlet and an air treatment chamber air outlet are alternately openable to alter the air flow path through the air treatment chamber. An advantage of this design is that dirt in different areas of the dirt collection region may be subjected to an emptying force, such as by a suction motor, increasing the likelihood that the entire dirt collection region is emptied during the dirt emptying mode of operation.

In accordance with this aspect, there is provided a surface cleaning apparatus comprising:
a) an air flow path extending from a dirty air inlet to a clean air outlet;
b) an air treatment chamber positioned in the air flow path, the air treatment chamber having an air treatment chamber air inlet, an air treatment chamber air outlet, a first end, an axially opposed second end, a sidewall extending between the first and second ends and a dirt evacuation port; and,
c) a suction motor provided in the air flow path,
   wherein, when the surface cleaning apparatus is docked at a docking unit, the surface cleaning apparatus is operable in a dirt emptying mode of operation, and
   wherein, during a first portion of the dirt emptying mode of operation, the air treatment chamber air outlet is closed and the air treatment chamber air inlet is open whereby air enters the air treatment chamber via the air treatment chamber air inlet and exits the air treatment chamber via the dirt evacuation port and, during a second portion of the dirt emptying mode of operation, the air treatment chamber air outlet is open and the air treatment chamber air inlet is closed whereby air enters the air treatment chamber via the air treatment chamber air outlet and exits the air treatment chamber via the dirt evacuation port.

In accordance with another aspect of this disclosure, at least two of an air treatment chamber air inlet, an air treatment chamber air outlet and a first evacuation air inlet port are operable to vary a direction of air flow through the air treatment chamber during the dirt emptying mode of operation. An advantage of this design is that the air flow path through the air treatment chamber may be varied during the dirt emptying mode of operation to improve the emptying efficiency.

In accordance with this aspect, there is provided a surface cleaning apparatus comprising:
a) an air flow path extending from a dirty air inlet to a clean air outlet;
b) an air treatment chamber positioned in the air flow path, the air treatment chamber having an air treatment chamber air inlet, an air treatment chamber air outlet, a first end, an axially opposed second end, a sidewall extending between the first and second ends, a dirt evacuation port and a first evacuation air inlet port; and,
c) a suction motor provided in the air flow path,
   wherein, when the surface cleaning apparatus is docked at a docking unit, the surface cleaning apparatus is operable in a dirt emptying mode of operation, and
   wherein at least two of the air treatment chamber air inlet, the air treatment chamber air outlet and the first evacuation air inlet port are operable to vary a direction of air flow through the air treatment chamber during the dirt emptying mode of operation.

In accordance with another aspect of this disclosure, the surface cleaning apparatus includes two evacuation air inlets that are operable to vary the air flow through the air treatment chamber during the dirt emptying mode of operation. An advantage of this design is that dirt in different areas of the dirt collection region may be exposed to a motive emptying force, thereby improving the emptying efficiency of the dirt emptying mode of operation.

In accordance with this aspect, there is provided a surface cleaning apparatus comprising:
a) an air flow path extending from a dirty air inlet to a clean air outlet;
b) an air treatment chamber positioned in the air flow path, the air treatment chamber having an air treatment chamber air inlet, an air treatment chamber air outlet, a first end, an axially opposed second end, a sidewall extending between the first and second ends, a dirt evacuation port a first evacuation air inlet port and a second evacuation air inlet port; and,
c) a suction motor provided in the air flow path,
   wherein, when the surface cleaning apparatus is docked at a docking unit, the surface cleaning apparatus is operable in a dirt emptying mode of operation, and
   wherein the first and second evacuation air inlet ports are operable to vary a direction of air flow through the air treatment chamber during the dirt emptying mode of operation.

In accordance with another aspect of this disclosure, the air flow is varied, e.g., pulsed on a regular or sporadic pattern, during the dirt emptying mode of operation. Varying the air flow, such as by, for example, changing the flow rate, may improve the ability of the emptying mode of operation to dislodge dirt from within a dirt collection region, thereby improving the emptying efficiency.

In accordance with this aspect, there is provided a docking unit for a surface cleaning apparatus, the docking unit comprising an emptying air flow path that extends from an inlet port that is connectable with a surface cleaning apparatus emptying port to an air outlet port, wherein a suction motor is positioned in the air flow path wherein, during a surface cleaning apparatus emptying operation, air flow through the emptying air flow path is varied.

In accordance with this aspect, there is also provided a surface cleaning apparatus that is dockable with a docking unit wherein, when the surface cleaning apparatus is docked with the docking unit, an emptying air flow path is provided whereby air flow through the emptying air flow path during a surface cleaning apparatus emptying operation empties a dirt collection region of the surface cleaning apparatus, wherein, during the surface cleaning apparatus emptying operation, air flow through the emptying air flow path is varied.

In accordance with another aspect of this disclosure, the air inlet port has an air inlet port valve that is moveable between an open position and a closed position. The valve is actuatable by an inlet port actuator, such as a bellows, that is drivenly connected to the suction motor such that activating the suction motor moves the inlet port valve to the open position. An advantage of this design is that the suction motor may be used to control the opening and closing of the inlet port during the dirt emptying mode of operation.

In accordance with this aspect, there is provided a docking unit for a surface cleaning apparatus, the surface cleaning apparatus comprising a first air inlet port and a first air inlet port valve, the first air inlet port valve is moveable between an open position in which the first air inlet port is open and a closed position in which the first air inlet port is closed, the docking unit comprising:
a) an emptying air flow path that extends from a docking unit air inlet port, which is connectable with a surface cleaning apparatus emptying port, to a docking unit air outlet port; and,
b) a first inlet port actuator wherein, when the surface cleaning apparatus is docked with the docking unit, the first inlet port actuator is driving connected to the air first inlet port valve,
   wherein, during a surface cleaning apparatus emptying operation when the surface cleaning apparatus is docked with the docking unit, a suction motor is positioned in the air flow path and the suction motor is drivingly connected to the first inlet port actuator whereby, when the suction motor is actuated, the first inlet port actuator is actuated and the first inlet port valve is moved to the open position.

In accordance with another aspect of this disclosure, an air treatment assembly has an air treatment chamber and a dirt collection chamber. The air treatment chamber has a moveable portion, e.g., a plate that is positioned at an interface of the air treatment chamber and a dirt collection chamber. The air treatment chamber and the dirt collection chamber are both opened, and optionally concurrently opened, as or when the surface cleaning apparatus is docked at a docking unit. An advantage of this design is that the plate may move to open the air treatment chamber during the dirt emptying mode of operation, thereby providing access to additional regions within the surface cleaning apparatus for emptying.

In accordance with this aspect, there is provided a surface cleaning apparatus comprising:
a) an air treatment assembly comprising an air treatment chamber and a dirt collection chamber external to the air treatment chamber, the air treatment assembly having a first end comprising a first end wall and a second end comprising a second end wall with a longitudinal axis that extends between the first and second end walls, wherein the first end of the air treatment assembly is openable;
b) the air treatment chamber having a dirt outlet in communication with the dirt collection chamber, a first end and a second end wherein the longitudinal axis extends between the first and second ends of the air treatment chamber;
c) a plate provided at the first end of the air treatment chamber, the plate is spaced from and faces the first end wall of the air treatment assembly whereby at least a portion of the dirt collection chamber is positioned between the first end wall of the air treatment assembly and the plate, the plate having a first portion and a second portion that is moveable with respect to the first portion; and,
d) the dirt outlet comprises a space between the plate and a sidewall of the air treatment chamber,
   wherein the second portion of the plate is openable while the first portion of the plate remains stationary.

In accordance with this aspect, there is also provided a surface cleaning apparatus comprising:
a) an air treatment assembly comprising an air treatment chamber and a dirt collection chamber external to the air treatment chamber, the air treatment chamber having a first end comprising a first end wall and a second end comprising a second end wall with a longitudinal axis that extends between the first and second end walls, wherein the first end of the air treatment assembly is moveably mounted between a closed position and an open position;
b) the air treatment chamber having a dirt outlet in communication with the dirt collection chamber, a first end and a second end wherein the longitudinal axis extends between the first and second ends of the air treatment chamber;
c) a plate provided at the first end of the air treatment chamber, the plate is spaced from and faces the first end wall of the air treatment assembly whereby at least a portion of the dirt collection chamber is positioned between the first end wall of the air treatment assembly and the plate, wherein the plate is moveably mounted between a closed position and an open position; and,
d) the dirt outlet comprises a space between the plate and a sidewall of the air treatment chamber,
   wherein a mount for the plate is positioned radially inwardly in a direction transverse to the longitudinal axis than a mount for the first end of the air treatment assembly.

In accordance with another aspect of this disclosure, a flexible sealing member is provided between the end wall of the air treatment chamber and the docking unit when the surface cleaning apparatus is docked at the docking unit. An advantage of this design is that the flexible sealing member may reduce the likelihood of contaminants and/or allergens from exiting the docking unit during the dirt emptying mode of operation, thereby improving the comfort of the user.

In accordance with this aspect, there is provided a docking unit and a surface cleaning apparatus dockable with the docking unit, the surface cleaning apparatus comprising:
a) an air treatment assembly comprising an air treatment chamber and a dirt collection chamber external to the air treatment chamber, the air treatment chamber having a first end comprising a first end wall and a second end comprising a second end wall with a longitudinal axis that extends between the first and second end walls, wherein the first end of the air treatment assembly is moveably mounted between a closed position and an open position;
b) the air treatment chamber having a dirt outlet in communication with the dirt collection chamber, a first end and a second end wherein the longitudinal axis extends between the first and second ends of the air treatment chamber;
c) a plate provided at the first end of the air treatment chamber, the plate is spaced from and faces the first end wall of the air treatment assembly whereby at least a portion of the dirt collection chamber is positioned between the first end wall of the air treatment assembly and the plate, wherein the plate is moveably mounted between a closed position and an open position;
d) the dirt outlet comprises a space between the plate and a sidewall of the air treatment chamber,
   wherein the docking unit has a docking port and the first end of the air treatment assembly interfaces with the docking port when the air treatment assembly docks with the docking unit, and
   wherein at least one of the first end of the air treatment assembly and the docking port has a first flexible sealing member, the first flexible sealing member has a diameter in a plane transverse to the longitudinal axis that is greater than a diameter of the first end wall in the plane transverse to the longitudinal axis whereby the first end wall of the air treatment assembly is positioned inwardly of the first flexible sealing member when the air treatment assembly is docked with the docking unit.

In accordance with another aspect of this disclosure, when the air treatment assembly is docked at the docking unit, the air treatment chamber and the dirt collection chamber are each openable whereby the air treatment chamber and the dirt collection chamber are each in communication with a dirt collection region of the docking unit. The air and dirt collection chambers may be opened, optionally concurrently opened, by opening a sidewall of the chambers and/or opening end walls of the chambers. An advantage of this design is that multiple regions of the surface cleaning apparatus may be emptied during the dirt emptying mode of operation.

In accordance with this aspect, there is provided a docking unit and a surface cleaning apparatus dockable with the docking unit, the surface cleaning apparatus comprising:
a) an air treatment assembly comprising an air treatment chamber and a dirt collection chamber external to the air treatment chamber, the air treatment chamber having a first end comprising a first end wall and a second end comprising a second end wall with a longitudinal axis that extends between the first and second end walls, wherein the first end of the air treatment assembly is openable;
b) the air treatment chamber having a dirt outlet in communication with the dirt collection chamber, a first end and a second end wherein the longitudinal axis extends between the first and second ends of the air treatment chamber;
c) a plate provided at the first end of the air treatment chamber, the plate is spaced from and faces the first end wall of the air treatment assembly whereby at least a portion of the dirt collection chamber is positioned between the first end wall of the air treatment assembly and the plate; and,
d) the dirt outlet comprises a space between the plate and a sidewall of the air treatment chamber,
   wherein the docking unit has a docking port and, when the air treatment assembly is docked with the docking unit, the air treatment chamber and the dirt collection chamber are each openable whereby the air treatment chamber and the dirt collection chamber are each in communication with a dirt collection region of the docking unit.

In accordance with another aspect of this disclosure, an upright surface cleaning apparatus includes an emptying port provided in one of the surface cleaning head or upright section whereby the upright surface cleaning apparatus is dockable at a docking unit without removing an air treatment assembly from the upright surface cleaning apparatus. An advantage of this design is that the upright surface cleaning apparatus may be easily emptied by being docked at the docking unit without any reconfiguration or removal of any component therefrom.

In accordance with this aspect, there is provided a surface cleaning apparatus comprising:
a) a surface cleaning head having a dirty air inlet;
b) an upright section that is mounted to the surface cleaning head and is moveable between an upright storage position and a reclined floor cleaning position;
c) an air flow path extending from the dirty air inlet to a clean air outlet;
d) an air treatment chamber positioned in the air flow path, the air treatment chamber having an air treatment chamber air inlet, an air treatment chamber air outlet;
e) a suction motor provided in the air flow path; and,
f) an emptying port provided in at least one of the surface cleaning head or a lower end of the upper section,
   wherein, when the surface cleaning apparatus is docked at a docking unit and is in a dirt emptying mode of operation, the emptying port is in flow communication with a dirt collection region of the docking unit.

In accordance with another aspect of this disclosure, the docking unit has a downflow duct extending from a docking unit inlet port to a base unit and an upflow duct extending from the docking unit outlet port to the base unit. An advantage of this design is that a surface cleaning apparatus is dockable at the docking unit in the dirt emptying mode of operation such that the suction motor of the surface cleaning apparatus may be used to provide the motive force to empty the dirt collection region of the surface cleaning apparatus.

In accordance with this aspect, there is provided a docking unit for emptying a dirt collection region of a surface cleaning apparatus, the surface cleaning apparatus having a motor and fan assembly, the docking unit comprising:
a) a floor standing base unit comprising a docking unit dirt collection chamber; and,
b) a docking unit inlet port connectable in flow communication with the dirt collection region of the surface cleaning apparatus;
c) a docking unit outlet port connectable in flow communication with the suction motor of the surface cleaning apparatus;
d) a down flow duct extending from the docking unit inlet port to the floor standing base;
e) an up flow duct extending from the floor standing base to the docking unit outlet port; and,
f) a docking unit air flow path extending from the docking unit inlet port to the docking unit outlet port, wherein the docking unit dirt collection chamber is provided in the docking unit air flow path.

In accordance with another aspect of this disclosure, the base unit has an upper surface that is exposed when the surface cleaning apparatus is docked at the docking unit. An advantage of this design is that the upper surface may be used for other emptying modes, such as being openable to provide access to a trash bin.

In accordance with this aspect, there is provided a docking unit for emptying a dirt collection region of a surface cleaning apparatus, the surface cleaning apparatus having a motor and fan assembly, the docking unit comprising:
a) a base unit comprising a docking unit dirt collection chamber and an upper surface, wherein the upper surface is exposed when the surface cleaning apparatus is docked at the docking unit; and,
b) a docking unit inlet port connectable in flow communication with the dirt collection region of the surface cleaning apparatus;
c) a docking unit outlet port connectable in flow communication with the suction motor of the surface cleaning apparatus;
d) a down flow duct extending from the docking unit inlet port to the floor standing base;
e) an up flow duct extending from the floor standing base to the docking unit outlet port; and,
f) a docking unit air flow path extending from the docking unit inlet port to the docking unit outlet port, wherein the docking unit dirt collection chamber is provided in the docking unit air flow path.

In accordance with another aspect of this disclosure, the surface cleaning apparatus is a hand vacuum cleaner that has the evacuation port positioned on one of the upper side, the lower side, and the right side. An advantage of this design is that the surface cleaning apparatus may be easily dockable at the docking unit.

In accordance with this aspect, there is provided a hand vacuum cleaner that is dockable with a docking unit, the hand vacuum cleaner having an upper side, a lower side, a right side and a laterally opposed left side, the hand vacuum cleaner comprising:
a) a cleaning air flow path that extends from a dirty air inlet to a clean air outlet, the dirty air inlet is provided at a front end of the hand vacuum cleaner, the hand vacuum cleaner has a longitudinal axis that extends between the front end of the hand vacuum cleaner and a rear end of the hand vacuum cleaner;
b) an air treatment chamber provided in the air flow path, the air treatment chamber comprising a dirt collection region;
c) a handle provided on a lower side of the hand vacuum cleaner; and,
d) a first dirt evacuation port provided on one of the upper side, the lower side and the right side.

In accordance with another aspect of this disclosure, the surface cleaning apparatus is a hand vacuum cleaner with a pistol grip handle and has the evacuation port positioned on one of the upper side, the lower side, and the right side. An advantage of this design is that the surface cleaning apparatus may be easily dockable at the docking unit by the user manipulating the surface cleaning apparatus by the pistol grip handle.

In accordance with this aspect, there is provided a hand vacuum cleaner that is dockable with a docking unit, the hand vacuum cleaner comprising:
a) a cleaning air flow path that extends from a dirty air inlet to a clean air outlet, the dirty air inlet is provided at a front end of the hand vacuum cleaner, the hand vacuum cleaner has a longitudinal axis that extends between the front end of the hand vacuum cleaner and a rear end of the hand vacuum cleaner;
b) an air treatment chamber provided in the air flow path, the air treatment chamber comprising a dirt collection region;
c) a pistol grip handle; and,
d) a first dirt evacuation port, wherein, when the hand vacuum cleaner is in use to clean a floor, the hand vacuum cleaner has an upper side, a lower side, a right side and a laterally opposed left side and the first dirt evacuation port is provided on one of the upper side, the lower side and the right side.

In accordance with another aspect of this disclosure, the surface cleaning apparatus has a plurality of dirt evacuation ports. An advantage of this design is that multiple regions of the surface cleaning apparatus may be emptied concurrently and/or sequentially to improve the efficiency of the dirt emptying mode of operation.

In accordance with this aspect, there is provided a hand vacuum cleaner that is dockable with a docking unit, the hand vacuum cleaner comprising:
a) a cleaning air flow path that extends from a dirty air inlet to a clean air outlet, the dirty air inlet is provided at a front end of the hand vacuum cleaner, the hand vacuum cleaner has a longitudinal axis that extends between the front end of the hand vacuum cleaner and a rear end of the hand vacuum cleaner;
b) an air treatment chamber provided in the air flow path, the air treatment chamber comprising a dirt collection region;
c) a handle;
d) a first dirt evacuation port, wherein, when the hand vacuum cleaner is in use to clean a floor, the hand vacuum cleaner has an upper side, a lower side, a right side and a laterally opposed left side and the first dirt evacuation port is provided on one of the upper side, the lower side and the right side; and,
e) a second dirt evacuation port.

In accordance with another aspect of this disclosure, an energy storage member positioned in the surface cleaning apparatus powers the suction motor that provides an air flow for transferring dirt from the dirt collection region into the docking unit during the dirt emptying mode of operation. An advantage of this design is that the energy storage member of the surface cleaning apparatus may be used to facilitate the dirt emptying mode of operation without requiring additional power to the docking unit.

In accordance with this aspect, there is provided a docking unit for emptying a surface cleaning apparatus, the surface cleaning apparatus having a dirt collection region and an energy storage member, the docking unit comprising:
a) a docking unit dirt collection chamber; and,
b) a docking unit air flow path extending from a docking unit inlet port to a docking unit outlet port, wherein a docking unit dirt collection chamber is provided in the docking unit dirt collection chamber,
   wherein, when at least a portion of the surface cleaning apparatus comprising the dirt collection region and the energy storage member is docked at the docking unit and the docking unit is in a dirt emptying mode of operation, the energy storage member powers a motor and fan assembly and the motor and fan assembly provide an air flow that transfers dirt from the dirt collection region into the docking unit dirt collection chamber.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 shows perspective view of a surface cleaning apparatus and docking unit in accordance with an embodiment herein.

FIG. 2 shows a cross-sectional view of the surface cleaning apparatus and docking unit of FIG. 1;

FIG. 3 shows a cross-sectional view of the surface cleaning apparatus of FIG. 1 with an illustration of a cleaning air flow path;

FIG. 4 shows a perspective view of the surface cleaning apparatus docked at the docking unit of FIG. 1;

FIG. 5 shows a cross-sectional view of the surface cleaning apparatus and docking unit of FIG. 4 with an illustration of an emptying air flow path;

FIG. 6 shows a cross-sectional view of the surface cleaning apparatus and docking unit of FIG. 4 with both openable doors closed;

FIG. 7 shows a cross-sectional view of the surface cleaning apparatus and docking unit of FIG. 4 with one openable door open and one openable door closed;

FIG. 8 shows a perspective view of a surface cleaning apparatus and docking unit in accordance with another embodiment herein;

FIG. 9 shows a cross-sectional view of the surface cleaning apparatus and docking unit of FIG. 8;

FIG. 10 shows a cross-sectional view of the surface cleaning apparatus of FIG. 8 with an illustration of a cleaning air flow path;

FIG. 11 shows a perspective view of the surface cleaning apparatus docked at the docking unit of FIG. 8;

FIG. 12 shows a cross-sectional view of the surface cleaning apparatus and docking unit of FIG. 8 with an illustration of an emptying air flow path;

FIG. 13 shows a cross-sectional view from below of the surface cleaning apparatus and docking unit of FIG. 8;

FIG. 14 shows a perspective view of a surface cleaning apparatus and docking unit in accordance with another embodiment herein;

FIG. 15 shows a cross-sectional view of the surface cleaning apparatus and docking unit of FIG. 14;

FIG. 16 shows a cross-sectional view of the surface cleaning apparatus of FIG.

14 with an illustration of a cleaning air flow path;

FIG. 17 shows a perspective view of the surface cleaning apparatus docked at the docking unit of FIG. 14;

FIG. 18 shows a cross-sectional view of the surface cleaning apparatus and docking unit of FIG. 14 with an illustration of an emptying air flow path;

FIG. 19 shows a cross-sectional view from below of the surface cleaning apparatus and docking unit of FIG. 14;

FIG. 20 shows a perspective view of a surface cleaning apparatus and docking unit in accordance with another embodiment herein;

FIG. 21 shows a cross-sectional view of the surface cleaning apparatus and docking unit of FIG. 20;

FIG. 22 shows a cross-sectional view of the surface cleaning apparatus of FIG. 20 with an illustration of a cleaning air flow path;

FIG. 23 shows a perspective view of the surface cleaning apparatus docked at the docking unit of FIG. 20;

FIG. 24 shows a cross-sectional view of the surface cleaning apparatus and docking unit of FIG. 20 with an illustration of an emptying air flow path;

FIG. 25 shows a perspective view of a surface cleaning apparatus and docking unit in accordance with another embodiment herein;

FIG. 26 shows a cross-sectional view of the surface cleaning apparatus and docking unit of FIG. 25;

FIG. 27 shows a cross-sectional view of the surface cleaning apparatus of FIG. 25;

FIG. 28 shows a perspective view of the surface cleaning apparatus docked at the docking unit of FIG. 25;

FIG. 29 shows a cross-sectional view of the surface cleaning apparatus and docking unit of FIG. 25 with an illustration of an emptying air flow path;

FIG. 30 shows a cross-sectional view of the surface cleaning apparatus and docking unit of FIG. 25 with a valve in a first position;

FIG. 31 shows a cross-sectional view of the surface cleaning apparatus and docking unit of FIG. 25 with the valve in the second position;

FIG. 32 shows a perspective view of a surface cleaning apparatus and docking unit in accordance with another embodiment herein;

FIG. 33 shows a cross-sectional view of the surface cleaning apparatus and docking unit of FIG. 32;

FIG. 34 shows a cross-sectional view of the surface cleaning apparatus of FIG. 32 with an illustration of a cleaning air flow path;

FIG. 35 shows a perspective view of the surface cleaning apparatus docked at the docking unit of FIG. 32;

FIG. 36 shows a cross-sectional view of the surface cleaning apparatus and docking unit of FIG. 32 with an illustration of an emptying air flow path;

FIG. 37 shows a cross-sectional view of the surface cleaning apparatus and docking unit of FIG. 32 with a valve in a first position;

FIG. 38 shows a cross-sectional view of the surface cleaning apparatus and docking unit of FIG. 32 with the valve in the second position;

FIG. 39 shows a perspective view of a surface cleaning apparatus and docking unit in accordance with another embodiment herein;

FIG. 40 shows a cross-sectional view of the surface cleaning apparatus and docking unit of FIG. 39 with an illustration of a first emptying air flow path;

FIG. 41 shows a cross-sectional view of the surface cleaning apparatus and docking unit of FIG. 39 with an illustration of a second emptying air flow path;

FIG. 42 shows a cross-sectional view of the surface cleaning apparatus and docking unit of FIG. 39 with an illustration of a third emptying air flow path;

FIG. 43 shows a cross-sectional view of the surface cleaning apparatus and docking unit of FIG. 39 with a valve in a first position;

FIG. 44 shows a cross-sectional view of the surface cleaning apparatus and docking unit of FIG. 39 with the valve in the second position;

FIG. 45 shows a perspective view of a surface cleaning apparatus and docking unit in accordance with another embodiment herein;

FIG. 46 shows a cross-sectional view of the surface cleaning apparatus and docking unit of FIG. 45;

FIG. 47 shows a cross-sectional view of the surface cleaning apparatus of FIG. 45 with an illustration of a cleaning air flow path;

FIG. 48 shows a perspective view of the surface cleaning apparatus docked at the docking unit of FIG. 45;

FIG. 49 shows a cross-sectional view of the surface cleaning apparatus and docking unit of FIG. 45 with an illustration of an emptying air flow path;

FIG. 50 shows a perspective view of a surface cleaning apparatus and docking unit in accordance with another embodiment herein;

FIG. 51 shows a cross-sectional view of the surface cleaning apparatus and docking unit of FIG. 50;

FIG. 52 shows a cross-sectional view of the surface cleaning apparatus of FIG. 50 with an illustration of a cleaning air flow path;

FIG. 53 shows a perspective view of the surface cleaning apparatus docked at the docking unit of FIG. 50;

FIG. 54 shows a cross-sectional view of the surface cleaning apparatus and docking unit of FIG. 50 with an illustration of an emptying air flow path;

FIG. 55 shows a perspective view of a surface cleaning apparatus and docking unit in accordance with another embodiment herein;

FIG. 56 shows a cross-sectional view of the surface cleaning apparatus and docking unit of FIG. 55;

FIG. 57 shows a cross-sectional view of the surface cleaning apparatus of FIG. 55 with an illustration of a cleaning air flow path;

FIG. 58 shows a perspective view of the surface cleaning apparatus docked at the docking unit of FIG. 55;

FIG. 59 shows a cross-sectional view of the surface cleaning apparatus and docking unit of FIG. 55 with an illustration of an emptying air flow path;

FIGS. 60A-60B show close-up views of a valve actuator of the surface cleaning apparatus of FIG. 55;

FIGS. 61A-61B show perspective views of a valve of the surface cleaning apparatus of FIG. 55

FIG. 62 shows a perspective view of a surface cleaning apparatus and docking unit in accordance with another embodiment herein;

FIG. 63 shows a cross-sectional view of the surface cleaning apparatus and docking unit of FIG. 62;

FIG. 64 shows a cross-sectional view of the surface cleaning apparatus of FIG. 62 with an illustration of a cleaning air flow path;

FIG. 65 shows a perspective view of the surface cleaning apparatus docked at the docking unit of FIG. 62;

FIG. 66 shows a cross-sectional view of the surface cleaning apparatus and docking unit of FIG. 62 with an illustration of an emptying air flow path;

FIG. 67 shows a perspective view of a surface cleaning apparatus and docking unit in accordance with another embodiment herein;

FIG. 68 shows a cross-sectional view of the surface cleaning apparatus and docking unit of FIG. 67;

FIG. 69 shows a cross-sectional view of the surface cleaning apparatus of FIG. 67 with an illustration of a cleaning air flow path;

FIG. 70 shows a perspective view of the surface cleaning apparatus docked at the docking unit of FIG. 67;

FIG. 71 shows a cross-sectional view of the surface cleaning apparatus and docking unit of FIG. 67 with an illustration of an emptying air flow path;

FIGS. 72A-27B show perspective views of a valve of the surface cleaning apparatus of FIG. 67;

FIG. 73 shows a perspective view of a surface cleaning apparatus and docking unit in accordance with another embodiment herein;

FIG. 74 shows a cross-sectional view of the surface cleaning apparatus and docking unit of FIG. 73;

FIG. 75 shows a cross-sectional view of the surface cleaning apparatus of FIG. 73 with an illustration of a cleaning air flow path;

FIG. 76 shows a perspective view of the surface cleaning apparatus docked at the docking unit of FIG. 73;

FIG. 77 shows a cross-sectional view of the surface cleaning apparatus and docking unit of FIG. 73 with an illustration of an emptying air flow path;

FIG. 78 shows a perspective view of a surface cleaning apparatus and docking unit in accordance with another embodiment herein;

FIG. 79 shows a cross-sectional view of the surface cleaning apparatus and docking unit of FIG. 78;

FIG. 80 shows a cross-sectional view of the surface cleaning apparatus of FIG. 78 with an illustration of a cleaning air flow path;

FIG. 81 shows a perspective view of the surface cleaning apparatus docked at the docking unit of FIG. 78;

FIG. 82 shows a cross-sectional view of the surface cleaning apparatus and docking unit of FIG. 78 with an illustration of an emptying air flow path;

FIG. 83 shows a perspective view of a surface cleaning apparatus and docking unit in accordance with another embodiment herein;

FIG. 84 shows a cross-sectional view of the surface cleaning apparatus and docking unit of FIG. 83;

FIG. 85 shows a cross-sectional view of the surface cleaning apparatus of FIG. 83 with an illustration of a cleaning air flow path;

FIG. 86 shows a perspective view of the surface cleaning apparatus docked at the docking unit of FIG. 83;

FIG. 87 shows a cross-sectional view of the surface cleaning apparatus and docking unit of FIG. 83 with an illustration of an emptying air flow path;

FIG. 88 shows a perspective view of a surface cleaning apparatus and docking unit in accordance with another embodiment herein;

FIG. 89 shows a cross-sectional view of the surface cleaning apparatus and docking unit of FIG. 88;

FIG. 90 shows a cross-sectional view of the surface cleaning apparatus of FIG. 88 with an illustration of a cleaning air flow path;

FIG. 91 shows a perspective view of the surface cleaning apparatus docked at the docking unit of FIG. 88;

FIG. 92 shows a cross-sectional view of the surface cleaning apparatus and docking unit of FIG. 88 with an illustration of an emptying air flow path;

FIG. 93 shows a perspective view of a surface cleaning apparatus and docking unit in accordance with another embodiment herein;

FIG. 94 shows a cross-sectional view of the surface cleaning apparatus and docking unit of FIG. 93;

FIG. 95 shows a cross-sectional view of the surface cleaning apparatus of FIG. 93 with an illustration of a cleaning air flow path;

FIG. 96 shows a perspective view of the surface cleaning apparatus docked at the docking unit of FIG. 93;

FIG. 97 shows a cross-sectional view of the surface cleaning apparatus and docking unit of FIG. 93 with an illustration of a first emptying air flow path;

FIG. 98 shows a cross-sectional view of the surface cleaning apparatus and docking unit of FIG. 93 with an illustration of a second emptying air flow path;

FIG. 99 shows a perspective view of a surface cleaning apparatus and docking unit in accordance with another embodiment herein;

FIG. 100 shows a cross-sectional view of the surface cleaning apparatus and docking unit of FIG. 99;

FIG. 101 shows a cross-sectional view of the surface cleaning apparatus of FIG. 99 with an illustration of a cleaning air flow path;

FIG. 102 shows a perspective view of the surface cleaning apparatus docked at the docking unit of FIG. 99;

FIG. 103 shows a cross-sectional view of the surface cleaning apparatus and docking unit of FIG. 99 with an inlet valve at a first position and an inlet valve actuator at a first position;

FIG. 104 shows a cross-sectional view of the surface cleaning apparatus and docking unit of FIG. 99 with the inlet valve at a second position and the inlet valve actuator at a second position;

FIG. 105 shows a cross-sectional view of the surface cleaning apparatus and docking unit of FIG. 99 with the inlet valve at the second position and the inlet valve actuator between the first position and the second position;

FIG. 106 shows a cross-sectional view of the surface cleaning apparatus and docking unit of FIG. 99 with the inlet valve at the second position and the inlet valve actuator at the first position;

FIG. 107 shows a cross-sectional view of the surface cleaning apparatus and docking unit of FIG. 99 with the inlet valve at a third position and the inlet valve actuator at the second position;

FIG. 108 shows a cross-sectional view of the surface cleaning apparatus and docking unit of FIG. 99 with the inlet valve at the third position and the inlet valve actuator at the first position, with an illustration of an emptying air flow path;

FIGS. 109A-109B show a perspective and cross-sectional view of a release mechanism for the inlet valve actuator of FIG. 99;

FIG. 110 shows an exploded view of the release mechanism of FIGS. 109A-109B;

FIG. 111 shows a perspective view of a surface cleaning apparatus and docking unit in accordance with another embodiment herein;

FIG. 112 shows a cross-sectional view of the surface cleaning apparatus and docking unit of FIG. 111

FIG. 113 shows a cross-sectional view of the surface cleaning apparatus of FIG. 111 with an illustration of a cleaning air flow path;

FIG. 114 shows a perspective view of the surface cleaning apparatus docked at the docking unit of FIG. 111;

FIG. 115 shows a cross-sectional view of the surface cleaning apparatus and docking unit of FIG. 111 with an illustration of an emptying air flow path;

FIG. 116 shows a cross-sectional view from below of the surface cleaning apparatus and docking unit of FIG. 111;

FIG. 117 shows a perspective view of a surface cleaning apparatus and docking unit in accordance with another embodiment herein;

FIG. 118 shows a cross-sectional view of the surface cleaning apparatus and docking unit of FIG. 117;

FIG. 119 shows a cross-sectional view of the surface cleaning apparatus of FIG. 117 with an illustration of a cleaning air flow path;

FIG. 120 shows a perspective view of the surface cleaning apparatus docked at the docking unit of FIG. 117;

FIG. 121 shows a cross-sectional view of the surface cleaning apparatus and docking unit of FIG. 117 with an arrester plate opened and a portion of a door opened, with an illustration of an emptying air flow path;

FIG. 122 shows a cross-sectional view of the surface cleaning apparatus and docking unit of FIG. 117 with the arrester plate and all of a door opened;

FIG. 123 shows a cross-sectional view of the surface cleaning apparatus and docking unit of FIG. 117 with the arrester plate and door opened and the arrester separated from the door;

FIG. 124 shows a perspective view of a surface cleaning apparatus and docking unit in accordance with another embodiment herein;

FIG. 125 shows a cross-sectional view of the surface cleaning apparatus and docking unit of FIG. 124;

FIG. 126 shows a cross-sectional view of the surface cleaning apparatus of FIG. 124 with an illustration of a cleaning air flow path;

FIG. 127 shows a perspective view of the surface cleaning apparatus docked at the docking unit of FIG. 124;

FIG. 128 shows a cross-sectional and close-up view of the surface cleaning apparatus and docking unit of FIG. 124;

FIG. 129 shows a cross-sectional view of the surface cleaning apparatus and docking unit of FIG. 124 with an illustration of an emptying air flow path passing through a side of an air treatment chamber and dirt collection region of the surface cleaning apparatus;

FIG. 130 shows a cross-sectional view of the surface cleaning apparatus and docking unit of FIG. 124 with a door and arrester plate opened;

FIG. 131 shows a cross-sectional view of the surface cleaning apparatus and docking unit of FIG. 124 with the door and arrester plate opened and a second portion of the door separated from a first portion of the door;

FIG. 132 shows a perspective view of a surface cleaning apparatus and docking unit in accordance with another embodiment herein;

FIG. 133 shows a cross-sectional view of the surface cleaning apparatus and docking unit of FIG. 132;

FIG. 133 shows a cross-sectional view of the surface cleaning apparatus and docking unit of FIG. 132;

FIG. 134 shows a cross-sectional view of the surface cleaning apparatus of FIG. 132 with an illustration of a cleaning air flow path;

FIG. 135 shows a perspective view of the surface cleaning apparatus docked at the docking unit of FIG. 132;

FIG. 136 shows a cross-sectional view of the surface cleaning apparatus and docking unit of FIG. 132 with an illustration of an emptying air flow path;

FIG. 137 shows a perspective view of an upright surface cleaning apparatus and docking unit in accordance with another embodiment herein;

FIG. 138 shows a cross-sectional view of the upright surface cleaning apparatus of FIG. 137 with an illustration of a cleaning air flow path;

FIG. 139 shows a perspective view of the upright surface cleaning apparatus docked at the docking unit of FIG. 137;

FIG. 140 shows a cross-sectional view of the upright surface cleaning apparatus and docking unit of FIG. 137 with an illustration of an emptying air flow path;

FIG. 141 shows a perspective view of a surface cleaning apparatus and docking unit in accordance with another embodiment herein;

FIG. 142 shows a cross-sectional view of the surface cleaning apparatus and docking unit of FIG. 141;

FIG. 143 shows a perspective view of the surface cleaning apparatus docked at the docking unit of FIG. 141; and,

FIG. 144 shows a cross-sectional view of the surface cleaning apparatus and docking unit of FIG. 141 with an illustration of an emptying air flow path.

The drawings included herewith are for illustrating various examples of articles, methods, and apparatuses of the teaching of the present specification and are not intended to limit the scope of what is taught in any way.

### DESCRIPTION OF EXAMPLE EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. None of the terms “coupled”, “connected”, “attached”, and “fastened” distinguish the manner in which two or more parts are joined together.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

As used herein, the wording “and/or” is intended to represent an inclusive—or. That is, “X and/or Y” is intended to mean X or Y or both, for example. As a further example, “X, Y, and/or Z” is intended to mean X or Y or Z or any combination thereof.

As used herein and in the claims, two elements are said to be “parallel” where those elements are parallel and spaced apart, or where those elements are collinear.

### General Description of a Surface Cleaning Apparatus

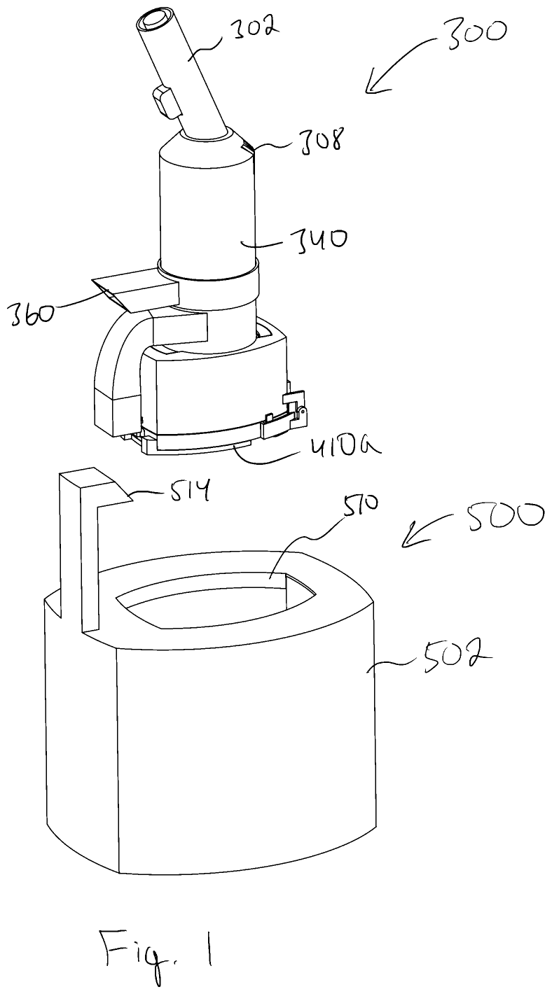

Referring to FIG. 1, an exemplary embodiment of a surface cleaning apparatus is shown generally as 300. The following is a general discussion of apparatus 300, which provides a basis for understanding several of the features that are discussed herein. As discussed subsequently, each of the features may be used individually or in any particular combination or sub-combination in this or in alternate embodiments disclosed herein.

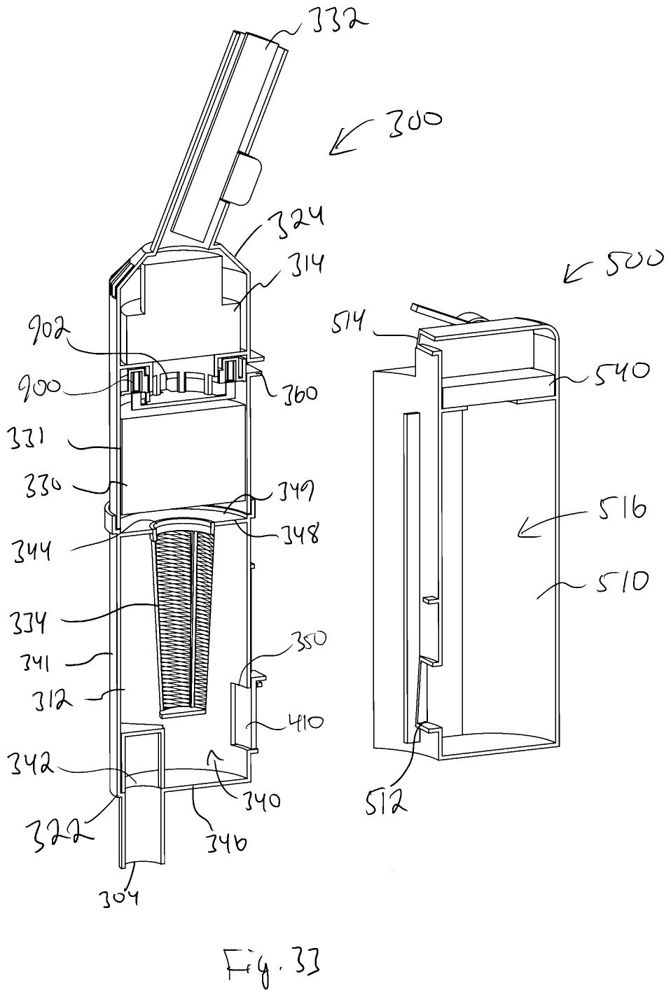

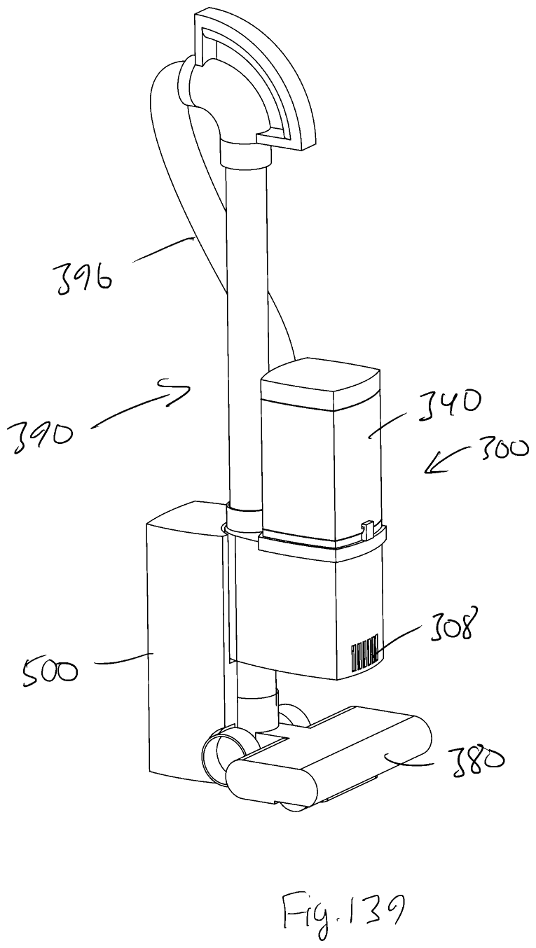

Embodiments described herein include an air treatment chamber 340, and a surface cleaning apparatus 300 including the same. Surface cleaning apparatus 300 may be any type of surface cleaning apparatus, including for example a hand vacuum cleaner as exemplified for example in FIG. 33, a stick vacuum cleaner, an upright vacuum cleaner as exemplified for example in FIG. 139, a canister vacuum cleaner, an extractor, or a wet/dry type vacuum cleaner. Each embodiment discussed subsequently may use any one or more of the features discussed herein.

In FIG. 33, surface cleaning apparatus 300 is illustrated as a hand vacuum cleaner, which may also be referred to also as a “handvac” or “hand-held vacuum cleaner”. As used herein, a hand vacuum cleaner is a vacuum cleaner that can be operated to clean a surface generally one-handedly. That is, the entire weight of the vacuum may be held by the same one hand used to direct a dirty air inlet of the vacuum cleaner with respect to a surface to be cleaned. For example, handle 302 and dirty air inlet 304 may be rigidly coupled to each other (directly or indirectly), such as being integrally formed or separately molded and then non-removably secured together (e.g., adhesive or welding), so as to move as one while maintaining a constant orientation relative to each other. This is to be contrasted with canister and upright vacuum cleaners, whose weight is typically supported by a surface (e.g., a floor) during use. When a canister vacuum cleaner is operated, or when an upright vacuum cleaner is operated in a ‘lift-away’ configuration, a second hand is typically required to direct the dirty air inlet at the end of a flexible hose.

Still referring to FIG. 33, surface cleaning apparatus 300 includes a main body or a handvac body having an air treatment chamber 340 (which may be permanently affixed to the main body or may be removable in part or in whole therefrom for emptying), a dirty air inlet 304, a clean air outlet 308, and an air flow path extending between the dirty air inlet 304 and the clean air outlet 308.

Surface cleaning apparatus 300 has a front end 322, a rear end 324, an upper end (also referred to as the top) 326, and a lower end (also referred to as the bottom) 328, as exemplified in FIG. 33. In the embodiment shown, dirty air inlet 304 is at a portion of apparatus front end 322 and clean air outlet 308 is at a rearward portion of apparatus 300 at apparatus rear end 324. It will be appreciated that dirty air inlet 304 and clean air outlet 308 may be positioned in different locations of apparatus 300. The dirty air inlet 304 may be useable without an attachment to clean a surface and may therefore also be referred to as a nozzle.

A suction motor 314 is provided to generate vacuum suction through air flow path, and may be positioned within a motor housing. Suction motor 314 may be a fan-motor assembly including an electric motor and impeller blade(s). In the illustrated embodiment, suction motor 314 is positioned in the air flow path downstream of air treatment chamber 340. In this configuration, suction motor 314 may be referred to as a “clean air motor”. Alternatively, suction motor 314 may be positioned upstream of air treatment chamber 340, and be referred to as a “dirty air motor”.

Air treatment chamber 340 is configured to remove particles of dirt and other debris from the air flow. In the illustrated example, an air treatment assembly may comprise or consist of a cyclone assembly (also referred to as a “cyclone bin assembly”). The cyclone bin assembly may comprise a single cyclonic cleaning stage or a plurality of cyclonic stages in series. Each cyclonic cleaning stage may comprise a single cyclone 318 and a dirt collection region. The dirt collection region may be internal of the cyclone 318 (e.g., a lower portion of the cyclone chamber of cyclone 318) or it may be an external dirt collection chamber 312 that has a discrete volume from that of the cyclone chamber (also referred to as a “dirt collection bin”, “dirt bin”, or “dirt chamber”) that is in communication with the cyclone chamber via a dirt outlet. Cyclone 318 and dirt collection chamber 312 may be of any configuration suitable for separating dirt from an air stream and collecting the separated dirt respectively, and may be in communication with dirt outlet(s) of the cyclone chamber. It will be appreciated that a cyclonic stage may have one or more cyclones in parallel and one or more dirt collection regions.

Accordingly, in alternate embodiments, air treatment chamber 340 may include a cyclone assembly having two or more cyclonic cleaning stages arranged in series with each other. Each cyclonic cleaning stage may include one or more cyclones arranged in parallel with each other and one or more dirt collection regions, of any suitable configuration. The dirt collection region(s) may be external to the cyclone chambers of the cyclones. Each cyclone may have its own dirt collection region or two or more cyclones fluidically connected in parallel may have a single common dirt collection chamber.

In alternate embodiments, air treatment chamber 340 need not be cyclonic and may comprise or consist of a non-cyclonic momentum separator, in which case the air treatment chamber 340 may have one or more air treatment chambers.

Surface cleaning apparatus 300 may include a pre-motor filter 330 provided in the air flow path downstream of air treatment chamber 340 and upstream of suction motor 314. Pre-motor filter 330 may be formed from any suitable physical, porous filter media. For example, pre-motor filter 330 may be one or more of a foam filter, felt filter, HEPA filter, or other physical filter media. In some embodiments, pre-motor filter 330 may include an electrostatic filter, or the like. Pre-motor filter 330 may be located in a pre-motor filter housing that is external to the air treatment chamber 340.

Dirty air inlet 304 may be at the front end 322 of the surface cleaning apparatus 300. Optionally, front end 322 may be used as a nozzle to directly clean a surface. Alternatively, or in addition to functioning as a nozzle, front end 322 may be connected (e.g., directly connected) to the downstream end of any suitable accessory tool such as a rigid air flow conduit (e.g., an above floor cleaning wand), a crevice tool, a mini brush, and the like. As shown, dirty air inlet 304 may be positioned forward of air treatment chamber 340, although this need not be the case.

Accordingly, in operation, after activating suction motor 314, dirty air enters apparatus 300 through dirty air inlet 304 and is directed to the cyclone 318. The dirty air flow may be directed to enter the cyclone 318 in a tangential direction so as to promote cyclonic action. Dirt particles and other debris may be disentrained (i.e., separated) from the dirty air flow as the dirty air flow travels through cyclone 318. The disentrained dirt particles and debris may discharge from cyclone 318 into dirt collection chamber 312, where the dirt particles and debris may be collected and stored until dirt collection chamber 312 is emptied.

Air exiting cyclone 318 may be directed into the optional pre-motor filter 330. The air flow may pass through pre-motor filter 330, and then exit into suction motor 314 and then discharged from apparatus 300 through clean air outlet 308. Prior to exiting the clean air outlet 308, the treated air may pass through a post-motor filter, which may be one or more layers of filter media.

Power may be supplied to suction motor 314 and other electrical components of apparatus 300 from an onboard energy storage member 332, which may include, for example, one or more batteries or other energy storage device, such as a capacitor. In the illustrated embodiment, apparatus 300 includes a battery pack 332. Battery pack 332 may be permanently connected to apparatus 300 and rechargeable in-situ, or removable from apparatus 300. In the example shown, battery pack 332 is located within handle 302. Alternatively, or in addition to battery pack 332, power may be supplied to apparatus 300 by an electrical cord (not shown) connected to apparatus 300 that can be electrically connected to mains power by at a standard wall electrical outlet.

### Docking Unit

This disclosure contains several designs for a surface cleaning apparatus and a docking unit for receiving dirt that has been collected by the surface cleaning apparatus.

The term “docking unit” is used to refer to any apparatus which is operable to receive dirt collected by a surface cleaning apparatus during an evacuation, (i.e., emptying) process and to which a surface cleaning apparatus may be docked (e.g., connected in flow communication so that some or all of the dirt may be transferred from the surface cleaning apparatus to the docking unit). Docking units may also be referred to as docking stations. A user may dock the surface cleaning apparatus at the docking unit and operate the surface cleaning apparatus in a dirt emptying mode (which may also be referred to as an emptying process or evacuation proceed) to empty the dirt from the surface cleaning apparatus into the docking unit.

Air flow may be used to transfer dirt from the surface cleaning apparatus to the docking unit. The air flow may be produced by a motor and fan assembly in the surface cleaning apparatus and/or a motor and fan assembly in the docking unit. Any such motor and fan assembly may be used to push air through one or more air treatment chambers, screens, filters, etc. of the surface cleaning apparatus so as to transfer collected dirt into a dirt collection region of the docking unit and/or to draw air through one or more air treatment chambers, screens, filters, etc. of the surface cleaning apparatus into the dirt collection region of the docking unit.

Accordingly, the docking unit may be used to receive dirt from the surface cleaning apparatus during an evacuation, (i.e., emptying) process. A user may dock the surface cleaning apparatus at the docking unit and operate the surface cleaning apparatus in a dirt emptying mode to empty the dirt from the surface cleaning apparatus into the docking unit. To assist with the emptying process, a suction motor may be used to provide a motive force for removing dirt from the dirt collection region of the surface cleaning apparatus into a docking unit dirt collection region. An advantage of this design is that the user may dock the surface cleaning apparatus at the docking unit and empty the dirt collection region using the suction force and/or the blowing force of the suction motor without manually opening the dirt collection region. This emptying process may enable a user to avoid the need to touch the dirt in the dirt collection region to remove trapped residual dirt, thereby reducing the likelihood of spilling, incomplete emptying, and releasing or contacting irritants that may harm the user.

Any motor and fan assembly may be operated in a suction mode (i.e. as a suction motor) and may be operated in a suction mode to draw air in a direction of flow towards the suction motor. Alternately or in addition, exhaust air from a motor and fan assembly may be used to push air away from the motor and fan assembly in a direction of flow. In any such case, the flow of air is directed through some or all of one or more air treatment chambers, screens, filters, etc. of the surface cleaning apparatus so as to transfer collected dirt into a dirt collection region of the docking unit. For convenience, any such motor and fan assembly is referred to as a suction motor.

The motive force to move the air during any dirt emptying mode of operation may be a motor and fan assembly in the surface cleaning apparatus, the docking unit, or both. For example, using the suction motor of the surface cleaning apparatus may allow for the manufacturing of a docking unit without a suction motor, thereby simplifying the design and reducing the cost of manufacturing the docking unit.

Accordingly, to assist with the emptying process, a suction motor may be used to provide a motive force for removing dirt from the dirt collection region of the surface cleaning apparatus into a docking unit dirt collection region. The user may therefore dock the surface cleaning apparatus at the docking unit and empty the dirt collection region using the suction force and/or the blowing force of a suction motor.

As set out herein, the air flow may pass through some or all of one or more air treatment chambers. The air flow may pass in the same direction as is used during a floor cleaning operation or in a reverse direction. The air flow may exit the air treatment chamber using the air treatment chamber air inlet (e.g., a tangential cyclonic inlet) or a separate dirt evacuation port which is opened to enable an air treatment member to be emptied or evacuated. The surface cleaning apparatus may be provided with one or more ports for air to enter into the surface cleaning apparatus (e.g., into the air treatment chamber(s)) during a dirt emptying mode of operation and one or more ports for air to exit from the surface cleaning apparatus (e.g., out of the air treatment chamber(s)) during a dirt emptying mode of operation.

During a dirt emptying mode of operation, one or more walls or wall portions may be opened to enable dirt to be evacuated from the dirt collection region of the surface cleaning apparatus. The wall or wall portions may be opened by, e.g., rotation, translation or the like. Accordingly, for example, part or all of an end wall or side wall of an air treatment assembly may pivot open, optionally into the docking unit to provide an evacuation port. Alternately, a sliding door (e.g., a gate valve) may open one or more ports on the air treatment assembly. In such a case, the gate valve may not enter into the docking station as it is moved to an open position.

It will be appreciated that a surface cleaning apparatus may have one or more evacuation ports, which may provide an air outlet during a dirt emptying mode of operation. The evacuation ports may be in the same air treatment member of the surface cleaning apparatus (e.g., an air treatment chamber such as a cyclone chamber) or they may be in different air treatment members (e.g., an air treatment chamber and a pre-motor chamber. The evacuation ports may each mate with its own mating inlet port of the docking unit. The evacuation ports may be opened concurrently or sequentially in any order.

The wall or wall portions may be opened automatically upon docking (e.g., by an engagement member, optionally on the docking unit) moving the wall or wall portion to an open position as the surface cleaning apparatus is docked. Alternately, the wall or wall portions may be opened manually by a user as or after the docking operation. Alternately, the wall or wall portions may be opened upon actuation of the dirt emptying mode of operation, e.g., by air flow produced during the dirt emptying mode of operation and/or by an actuator which initiates the dirt emptying mode of operation causing the wall or wall portions to be opened (e.g., by a mechanical linkage and/or an electromechanical member).

During any dirt emptying mode of operation, the air may flow continuously or it may be pulsed for part or all of a dirt emptying mode of operation.

During any dirt emptying mode of operation, an agitator may be operated to assist in removing dirt, such as by agitating a pre-motor filter, a screen of a cyclone air outlet, or a part of an air treatment assembly wall.

The air treatment assembly may have an air treatment chamber and an exterior dirt collection chamber which may be concurrently opened or sequentially opened prior to or during a dirt emptying mode of operation. Alternately, an air treatment assembly may have two or more external dirt collection chambers that are opened concurrently or sequentially.

The docking unit may be a docking station for an upright surface cleaning apparatus, such as an upright vacuum cleaner, and optionally also a charging base for the upright surface cleaning apparatus. Accordingly, a user may be able to dock an upright surface cleaning apparatus at a docking unit without having to remove the air treatment assembly.

The docking unit may also be a charging base for the surface cleaning apparatus. Alternately, or in addition, the docking unit may be used to power the motor and fan assembly used for the dirt emptying mode of operation, which may be in the surface cleaning apparatus, and to charge an energy storage member provided in the surface cleaning apparatus. The dirt emptying mode of operation may occur concurrently or sequentially with charging the energy storage member. The charging process may provide power at a different power level than is used during the evacuation process.

The following is a discussion of different aspects or features that may be provided in a surface cleaning apparatus or a docking unit. Any docking unit may use any one or more of these aspects and a surface cleaning apparatus that is dockable at a docking unit may use any one or more of these aspects.

### Suction Motor Provides a Motive Force for Emptying in a Cleaning Mode Direction

In accordance with this aspect, which may be used by itself or in combination with one or more other aspects, there is provided a surface cleaning apparatus that has an air inlet end of an air treatment chamber (e.g., a cyclone chamber) and a distal end that is spaced from and opposed to the air inlet end. For example, a cyclone may have an air inlet end and an axially opposed second end or air outlet end. During a dirt emptying mode of operation, air may enter the air treatment chamber at the air inlet end and exit at a downstream location, which may be the opposed air outlet end. Optionally, air may enter the air inlet end through the air inlet of the air treatment chamber (e.g., if the air treatment chamber is a cyclone chamber, through the cyclone air inlet). Optionally, the surface leaning apparatus may have a dirty air inlet (or nozzle) and air may enter the surface leaning apparatus during an evacuation process through the dirty air inlet. An advantage of this design is that fewer seals may be required if the evacuation process uses an air inlet that is part of the air flow path that is used during use of the surface cleaning apparatus to clean a surface. A further advantage is that, if the air travels from the inlet end to the outlet end during the evacuation process, the air will travel through most or all of the axial length of the air treatment chamber thereby increasing the amount of collected dirt that may be evacuated.

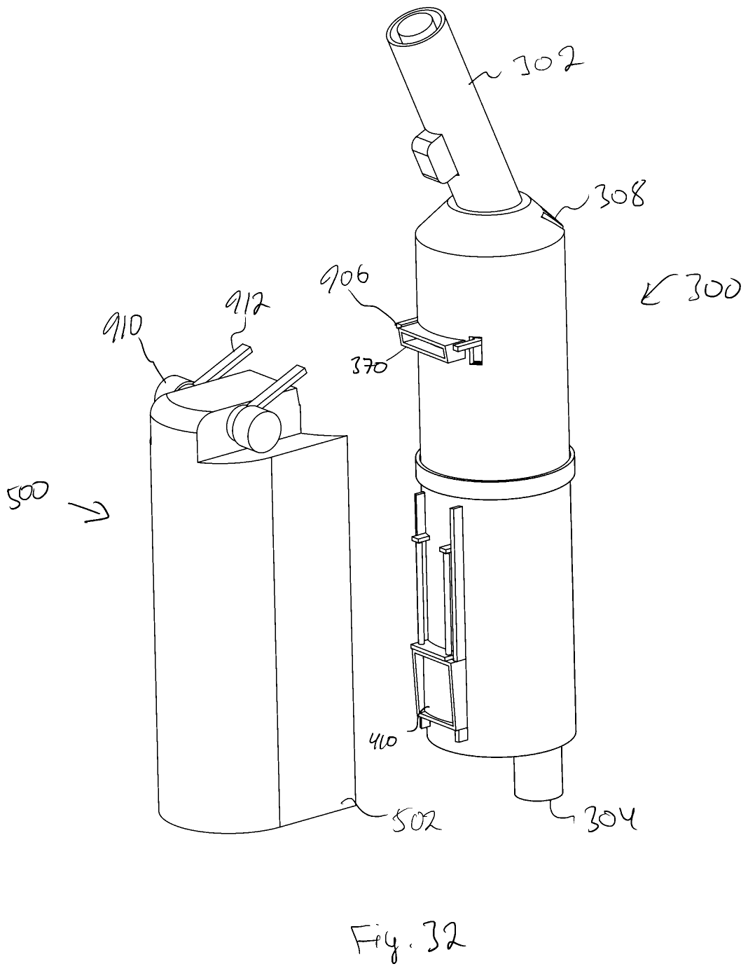

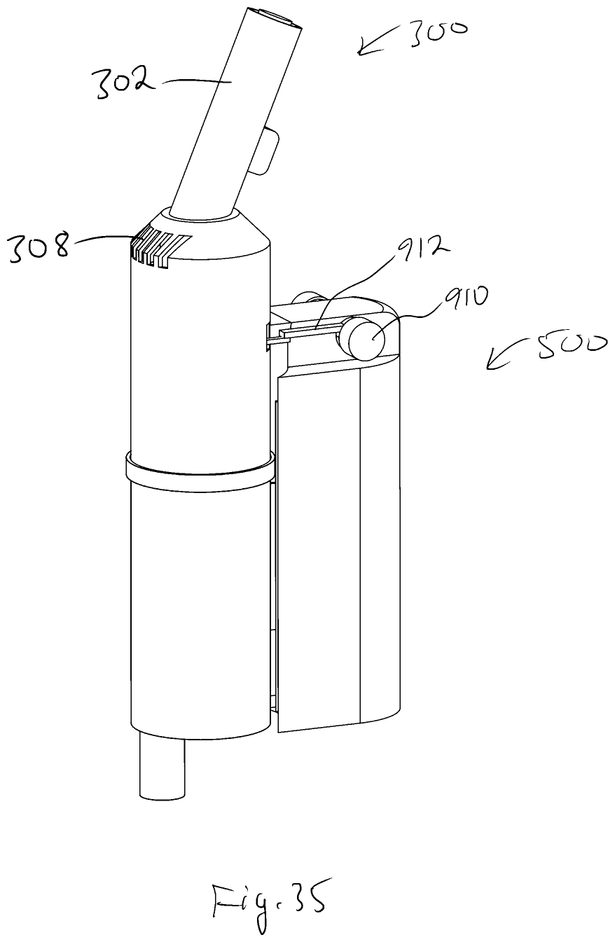

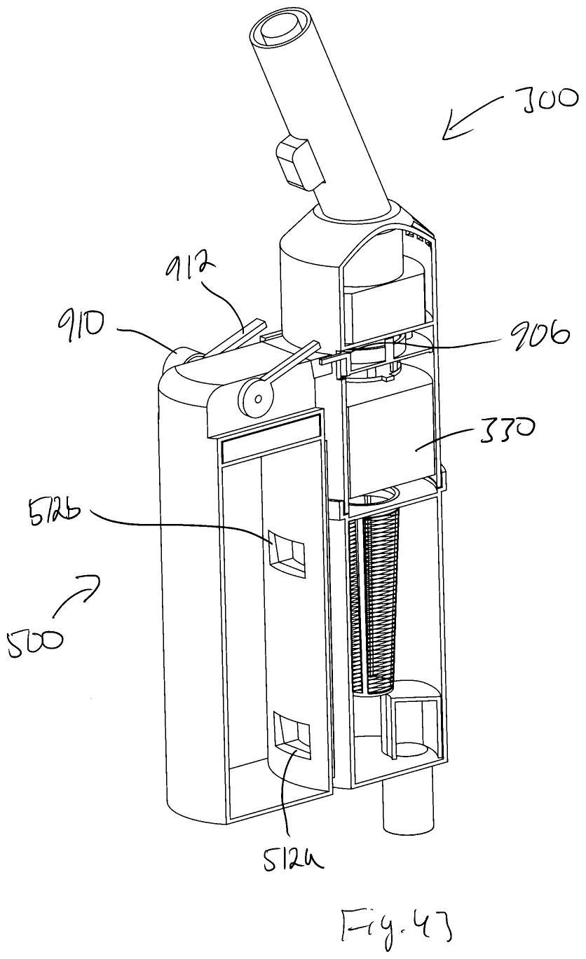

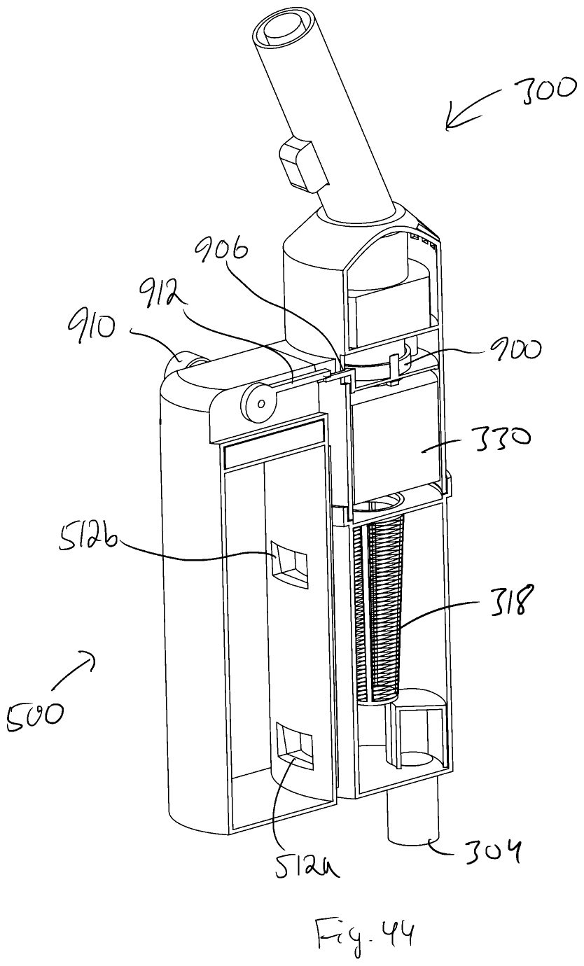

In accordance with this aspect, referring to FIGS. 32-44, shown therein is an exemplary surface cleaning apparatus 300 and docking unit 500. While the illustrated surface cleaning apparatus 300 is shown as a hand vacuum, it will be appreciated that the surface cleaning apparatus may be any type, including, but not limited to, upright, cannister, and/or stick vacuum.

As exemplified in FIG. 33, the surface cleaning apparatus 300 has an air treatment chamber 340 positioned in the air flow path, the air treatment chamber 340 having an air treatment chamber air inlet 342 and an air treatment chamber air outlet 344. The air treatment chamber 340 has a first end 346, which may be referred to as an inlet end and an axially opposed second end 348, which may be referred to as an outlet end. As discussed previously, air treatment chamber may be any air treatment chamber known in the vacuum cleaner arts. In the orientation of FIG. 33, the dirt collection region is a lower end of the cyclone chamber.

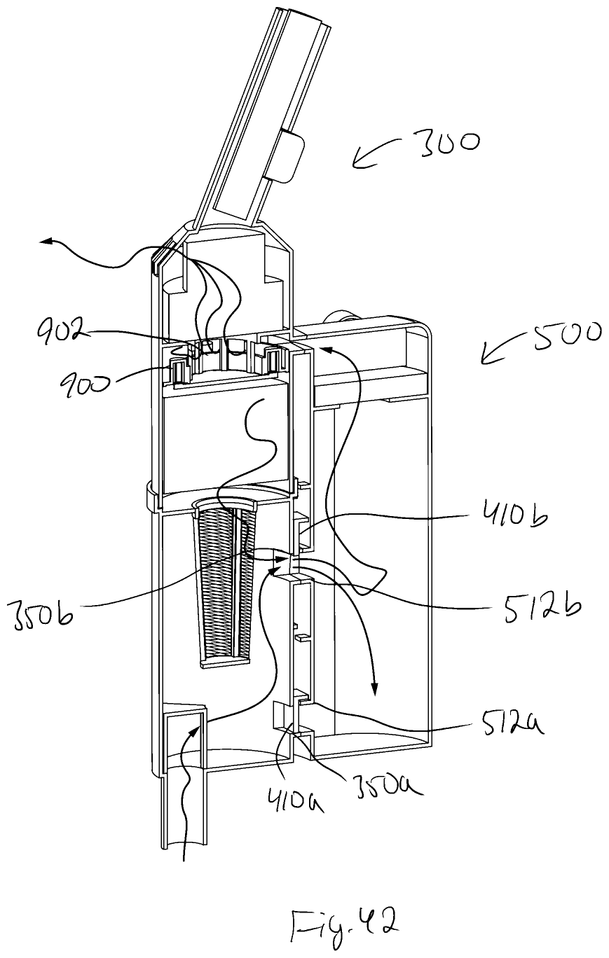

The air treatment chamber 340 has at least one emptying port 350. As exemplified in FIG. 33, there is a single emptying port or evacuation port 350. It will be appreciated that, as discussed subsequently and as exemplified in FIG. 42, the surface cleaning apparatus 300 may have a plurality of outlet ports 350. The outlet port(s) 350 may be used to provide an emptying path when docked at the docking unit, or may be used to empty dirt from the dirt collection region 312 directly into a dust bin or other collection apparatus.

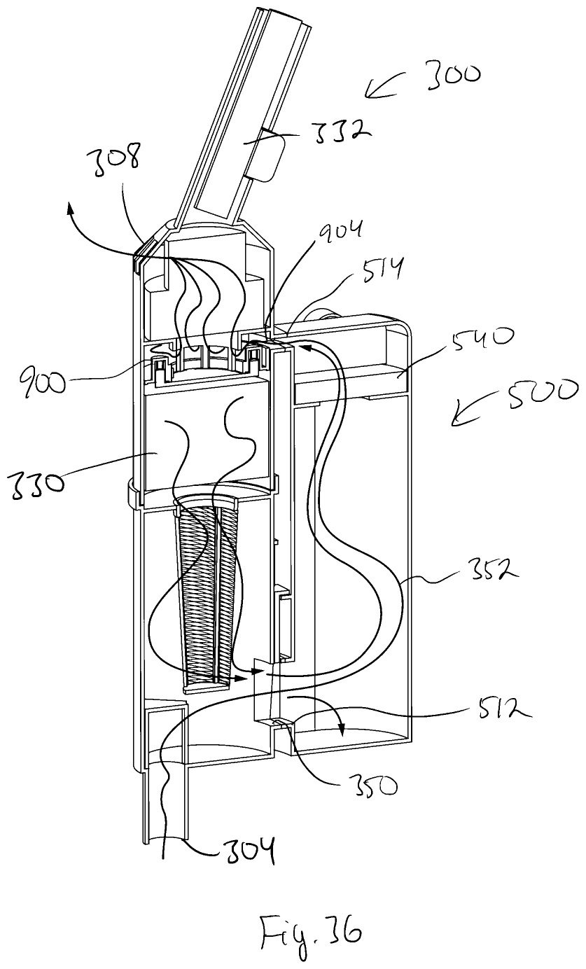

The docking unit 500 has a docking unit body 502 with a dirt collection region 510. The dirt collection region 510 has a dirty air inlet 512 and a clean air outlet 514 with an airflow path 516 extending therebetween. As exemplified in FIG. 36, the dirty air inlet 512 is in flow communication with the emptying port 350. Accordingly, when the surface cleaning apparatus 300 is docked at the docking unit 500 and is in a dirt emptying mode of operation, the emptying port 350 is in flow communication with the dirt collection region 510 through the dirty air inlet 512 and a flow of air may enter the air treatment chamber 340 through the dirty air inlet 304 and may exit through the emptying port 350. The flow of air can be used as the motive force to empty dirt from the dirt collection region 312 into the docking unit 500. In some embodiments, as exemplified in FIG. 36, the dirty air inlet 304 may be suspended above the ground when docked at the docking unit 500 to facilitate airflow into the surface cleaning apparatus 300 during the dirt emptying mode of operation.

The motive force used to move dirt from the dirt collection region 312 into the docking unit 500 may be provided by a suction motor. For example, as exemplified in FIG. 36, the surface cleaning apparatus 300 has an inlet port 360. When the surface cleaning apparatus 300 is docked at the docking unit 500, the inlet port 360 is in flow communication with clean air outlet 514 of the docking unit 500. As exemplified, the air outlet 514 and the inlet port 360 are positioned at a location upstream of the suction motor 314. As shown, the suction motor 314 of the surface cleaning apparatus 300 is in the flow path of the dirty air inlet 304, the emptying port 350, the dirty air inlet 512, the clean air outlet 514, and the clean air outlet 308. In other words, when the surface cleaning apparatus 300 is docked at the docking unit 500, the suction motor 314 may be activated to provide the motive force to pull the dirt from the air treatment chamber 340 into the docking unit 500.

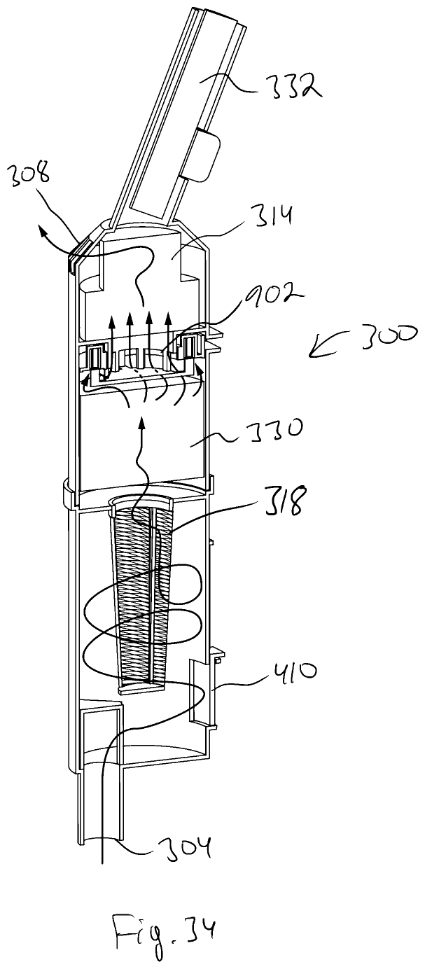

Accordingly, the surface cleaning apparatus 300 may be operable in a cleaning mode (see FIG. 34) in which air to be treated enters the surface cleaning apparatus 300 through the dirty air inlet 304, enters the air treatment chamber 340, and exits the air treatment chamber through the air treatment chamber air outlet. The air then passes through the air flow path to the suction motor 314 and subsequently exits the surface cleaning apparatus 300 through the clean air outlet 308. The surface cleaning apparatus 300 is also operable in a dirt emptying mode of operation, whereby air travels from the air treatment chamber 340 through the emptying port 350 into the docking unit 500.

To facilitate the operation of the dirt emptying mode, at least part, and optionally all, of the airflow during the dirt emptying mode of operation is directed through the evacuation port 350. Accordingly, one or more valves may be provided to partially or fully block the air flow path so as to force part or all of the airflow through the evacuation port 350. The valve or valves may be located at any location that would be downstream of the evacuation port 350 if the valve or valves were not provided. For example, the valve or valves may close the air outlet of the air treatment chamber, the air flow path through a header upstream of the pre-motor filter, a header downstream of the pre-motor filter or the suction motor air inlet.

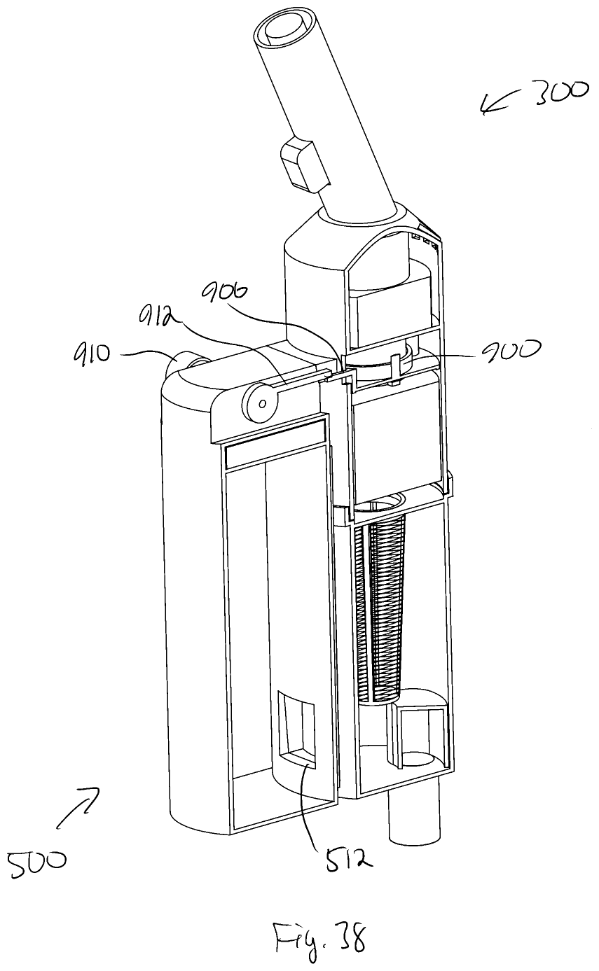

As exemplified, the surface cleaning apparatus 300 includes a valve 900 which prevents air from flowing through the air treatment chamber 340 and then out the air treatment chamber outlet and into the suction motor 314. Instead, when the valve 900 is closed, air flows through the emptying port 350 after entering the air treatment chamber 340. The valve 900 may be moveable been a first (open or cleaning) position in which the surface cleaning apparatus 300 is in the cleaning mode of operation (e.g., FIG. 34) and a second (closed or evacuation) position in which the surface cleaning apparatus 300 is in the dirt emptying mode of operation (e.g., FIGS. 36 and 38). In the cleaning mode of operation, air may flow from the pre-motor filter 330, through one or more (e.g. a plurality as exemplified) of valve apertures 902, and into the suction motor 314. In the dirt emptying mode of operation, when the valve 900 is in the second position, the apertures 902 may be moved closed such that an inlet port aperture 904 is opened. The inlet port aperture 904 may enable air to flow through the inlet port 360 into the suction motor 314, as exemplified in FIG. 36. In some embodiments, the valve 900 may be moved through additional positions depending on the dirt emptying mode of operation.

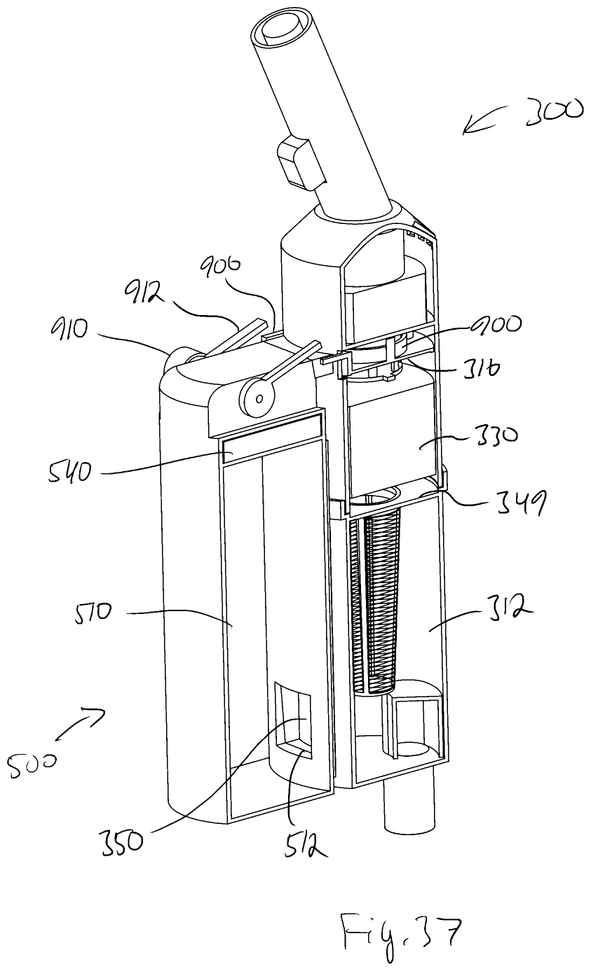

The valve 900 may be coupled to a valve actuator 910 that actuates the valve 900 between the first position and the second position, such as when the surface cleaning apparatus is docked, then the suction motor is energized, manually by a user or the like. The valve actuator 910 may be positioned within the surface cleaning apparatus 300, on the surface cleaning apparatus 300, or may be external to the surface cleaning apparatus 300. As exemplified in FIGS. 37-38, the valve actuator 910 includes a first engagement member 912 that engages with a second engagement member 906 on the valve 900. The first engagement member 912 is movable between a disengaged position (e.g., FIG. 37), in which the valve 900 is in the first position, and an engaged position, in which the valve 900 may be actuated by the valve actuator 910 to move to the second position (e.g., FIG. 38). The valve actuator 910 may be any mechanism capable of moving the second engagement member 906 between positions. In some embodiments, the second engagement member 906 may be biased to the first position such that when the force applied by the valve actuator 910 is removed, the valve 900 moves back to the first position.

The valve 900, as exemplified, is a sliding valve. The valve 900 moves between the first and second positions by moving up and down within the surface cleaning apparatus 300. The valve 900 may be any kind of valve capable of facilitating changing air flows within the surface cleaning apparatus 300. For example, the valve 900 may be, including, but not limited to, a gate valve, a rotating valve, hinged, magnetic, or any combination thereof.

Optionally, as exemplified in FIG. 34, the surface cleaning apparatus 300 may include a pre-motor filter 330 and the evacuation air flow path may include the pre-motor filter. Accordingly, air which has moved dirt from the surface cleaning apparatus to the docking unit may pass through the pre-motor filter of the surface cleaning apparatus prior to traveling to the suction motor, which may be in the surface cleaning apparatus and/or the docking unit. As exemplified, when the surface cleaning apparatus 300 is docked at the docking unit and is in the dirt emptying mode of operation, the air outlet 514 of the docking unit 500 is in fluid flow communication with the surface cleaning apparatus 300 at a location that is upstream of the pre-motor filter 330. An advantage of this design is that any residual dirt in the flow path from the docking unit 500 may be captured by the pre-motor filter 330 before entering the suction motor 314, thereby increasing the lifespan of the motor 314. In some embodiments, the docking unit 500 may include a filter 540, as exemplified in FIG. 34.

In some embodiments, the suction motor used to provide the motive emptying force may be provided in the docking unit 500. Accordingly, the air outlet 514 may instead be in flow communication with the ambient instead of connecting back to the surface cleaning apparatus 300.

The position of the emptying port 350 may vary depending on the design of the surface cleaning apparatus 300 and/or the docking unit 500. For example, the emptying port 350 may be positioned in the sidewall 341 of the air treatment chamber 340. As exemplified in FIG. 36, the emptying port 350 may be positioned upstream of the suction motor 314 in the sidewall of the air treatment chamber 340. It will be appreciated that an emptying port 350 may be in an end wall of the air treatment chamber 340.

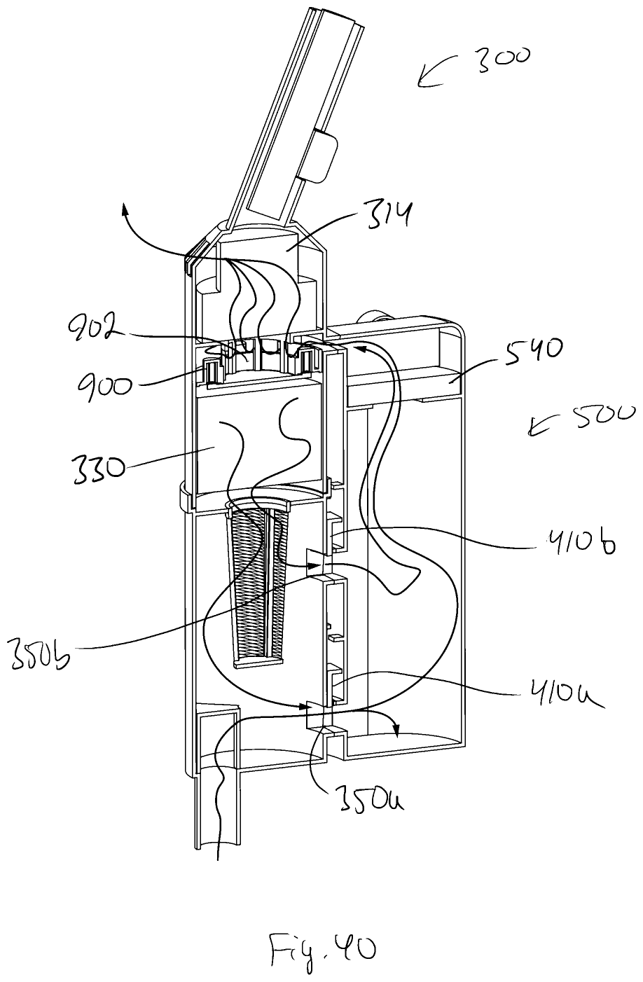

The emptying port may be at various location. Accordingly, the emptying port may be at any location along the axial length of the air treatment chamber 340. As exemplified in FIG. 33, the emptying port is located at the air inlet end. As exemplified in FIG. 40 the emptying port may be at the air outlet end (see emptying port 410b). Optionally, the emptying port is at the air outlet end. An advantage of providing the emptying port at the outlet end (or an end of the air treatment chamber opposed to the inlet port used during the dirt emptying mode of operation) is that air may travel through most or all of the air treatment chamber and push or draw collected dirt from all portions of the air treatment chamber (or an external dirt collection chamber) to the emptying port.

### A Plurality of Emptying Ports

In accordance with this aspect, which may be used by itself or in combination with one or more other aspects, an air treatment chamber of a surface cleaning apparatus ,such as a cyclone chamber, has more than one emptying port. An advantage of this aspect is that the additional air flow ports may facilitate removing dirt which has been collected at a particular location in an air treatment chamber. Accordingly, it may enhance the amount of dirt that is emptied from an air treatment chamber.

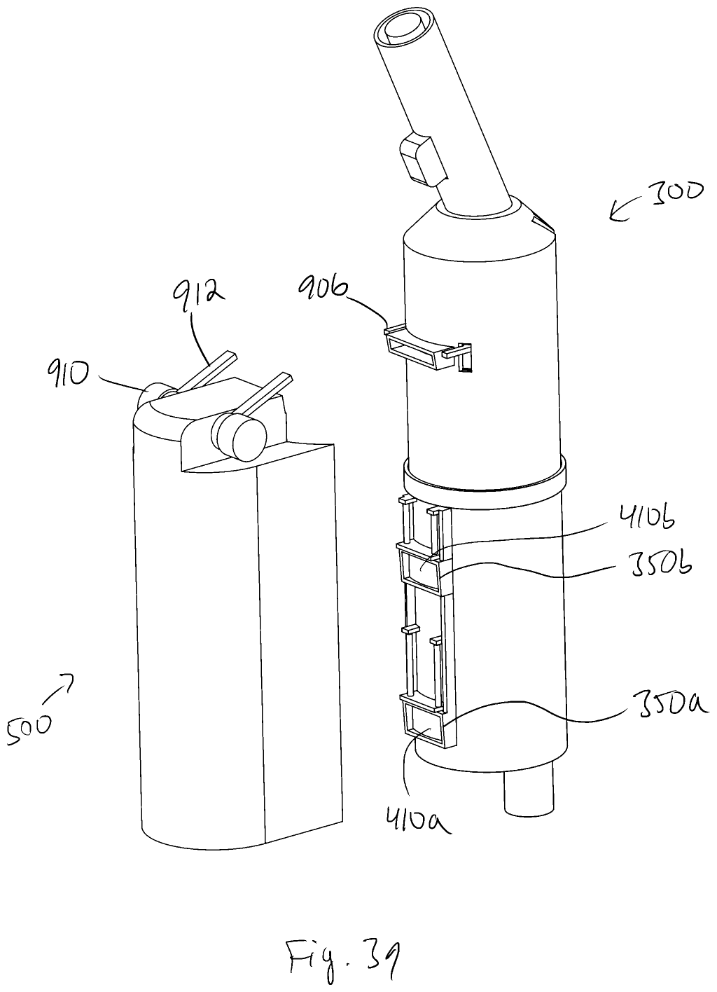

As exemplified in FIGS. 39-44, there is a first emptying port 350a and a second emptying port 350b. Each emptying port provides a connection point with the docking unit 500. Accordingly, the docking unit 500 may also have a plurality of dirty air inlets 512, or a single dirty air inlet 512 that is connectable in flow communication with each emptying port 350. As exemplified in FIG. 40, the first emptying port 350a is connectable with a first dirty air inlet 512a and the second emptying port 350b is connectable with a second dirty air inlet 512b.

As exemplified in FIGS. 39-44 a first emptying port 350a may be provided at the lower (inlet) end of the air treatment chamber and a second emptying port 350b may be is provided at an upper (outlet) end of the air treatment chamber.

It will be appreciated that the emptying ports 350a, 350b may be positioned anywhere on the surface cleaning apparatus 300. As shown, the first emptying port 350a is positioned at the inlet end 346 of the air treatment chamber 340 and the second emptying port 350b is positioned at the outlet end 348 of the air treatment chamber 340. However, in alternate embodiments, one or more of the plurality of emptying ports 350 may open the air treatment chamber 340 and one or more of the plurality of emptying ports 350 may open the pre-motor filter chamber.

The plurality of emptying ports may be concurrently openable and/or sequentially openable.

Therefore, according to one option, the two emptying ports are concurrently openable during the dirt emptying mode of operation or may be sequentially openable. For example, in some embodiments, each of emptying ports 350a and 350b may be opened concurrently when in the dirt emptying mode of operation such that dirt may exit the air treatment chamber 340 from either emptying port (see e.g., FIG. 40. An advantage of this design is that if one port becomes impeded with dirt or larger debris (e.g., hair), there is a second port available for removing the rest of the dirt.

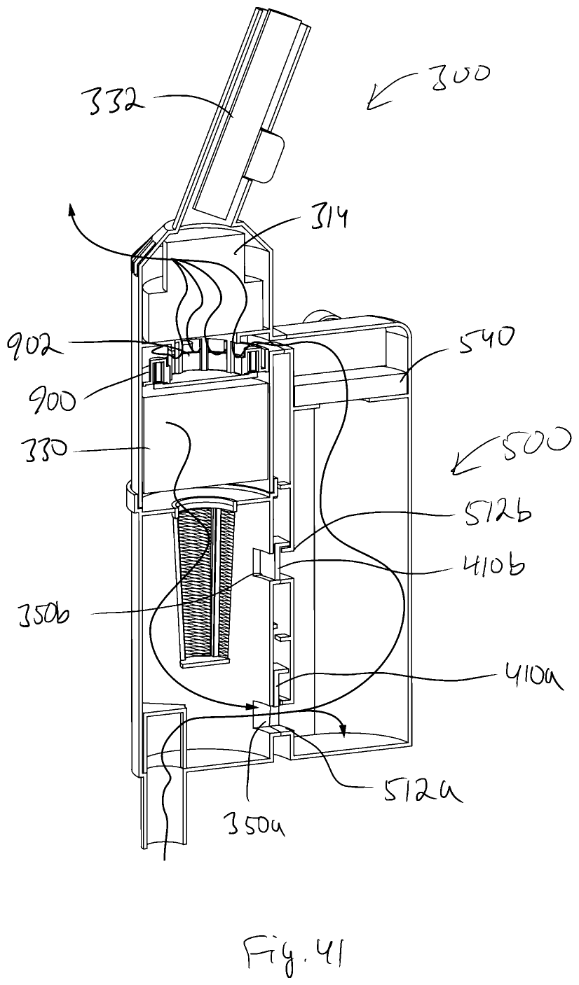

According to another option, sequential opening of the ports may allow for residual dirt that was not removed by one port to be removed through the other. The emptying ports 350 may each be opened a single time during an dirt emptying mode of operation or one or all of the emptying ports may be opened repeated. As exemplified in FIG. 41, the first emptying port 350a is opened and the second emptying port 350b is closed, vice versa in FIG. 42. An advantage of alternating the opening of the emptying ports is that dirt and/or debris caught in different regions of the air treatment chamber 340 may be exposed to different directions and forces of air, which may improve the removal of dirt from the air treatment chamber 340.

During the dirt emptying mode of operation the suction motor 314 may be used, to create a vacuum within the dirt collection region 312. Once suction has been built up, the first emptying port 350a and/or the second emptying port 350b may be opened to release the suction and evacuate the dirt collection region 312.

Each emptying port 350 may have an openable door 410 that opens and closes the emptying port 350. As exemplified in FIGS. 32-44, the openable doors 410 are slidingly openable. The door 410 may be opened by mechanical connections as the surface cleaning apparatus 300 is docked with the docking unit 500 and/or may be actuatable between the open and the closed positions once docked. More details on the emptying port opening and closing means is discussed subsequently.

### Openable Door

In accordance with this aspect, which may be used by itself or in combination with one or more other aspects, one or more of an inlet port and an emptying port used during a dirt emptying mode of operation has a door or valve that is slideable between the open and closed positions. An advantage of this design is that the emptying process may be simplified by moving a single member to vary the air flow path between cleaning and emptying modes. Another advantage is that one or more ports may be opened using a single sliding valve, simplifying the process of modifying the air flow path during the emptying process. A further advantage is that the door or valve may be located exterior of the docking unit when in the open position.

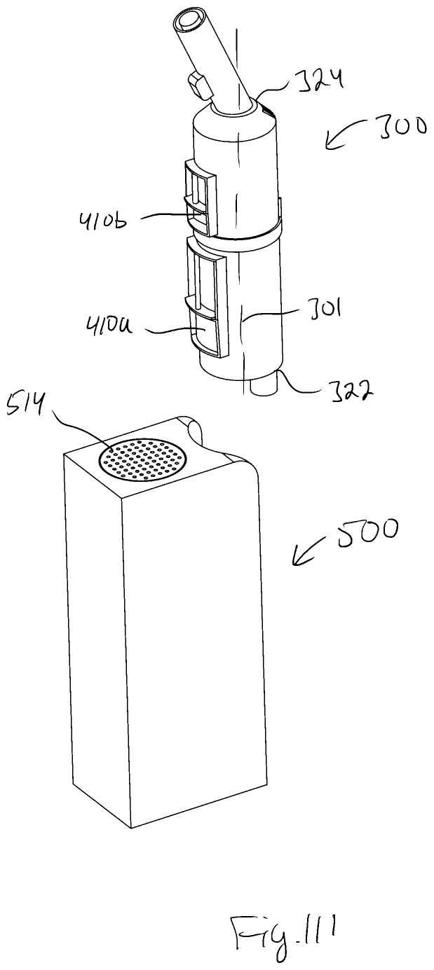

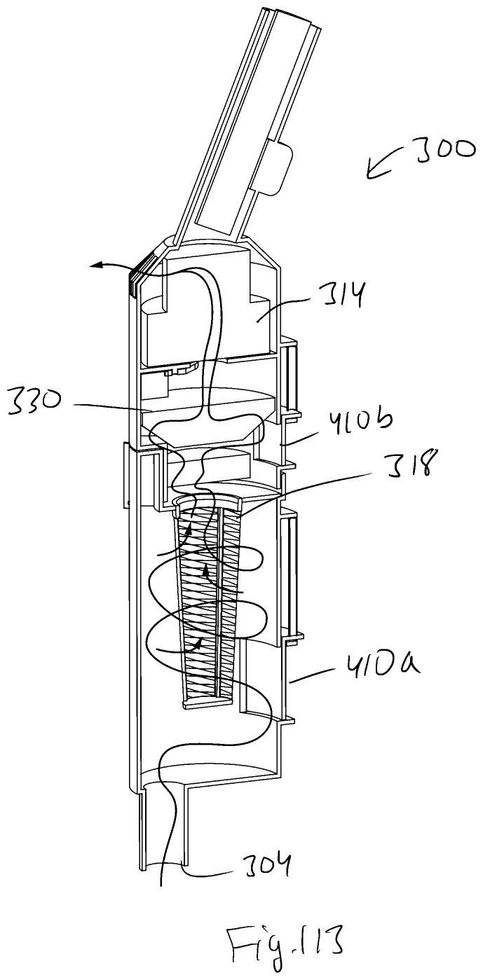

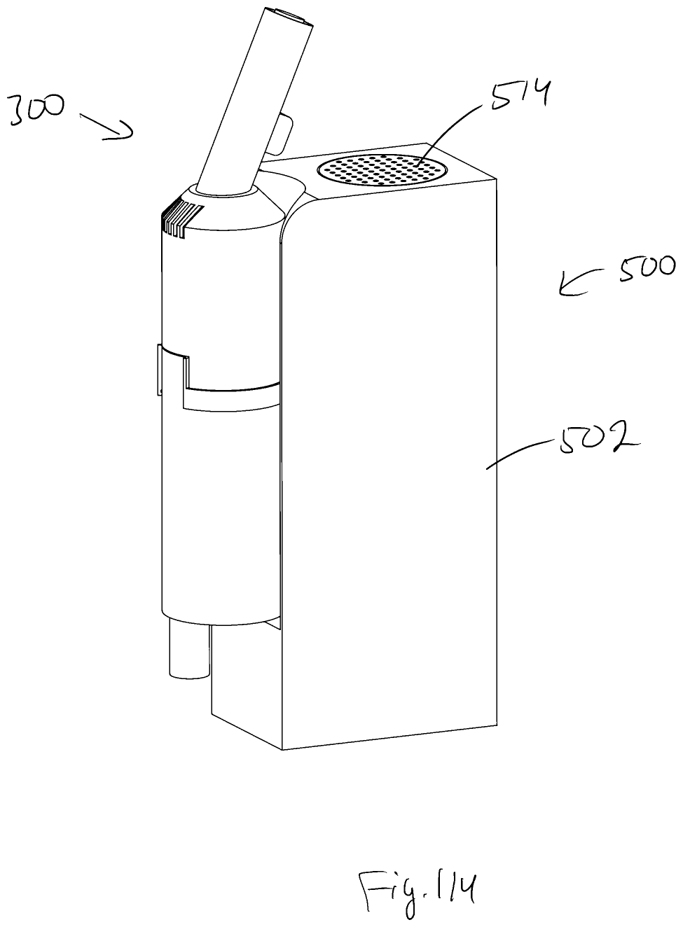

As exemplified in FIGS. 111-116, openable door 410 may be an emptying port valve 410 that is moveable between an open position in which the emptying port 350 is open and a closed position in which the first emptying port is closed. As shown, the port valve 410 is sideably movable between the open position and the closed position. The sliding port valve 410 may be any type of valve that is slideable between the open position and the closed position. For example, as exemplified in FIG. 111, the port valve 410 is a gate valve.

It will be appreciated that valve 410 may be provided at any location on the surface cleaning apparatus and, when moved to the open position, may open one or more ports concurrently.

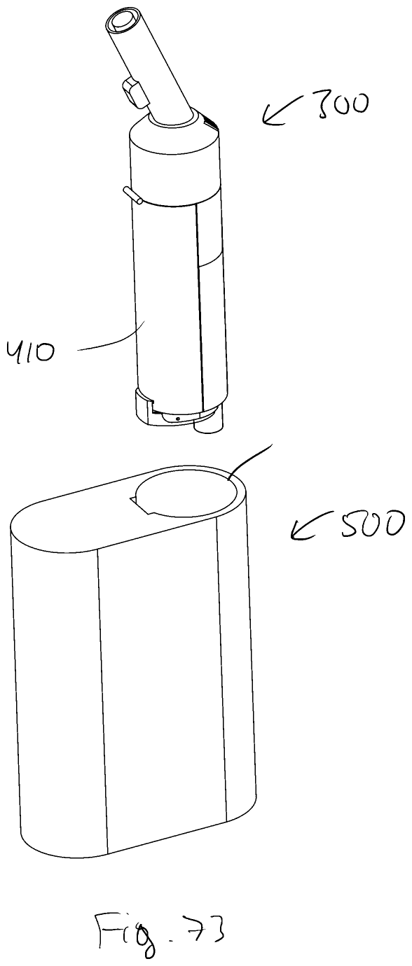

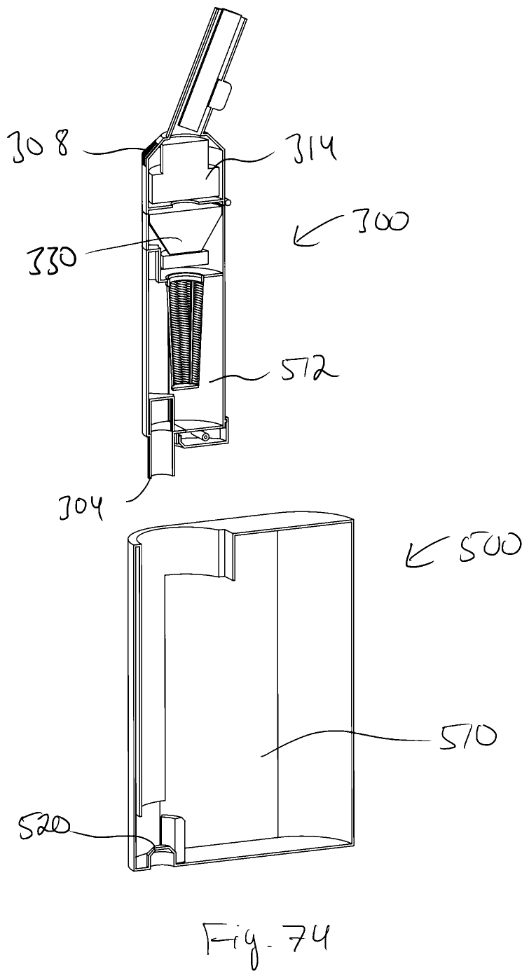

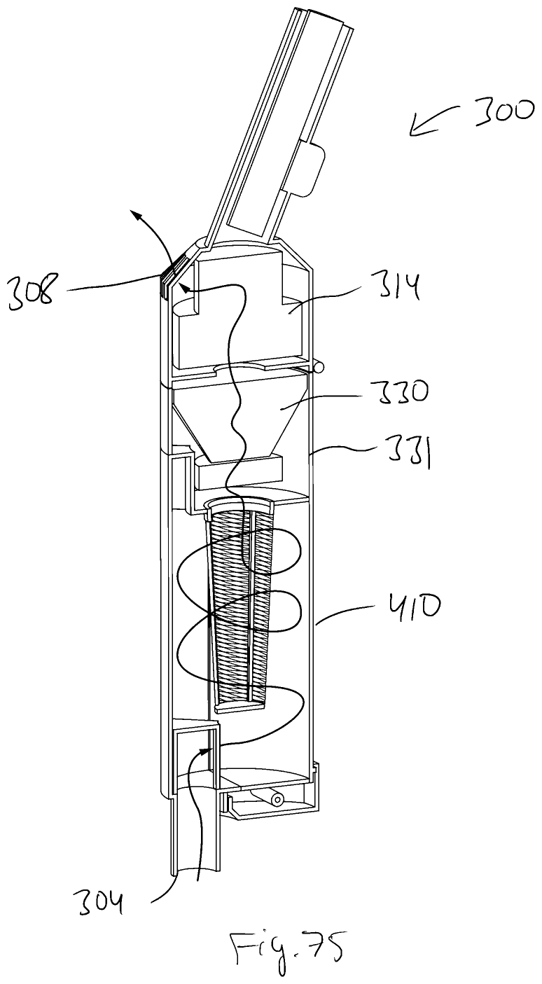

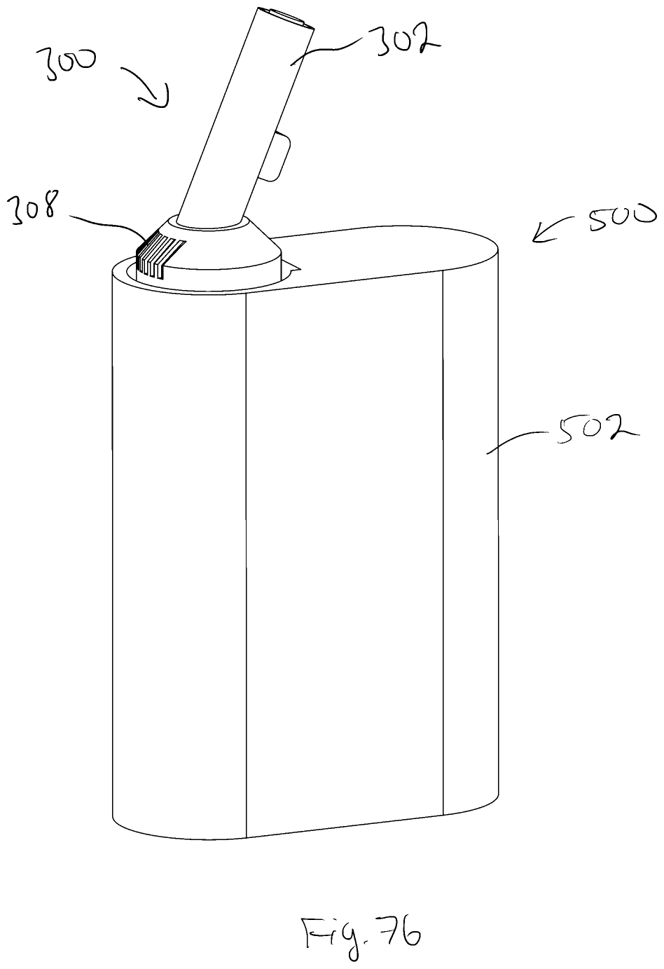

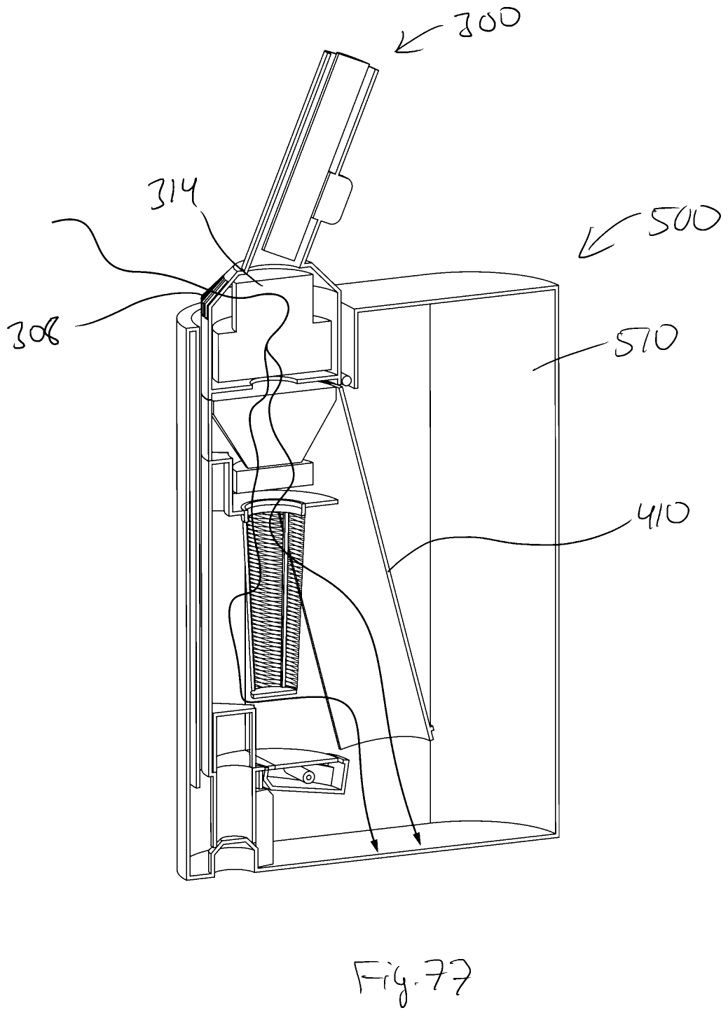

It will be appreciated that while valve 410 is exemplified as moving axially to the open position, it may move in a different direction. For example, the door or valve may move angularly around the circumference of the air treatment member to the open position. Alternately, the openable door 410 may be pivotably connected to the surface cleaning apparatus 300, as exemplified in FIGS. 73-77. As exemplified in FIGS. 73-78, a single openable door 410 provides access to one or more regions of the surface cleaning apparatus 300. As exemplified in FIG. 77, a sidewall of the air treatment member assembly, e.g., a lower end when the hand vacuum cleaner is in a floor cleaning position, may pivot open to open both the air treatment chamber and the pre-motor filter chamber.

Any valve opening member may be used and the valve may be opened prior to, during or subsequent to a docking operation.

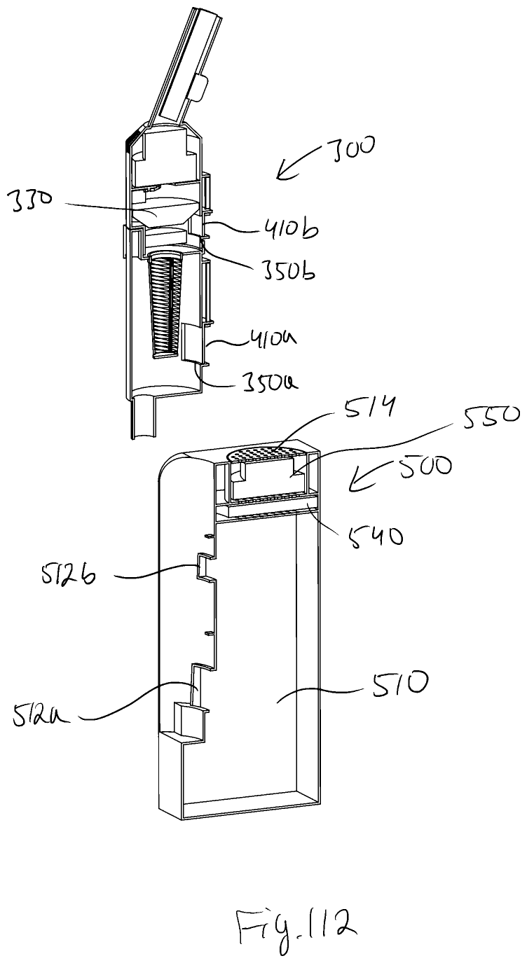

Optionally, the emptying port valve 410 may be automatically moved to the open position as the surface cleaning apparatus 300 is docked with the docking unit 500. For example, as shown in FIG. 111, the surface cleaning apparatus 300 is a hand vacuum cleaning having a longitudinal axis 301 extending between the front end 322 and the rear end 324. As exemplified, the emptying port valve 410 is axially slideably moveable between the open position and the closed position as the surface cleaning apparatus is docked. In FIG. 111, the surface cleaning apparatus 300 is not docked at the docking unit 500, and as such, the sliding port valve 410 is closed. Referring to FIGS. 112, 114, and 115, the surface cleaning apparatus 300 is moved in a mounting direction as the surface cleaning apparatus 300 is docked with the docking unit 500. As the surface cleaning apparatus 300 contacts the docking unit 500, the emptying port valve 410 is caused to move to the open position. As exemplified, the emptying port valve 410 moves opposite the mounting direction as the docking unit 500 is contacted. In some embodiments, the emptying port valve 410 may move in the mounting direction or another direction.

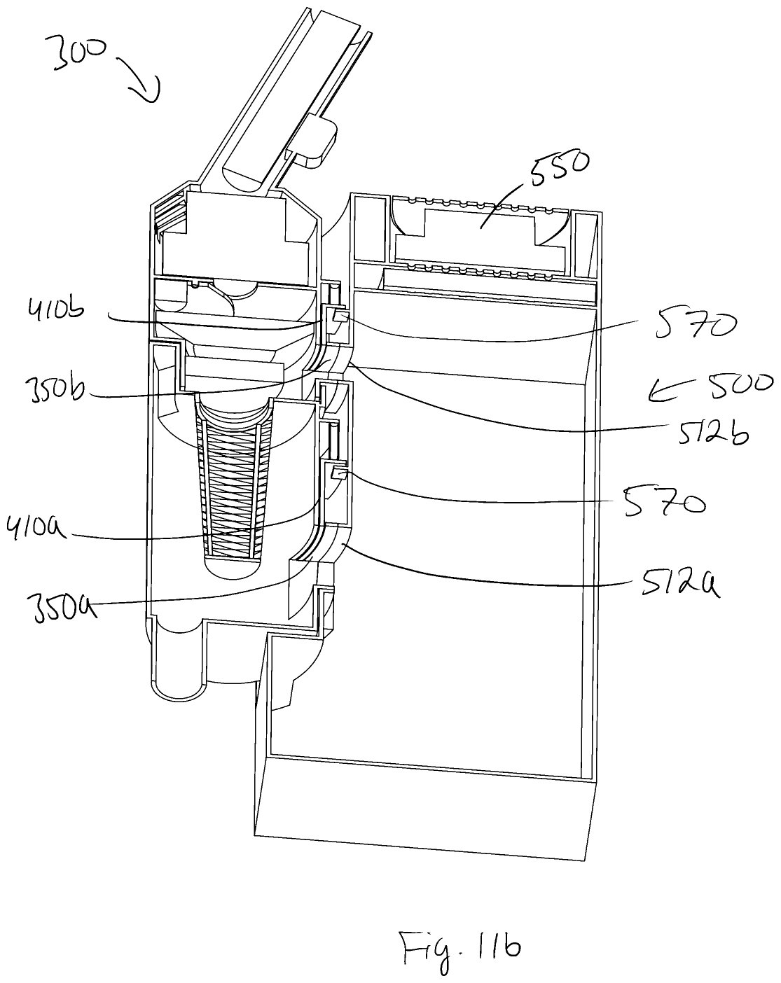

As exemplified in FIG. 116, the docking unit 500 has a valve actuator 570. As shown, the valve actuator 570 contacts the emptying port valve 410, or an arm of the like connected to valve 410, as the surface cleaning apparatus 300 docks at the docking unit. The valve actuator 570 is drivingly connected to the emptying port valve 410 such that as the surface cleaning apparatus 300 moves in the mounting position, the valve actuator 570 moves the emptying port valve 410 from the closed position to the open position. As exemplified, the valve actuators 570 are stationary (i.e., they are a mechanical member which is non-moveably mounted to the docking unit). Accordingly, the valve actuator may be a mechanical engagement member, such as a rod or a flange, that has an engagement end that engages the valve 410 or a member attached thereto to drive the valve 410 to the open position during the docking operation.

Alternately, the valve actuator may be electromechanical (e.g., a solenoid) or a manual actuator operable b a user that is actuated prior to, during or subsequent to a docking operation.

Alternately, the valve actuator 570 may be pneumatically driven and may be slideably moveable to open the emptying port valve 410. For example, the surface cleaning apparatus 300 may be docked at the docking unit 500 and subsequently the valve actuator 570 may be pneumatically activated to slidingly engage with the emptying port valve 410 to move the emptying port valve 410 to the open position.

The surface cleaning apparatus 300 may include a biasing member that biases the valves to the closed position when the surface cleaning apparatus 300 is removed from the docking unit 500.

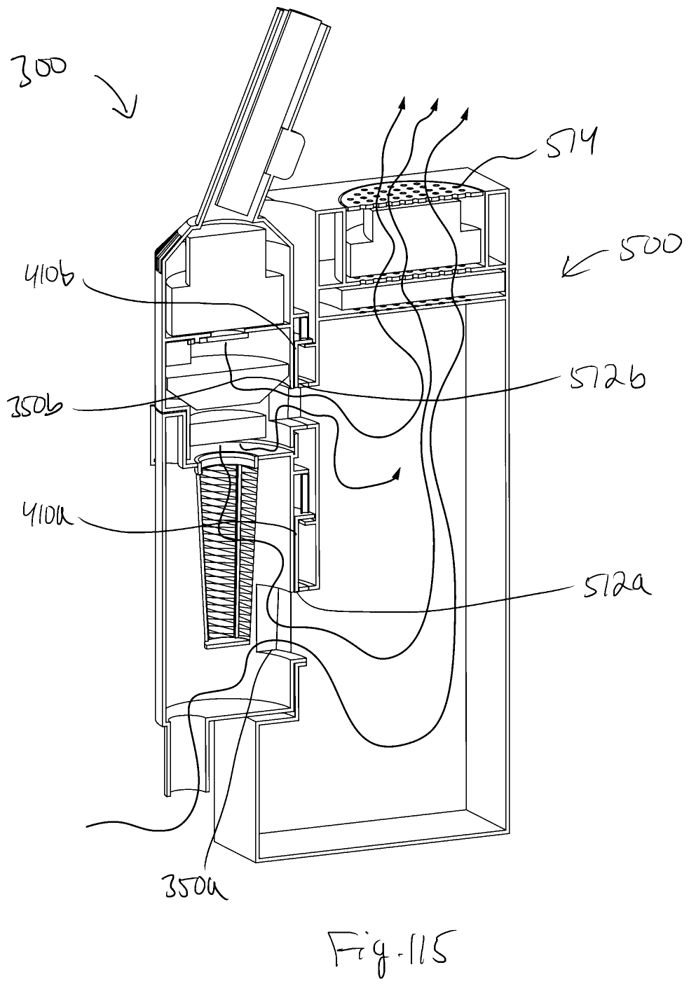

If, as discussed previously, the surface cleaning apparatus 300 includes a plurality of emptying ports 350, then the surface cleaning apparatus 300 may include a second emptying port valve 410b that is moveable between an open position in which the second emptying port 350b is open and a closed position in which the second emptying port 350b is closed. As shown, the second emptying port valve 410b is slideably moveable between the open position and the closed position. As exemplified in FIG. 115, the valves may be discrete from one another or, alternately, a single valve may be operable to concurrently or sequentially open the ports.

In some embodiments, the first emptying port valve 410a and the second emptying port valve 410b may be a single common sliding valve. The common sliding valve 410 may be moveable between a first position in which the first and second emptying ports 410a and 410b are closed, a second position in which the first emptying port 410a is open and the second emptying port 410b is closed, and a third position in which the first emptying port 410a is closed and the second emptying port 410b is open. In some embodiments, when in the third position, each of the first emptying port 410a and the second emptying port 410b may be open.

### Emptying Ports Enable Air Flow Into or Out of Two or More Treatment Members in the Evacuation Air Flow Path

In accordance with this aspect, which may be used by itself or in combination with one or more other aspects, if two or more evacuation air inlet ports 370 and/or emptying ports 350 are provided, then each of the evacuation air inlet ports 370 and/or emptying ports 350 may open a first air treatment chamber and another of the evacuation air inlet ports 370 and/or emptying ports 350 may open a pre-motor filter chamber and/or a second air treatment chamber.

For example, as exemplified in FIG. 115, the first emptying port 350a, when opened, may provide an opening to the air treatment chamber 340 and the second emptying port, when opened, may provide an opening to the pre-motor filter housing 331. An advantage of this design is that dirt may be drawn directly from each of the air treatment chamber 340 and the pre-motor filter housing 331 into the docking unit 500. Alternately, or in addition, as exemplified in FIGS. 111-116, a first evacuation air inlet port 370, when opened, may provide an opening to the air treatment chamber 340 and a second evacuation air inlet ports 370, when opened, may provide an opening to the pre-motor filter chamber 331.

As discussed previously, one or more emptying port valve(s) 410 may be provided and/or one or more evacuation air inlet port valve(s) may be provided.

It will be appreciated that one valve may be used to open one or more evacuation air inlet ports 370 and a separate valve may be used to open one or more emptying ports 350. Alternately, each port may have its own valve or a single valve may be used to open every evacuation air inlet port 370 and every emptying port 350.

The valves or doors may be openable concurrently or sequentially.

### Suction Motor Provides a Motive Force for Emptying in a Reverse Direction

In accordance with this aspect, which may be used by itself or in combination with one or more other aspects, during a dirt emptying mode of operation, air travels is a reverse direction than during a cleaning mode of operation through part or all of the air flow path through one or more air treatment members. Accordingly, for example, air may flow in the reverse direction through some or all of a pre-motor filter housing and/or through some or all of one or more air treatment chambers (e.g., one or more cyclone chambers wherein the cyclones may be series and/or parallel as discussed previously). In order to enable a reverse air flow a portion of the surface cleaning apparatus air flow path may be closed such that air is inhibited from travelling to the suction motor air inlet and/or an evacuation air outlet port may be opened such that air travels from an inlet port through the dirt evacuation port to the docking unit.

An advantage of this design is that if air enters the air treatment chamber through a port at the outlet end or through the air treatment chamber air outlet, the air may flow through the air treatment apparatus in a reverse direction, thereby contacting dirt at the outlet end whereby dirt that has collected at the outlet end may be dislodged. Additionally, since the airflow may operate in the reverse direction through all of the air treatment chamber, the air may remove a larger portion of the dirt in the apparatus. For example, dirt may be caught in a pre-motor filter or a difficult to reach area in the air treatment chamber. By reversing the air flow, air flows in a direction that does not occur during normal cleaning operation and more dirt may be dislodged from the pre-motor filter and/or the air treatment chamber. Removing residual dirt may improve the efficiency of the surface cleaning apparatus and may allow a user to clean a larger surface area before needing to empty the surface cleaning apparatus.

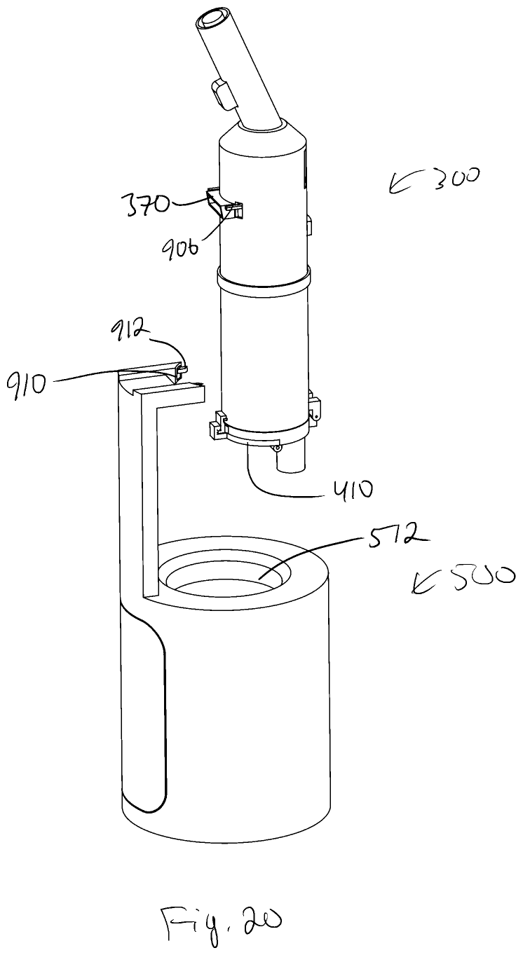

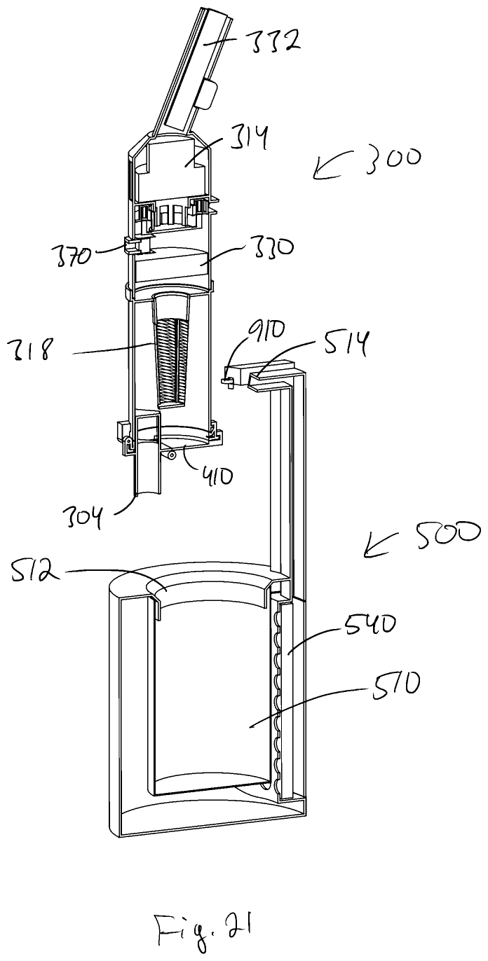

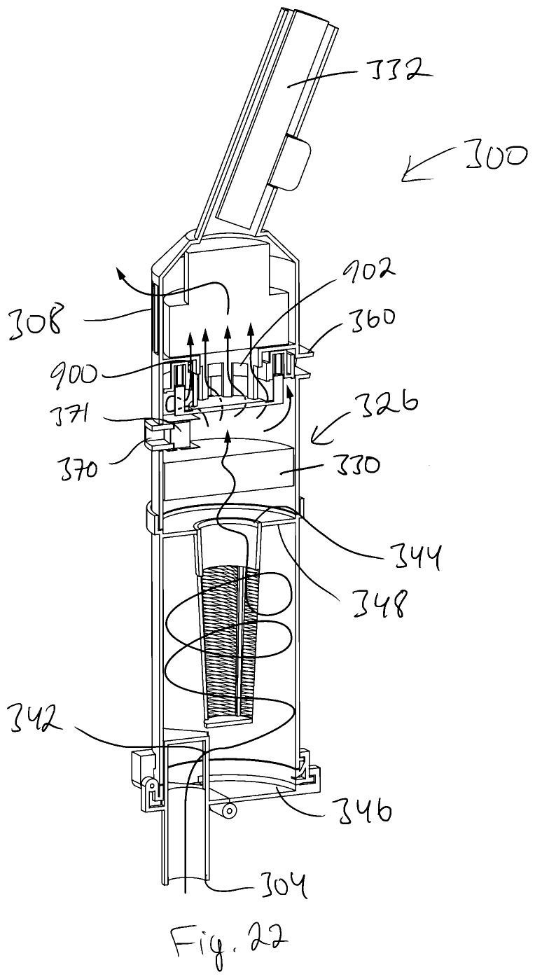

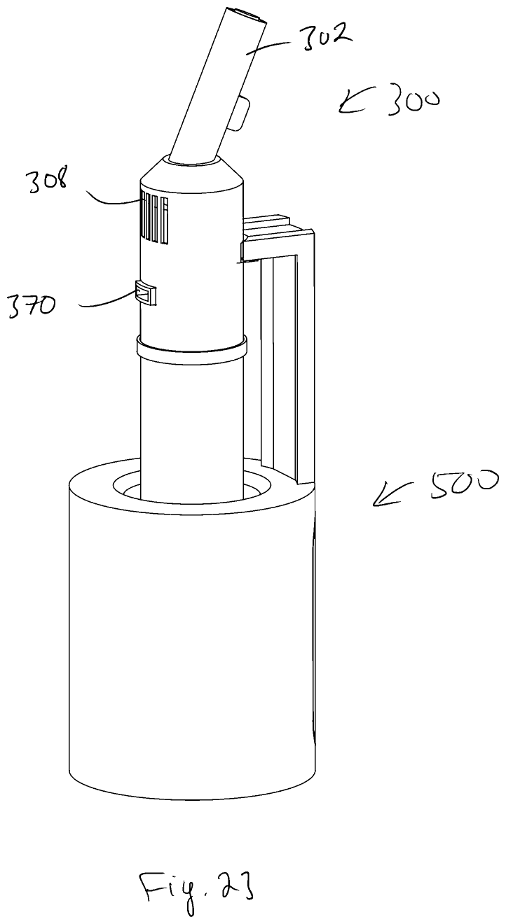

As exemplified in FIGS. 20-24, the air treatment chamber air outlet 344 is provided at the second (outlet) end 348 of the air treatment chamber 340 (see FIG. 22). A downstream part 326 of the air flow path that extends between the air outlet 344 and a suction motor air inlet 316.

The surface cleaning apparatus 300 is operable in a cleaning mode (e.g., FIG. 22) in which air to be treated enters the surface cleaning apparatus 300 from the dirty air inlet 304 into the air treatment chamber 340 and exits the air treatment chamber 340 through the air outlet 344. The air then passes through the downstream part 326 of the air flow path to the suction motor 314 and subsequently exits the surface cleaning apparatus 300 by the clean air outlet 308.

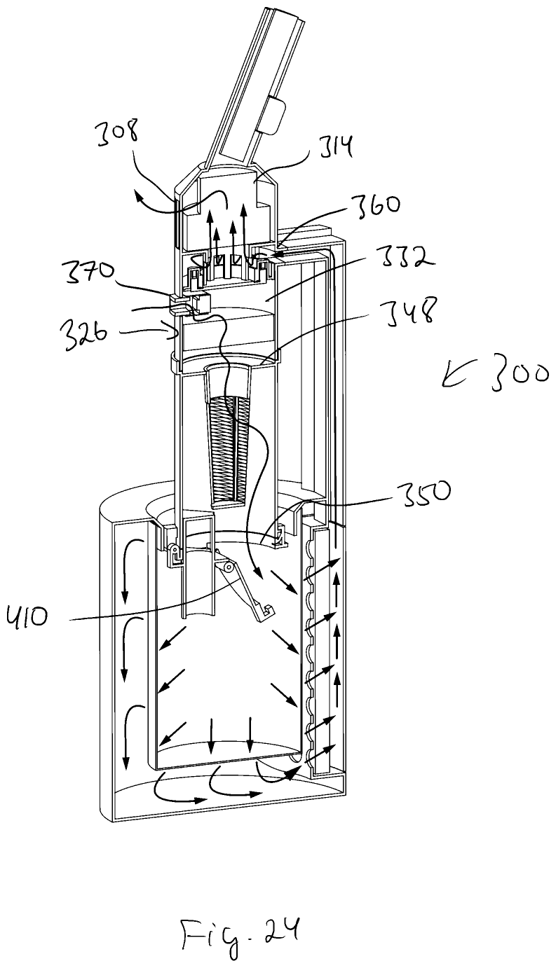

The surface cleaning apparatus 300 is also operable in a dirt emptying mode of operation (e.g., FIG. 24) whereby dirt exits the dirt collection region 312 into the docking unit 500. During the dirt emptying mode of operation the air flow path may be altered to facilitate reverse air flow through the surface cleaning apparatus 300. For example, in some embodiments, at least a portion, and optionally all, of the downstream part 326 of the air flow path may be closed and an evacuation air inlet port 370 may be opened. When the downstream portion is closed and the evacuation air inlet port 370 is opened, air is inhibited from travelling to the suction motor air inlet 316 and air travels from the evacuation air inlet port 370 through an open emptying port 350 into the docking unit 500. The emptying port 350 may also be referred to as the dirt evacuation port. In such an embodiment, when the evacuation air inlet port 370 is open, it may communicate directly with the ambient, e.g., the evacuation air inlet port 370 may be on an outer surface of the surface cleaning apparatus.

If the air treatment chamber air inlet is not the emptying port 350, then, optionally, the air treatment chamber air inlet is partially or fully closed to inhibit air exiting through the air treatment chamber air inlet and thereby direct the air flow through the emptying port 350. For example, a closure flap 400, as discussed subsequently, may be used to close an air treatment chamber air inlet.

To close the portion of the downstream part of the air flow path, a valve may be actuated to inhibit air flow through the suction motor air inlet 316. For example, the valve 900 is actuatable by the valve actuator 910 to move between a first position (FIG. 22) and a second position (FIG. 24), as described previously. As exemplified in FIGS. 22 and 24, the valve actuator 910 may also be operable to actuate an evacuation air inlet door 371 between a closed position (for the cleaning mode of operation) and an open position (for the dirt emptying mode of operation). In such a case, the source or motive force for the air flow may be the suction motor of the surface cleaning apparatus (either by using exhaust air from the suction motor as discussed subsequently or by using the suction motor at a downstream end of an evacuation air flow path as discussed herein and/or a suction motor in the docking unit as discussed subsequently.

Alternately, the suction motor of the surface cleaning apparatus may be operable also in a reverse direction. For example, the suction motor 314 may be operated in a first direction when in the cleaning mode and in a reverse direction during the dirt emptying mode of operation. In such a case, the suction motor may be operated in reverse during a dirt emptying mode of operation to push dirt through part of all of the air treatment chamber in a reverse direction and into the docking unit.

Alternately, the suction motor used to provide the air flow during the dirt emptying mode of operation may be positioned in the docking unit 500. In such embodiments, the suction motor 314 may be isolated from the pre-motor filter 330 and/or the air treatment chamber 340 such as by a valve 900. The evacuation air inlet 370 may be opened downstream of the pre-motor filter and/or the air treatment chamber 340. Accordingly, during the dirt emptying mode, the suction motor 314 is isolated from the air flow path by, e.g., the valve 900, the evacuation air inlet 370 is opened, and the suction motor in the docking unit 500 is activated to provide a suction force to draw air through the evacuation air inlet 370, through the pre-motor filter 330 and/or air treatment chamber 340, and into the docking unit 500.

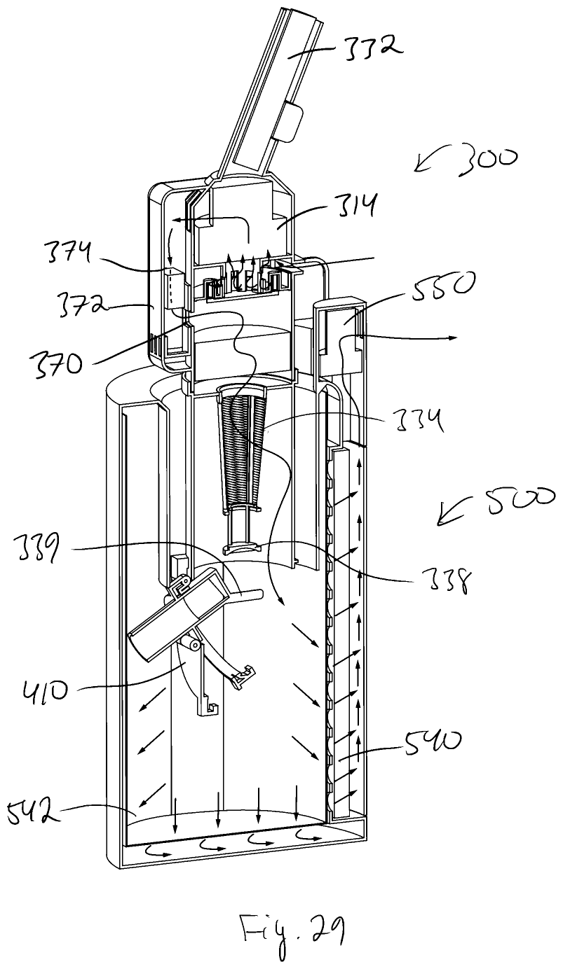

The emptying port 350 may be the air inlet of the air treatment chamber. Alternately, as exemplified in FIG. 24, the outlet port may be a front door of the hand vacuum cleaner. Accordingly, the vacuum cleaner may have an openable door which may be used to empty a dirt collection region (e.g., a cyclone chamber and/or an external dirt collection chamber) when the air treatment assembly is positioned overlying a garbage can. The same door may be used to empty the air treatment chamber when the surface cleaning apparatus or the air treatment assembly is docked. Accordingly, a front openable door may have two uses for emptying an air treatment assembly. It will be appreciated that, in any such embodiment, the front openable door may include the air treatment member air inlet as exemplified in FIG. 29. Alternately, the front door or a side door may be used when the air treatment assembly is positioned overlying a garbage can and the air treatment chamber air inlet may be used when the surface cleaning apparatus is docked.

The reverse air flow path may vary depending on the design of the surface cleaning apparatus 300. For example, air may travel from the second end 348 to the dirt evacuation port 350. In some embodiments, during the dirt emptying mode of operation, air may travel from the evacuation air inlet 370 through all of the air treatment chamber 340 to the dirt evacuation port 350. For example, the dirt evacuation port 350 may be provided at the first end 346 of the air treatment chamber 340 such that air passes through all of the air treatment chamber 340 during the dirt emptying mode of operation. The dirt evacuation port 350 may be provided in the first end, for example, in an end wall located at the first end 346 (see, e.g., FIG. 24), or proximate the first end 346, for example, in the sidewall 341 of the air treatment chamber 340 at or towards the first end 346.

To facilitate the air flow through all of the air treatment chamber 340, the evacuation air inlet port 370 may be provided at the opposed second end 348. For example, the opposed second end 348 may include a second end wall 349 and the evacuation air inlet port 370 may be provided in a sidewall of the air treatment chamber 340 at the second end wall or in the second end wall.

Alternately, if the surface cleaning apparatus 300 has a pre-motor filter 330 having a pre-motor filter header in the pre-motor filter chamber 331, then the evacuation air inlet port 370 may be provided in the pre-motor filter chamber 331, optionally in a downstream pre-motor filter header, as exemplified in FIG. 24, or in an upstream pre-motor filter header.

In some embodiments, the docking unit 500 may include the clean air outlet 514 that is operable in flow communication with the suction motor 314 through the inlet port 360. Accordingly, during the dirt emptying mode of operation, when the downstream part 326 of the air flow path is closed, the evacuation air inlet port 370 is opened, the emptying port 350 is opened, and the inlet port 360 is opened. When the suction motor 314 is activated, air flows through the evacuation air inlet port 370, through at least a portion of the air treatment chamber 340, out the emptying port 350, through the air inlet port 512, out the air outlet 514, into the inlet port 360, and into the suction motor 314. Thus, the suction motor 314 can provide the air flow to empty the air treatment chamber 340 into the docking unit 500. It will be appreciated that the inlet port 360 may be provided upstream of the pre-motor filter of the surface cleaning apparatus (e.g., into the upstream pre-motor filter header). If the docking unit includes a pre-motor filter, then the inlet port 360 may be provided downstream of the pre-motor filter of the surface cleaning apparatus (e.g., into the downstream pre-motor filter header).

provides a suction force to suck dirt from the dirt collection region 312 into the docking unit 500.

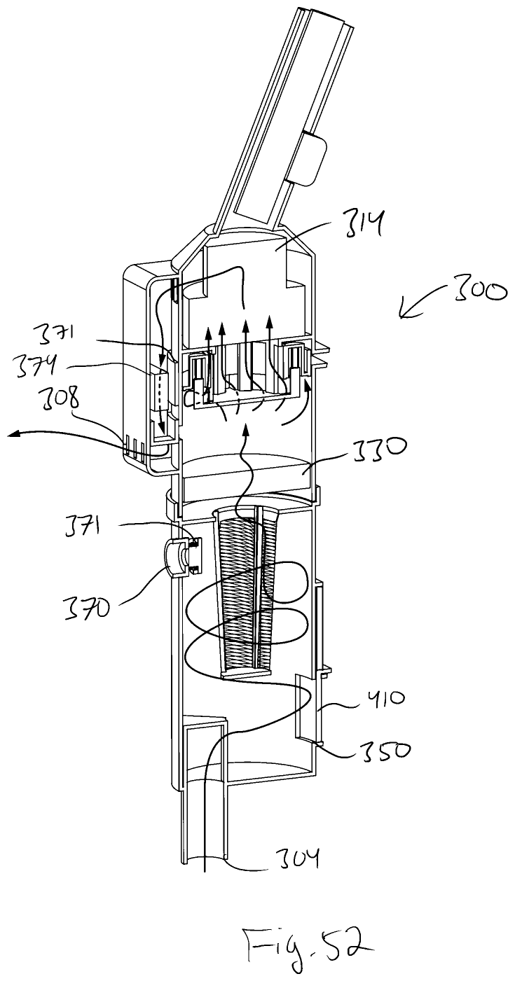

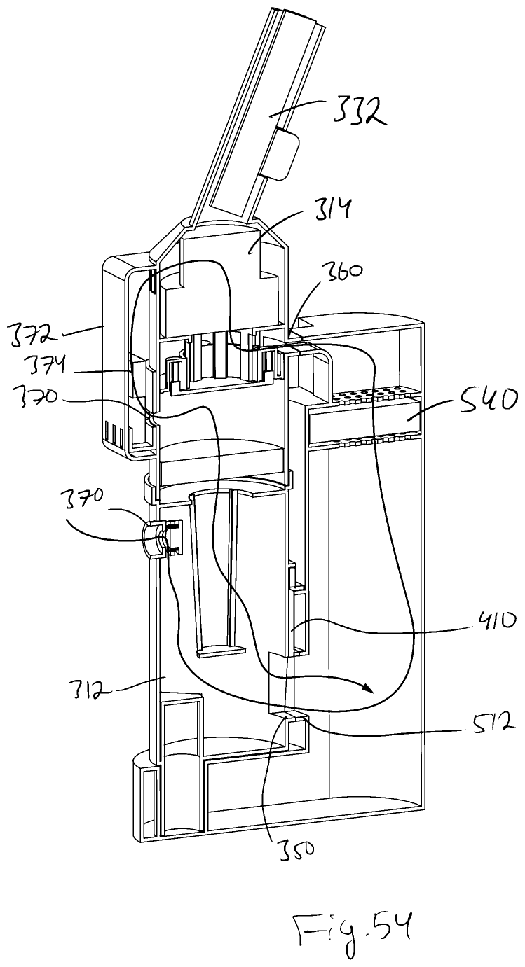

As exemplified in FIG. 54, the surface cleaning apparatus 300 may include the evacuation air inlet port 370 to provide air from ambient into the surface cleaning apparatus 300 during the dirt emptying mode of operation. The ambient air may reduce the temperature of the air flow through the suction motor 314, thereby reducing the likelihood of damage to the surface cleaning apparatus 300 caused by overheating. As shown, the air inlet 304 of the surface cleaning apparatus (see FIG. 52) is closed by the docking unit 500 such that the evacuation air inlet port 370 may operate as a bleed valve to introduce ambient air into the surface cleaning apparatus 300. In some embodiments, air may also be introduced through the air inlet 304 to provide ambient air to the dirt emptying mode of operation.

it will be appreciated as discussed elsewhere herein that there may be a plurality of evacuation air inlet ports 370 to introduce air into different regions of the surface cleaning apparatus 300 during the dirt emptying mode of operation. The plurality of evacuation air inlet ports 370 may be opened sequentially or concurrently to modify the air flow path during the dirt emptying mode of operation.

### Closure Flap

In accordance with this aspect, which may be used by itself or in combination with one or more other aspects, an air inlet of a surface cleaning apparatus and, optionally a hand vacuum cleaner, has a valve such as a closure flap which assists in retaining dirt in the surface cleaning apparatus when the suction motor of the surface cleaning apparatus is deenergized. The valve (closure flap) is opened in a dirt emptying mode of operation. An advantage of this design is that, when the surface cleaning apparatus is in the dirt emptying mode of operation, the closure flap is open so that the dirt may be evacuated through the air inlet of the surface cleaning apparatus. Accordingly, the air inlet of the air treatment member of a surface cleaning apparatus may be one of the emptying ports 350, if a plurality of emptying ports 350 are provided, or the sole emptying port 350. Accordingly an additional door 410 is not required and an additional seal is not required.

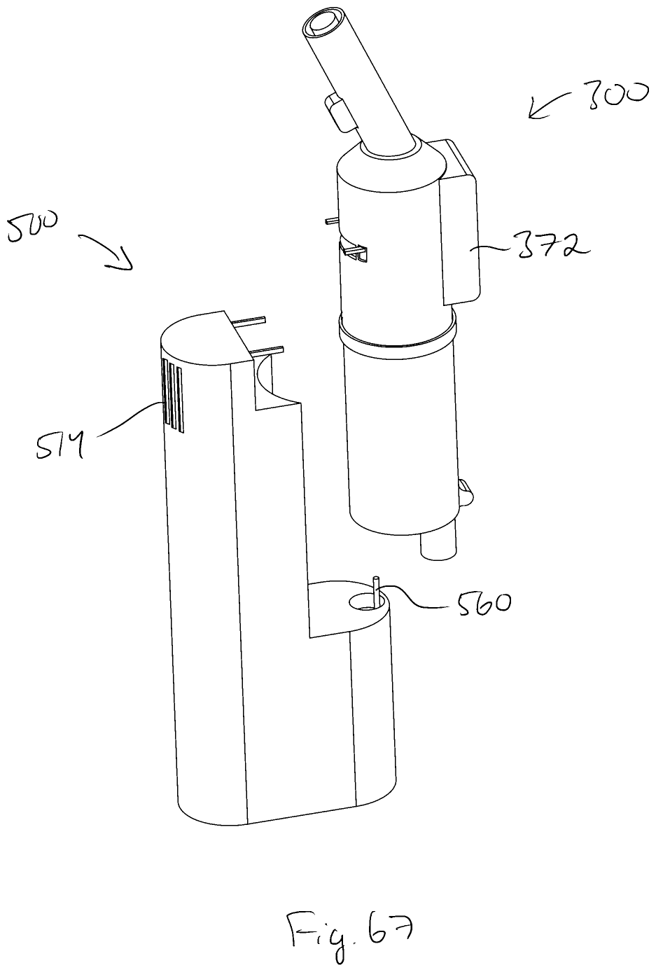

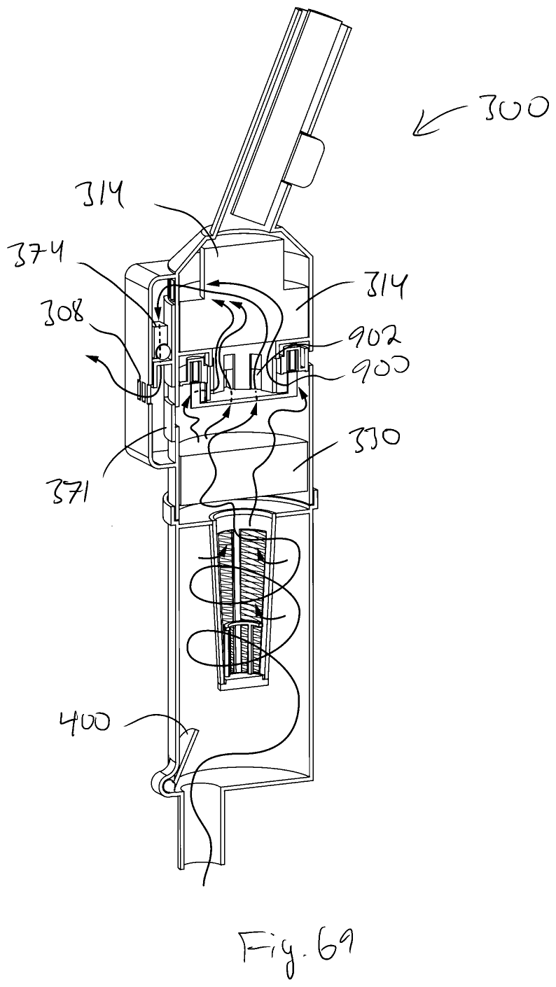

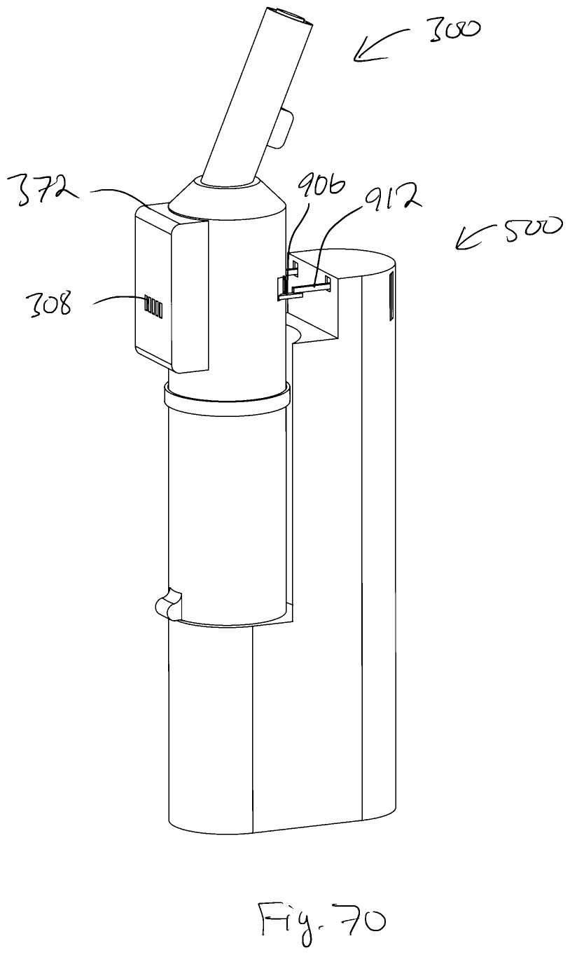

As exemplified in FIGS. 67-71, the surface cleaning apparatus 300 has an air treatment chamber 340 with an air treatment chamber air inlet 342 and a closure flap 400. The closure flap 400 is moveable between a closed position in which the air treatment chamber air inlet 342 is closed and an open position in which the air treatment chamber air inlet 342 is opened.

When the surface cleaning apparatus 300 is in a surface cleaning mode of operation, the closure flap 400 is open. For example, the closure flap 400 may be opened by a suction force provided by the suction motor 314. Accordingly, when the suction motor 314 is activated, the suction force moves the closure flap 400 to the open position, allowing air to flow into the air treatment chamber 340 through the air treatment chamber air inlet 342. In some embodiments, the closure flap 400 may be biased to the closed position. For example, when the suction motor 314 is deenergized and the suction force is removed, the closure flap 400 may be biased back to the closed position.

When the surface cleaning apparatus 300 is in the dirt emptying mode of operation and is docked at the docking unit, the air treatment chamber air inlet 342 is in flow communication with the dirt collection region 510 of the docking unit and the closure flap 400 is in the open position. Accordingly, the flow of air travels through the air treatment chamber air inlet 342 into the docking unit 500, thereby allowing the air treatment chamber 340 to be emptied.

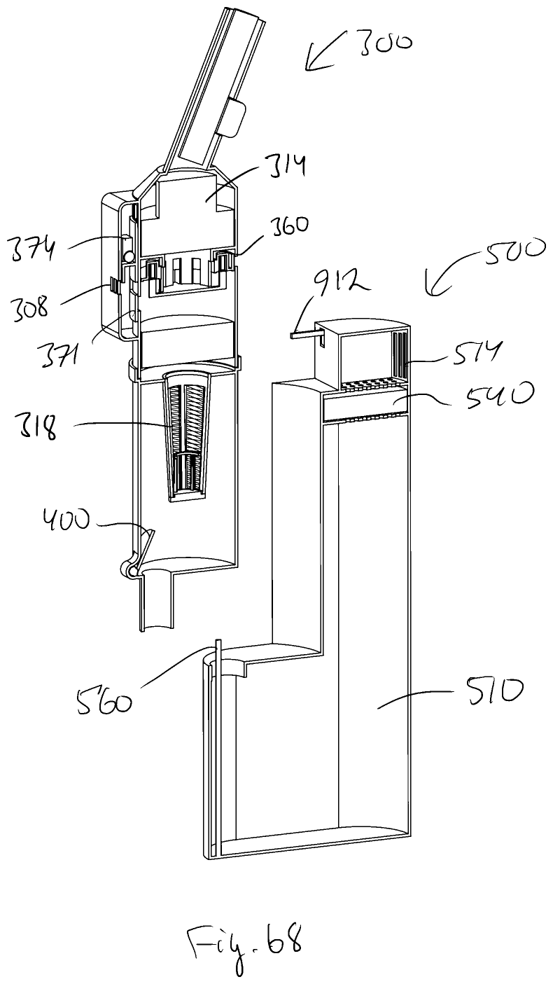

It will be appreciated that the air treatment chamber air inlet 342 may be provided at any location on an air treatment chamber such as at an upper end of the air treatment chamber 340 when the surface cleaning apparatus is in use (see, e.g., FIG. 68) or at a lower end of the air treatment chamber 340.

It will also be appreciated that the air treatment chamber air inlet 342 may be of any design known in the art. Optionally, as exemplified, the air treatment chamber air inlet 342 is the downstream end of dirty air inlet 304 of a hand vacuum cleaner (see FIG. 22).

The closure flap may open any amount during a cleaning mode or during an emptying mode of operation. As exemplified in FIG. 67-71, the closure flap 400 opens inwardly about 70°. Optionally, the closure flap opens about 90° or opens to be flush with a wall of the air treatment chamber so as to not be in the air flow path. In particular, the closure flap optionally opens so as not to overlie the air treatment chamber air inlet 342.

It will be appreciated that any other valve may be used which opens and closes dirty air inlet 304 and the valve need not be at the outlet end of the dirty air inlet 304.

Optionally, the valve is of a design which enables the valve to move to the open position due to air flow therethrough when the suction motor is actuated to draw air into the air treatment chamber. The closure flap 400 is an optional embodiment which is exemplified.

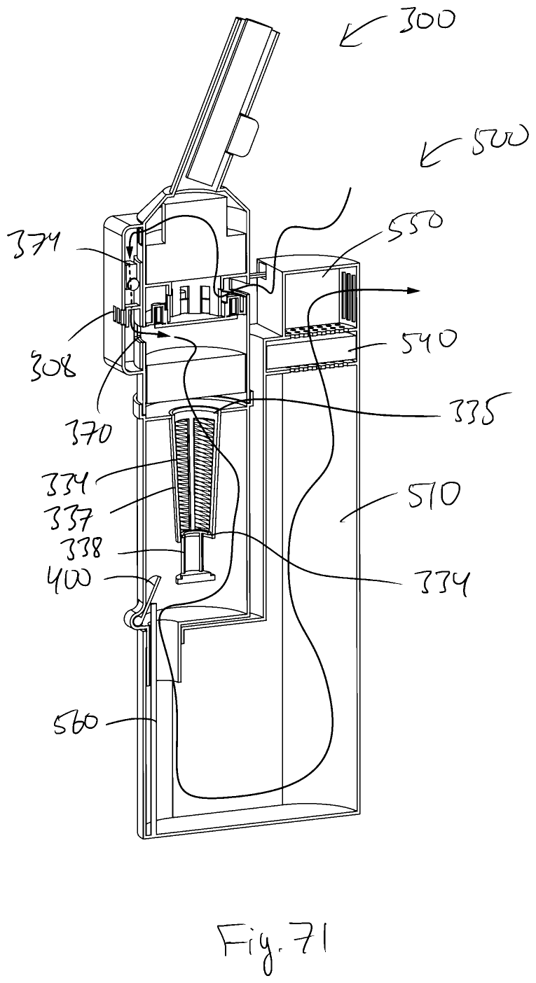

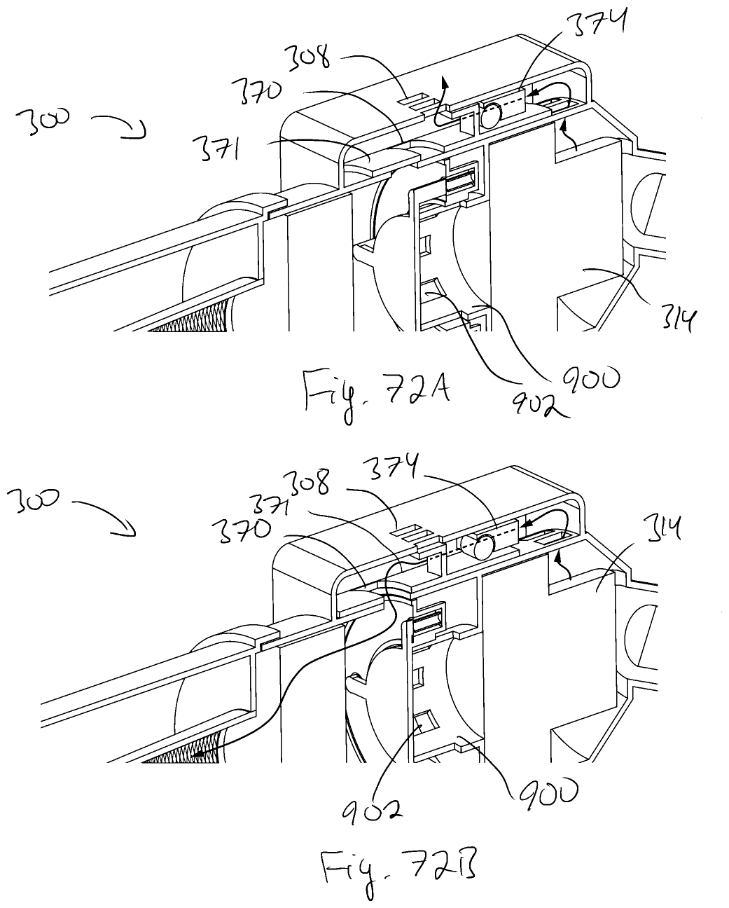

Optionally, the closure flap 400 may be moved to the open position as the surface cleaning apparatus 300 is docked at the docking unit. For example, as exemplified in FIG. 71, the docking unit 500 has a drive member 560 that mechanically engages with the surface cleaning apparatus 300 when the surface cleaning apparatus 300 is docked at the docking unit. The mechanical engagement between the drive member 560 and the surface cleaning apparatus 300 drives the closure flap 400 to the open position. As exemplified in FIG. 71, the drive member is a mechanical drive member (e.g., a rod) which is fixed in position on the docking unit and mechanically engages directly with the closure flap 400 to move the closure flap 400 to the open position. Alternately, the drive member 560 may engage with another element of the surface cleaning apparatus 300 that subsequently opens the closure flap 400. The other element may be a mechanical linkage that is drivingly connected to the closure flap, an electromechanical member (e.g., a solenoid), that is drivingly connected to the closure flap 400 and is actuated when contacted by the drive member 560, or the like. Alternately, the drive member may be a moveable member which moves to open the closure flap when the docking unit detects that the surface cleaning apparatus is being or has been docked. For example, an electromechanical member may be actuated when the surface cleaning apparatus is docked. The electromechanical member may comprise an arm of the like which is actuated to drivingly engage the closure flap 400, or a mechanical linkage drivingly connected to the closure flap 400, and open the closure flap 400. Alternately, if an electromechanical member, a motor or the like (an electrically operated driving member) is drivingly connected to the closure flap 400, the electrically operated driving member may be actuated as of after the surface cleaning apparatus is docked.

It will be appreciated that if the valve is opened by an electrically operated driving member, then the electrically operated driving member may be actuated when the surface cleaning apparatus is actuated so as to open the dirty air inlet 304 during the cleaning mode of operation.

### Openable Porous Member

In accordance with this aspect, which may be used by itself or in combination with one or more other aspects, a surface cleaning apparatus has an air treatment chamber air outlet that has a porous member, which may extending into the air treatment chamber from a wall of the air treatment chamber. The porous member has a moveable portion that is moveable to an open position. When the surface cleaning apparatus is in the dirt emptying mode of operation, a flow of air moves through the air treatment chamber to facilitate the emptying of the air treatment chamber. During the dirt emptying mode of operation, the moveable portion of the porous member is positioned in the open position for at least a portion of the duration of the emptying mode such that at least some of the flow of air exits the porous member without passing through the porous section of the porous member. An advantage of this design is that the air flow path through the air treatment chamber may be varied to improve the removal of dirt from the air treatment chamber. For example, instead of all of the air flow passing through the porous portion of the porous member, the moveable portion may be positioned further interior of the air treatment chamber thereby opening a section of the porous member such that at least some of the air flow passes through the open section thereby reducing the back pressure during the emptying mode and increasing the velocity of air travelling through the air treatment chamber, which may enhance the amount of dirt which is removed from an air treatment chamber during the emptying mode of operation. Another advantage is that any dirt and/or debris caught within the porous member and/or the pre-motor filter chamber may exit the porous member without remaining trapped in the interior of the porous member.

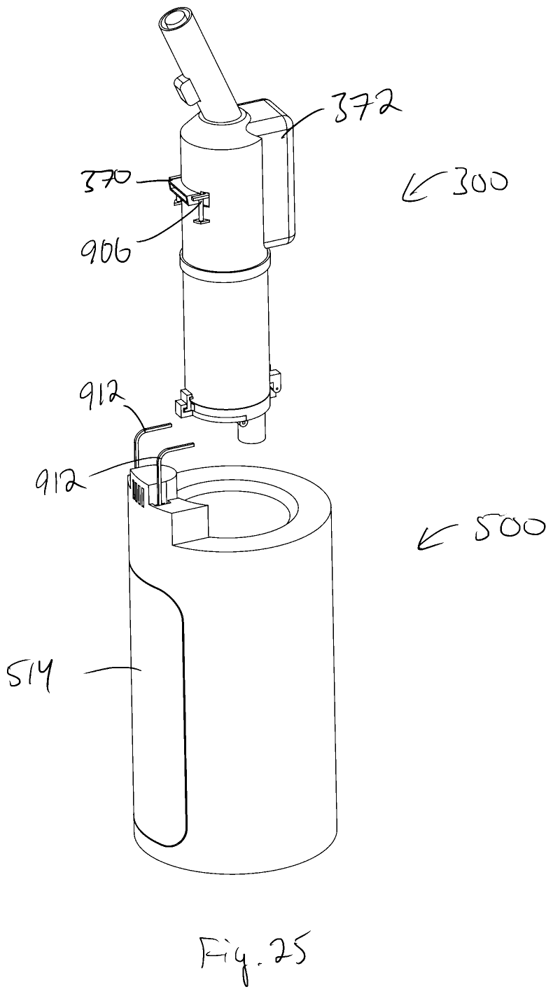

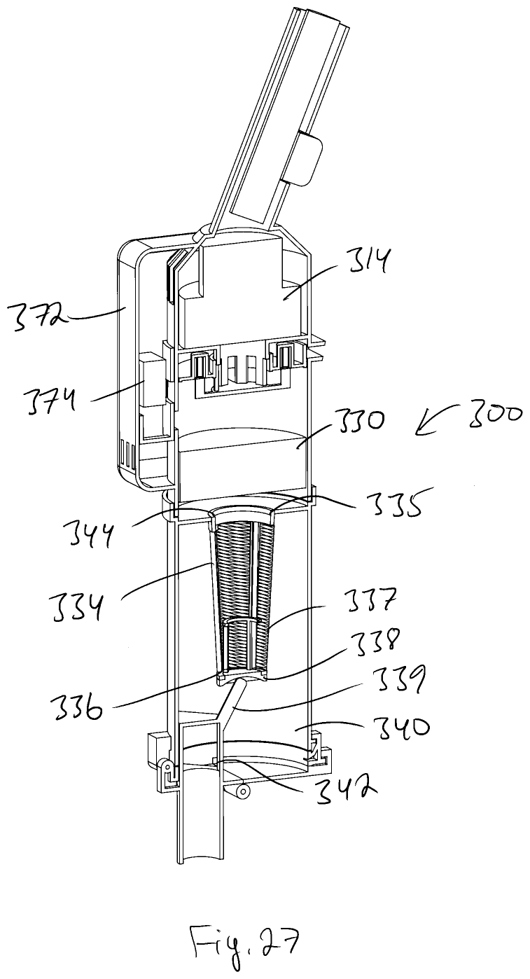

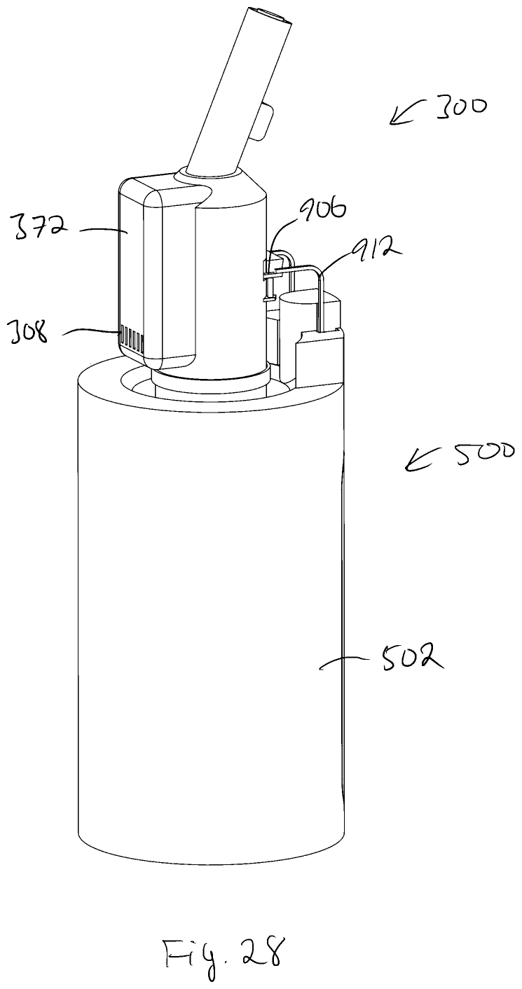

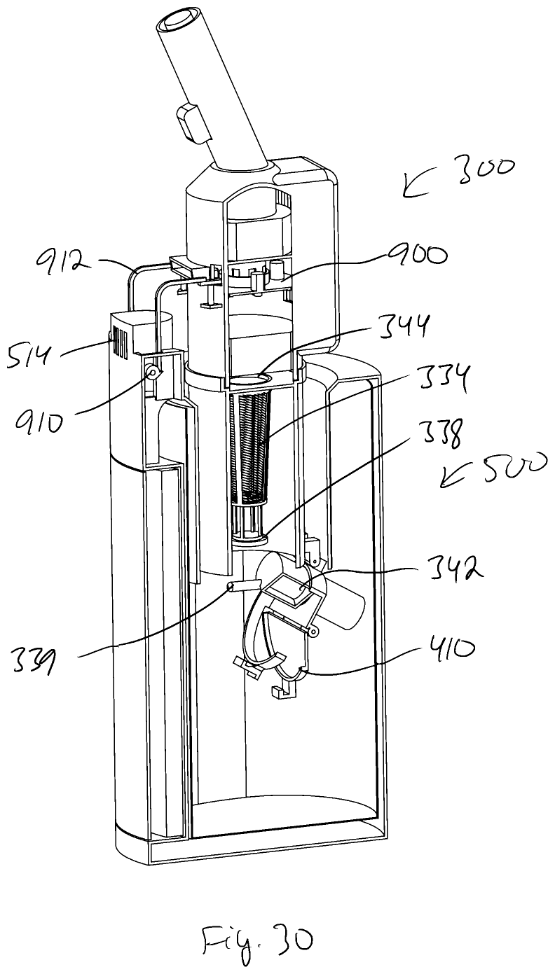

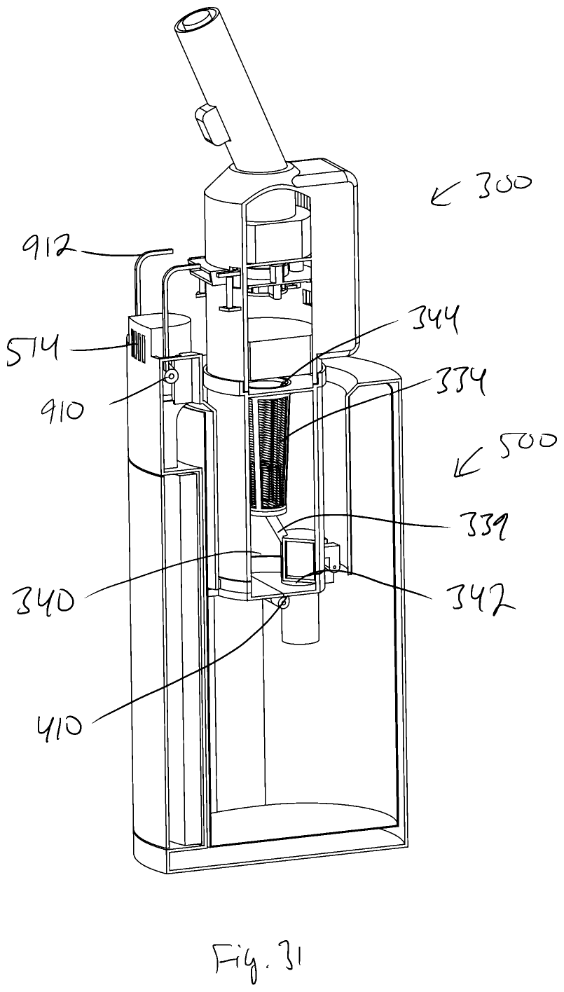

In accordance with this aspect, as exemplified in FIGS. 25-31 there is provided the surface cleaning apparatus 300 having a porous member 334. The porous member 334 is provided at the air treatment chamber air outlet 344. The porous member 334 has an outlet end 335, an inner end 336, a porous section 337, and a moveable portion 338. As exemplified, the porous member 334 is a screen that may be a vortex finder for a cyclone and overlies an outlet port of a cyclone chamber.

The moveable portion 338 may be the inner end 336 or tip. It will be appreciated that the moveable portion may be any part of the porous member 334 and may itself be porous or non-porous.

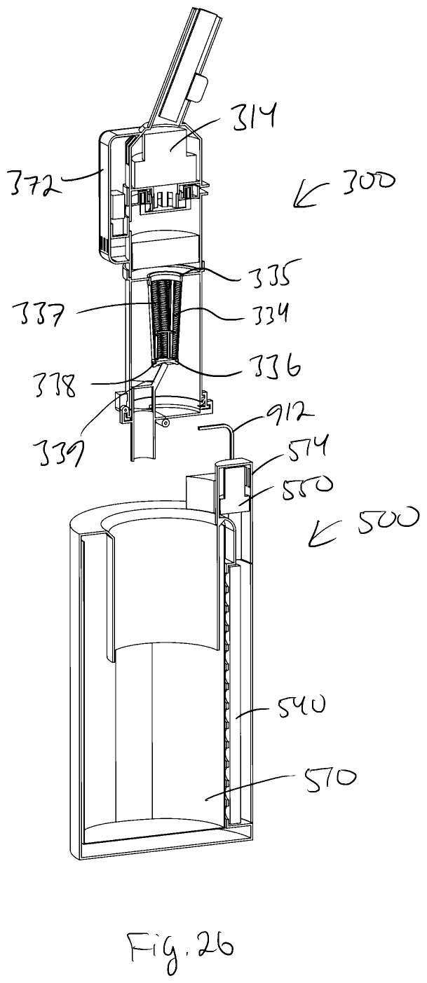

As exemplified in FIGS. 26-31, the moveable portion 338 is moveable between a closed position and an open position. As shown, the porous member 334 extends into the air treatment chamber 340 from a wall 349 at the second end 348. As exemplified in FIG. 29, the air treatment chamber air inlet 342 may be provided at the first end 346 and the wall 349 may be positioned at the axially opposed second end 348 of the air treatment chamber 340 with the porous member 334 extending axially into the air treatment chamber 340.

During the cleaning mode of operation, air to be treated enters the surface cleaning apparatus 300 through the dirty air inlet 304 into the air treatment chamber 340. The air then passes through the porous member 334, exits the air treatment chamber 340, and exits the surface cleaning apparatus 300 by the clean air outlet 308. When in the dirt emptying mode of operation, a flow of air enters the air treatment chamber 340 through the porous member 334 and, during at least a portion of the dirt emptying mode of operation, the moveable portion 338 of the porous member 334 is in the open position such that at least some of the flow of air exits the porous member 334 without passing through the porous section 337.

The moveable portion 338 may be moved from the closed to the open position by any means. For example, the moveable portion may be moved to the open position by, including, but not limited to, an electronic and/or pneumatic system that is actuated at the commencement or during a dirt emptying mode, may be pushed open by a pressure caused by the air flow during the emptying mode, e.g., by exhaust air from the suction motor 314 that is directed to flow through the porous member 334, and/or may be mechanically opened as the surface cleaning apparatus 300 is docked at the docking unit.

As discussed elsewhere herein, the air flow during the emptying mode may be from various sources. As exemplified in FIG. 29, when the surface cleaning apparatus 300 is in the dirt emptying mode of operation, the suction motor 550 provides the air flow that operates to open the moveable portion 338 of the porous member 334. Air flows from the pre-motor filter chamber 331, through the air treatment chamber air outlet 344. This air flow pushes the moveable portion 338 to the open position. The air then flows through the opening 350 at the front of the surface cleaning apparatus 300 and into the docking unit 500. It will be appreciated that the moveable portion 338 may be biased to the closed position (e.g., by a resilient member such as a spring). The air flow may overcome the spring tension to open the porous member 334. The moveable portion may accordingly return to the closed position when the suction motor is deenergized.

Alternately, as exemplified in FIG. 29, the surface cleaning apparatus 300 has an openable end formed by the openable door 410. When the air treatment chamber 340 is opened during the dirt emptying mode of operation, the moveable portion 338 may be moved concurrently to the open position. For example, air flow provided during the emptying mode may open both the door 410 and the moveable portion 338.

Alternately, the openable end 410 may be mechanically linked to the porous member 334 such that opening the door 410 concurrently opens the moveable portion 338 of the porous member 334. For example, as exemplified in FIG. 29, a linking rod 339 extends between the first end 346 of the air treatment chamber 340 and the moveable portion 338 such that the moveable portion 338 is moved to the open position concurrently when the air treatment chamber 340 is opened. In such an embodiment, the moveable portion may be biased to the open position. When the door is closed, the linking rod 339 may move the moveable portion 338 to the closed position.

Alternately, the valve 900 discussed previously may also be drivingly connected to the moveable portion. Accordingly, actuating the valve 900 may also open the porous member.

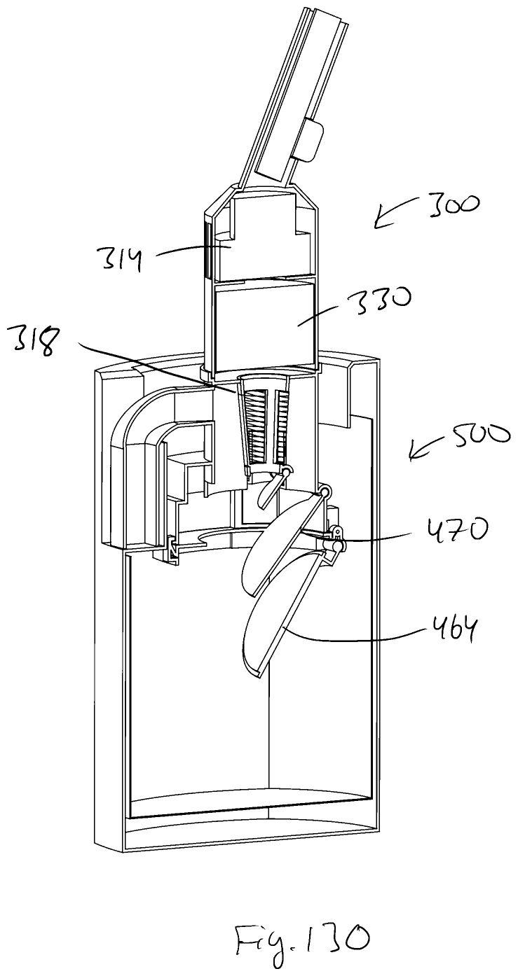

It will be appreciated that, as exemplified, the moveable portion may move axially. It will also be appreciated that the moveable portion may also rotate open (see, e.g., FIG. 130), translate open or the like.

The moveable portion 338 may be in the open position throughout the entire dirt emptying mode of operation or may be open for at least a portion of the dirt emptying mode of operation. For example, in some embodiments, during a first part of the dirty emptying mode of operation, the moveable portion 338 is in the closed position, thereby forcing the air flow through the porous section of the porous member to assist in cleaning the porous section, and during a subsequent part of the dirt emptying mode of operation, the moveable portion 338 may be in the open position to increase the velocity of air through the air treatment chamber.

During the dirt emptying mode of operation, varying power levels may be applied to the suction motor. For example, during the first part of the dirt emptying mode of operation, a first level of power may be provided to the suction motor that produces the flow of air and during the subsequent part of the dirt emptying mode of operation, a second level of power may be provided to the suction motor. The second level of power may be lower than the first level of power or may be higher than the first level of power.

As discussed subsequently with respect to an agitator for a pre-motor filter, an agitator may engage with the porous member 334 during at least a portion of the dirt emptying mode of operation. The agitator may operate to dislodge dirt and/or debris caught in the porous member 334 such that the dirt and/or debris is removed during the emptying process. The agitator may optionally be the same as the agitator for the pre-motor filter if such an agitator is provided.

### Opening the Pre-Motor Filter Chamber

In accordance with this aspect, which may be used by itself or in combination with one or more other aspects, part or all of a wall separating the pre-motor filter and the air treatment chamber may be opened during part or all of the emptying mode. An advantage of this aspect is that the velocity of air flow through the pre-motor filter may be enhanced during the emptying mode of operation, as screen or other porous member may be moved out of the emptying mode flow path.

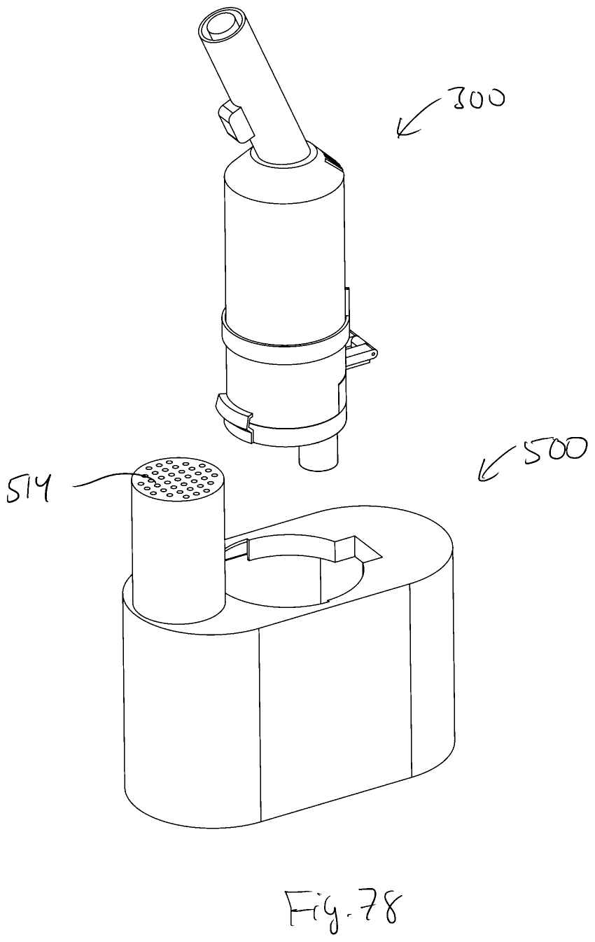

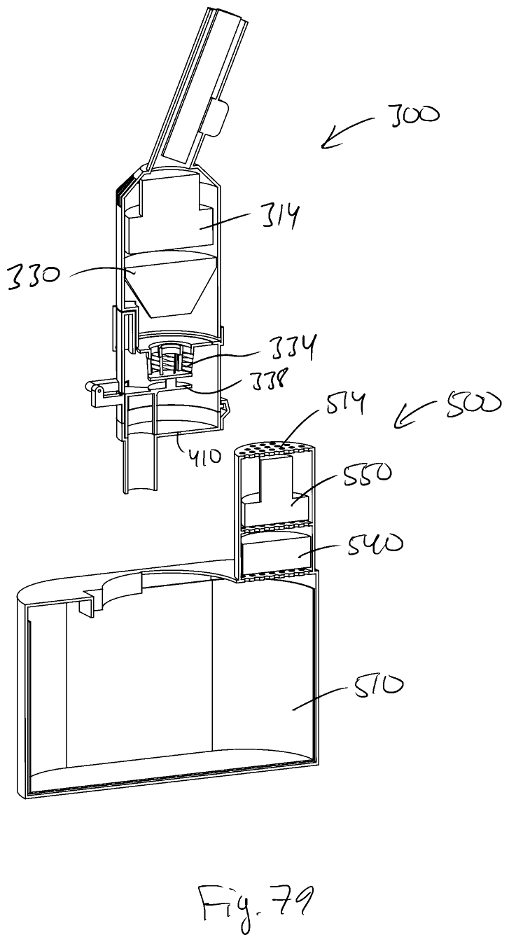

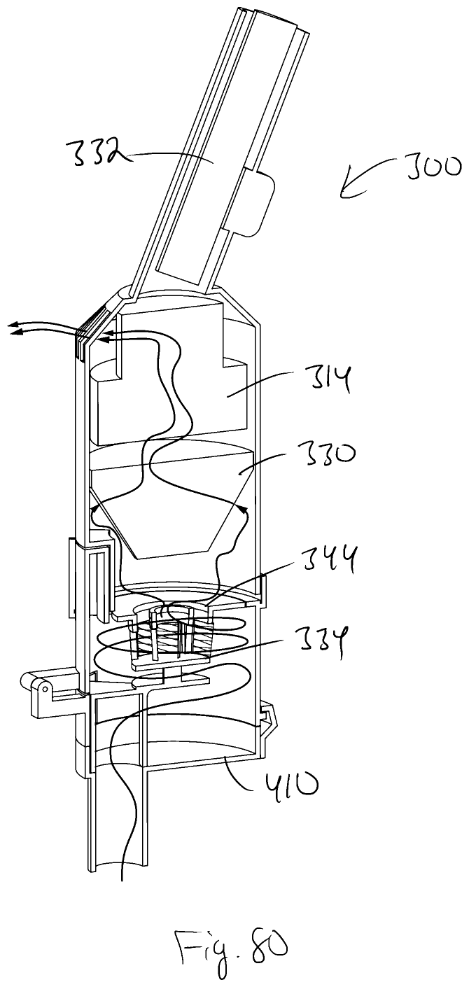

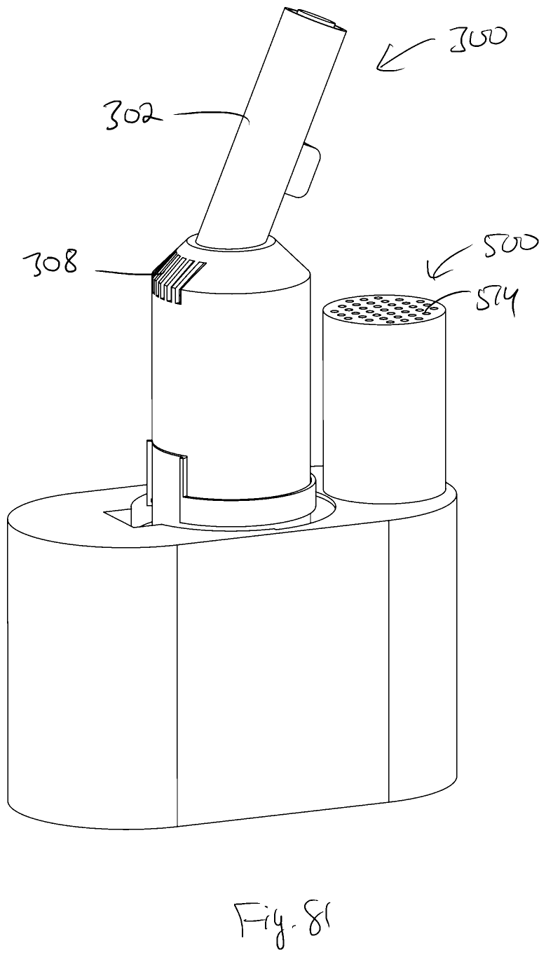

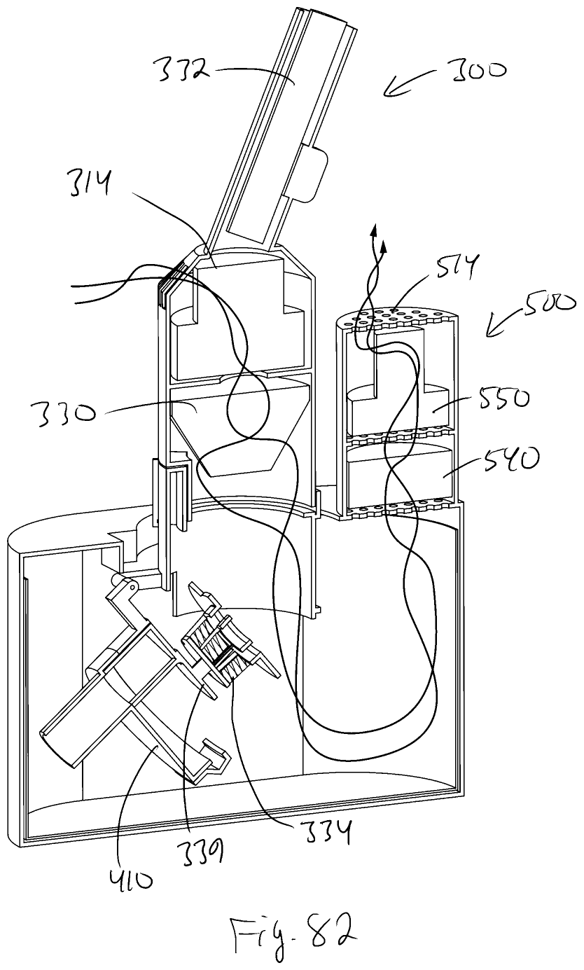

It will be appreciated that the wall, or any part thereof, may be moved to an open position, such as by rotation, translation or the like. As exemplified in FIG. 78-82, all of the wall to which the porous member 334 is mounted may pivot open. Optionally, the wall may pivot about 45° as exemplified. Alternately, the wall may pivot open 90° or more so as to more fully remove the screen from the air treatment chamber. In order to more fully open the air treatment chamber, part or all of a sidewall of the air treatment chamber may also open.

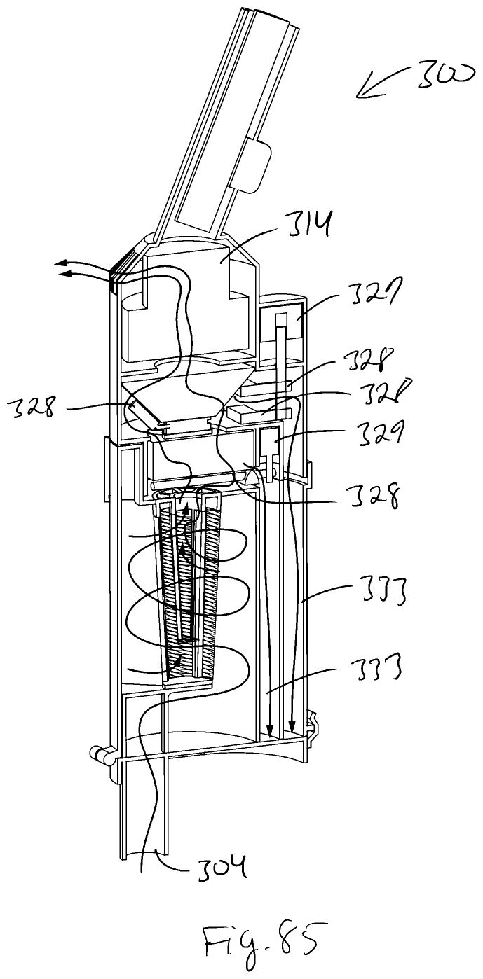

Optionally, the openable door 410 may provide access to each of the air treatment chamber 340 and the pre-motor filter chamber 331. As exemplified the porous member 334 may be coupled to the openable door 410 such that when the door is moved to the open position, the porous member 334 moves to expose the pre-motor filter 330. For example, the screen may extend to the air treatment chamber air inlet (see, e.g., FIG. 85). The screen may be attached to the air treatment chamber air inlet. In such a case, the front and sidewall of the air treatment chamber may open, e.g., pivot open. An advantage of this design is that a single actuation movement may provide access to multiple elements within the surface cleaning apparatus 300, thereby facilitating the emptying process.

### Use of Exhaust Air From the Suction Motor

In accordance with this aspect, which may be used by itself or in combination with one or more other aspects, a suction motor, such as the suction motor of the surface cleaning apparatus, may provide the motive force to facilitate the dirt emptying mode by using exhaust air from the suction motor. An advantage of this aspect is that the suction motor of the surface cleaning apparatus may be used to provide all of the air flow during the dirt emptying mode. Accordingly, the docking unit need not have a suction motor, thereby simplifying the docking unit. For example, the docking unit need not have any electrical components and therefore need not be plugged into household mains. An further advantage of this aspect is that the suction motor of the surface cleaning apparatus may be used to provide all of the air flow during the dirt emptying mode without reversing the direction or rotation of the suction motor during a dirt emptying mode of operation. Instead, the air flow from the downstream side of the suction motor may be directed back into the surface cleaning apparatus during the dirt emptying mode of operation.

The exhaust air flow from the suction motor of the surface cleaning apparatus may be directed back to the air treatment chamber 340 by using an internal passage provided in the surface cleaning apparatus (such as in the motor housing and the/or the pre-motor filter housing), or by a passage created when the surface cleaning apparatus is docked at the docking unit (e.g., a passage is defined between outer walls of the docking unit and the surface cleaning apparatus) or an internal passage in the docking unit.

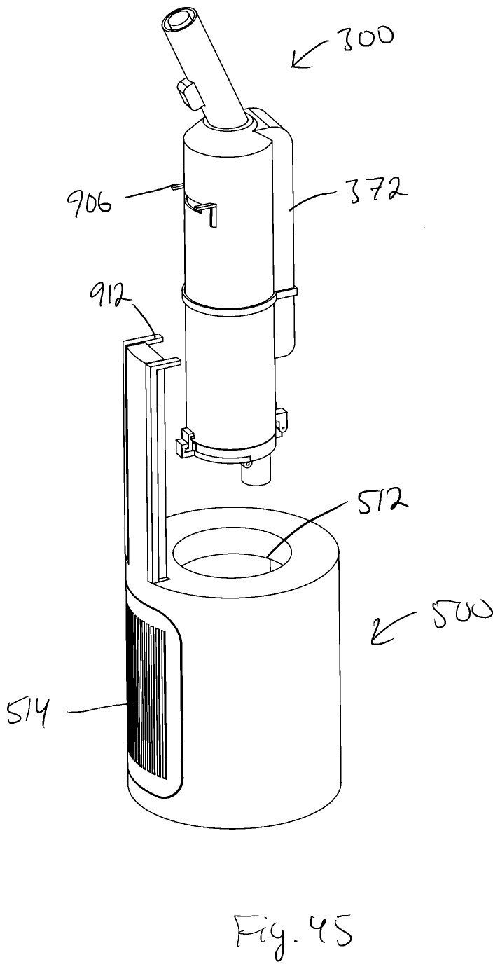

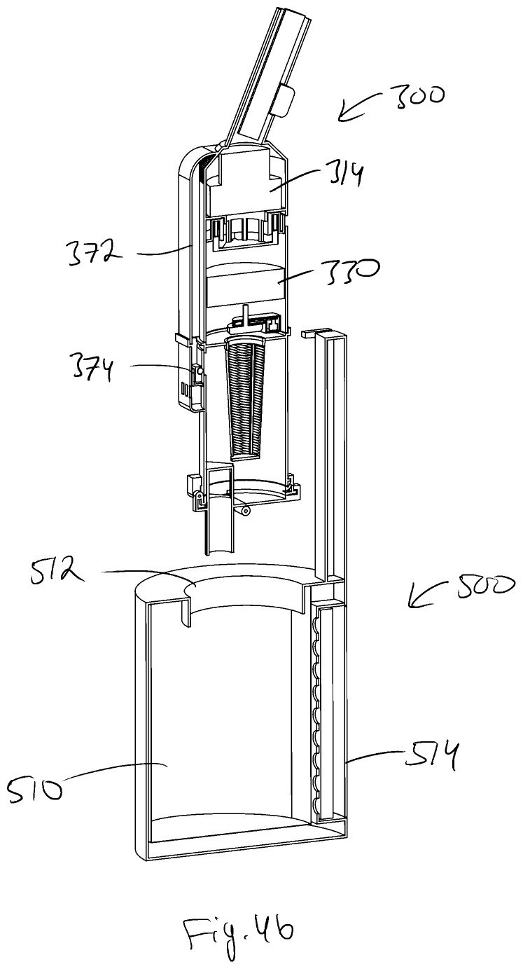

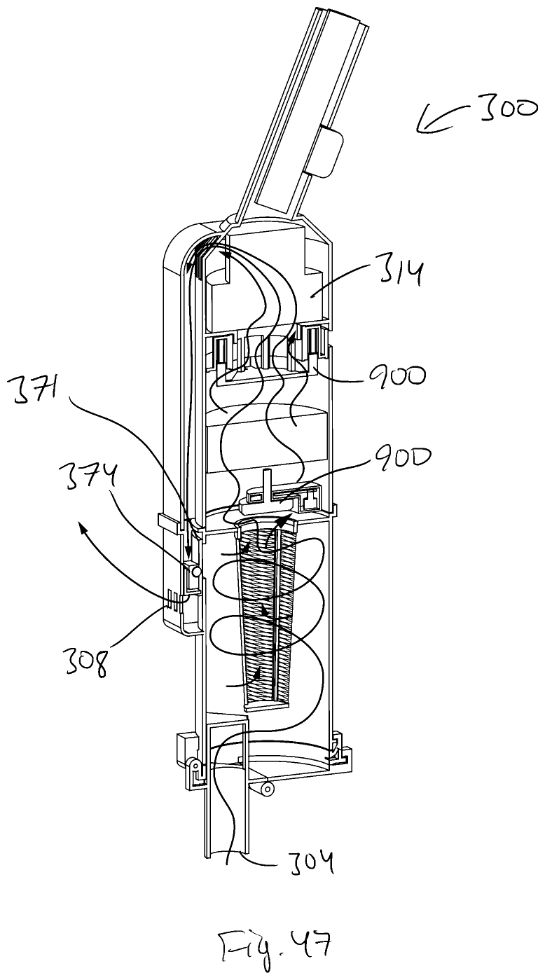

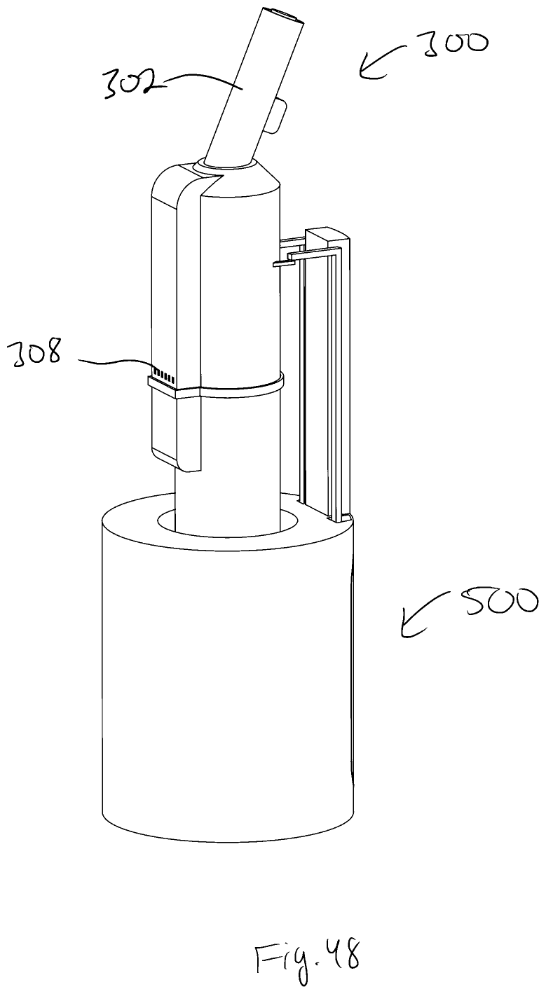

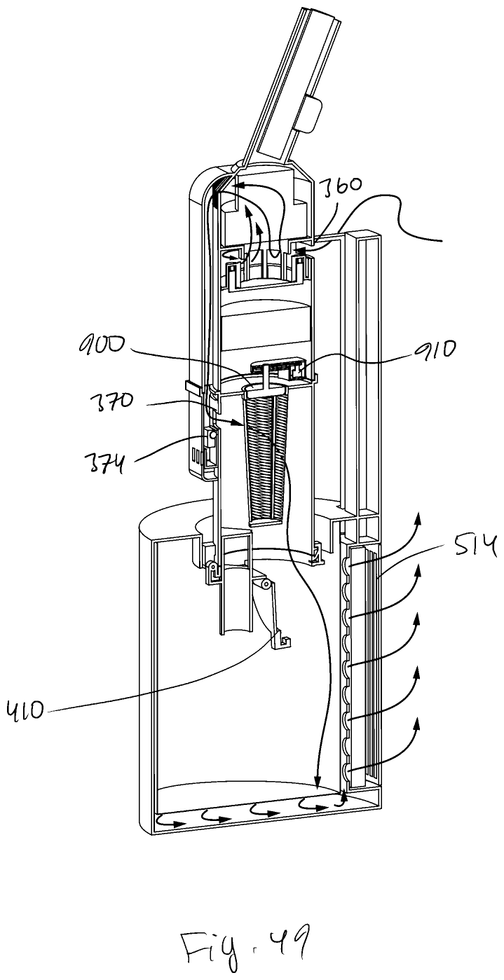

For example, as exemplified in FIGS. 45-49, there is an exhaust conduit 372 that connects the clean air outlet 308 to the evacuation air inlet port 370. Accordingly, when the surface cleaning apparatus 300 is docked at the docking unit 500 and is operating in the dirt emptying mode of operation (see FIG. 49), air passes from the clean air outlet 308, through the exhaust conduit 372, and into the evacuation air inlet port 370. The air then flows through the air treatment chamber 340 as discussed previously to evacuate the dirt into the docking unit 500.

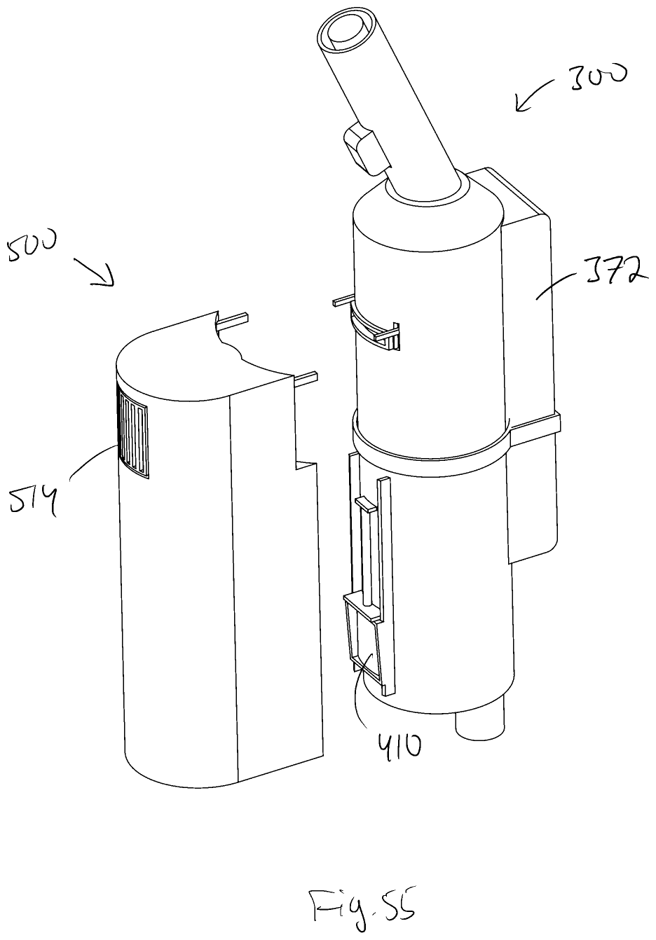

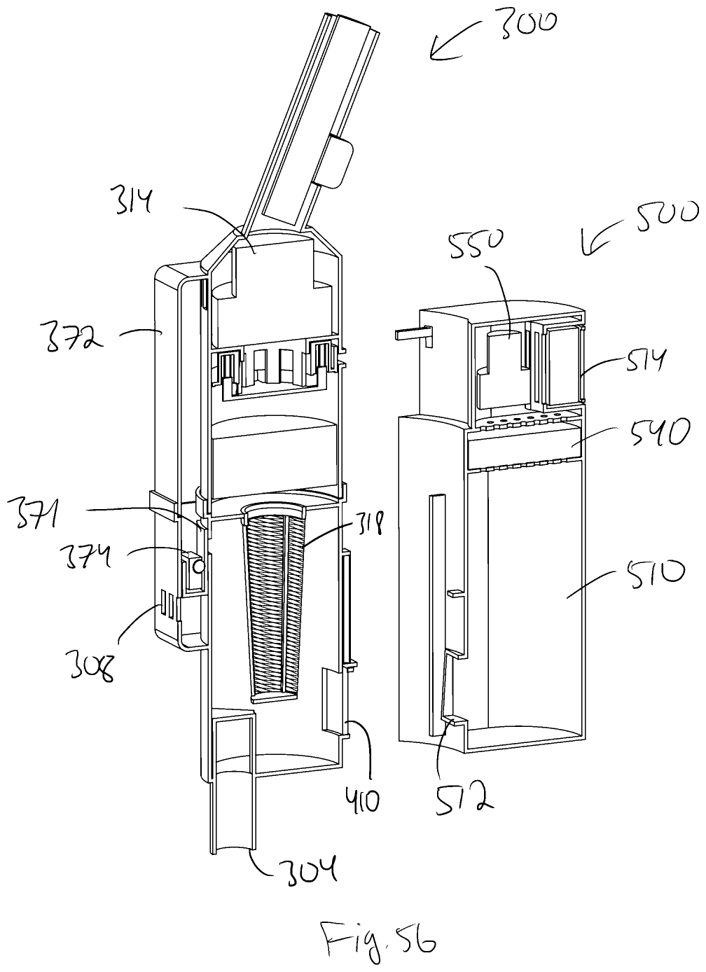

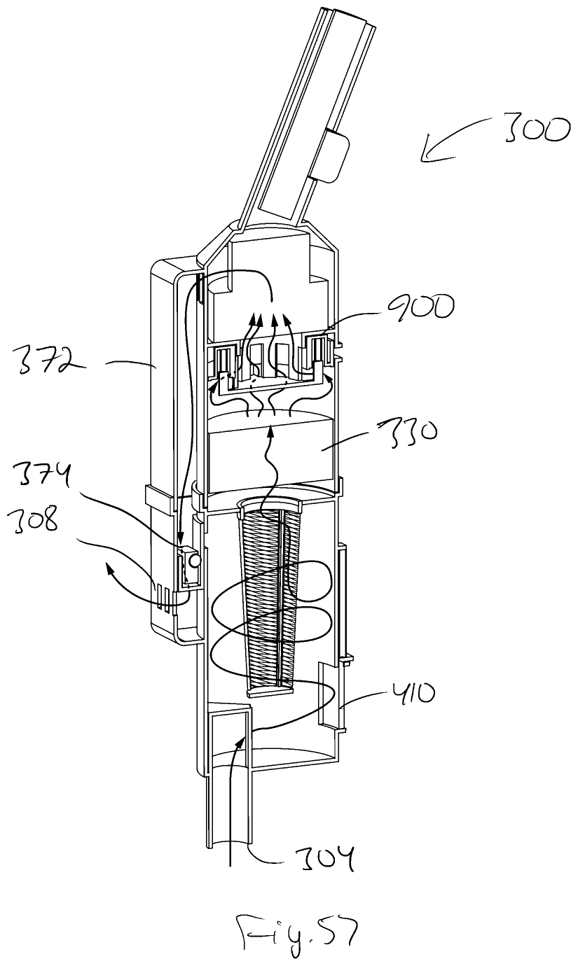

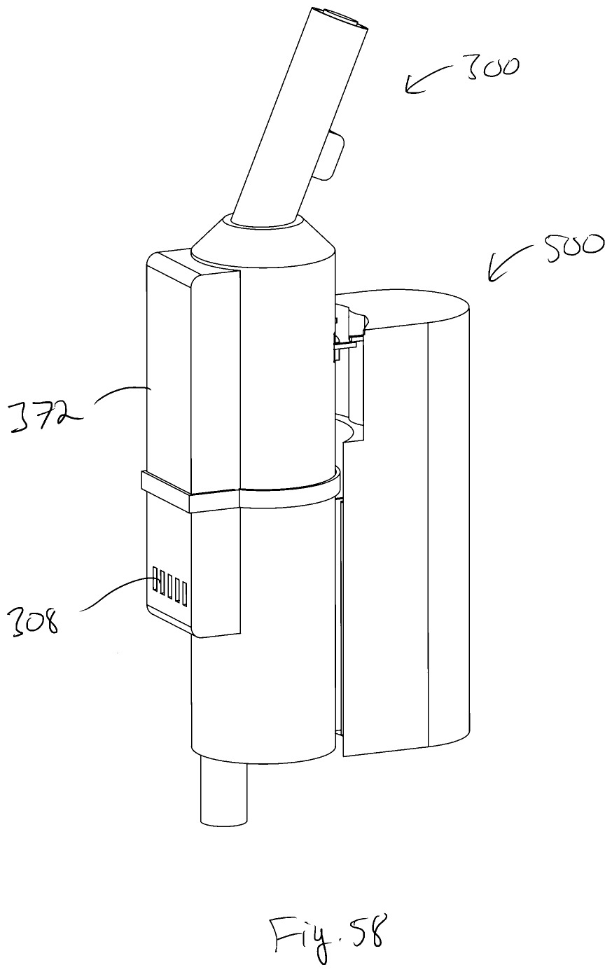

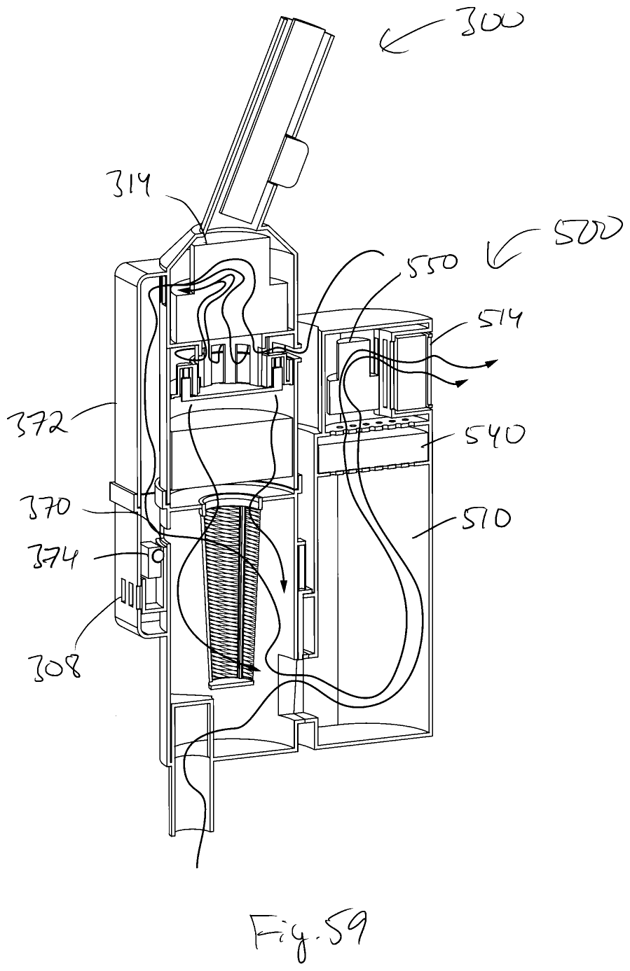

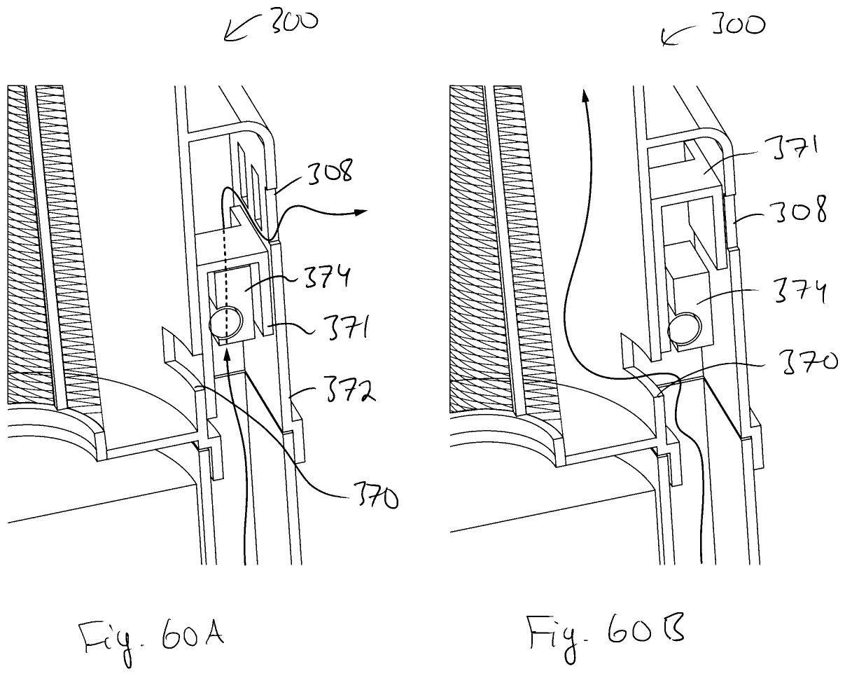

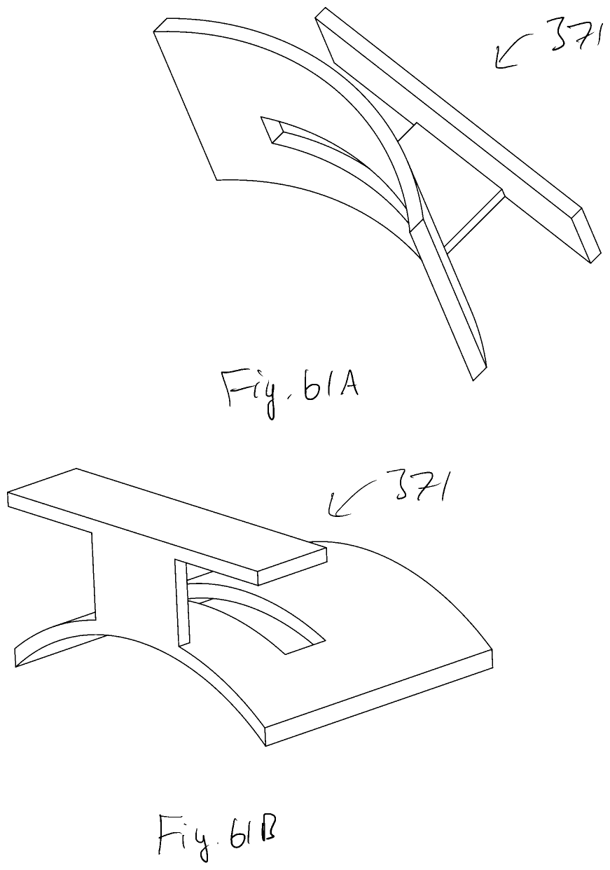

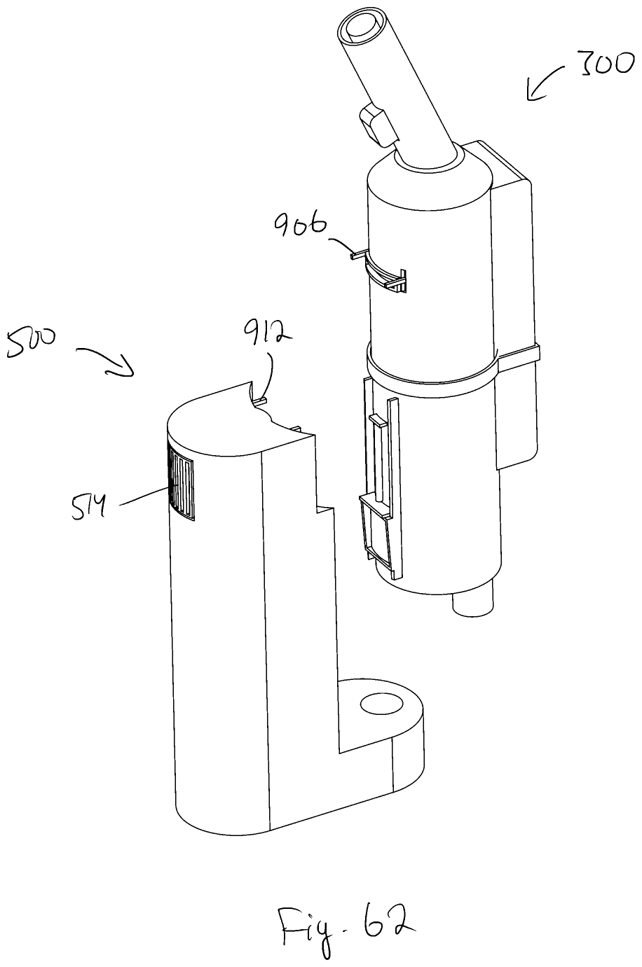

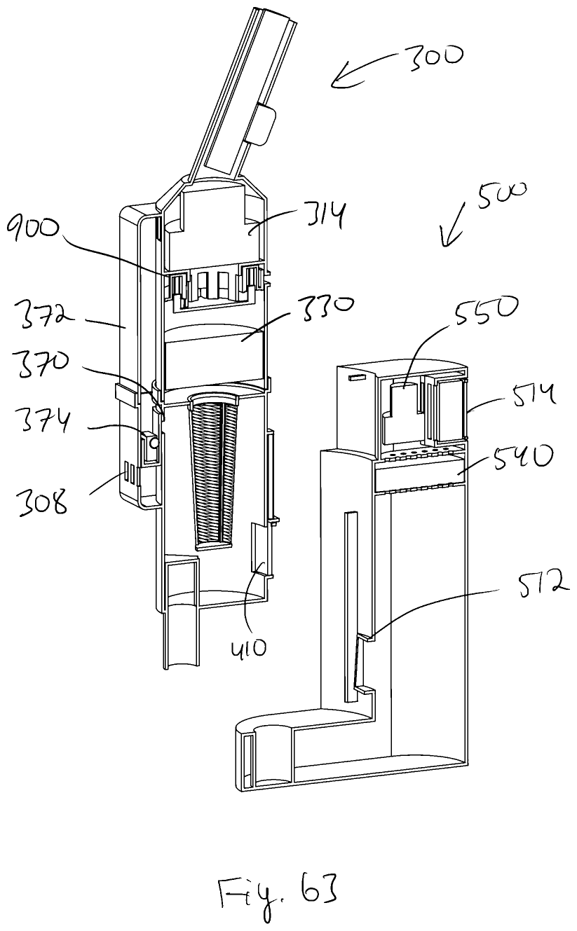

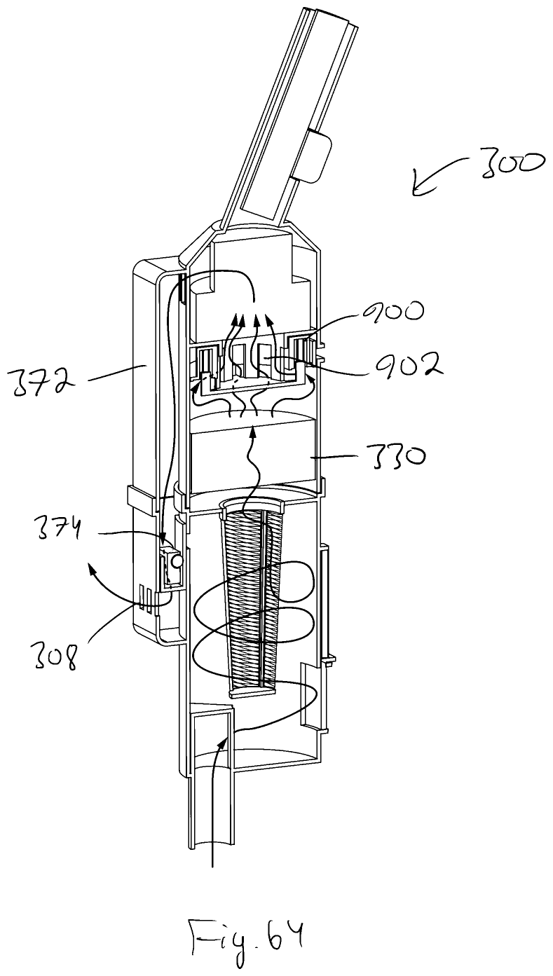

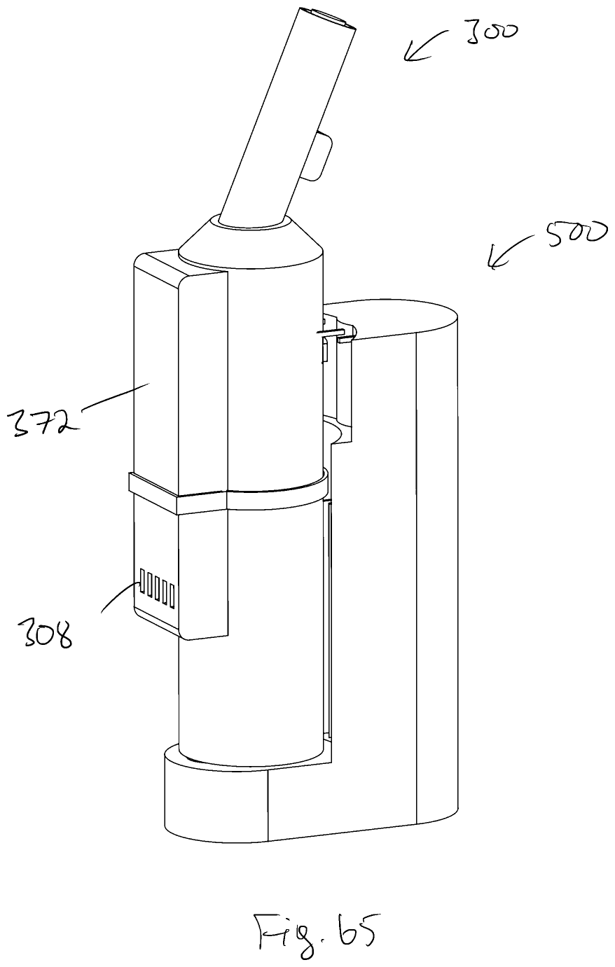

The exhaust conduit 372 may include an air inlet actuator 374 for actuating the valve 371 between the open and closed positions. As exemplified in FIGS. 55-66, the actuator 374 moves the valve 371 to the closed position for the cleaning mode of operation and the open position for the dirt emptying mode of operation.

### Use of Suction and Exhaust Air

In accordance with this aspect, which may be used by itself or in combination with one or more other aspects, the air flow used during an emptying operation may be both suction air flow produced by a suction motor to draw air towards the suction motor and also exhaust air from a suction motor. Accordingly, the air flow may be produced by both suction and exhaust air (a pushing force). Optionally, the same suction motor, such as the suction motor in a surface cleaning apparatus, may be used. Accordingly, when the suction motor is actuated, the rotation of the fan blade draws air into the air flow chamber and also is used to push air through the air treatment chamber, to one or more emptying ports 350.

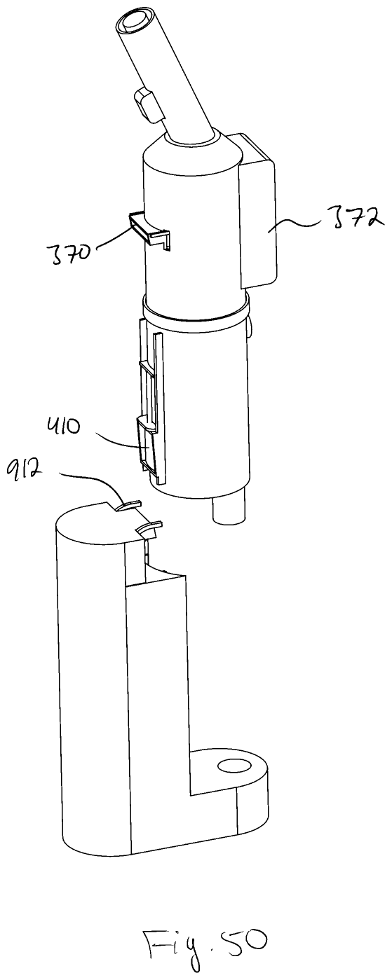

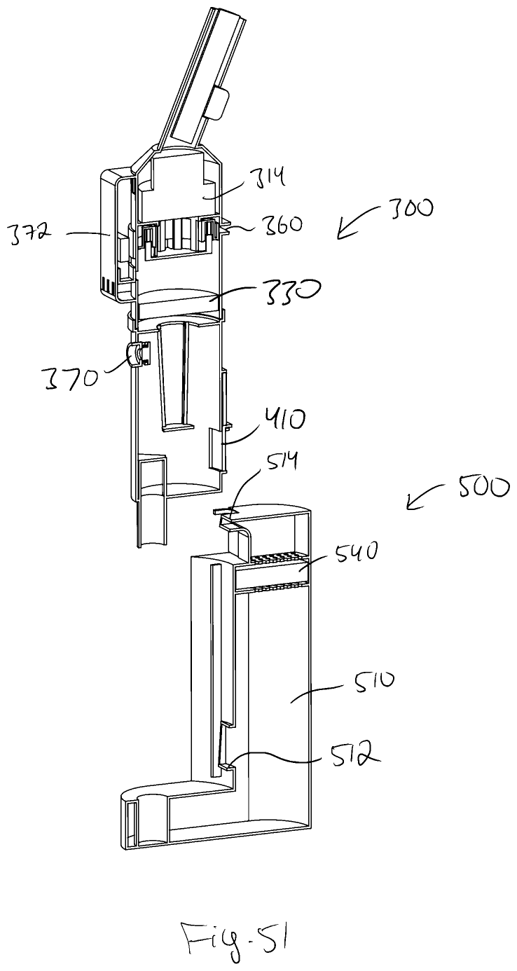

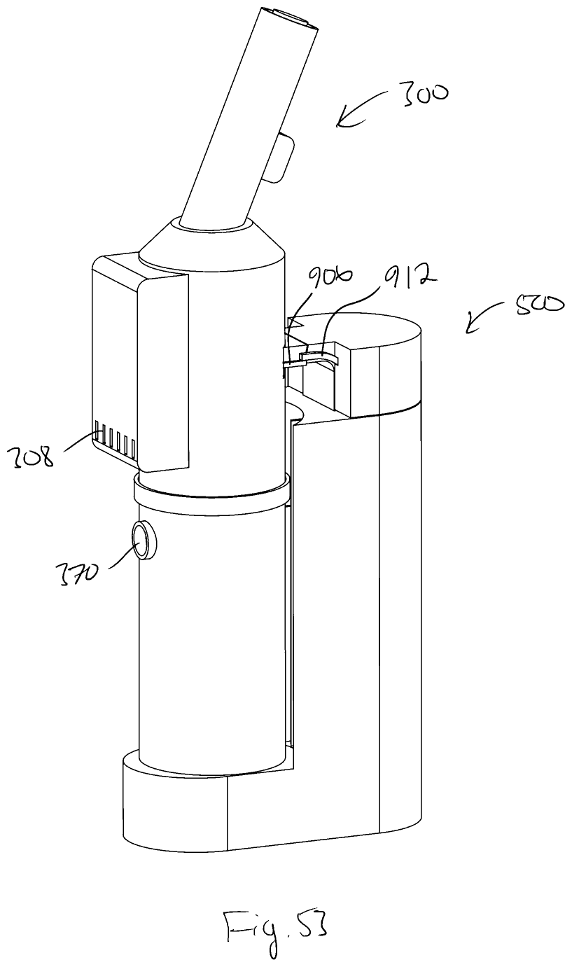

As exemplified in FIGS. 50-54, the suction motor 314 of the surface cleaning apparatus provides both a suction force and a pressure to push dirt from the dirt collection region 312 into the docking unit 500. As exemplified, the suction motor 314 is connected to the exhaust conduit 372 and the clean air outlet 514 of the docking unit 500 is connected to the inlet port 360. Accordingly, during the dirt emptying mode of operation, exhaust air from the suction motor 314 travels through the exhaust conduit 372 and into the evacuation air inlet port 370. The exhaust air provides a pressure that pushes the dirt from the dirt collection region 312 through the dirty air inlet 512. The air in the docking unit 500 is then sucked through the clean air outlet 514 and into the air inlet 360 into the suction motor 314. This suction force also facilitates the removal of dirt from the dirt collection region 312. Accordingly, there are two air flow connections between the surface cleaning unit 300 and the docking unit 500. In other words, the exhaust air from the suction motor 314 provides a pressure to push dirt through part or all of the air treatment chamber 340 into the docking unit while the suction motor 314 also draws air through part or all of the air treatment chamber 340 into the docking unit and then to the suction motor to also assist in emptying dirt from the air treatment chamber 340.As discussed previously, the ports 350 and 370 may be at any location.

It will be appreciated that the motor which is used to provide suction and exhaust air may be in the docking unit.

### Use of Dual Suction Motors

In accordance with this aspect, which may be used by itself or in combination with one or more other aspects, two or motors and fan assemblies may be used during a dirt emptying mode of operation. An advantage of this aspect is that a docking unit may have a smaller (lower air flow and/or lower suction level) motor as the motive force produced by the suction motor of the surface cleaning apparatus may be used concurrently or sequentially or periodically during the emptying mode of operation to supplement the air flow produced by the motor of the docking unit.

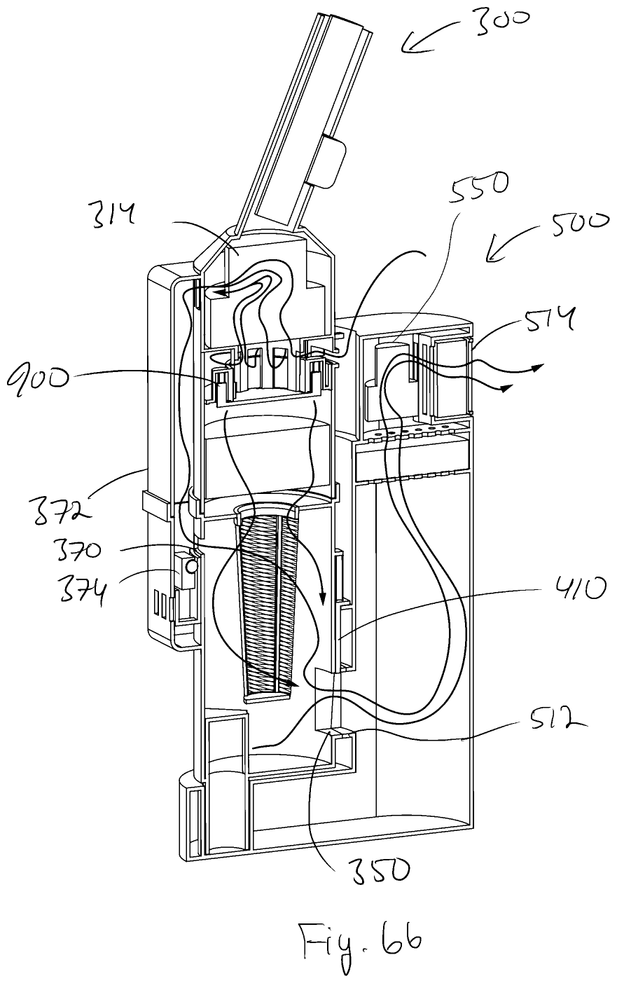

Accordingly, each of the surface cleaning apparatus 300 and the docking unit 500 may have a suction motor. As exemplified in FIG. 66, the surface cleaning apparatus 300 includes the suction motor 314 and the docking unit 500 includes the suction motor 550. Each of the suction motors 314 and 550 may operate concurrently or sequentially or periodically. For example, the suction motor 314 may provide a pressure (e.g., by providing exhaust air) to push the dirt from the dirt collection region 312 while the suction motor 550 may provide a suction to pull dirt from the dirt collection region 312. In some embodiments, they may each operate with a suction force.

It will be appreciated that one of the two motors may operate continuously during a dirt emptying mode of operation and the other may operate for only part of the dirt emptying mode of operation, e.g., periodically. Alternately, each may be operated continuously or each may be operated in alternating sequence (e.g., the docking unit motor is on while the surface cleaning apparatus motor is off and then the docking unit motor is off while the surface cleaning apparatus motor is on).

### Pre-Motor Filter Agitator

In accordance with this aspect, which may be used by itself or in combination with one or more other aspects, one or more agitators is positioned proximate a pre-motor filter such that the agitators may be used to remove debris from the pre-motor filter, before or during a dirt emptying mode of operation. An advantage of this design is that the cleaning of the pre-motor filter during a dirt emptying mode of operation, optionally a dirt emptying mode wherein air passes through the pre-motor filter housing and optionally through the pre-motor filter itself, may be enhanced.

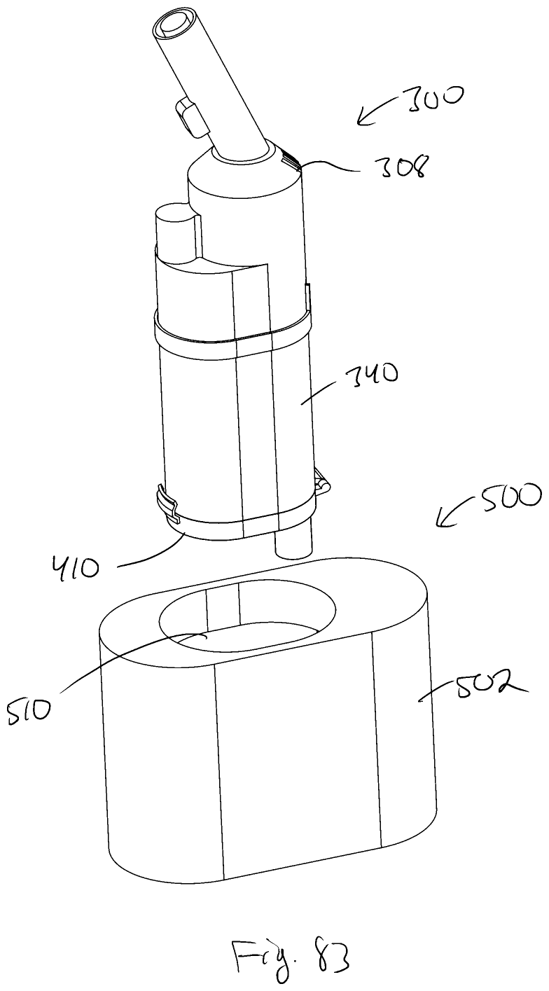

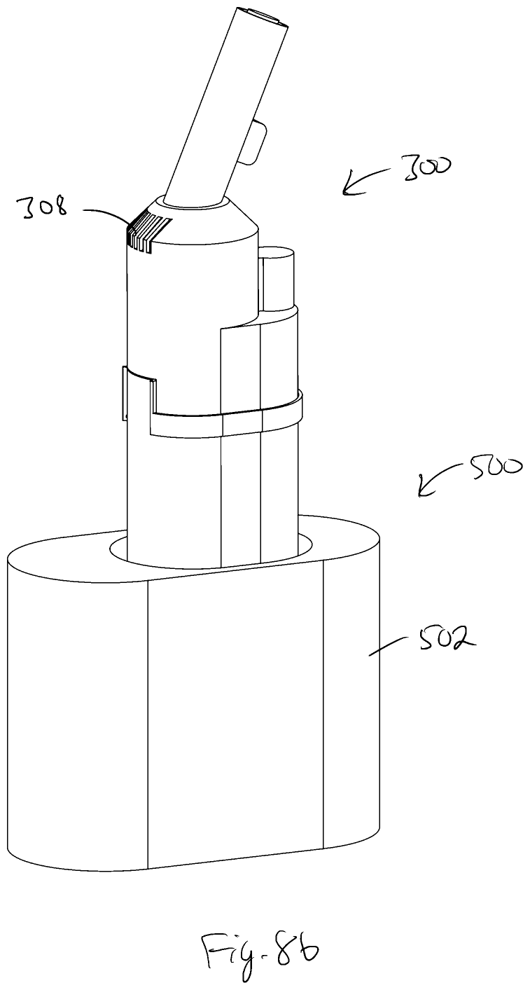

As exemplified in FIGS. 83-87, the pre-motor filter chamber 331 contains a plurality of agitators 328 that are each drivingly coupled to actuators 329. Optionally, there may be a single agitator 328.

The agitators 328 may be used to contact the pre-motor filter 330 such that dirt and/or debris is agitated and removed from the pre-motor filter 330. The agitators 328 may operate by vibrating and/or sliding against the pre-motor filter 330 to dislodge dirt that is on or in the pre-motor filter. Any agitator known in the vacuum cleaner arts may be used.

The agitation of the pre-motor filter 330 may occur prior to or during part or all of a dirt emptying mode of operation, such that dirt that is dislodged from the pre-motor filter 330 may be removed during the dirt emptying mode of operation.

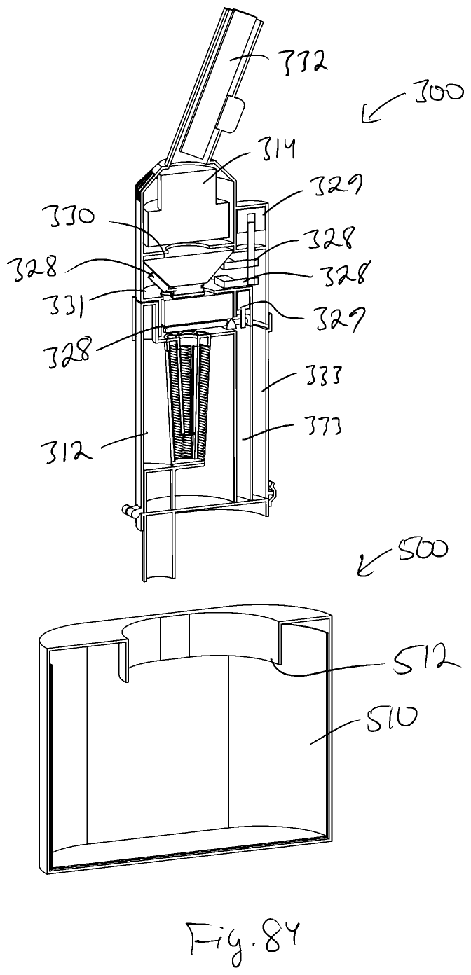

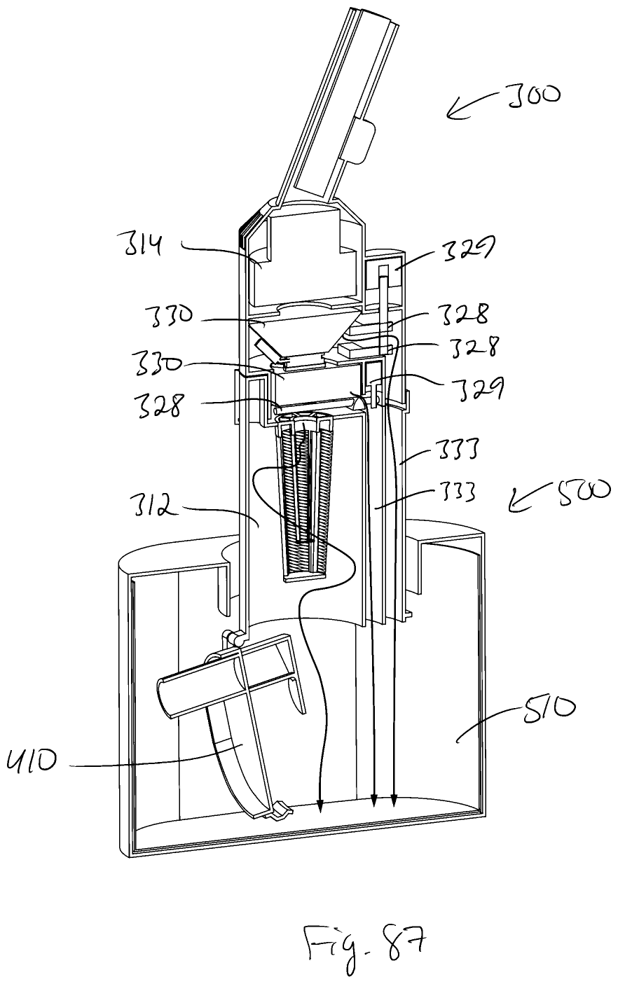

Optionally, as exemplified in FIG. 84, the surface cleaning apparatus 300 may include one or more pre-motor filter dirt collection regions 333 for receiving dirt dislodged by the agitators 328. The pre-motor filter dirt collection regions 333 may be emptyable concurrently or sequentially with the dirt collection region 312 during the dirt emptying mode of operation. For example, as exemplified in FIG. 87, the pre-motor filter dirt collection regions 333 are opened concurrently with the dirt collection region 312 by opening the front end of the surface cleaning apparatus 300 during the dirt emptying mode of operation.

### Multiple Dirt Collection Regions

In accordance with this aspect, which may be used by itself or in combination with one or more other aspects, there is provided a docking unit for emptying first and second dirt collection regions of a surface cleaning apparatus. The docking unit has a docking unit air flow path extending from an inlet port to an outlet port, with a docking unit dirt collection chamber in the air flow path. When the surface cleaning apparatus is docked at the docking unit, dirt is transferrable from the first dirt collection region into the docking unit dirt collection region prior to dirt being transferred from the second dirt collection region into the docking unit dirt collection chamber. The first and second dirt collection regions may collect dirt and/or debris of different sizes. An advantage is that by emptying the courser dirt and/or debris first, the larger debris may form a barrier in the docking unit dirt collection region that may reduce the likelihood of finer dirt passing through a bag or a filter media in the docking unit. In other words, the coarser material may improve the efficiency of a porous filter medium, which may be positioned within the dirt collection chamber of the docking unit.

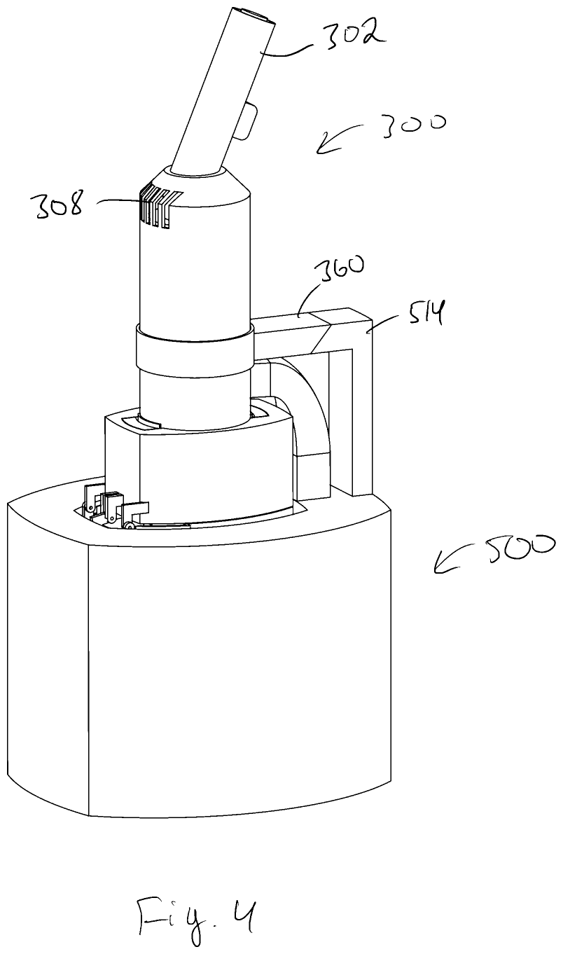

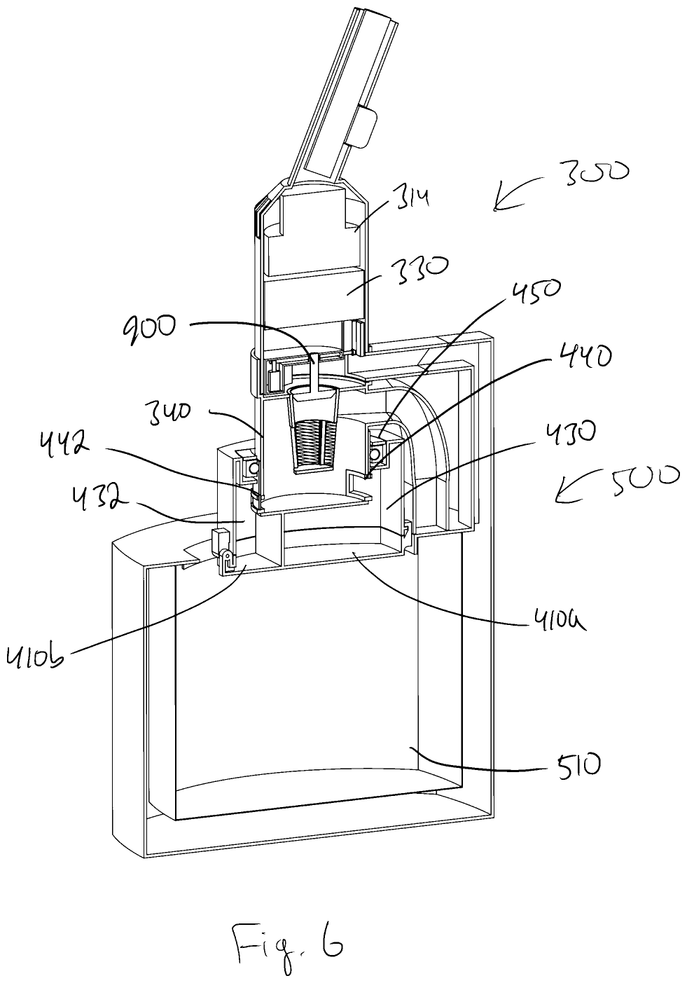

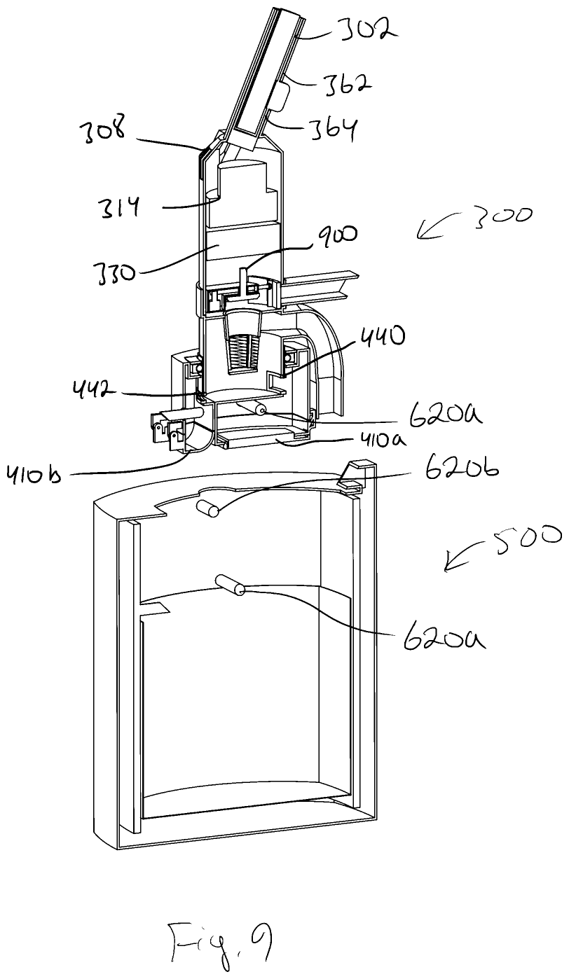

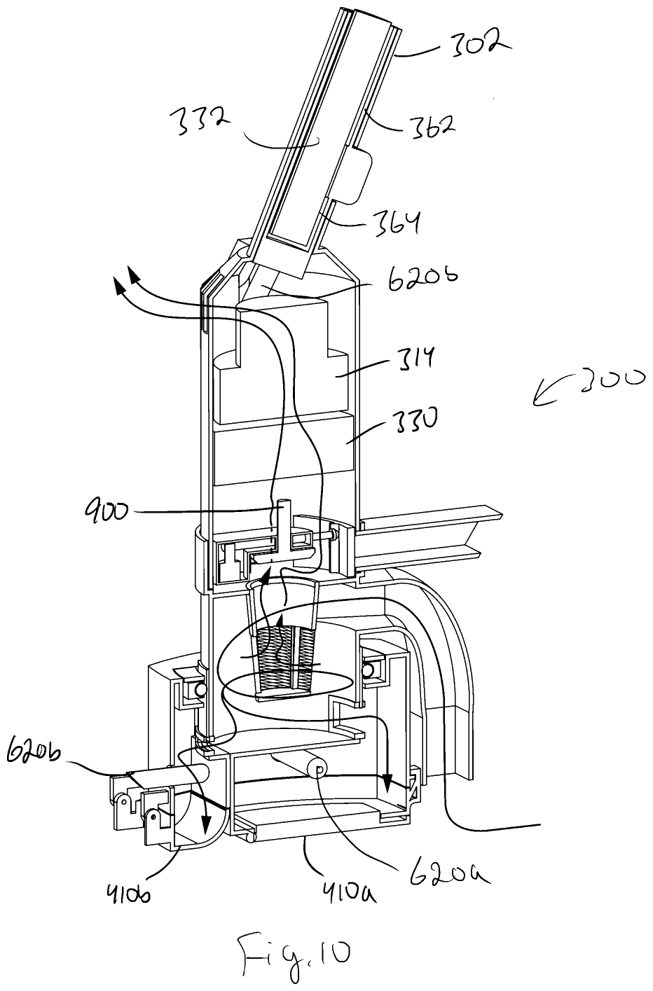

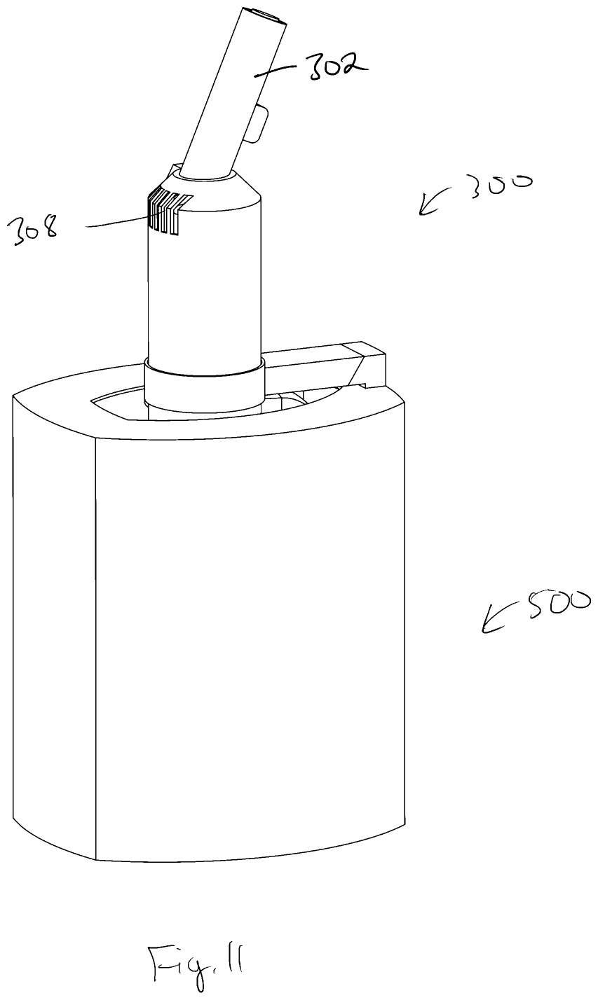

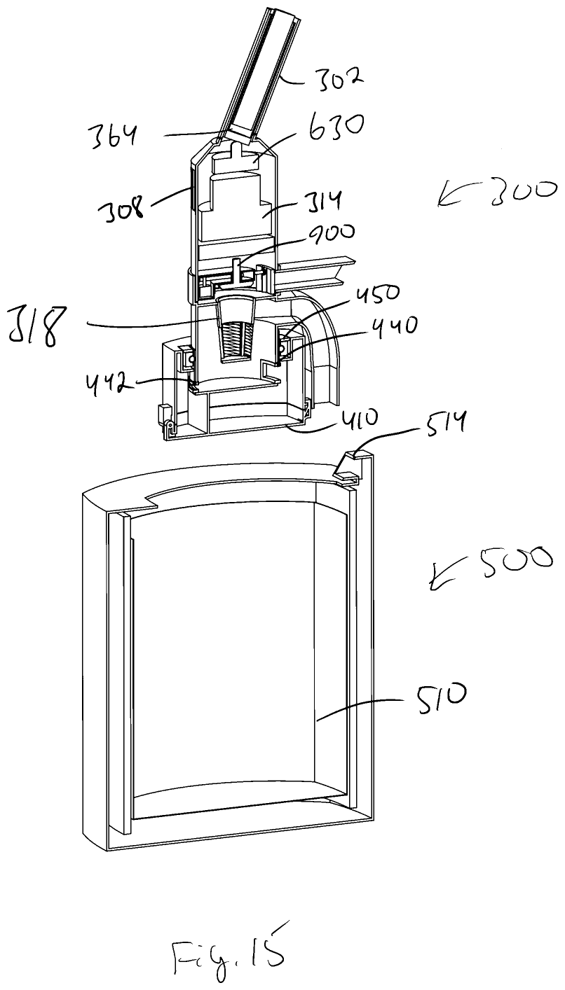

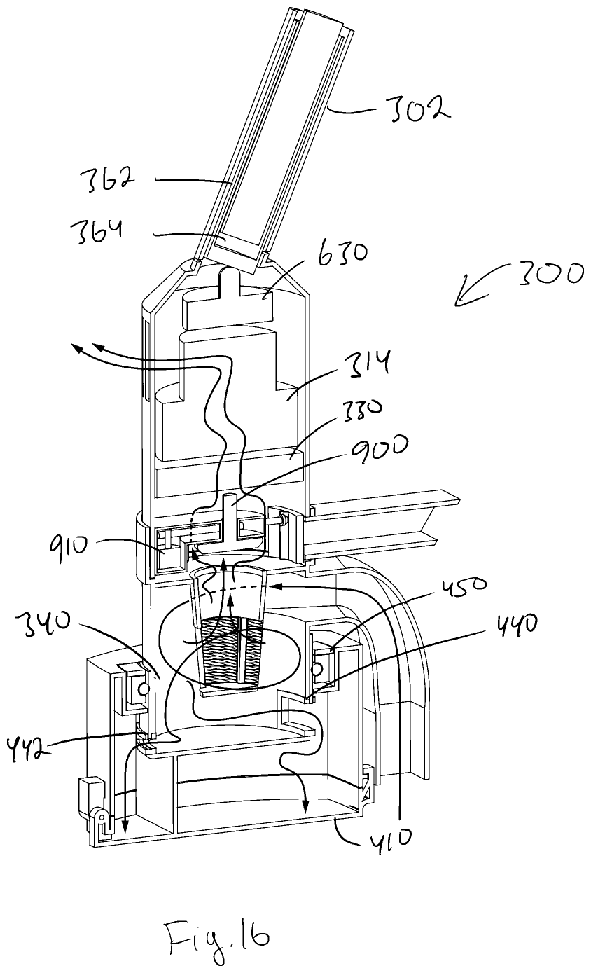

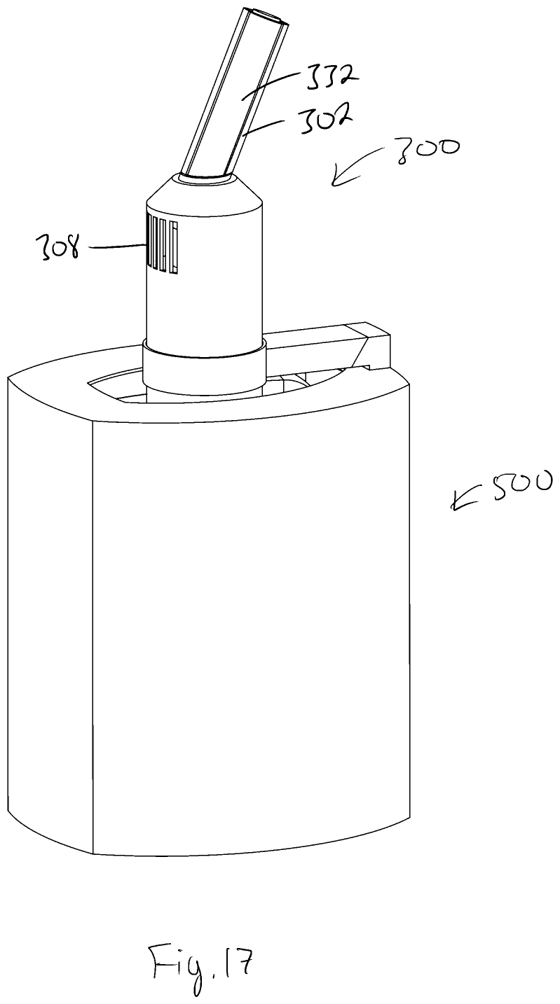

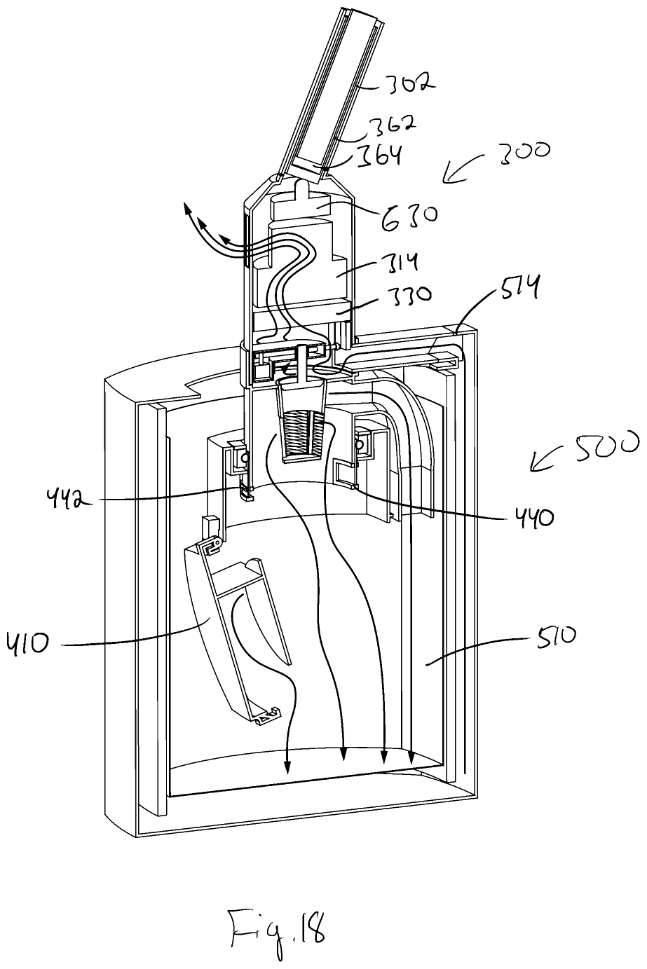

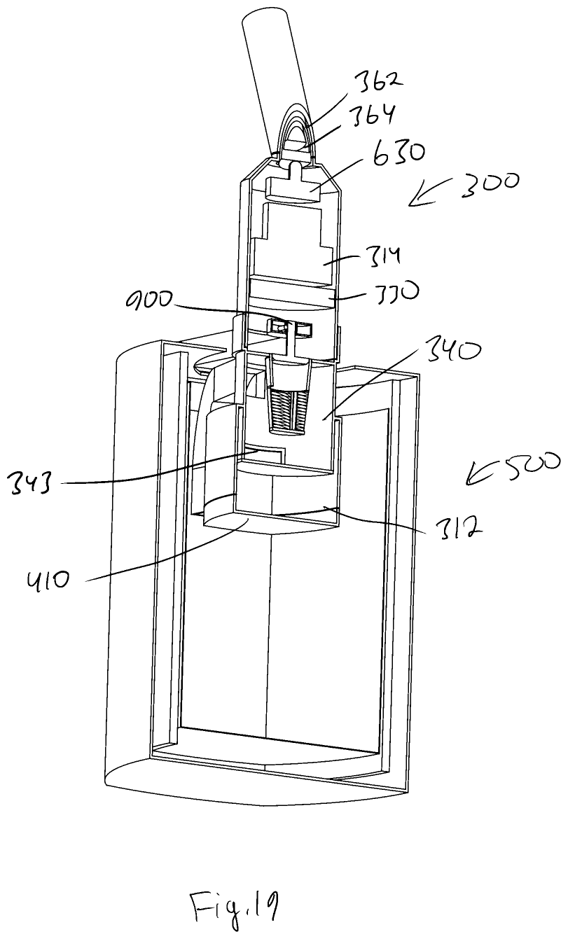

As exemplified in FIGS. 1-19 the surface cleaning apparatus 300 has the dirt collection region 312 that has two regions, a first dirt collection region 430 and a second dirt collection region 432. The docking unit 500 has a dirt collection region 510 positioned in the air flow path 516. As shown, a portion 434 of the surface cleaning apparatus 300 includes the first dirt collection region 430 and the second dirt collection region 432. The portion may be the air treatment member assembly.

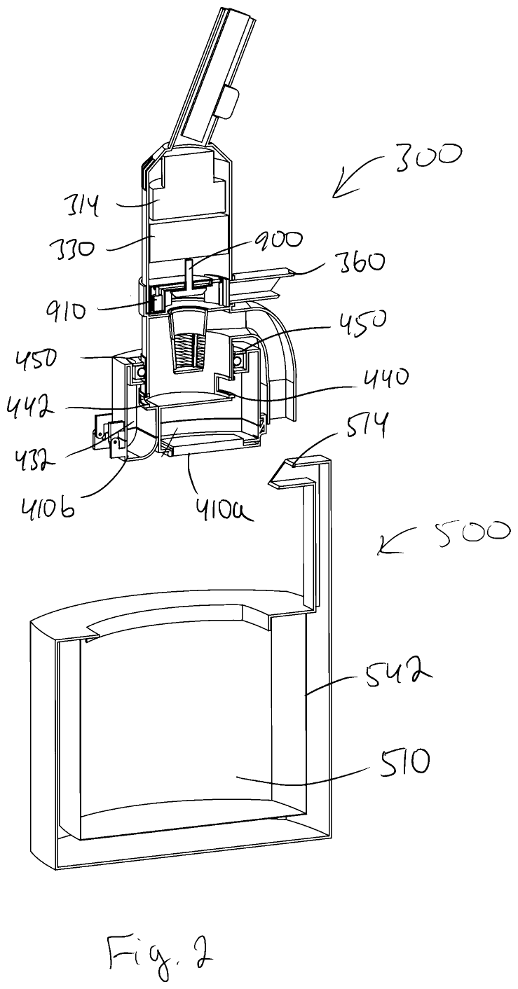

During the cleaning mode of operation, dirt may enter the air treatment chamber 340 through the dirty air inlet 304 and exit through either a first dirt outlet 440 or a second dirt outlet 442. The first dirt outlet 440 connects the air treatment chamber 340 in communication with the first dirt collection region 430 and the second dirt outlet 442 connects the air treatment chamber 340 in communication with the second dirt collection region 432. The first and second dirt outlets may be the same size or may be differently sized. For example, as exemplified in FIG. 2, the first dirt outlet 440 is larger than the second dirt outlet 442. Accordingly, larger dirt and/or debris may pass through the first dirt outlet 440 and finer debris may pass through the second dirt outlet 442, allowing for the second dirt collection region 432 to collect finer dirt than dirt collected in the first dirt collection region 430. Alternately, the different dirt outlets may be positioned such that larger debris will exit the connects the air treatment chamber 340 first dirt outlet 440 and smaller debris will exit through the second dirt outlet 442.

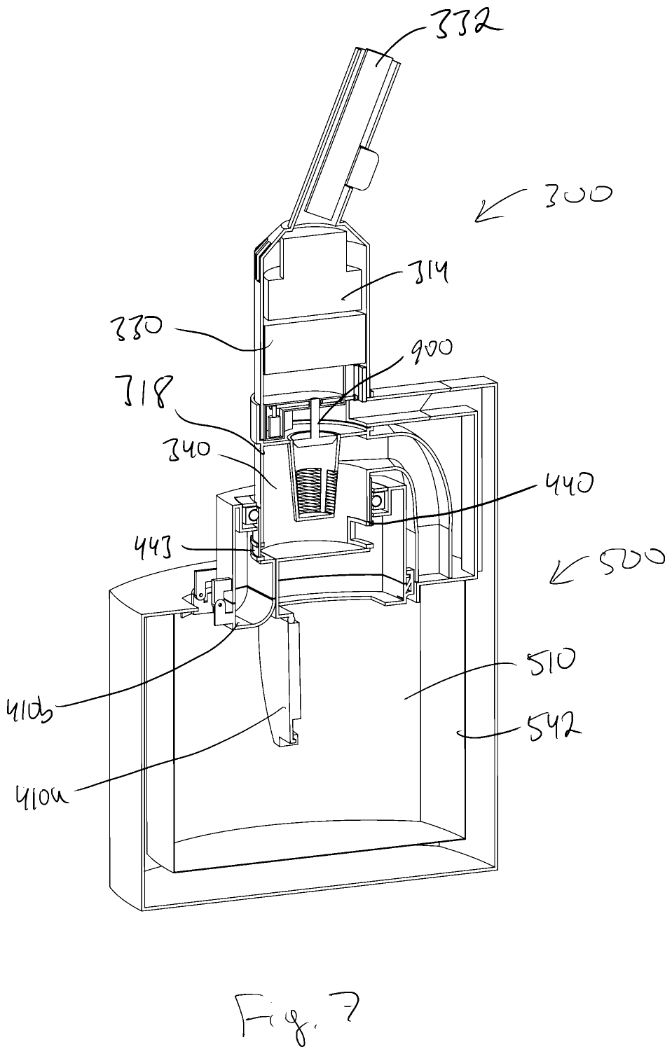

When the surface cleaning apparatus 300 is docked at the docking unit 500 and is in the dirt emptying mode of operation, dirt may be transferred from the first dirt collection region 430 into the docking unit dirt collection region 510 prior to dirt being transferred from the second dirt collection region 432 into the docking unit dirt collection region 510. For example, as shown in FIG. 7, the surface cleaning apparatus 300 is docked at the docking unit 500 with the portion 434 connected to the docking unit 500. The first dirt collection region 430 has a first openable door 410a and the second dirt collection region 432 has a second openable door 410b. Each openable door may allow for dirt to be emptied from the surface cleaning apparatus 300 during the dirt emptying mode of operation.

It will be appreciated that the first openable door 410a may be opened first and when the first dirt collection region 430 has had air flow therethrough for, e.g., a predetermined amount of time or a sensor detects that air exiting the first dirt collection region 430 has less than a certain amount of debris therein, the second openable door 410b may be opened and, optionally, when the second dirt collection region 432 has had air flow therethrough for, e.g., a predetermined amount of time or a sensor detects that air exiting the second dirt collection region 432 has less than a certain amount of debris therein, the evacuation process may be terminated. Alternately air flow through the first dirt collection region 430 may be terminated, e.g., by closing the first openable door 410a, when air flow commences through the second dirt collection region 432, e.g., by opening the second openable door 410b.

As discussed herein, any motor or motors may be used to produce the air flow for the emptying mode of operation. As shown in FIG. 7, the suction motor 314 may be used to draw air from the first dirt collection region 430 and the second dirt collection region 432 into the docking unit dirt collection region 510. Accordingly, the suction motor 314 may be in flow communication with the docking unit 500 at a location upstream of the suction motor 314 and downstream of the pre-motor filter 330.

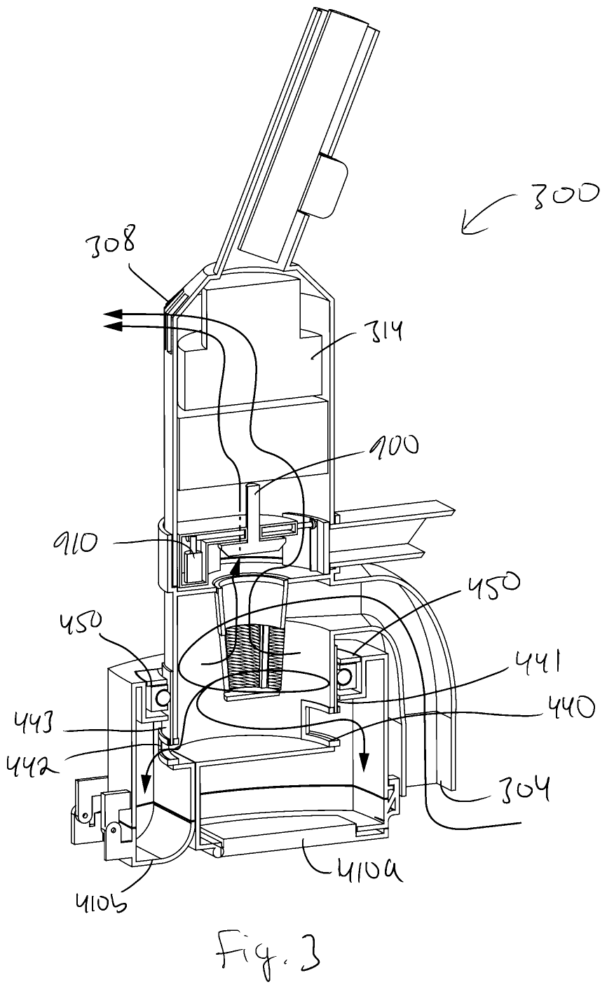

Optionally, the two dirt collection regions may be isolated from each other during the dirt emptying mode of operation so as to direct all of the air flow through the air treatment chamber and the dirt collection region which is open. As exemplified in FIGS. 3-7, a first valve 441 is operable to close the first dirt outlet 440 and a second valve 443 is operable to close the second dirt outlet 442. Each valve may be actuatable by an actuator 450 to move the valve between the open and closed positions. Accordingly, in the first dirt emptying mode of operation, the first openable door 410a may be opened and the first valve 441 may be opened by the actuator 450.

As described previously, the valve actuator 910 may also be used to actuate a downstream valve 900 to close the air flow path from the air treatment chamber 340 to the suction motor 314. As exemplified in FIGS. 3-7, the valve 900 is shaped like a plunger that closes the air flow path between the pre-motor filter 330 and the air treatment chamber 340.

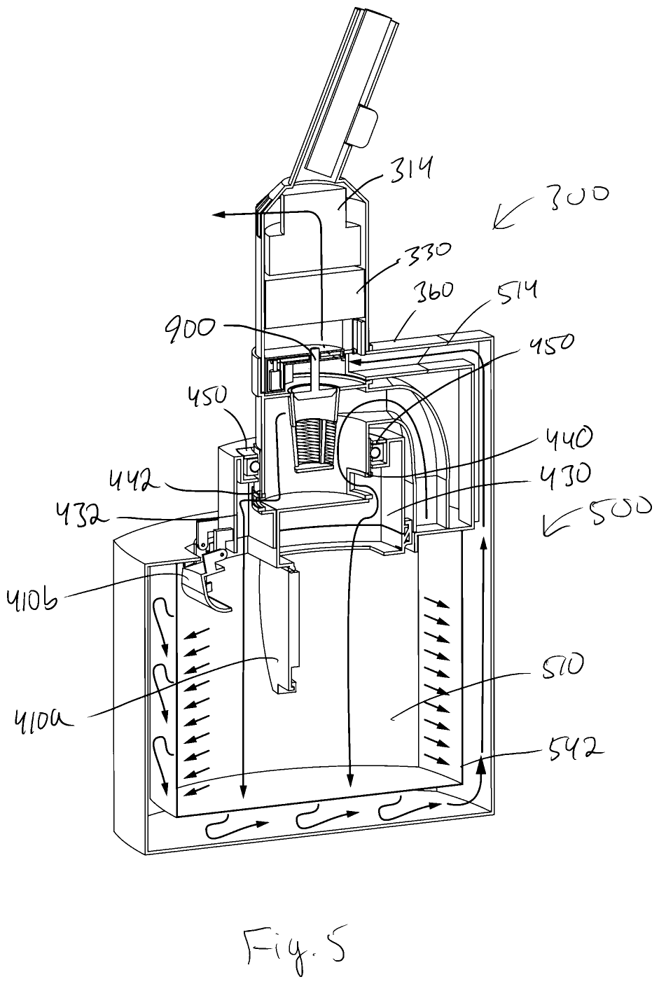

The suction motor 314 may be energized such that air is pulled through the air treatment chamber 340, through the first dirt outlet 440, through the first dirt collection region 430, and out the first openable door 410a into the dirt collection region 510 of the docking unit 500, thereby emptying the first dirt collection region 430 (see FIG. 5). Subsequently, the first valve 441 may be closed by the actuator 450 and the second valve 443 may be opened by the actuator 450. The second dirt emptying mode of operation may commence, with the suction motor 314 pulling air through the air treatment chamber 340, through the second dirt outlet 442, through the second dirt collection region 432, and out the second openable door 410b into the dirt collection region 510 of the docking unit 500, thereby emptying the second dirt collection region 432.

An advantage of this design is that the courser dirt collected in the first dirt collection region 430 may be used to form a barrier inside the dirt collection region 510 of the docking unit 500 to improve the capture of finer dirt once the second dirt collection region 432 is emptied. For example, as exemplified in FIG. 7, the docking unit 500 has a removable filter bag 542. When the first dirt collection region 430, containing coarser dirt, is emptied first, the coarser dirt may provide an additional barrier along the surface of the removable filter bag 542, thereby improving the retention of dirt within the docking unit 500.

It will be appreciated that, alternately, once the first dirt collection region is emptied or has air flow therethrough, e.g., for a predetermined amount of time, the second dirt collection region may be opened without closing the first dirt collection region. In still another alternate mode of operation, both or all dirt collection regions may be opened (emptied) concurrently.

The first dirt collection region 430 and the second dirt collection region 432 may be part of the same air treatment stage or may be in separate air treatment stages. As exemplified in FIG. 7, the first dirt collection region 430 and the second dirt collection region 432 are each part of the air treatment chamber 340. In some embodiments, the first dirt collection region 430 may be part of a first air treatment stage and the second dirt collection region 432 may be part of a downstream second air treatment stage. The first air treatment stage may have a first air treatment chamber and the second air treatment stage may have a second air treatment chamber. For example, the first air treatment stage may include a first cyclone chamber and the second air treatment stage may include a second cyclone chamber. In some embodiments, the surface cleaning apparatus 300 may have a plurality of air treatment stages and the first dirt collection region 430 and the second dirt collection region 432 may each be in communication with the first air treatment stage, such as a first cyclone chamber.

### Separator Plate

In accordance with this aspect, which may be used by itself or in combination with one or more other a plate is provided at the first (dirt outlet) end of an air treatment chamber and provides a wall between a dirt collection region and an air treatment chamber. The plate has a first portion and a second portion that is moveable with respect to the first portion. An advantage of this design is that a portion of the plate may be movable concurrently or sequentially with a wall of the air treatment assembly for emptying the dirt collection region and the air treatment chamber. By emptying both the dirt collection region and the air treatment chamber, more dirt may be removed from the surface cleaning apparatus, thereby improving the efficiency.

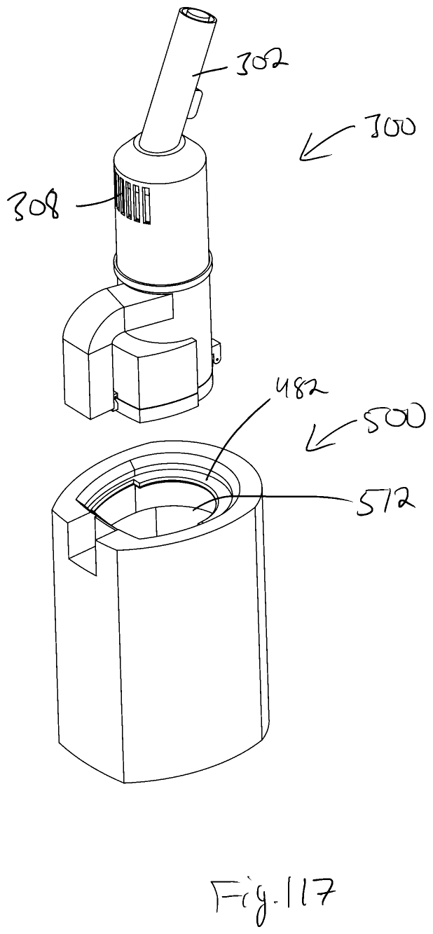

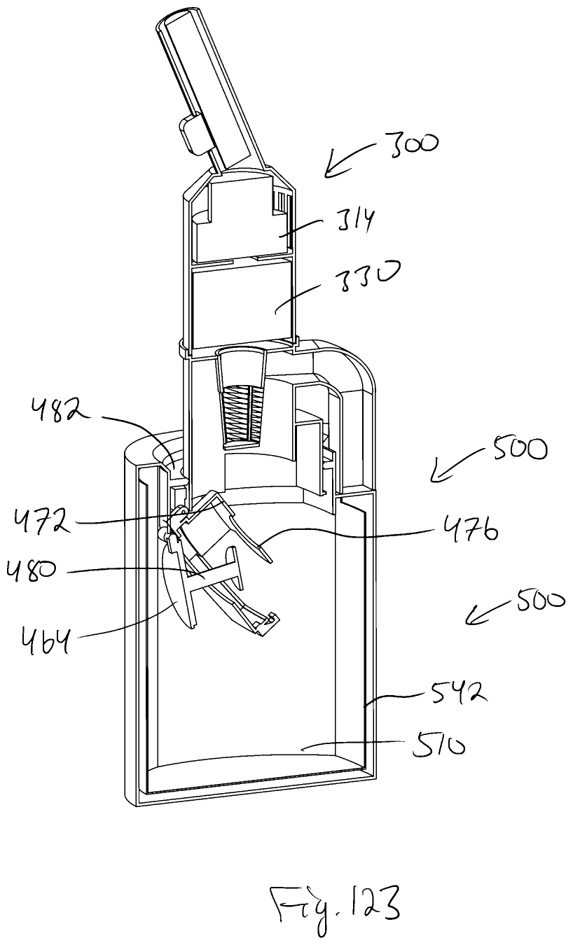

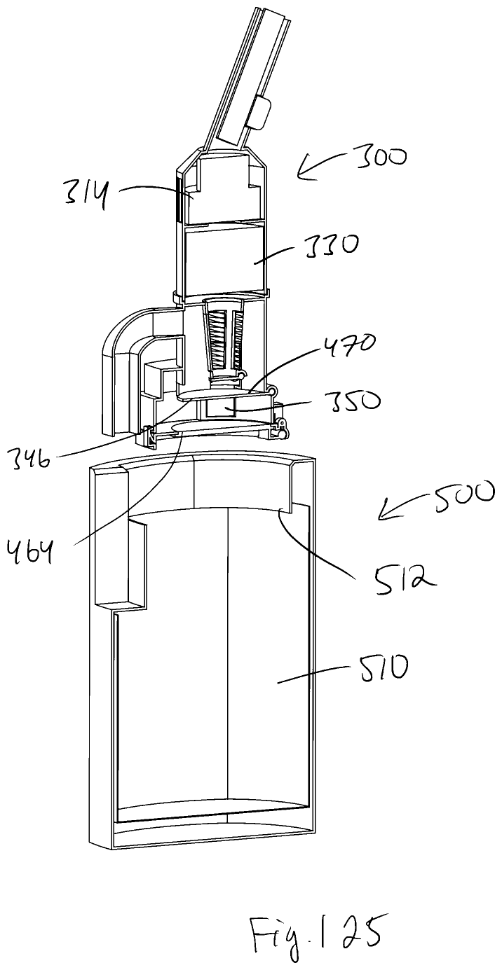

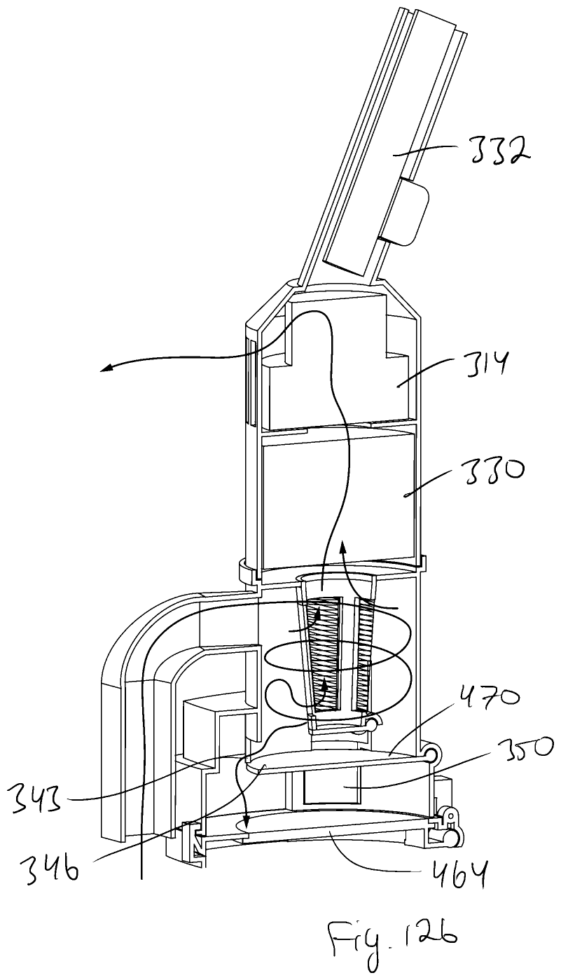

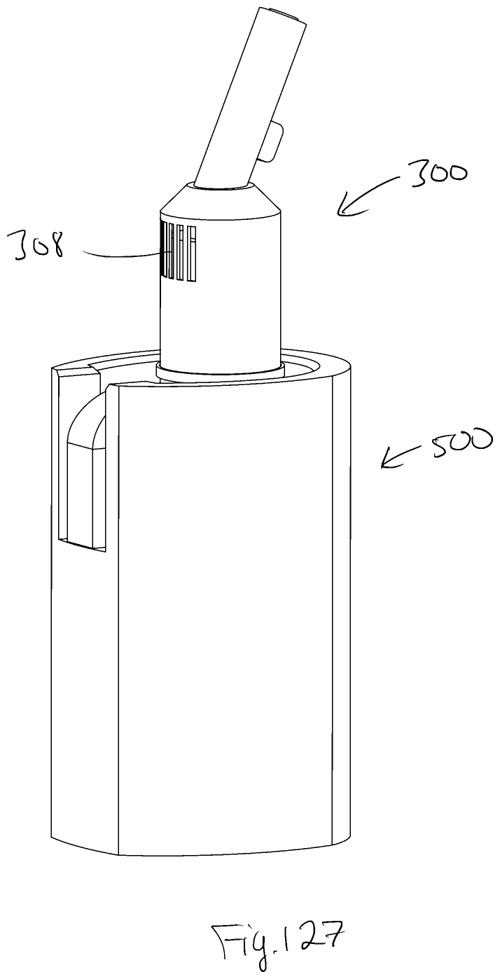

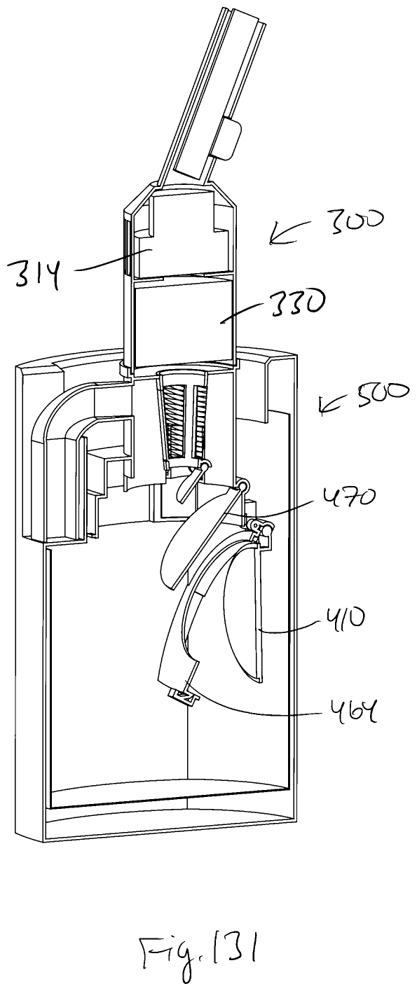

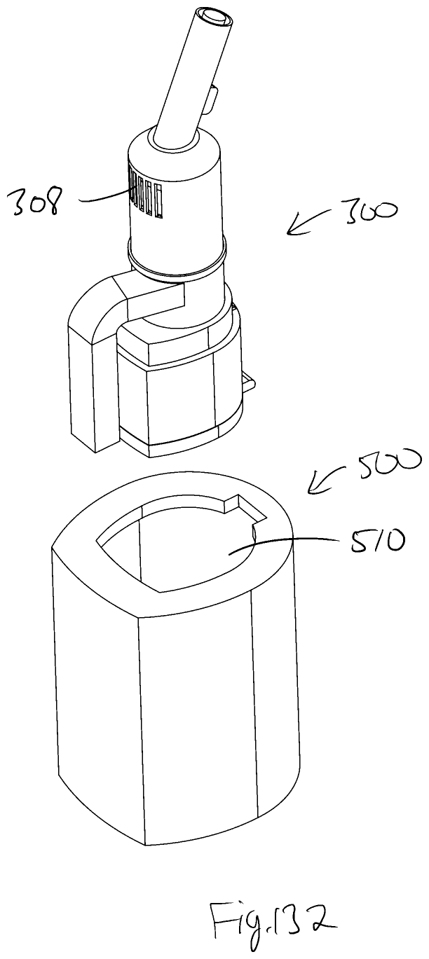

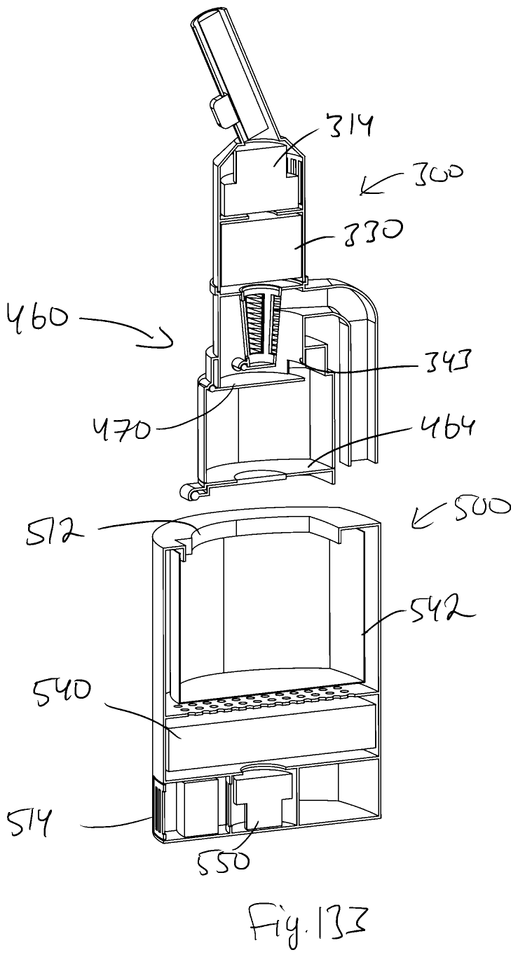

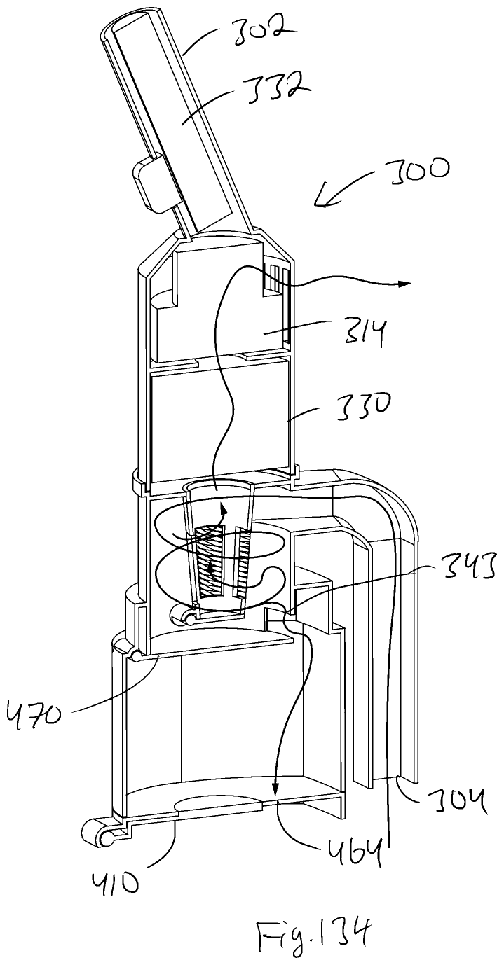

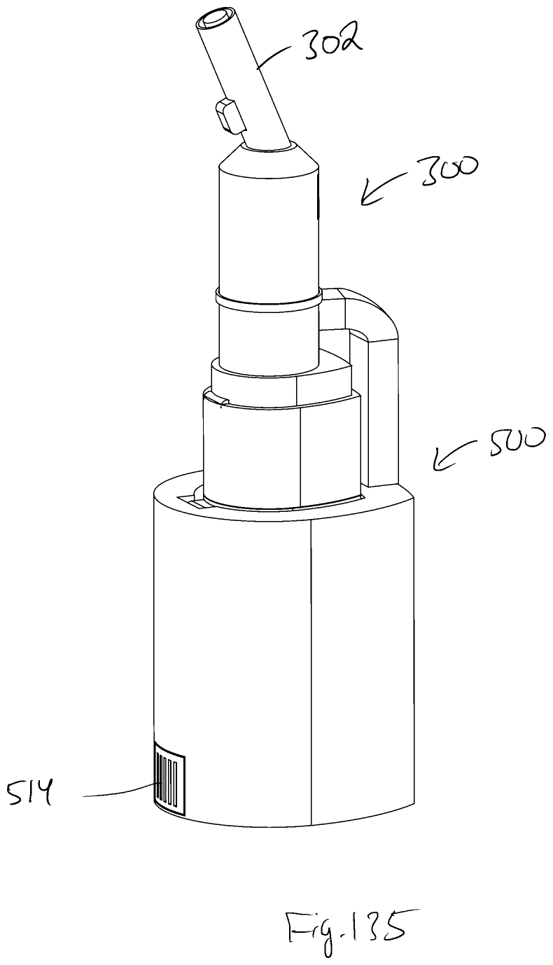

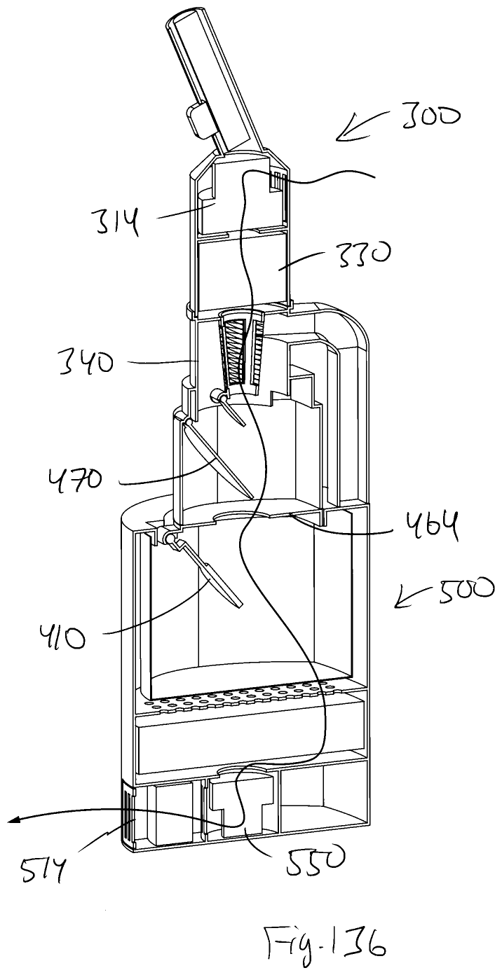

As exemplified in FIGS. 117-136, an air treatment assembly 460 includes an air treatment chamber 340 and a dirt collection chamber 312 that is external of the air treatment chamber 340. The air treatment assembly 460 has a first end 462 with a first end wall 464 and the second end 466 with a second end wall 468 with a longitudinal axis 461 that extends between the first end and the second end walls.

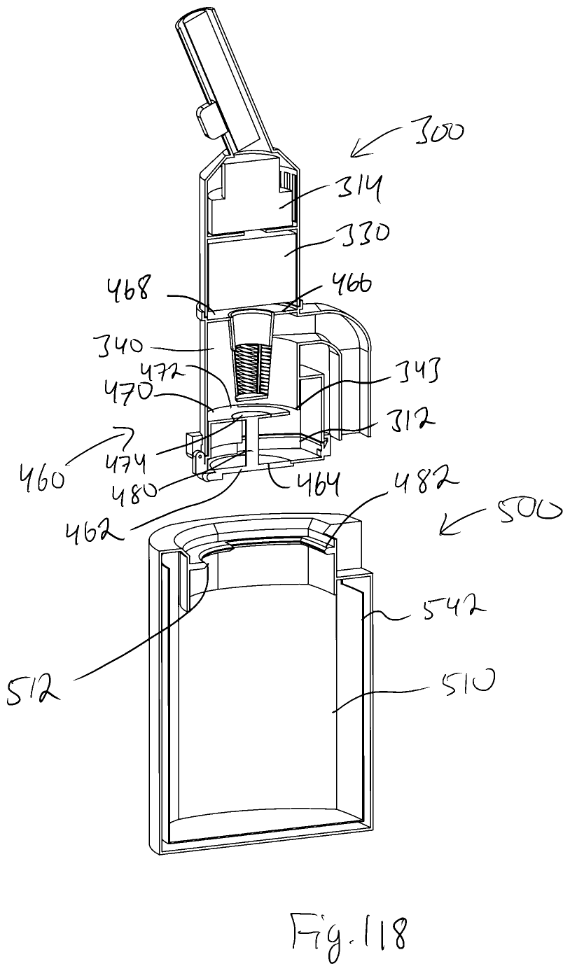

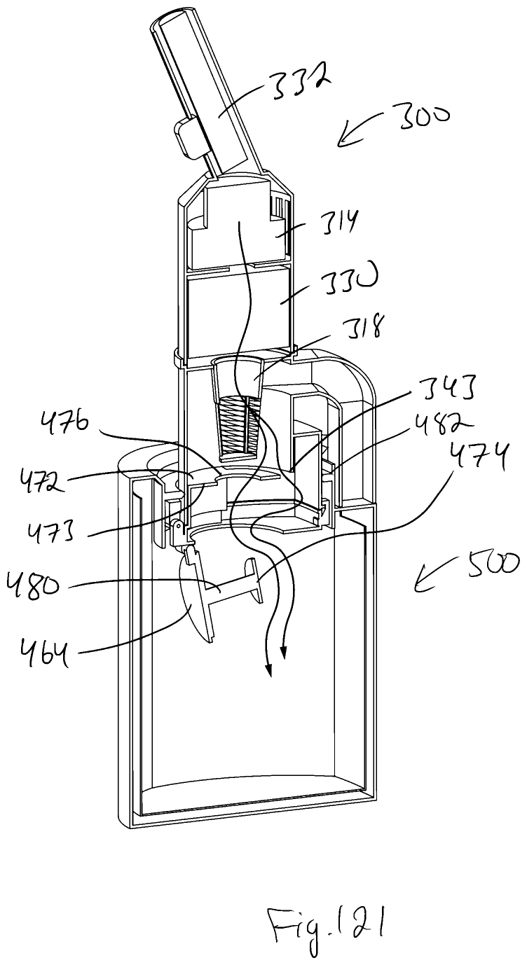

As exemplified in FIG. 118, the surface cleaning apparatus 300 has a plate 470 that is provided at the first end 346 of the air treatment chamber 340. As shown, the plate 470 is spaced from and faces the first end wall 464 of the air treatment assembly 460 with at least a portion of the dirt collection chamber 312 positioned between the first end wall 464 and the plate 470. As exemplified in FIG. 121, the first end 462 of the air treatment assembly 460 may be openable. For example, the first end 462 may be openable during the dirt emptying mode of operation to empty dirt from the dirt collection region 312 into the docking unit 500.

Referring to FIG. 118, as exemplified, the air treatment chamber 340 has a dirt outlet 343 in communication with the dirt collection chamber 312. The dirt outlet 343 may be an opening in a sidewall 341 of the air treatment chamber 340 at a location of the plate and/or, as exemplified in FIG. 118, the dirt outlet 343 may be a gap between the plate 470 and the sidewall 341 of the air treatment chamber 340. The gap may extend part way or all the way around a perimeter of the plate.

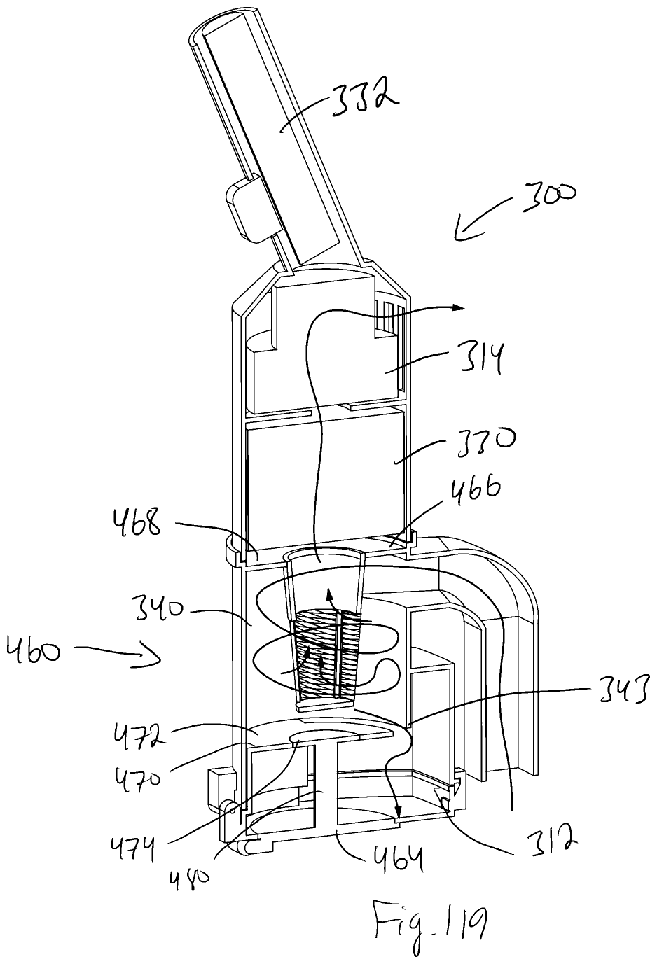

As exemplified, the plate 470 may have a plurality of portions. As exemplified in FIG. 118-121, the plate 470 has a first portion 472 and a second portion 474 that is moveable with respect to the first portion 472. For example, the second portion 474 may be openable while the first portion 472 is stationary. The first portion 472 may have an open portion 476 that forms an interior opening in the first portion 472. As exemplified in FIGS. 119 and 121, the second portion 474 closes the open portion 476 when the second portion 474 is in a closed position. When the second portion 474 is in the closed position, the first and second portions may define a generally continuous planar surface. As exemplified in FIG. 119, the planar surface may form the first end wall of the air treatment chamber 340.

Alternately, the first and second portions may be offset from one another. For example, the first portion 472 may have a dirt chamber face 473 and the second portion 474 may abut the dirt chamber face 473 when the second portion 474 is in the closed position, thereby closing the open portion 476.

It will be appreciated that the second portion 474 may be any part of the plate and need not be a centrally located portion. The second portion 474 may provide a smaller opening in the end face of an air treatment chamber than opening the entire plate to provide a higher air flow velocity at that end during part or all of an evacuation process. Accordingly, the second portion 474 may form part of the perimeter of the plate and/or it may have a perimeter of any shape.

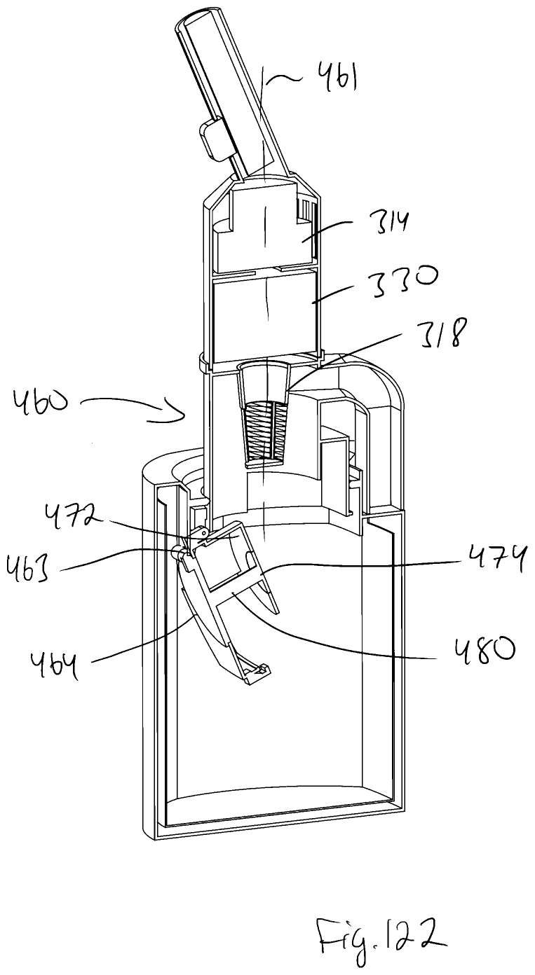

As exemplified in FIGS. 121-122, the second portion 474 of the plate 470 may be openable when the first end 462 of the air treatment assembly 460 is opened. The second portion 474 may be concurrently openable with the first end 462 of the air treatment assembly 460. For example, as shown, the second portion 474 may be coupled to the first end wall 464 by a mount 480 such that opening the first end wall 464, the second portion 474 is moved, thereby opening the open portion 476. By opening the second portion 474 of the plate 470 with the first end 462 of the air treatment assembly 460, dirt may be emptied from multiple regions in the surface cleaning apparatus 300, thereby improving the efficiency of the emptying process. In other words, the air treatment chamber 340 and the dirt collection region 312 may be opened concurrently for emptying and/or cleaning. In some embodiments, the second portion 474 may be opened sequentially with the first end 462 of the air treatment assembly 460. Providing a smaller opening of the air treatment chamber 340, by opening only the second portion 474, produces a higher air flow velocity through the first end of the air treatment chamber and may assist in emptying debris from the air treatment chamber 340.

In some embodiments, the first portion 472 of the plate may also be openable. For example, as exemplified in FIG. 122, both of the first portion 472 and the second portion 474 may be sequentially openable during the evacuation process. Accordingly, the first portion 472 may open after the second portion 474 has been opened for part of an evacuation process.

The second portion 474 may be supported by any member what will enable the second portion 474 to open. For example, the second portion 474 may itself be pivotally mounted, e.g., to a sidewall of the air treatment chamber 340. Accordingly, it may be supported by a mount 480 that extends inwardly from the openable end wall 464 of the air treatment assembly. Accordingly, when the end wall opens, the mount 480 is moved outwardly and the second portion 474 may pivot downwardly. In such a case, each of end wall 464 and the second portion 474 may be pivotally mounted to the air treatment assembly. Alternately, the plate may be mounted to the mount 480 such that it moves with mount 480 when the end wall 464 is opened (see, e.g., FIG. 121).

It will be appreciated that end wall 464 may be the entire end face of the air treatment assembly (i.e., it may underlie all of the dirt collection chamber.

The mount 480 may be positioned radially inwardly, in a direction transverse to the longitudinal axis 461, from a mount for the first end 462 of the air treatment assembly 460. For example, as shown in FIG. 122, the first end wall 464 of the air treatment assembly 460 is pivotably mounted by a mount 463 to the surface cleaning apparatus 300 and the mount 480 is positioned radially inwardly of the mount 463.

The second portion 474 may have a larger or smaller cross-sectional area than the first end 462 of the air treatment assembly. For example, as exemplified in FIGS. 121-122, the first end 462 of the air treatment assembly 460 has a larger cross-sectional area in a plane transverse to the longitudinal axis 461 than a cross-sectional area of the second portion 474 in the plane transverse to the longitudinal axis. As exemplified, this difference in cross-sectional areas may allow for a larger surface area for the dirt collection region 312 than the air treatment chamber 340, thereby providing more volume for containing disentrained dirt.

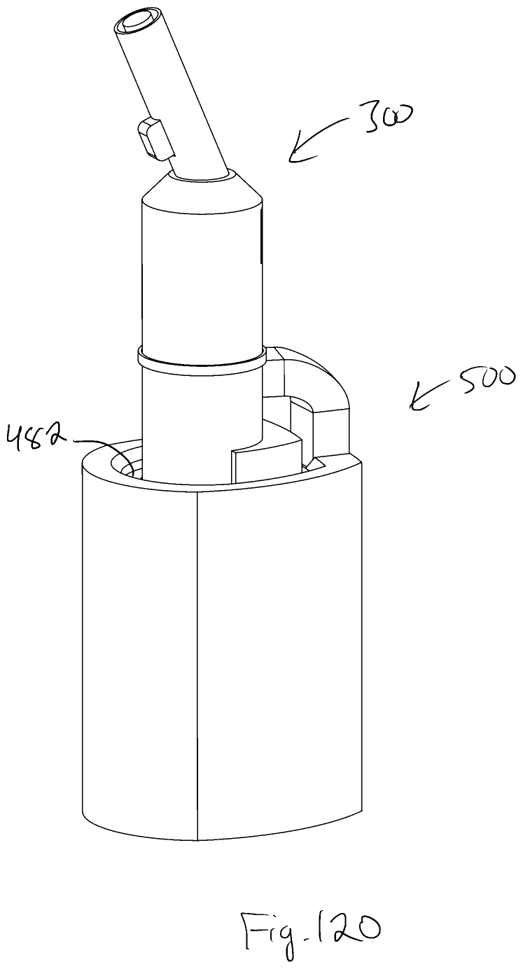

As exemplified in FIG. 120, the surface cleaning apparatus 300 may dock at the docking unit 500. As shown, the dirt inlet 512 of the docking unit 500 may form a docking port for the surface cleaning apparatus 300 such that during the dirt emptying mode of operation, dirt may exit the surface cleaning apparatus 300 and be contained in the docking unit 500. The first end 462 of the air treatment assembly 460 may interface with the docking port 512 when the air treatment assembly 460 is docked at the docking unit 500. The interfacing portion of the surface cleaning apparatus 300 may vary depending on the design of the surface cleaning apparatus 300 and docking unit 500.

The openable end of the air treatment assembly may be positionable interior of the docking unit such that, when the air treatment assembly is opened, both the openable wall of the air treatment assembly and the plate are positioned interior of the docking unit. Optionally, the openable end of the air treatment assembly is positioned interior the dirt collection region of the docking unit.

Accordingly, at least one of the surface cleaning apparatus 300 and the docking unit 500 may have a flexible sealing member 482, which may be used in any embodiment discussed herein. The flexible sealing member 482 may be used to facilitate the interfacing between the surface cleaning apparatus 300 and the docking unit 500 to reduce the likelihood of dirt and/or allergens from being exposed to the user during an evacuation process. As exemplified in FIG. 121, the flexible sealing member 482 may have a diameter in a plane transverse to the longitudinal axis 461 that is greater than a diameter of the first end wall 464 in the same plane such that when the air treatment assembly 460 is docked at the docking unit 500, the first end wall 464 is positioned inwardly of the flexible sealing member 482. As exemplified in FIG. 121, the sealing member 482 may be positioned on the docking unit 500.

In some embodiments, there may be a plurality of flexible sealing members. For example, the docking unit 500 may have a first flexible sealing member and the first end 464 of the air treatment assembly 460 may have a second flexible sealing member. The first and second flexible sealing members may inter-engage with one another to improve the seal between the surface cleaning apparatus 300 and the docking unit 500. For example, the sealing members may have male and female inter-engageable components.

### Concurrently Opening a Dirt Collection Chamber and an Air Treatment Chamber That are Separated by an Openable Plate

In accordance with this aspect, which may be used by itself or in combination with one or more other aspects, a plate is provided at the first (dirt outlet) end of an air treatment chamber and provides a wall between a dirt collection region and an air treatment chamber. The plate is moveably mounted such that the dirt collection region and the air treatment chamber may each be emptied and, optionally, concurrently opened.

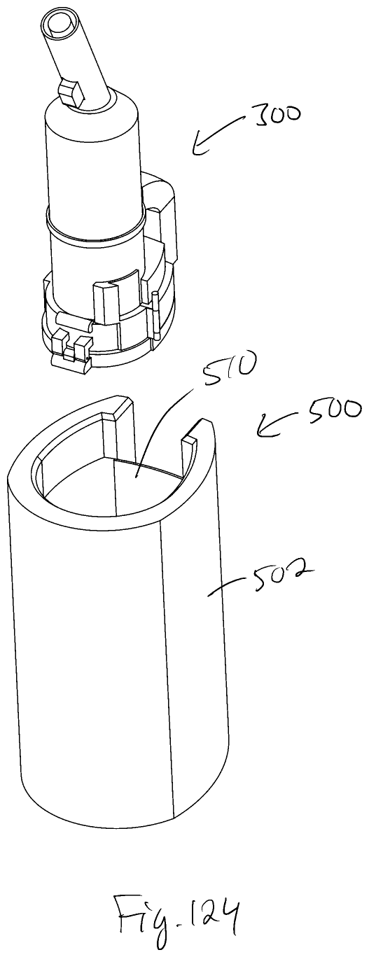

According to this aspect, the air treatment chamber 340 and the dirt collection chamber 312 may each be openable such that they are each in communication with the dirt collection region 510 of the docking unit 500. As exemplified in FIGS. 124-136, the plate 470 may be moveable between an open position and a closed position.

The plate may be a single piece (e.g., an integrally molded member) or it may have two portions 472,474 that are concurrently openable.

As discussed previously with respect to the second portion 474, the plate 470 may be pivotally coupled to the sidewall of the air treatment assembly 460, e.g. the sidewall of the air treatment chamber 340. Alternately, it may be supported by a mount or affixed to a mount 480.

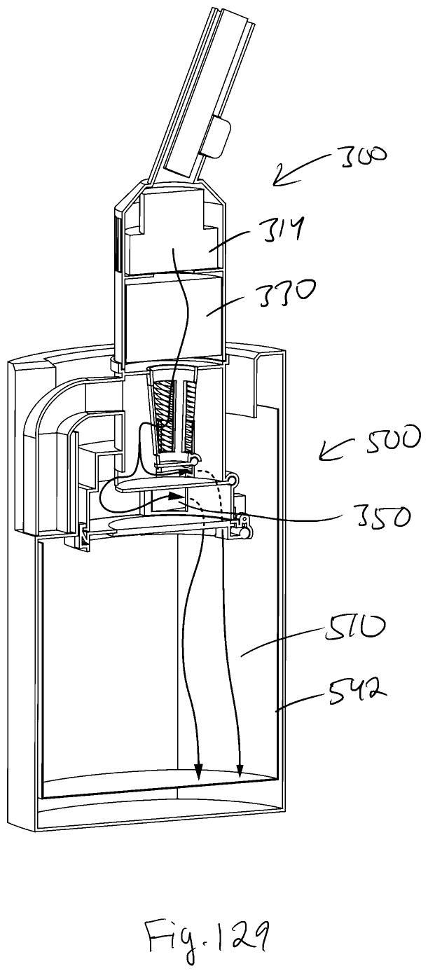

As shown in FIG. 129, when the plate 470 is in the open position, the first end 346 is opened. Accordingly, when the surface cleaning apparatus 300 is docked at the docking unit 500 and the plate 470 is in the open position, dirt may pass into the docking unit 500 from each of the air treatment chamber 340 and the dirt collection chamber 312 due to gravity.

As exemplified in FIG. 129, when the surface cleaning apparatus 300 is docked at the docking unit 500, the first end 462 of the air treatment assembly 460 may be positioned within the docking unit 500 as discussed previously. As shown, when the plate 470 is in the open position and the surface cleaning apparatus 300 is docked at the docking unit 500, at least a portion of the plate 470, and optionally all of the plate, may be positioned within the docking unit 500.

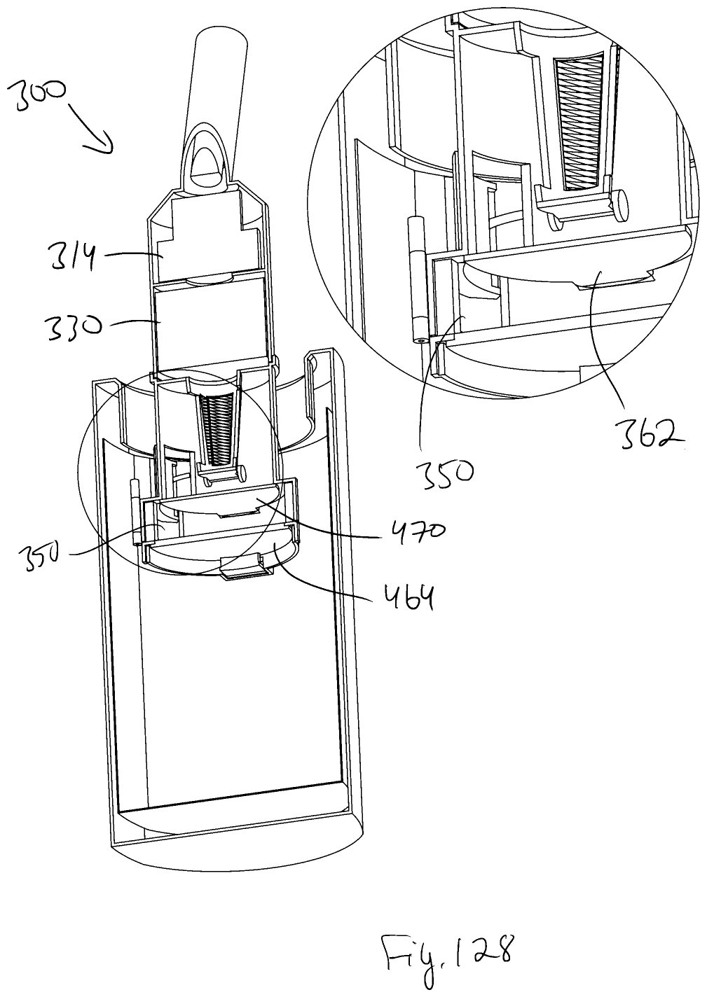

Optionally, a portion of the sidewall of the air treatment assembly 460, extending between the first end 462 and the second end 466, may be moveable such that each of the air treatment chamber 340 and the dirt collection chamber 312 are opened. For example, an openable door 410 as exemplified in FIG. 77 may be used in the embodiment of 129. Accordingly, the air treatment assembly may be positioned in the docking unit such that openable door 410 of FIG. 77 may pivot or translate open thereby opening both the air treatment chamber 340 and the dirt collection region between the plate and the end wall 464. It will be appreciated that, in such an embodiment, the plate need not be moveable. Alternately, the portion of the sidewall may be an evacuation port 350. A first plane that is transverse to the longitudinal axis 461 may extend through the at least a portion of the dirt collection chamber 312 and the portion of the sidewall and a second plane that is transverse to the longitudinal axis may extends through the air treatment chamber 340 and the portion of the sidewall. In other words, the evacuation port 350 may be large enough to open each of the dirt collection region 312 and the air treatment chamber 340, as exemplified in FIG. 128.

In some embodiments, the longitudinal axis 461 may extend horizontally when the air treatment assembly 460 is docked with the docking unit 500. This configuration may allow dirt to pass through the evacuation port 350 due to gravity when the surface cleaning apparatus 300 is positioned in the docking unit 500 horizontally.

Air Treatment Assembly with Openable Air Inlet and Dirt Evacuation Ports

In accordance with this aspect, which may be used by itself or in combination with one or more other aspects, an air treatment assembly, e.g., an air treatment chamber, of a surface cleaning apparatus has an evacuation air inlet port and a dirt evacuation port which are each opened during a dirt emptying mode of operation. When the surface cleaning apparatus is docked at a docking unit and is in a dirt emptying mode of operation, the openable door of the evacuation air inlet port is opened and the dirt evacuation port is opened and in flow communication with a dirt collection region of the docking unit such that air enters through the evacuation air inlet port and exits through the dirt evacuation port, thereby emptying the air treatment chamber of the surface cleaning apparatus. An advantage of this design is that an alternate air flow path is established that may facilitate a more efficient emptying of the air treatment chamber.

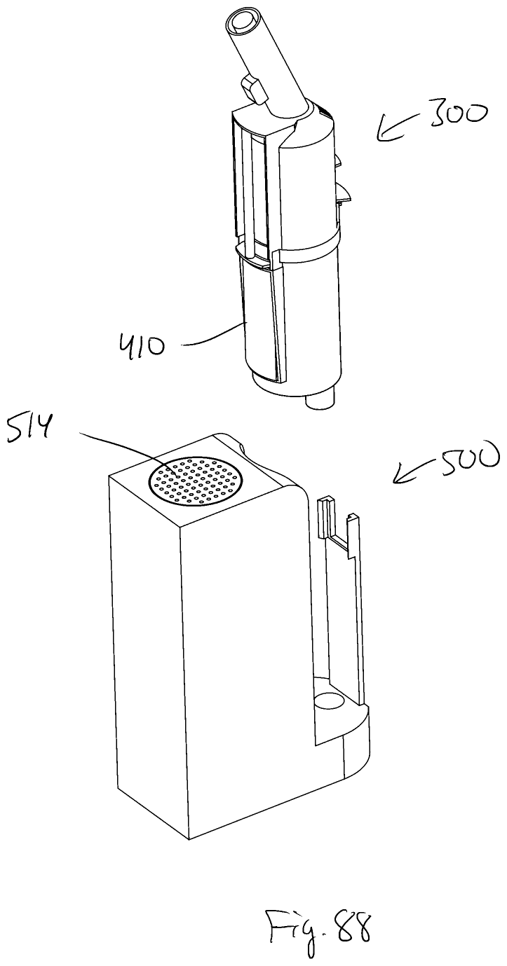

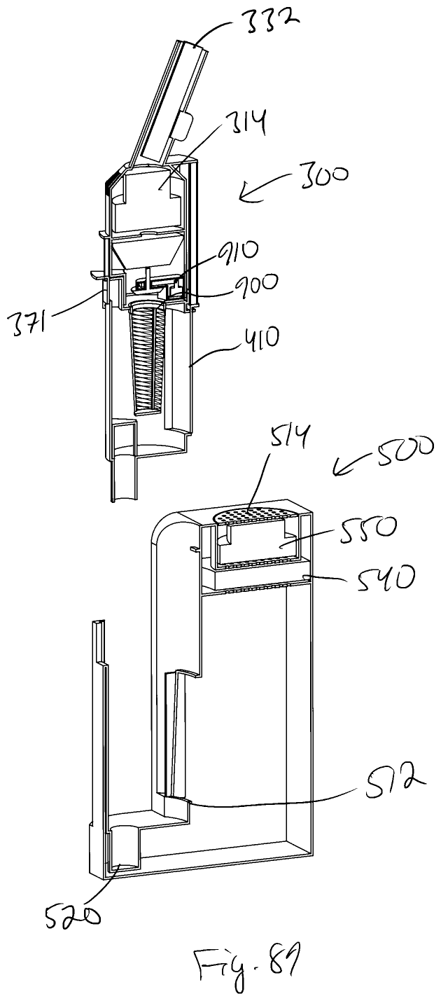

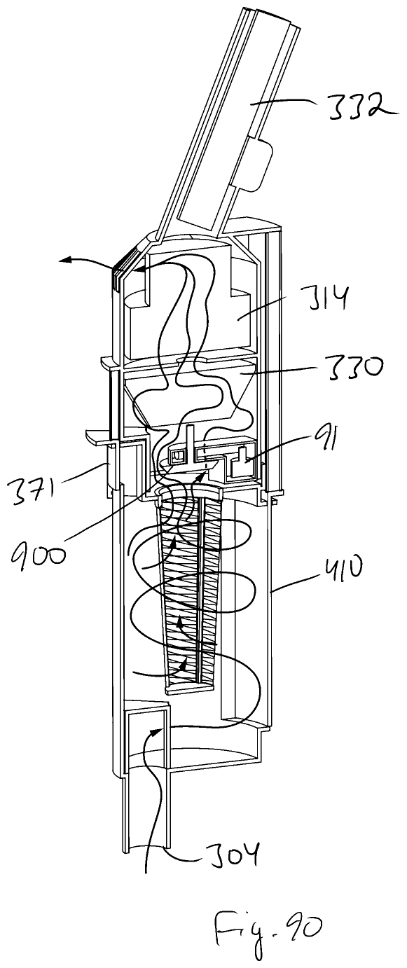

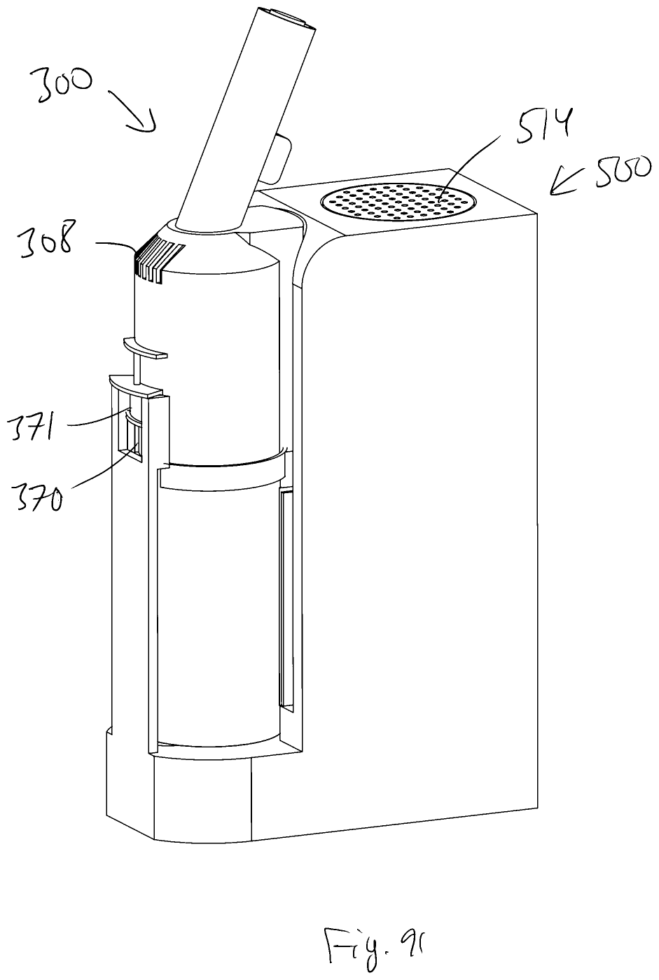

As exemplified in FIGS. 88-92, each of the evacuation air inlet port 370 (which may also be referred to as a bleed valve) and the emptying port 350 have openable doors 371 and 410, respectively. As shown, the openable door 371 opens the air inlet 370 and the openable door 410 opens the emptying port 350 with each door forming a portion of the sidewall of the surface cleaning apparatus 300. As exemplified, each door is a sliding gate valve. It will be appreciated that the openable doors may be any type of door that allows air and/or dirt to enter and/or exit the surface cleaning apparatus 300 and may be at any locations as discussed elsewhere herein.

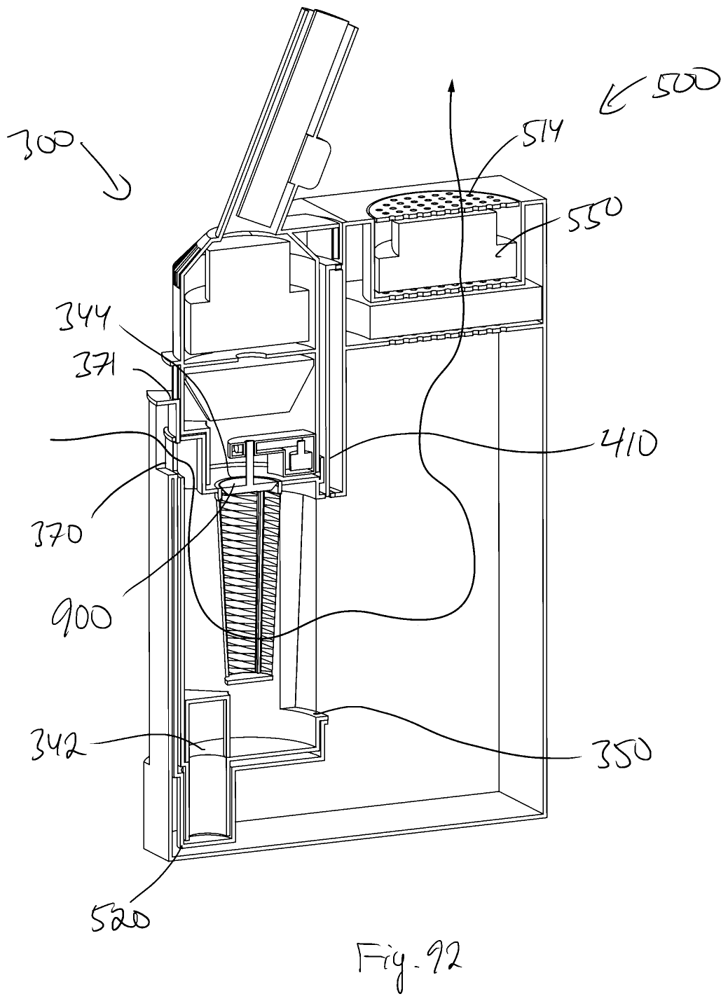

As exemplified in FIG. 92, when the surface cleaning apparatus 300 is docked at the docking unit 500 and is in the dirt emptying mode of operation, the openable door 371 of the evacuation air inlet 370 is opened and the openable door 410 of the emptying port 350 is opened such that the emptying port 350 is in flow communication with the dirt collection region 510 of the docking unit 500. Air may enter the air treatment chamber 340 via the evacuation air inlet 370, pass at least partially through the air treatment chamber 340, and exit the air treatment chamber 340 via the emptying port 350. Accordingly, dirt may be removed from the air treatment chamber 340 by the air flow path between the air inlet 370 and the emptying port 350.

To facilitate the emptying process, one or more regions of the air treatment chamber 340 may be at least partially closed to allow for air to flow from the air inlet 370 to the emptying port 350. For example, in some embodiments, the air treatment chamber air inlet 342 may be closed such that air may not enter through the air treatment chamber air inlet 342 during the emptying process, i.e., when in the dirt emptying mode of operation. As exemplified in FIG. 92, the surface cleaning apparatus 300 is docked at the docking unit 500 and the docking unit 500 has a recess 520 with a closed end. Accordingly, as shown, when the surface cleaning apparatus 300 is docked at the docking unit, the air treatment chamber air inlet 342 is closed.

Alternately, the surface cleaning apparatus 300 may include a closure flap 400, as described previously. In accordance with this aspect, when the surface cleaning apparatus 300 is in the dirt emptying mode of operation, the closure flap 400 may be closed. Accordingly, a drive member, such as a mechanical or electromechanical member may be drivingly connected to the closure flap to close the closure flap 400 during part or all of the dirt emptying mode of operation. The drive member may be actuated upon or subsequent to a docking operation as discussed elsewhere herein.

Optionally, during at least a portion of the dirt emptying mode of operation, the closure flap 400 may be open. For example, during at least a portion of the dirt emptying mode of operation when the closure flap 400 is opened, the evacuation air inlet port 370 may be closed. Accordingly, during the dirt emptying mode of operation, the air flow may begin with the closure flap 400 closed and the evacuation air inlet port 370 opened, such that air flows from the evacuation air inlet port 370 to the emptying port 350. At some point during the dirt emptying mode of operation, the air inlet 370 may be closed by the valve 371 and the closure flap 400 may be opened such that air flows from the air treatment chamber air inlet 342 to the emptying port 350. In other words, during a first portion of the dirt emptying mode of operation, the closure flap 400 may be closed and the air inlet port 370 may be open and during a second portion of the dirt emptying mode of operation the closure flap 400 may be open and the air inlet port 370 may be closed. An advantage of this design is that a larger percentage of dirt may be removed from the air treatment chamber 340. For example, dirt and/or other debris, such as hair, may be caught in one region of the air treatment chamber 340 and may be inhibited during the first air flow path but may be removed during the second air flow path.

During the dirt emptying mode of operation, the closure flap 400 and/or the air inlet port 370 may cycle between the open position and the closed position a plurality of times. An advantage of this design is that repeated variation of the air flow path may help dislodge dirt and/or other debris that would otherwise be caught in the air treatment chamber 340.

It will be appreciated that, in some dirt emptying modes, one of the c may be opened for the duration of the evacuation process and the other opened for part of the evacuation process (e.g., it may be opened once or several times). Alternately both of the closure flap 400 and the evacuation air flow port 370 may be opened for all of the evacuation process.

To facilitate the emptying process, in some embodiments, during a portion or all of the dirt emptying mode of operation, the air treatment chamber air outlet 344 may be partially or fully closed. Partially or fully closing the air treatment chamber air outlet 344 will cause more air flow from the air inlet 370 to the emptying port 350 during the emptying process. As exemplified in FIG. 92 and as discussed previously, the air treatment chamber air outlet 344 has a valve 900 that at least partially closes the air treatment chamber air outlet 344 during the dirt emptying mode of operation.

As with the closure flap 400, the air treatment chamber air outlet may be open for part or all of an evacuation process. Accordingly, the valve 900 may change between the open and closed or at least partially closed positions during the dirt emptying mode of operation. For example, during a first portion of the dirt emptying mode of operation, the air treatment chamber air outlet 344 may be closed and the air inlet port 370 is open and during a second portion of the dirt emptying mode of operation the air treatment chamber air outlet 344 may be open and the air inlet port 370 is closed. As noted above, variation in the air flow path during the dirt emptying mode of operation may facilitate the dislodging and subsequent removal of dirt and/or other debris from the air treatment chamber 340.

It will be appreciated that, in another embodiment, each of the air treatment chamber air inlet 342, the air treatment chamber air outlet 344 and the evacuation air inlet port 370 may be open for part or all of an evacuation process.

As discussed elsewhere herein, the evacuation air inlet port 370 may be positioned anywhere in the sidewall of the air treatment chamber 340 to facilitate the emptying of the air treatment chamber 340 during the dirt emptying mode of operation. As exemplified in FIG. 92, the air inlet 370 is positioned distal to the air treatment chamber air inlet 342. As shown, the air treatment chamber air inlet 342 is located at the first end of the air treatment chamber 340 and the air inlet port 370 is located at the second end of the air treatment chamber 340.

It will be appreciated that one or more of the air flow ports described above may be opened and/or closed to facilitate the emptying of the surface cleaning apparatus 300. For example, during the dirt emptying mode of operation, at least two of the air treatment chamber air inlet 342, air treatment chamber air outlet 344, and the evacuation air inlet port 370 may be operable to vary a direction of air flow during the air treatment chamber 340. During the dirt emptying mode of operation, at least one of the air treatment chamber air inlet 342, air treatment chamber air outlet 344, and the evacuation air inlet port 370 may cycle open and closed more than once.

In some embodiments, the air treatment chamber 340 may include a plurality of evacuation air inlet ports 370. For example, the air treatment chamber 340 may include a second evacuation air inlet port 370. The second evacuation air inlet port 370 may be openable while the first air inlet port 370 is closed or they may be open at the same time. Accordingly, the air flow path may be varied during the dirt emptying mode of operation.

### Air Flow Variation During an Evacuation Process

In accordance with this aspect, which may be used by itself or in combination with one or more other aspects, the volume and/or flow rate of air flow passing from the surface cleaning apparatus to the docking unit may be varied. For example, a suction motor that is used during an evacuation process may be operable to vary air flow through an evacuation air flow path to facilitate a dirt emptying mode of operation of the surface cleaning apparatus. Variation in the air flow, e.g., pulsing the air flow, may assist with dislodging otherwise difficult to remove dirt from the surface cleaning apparatus.

In one more of operation, a power level provided to the suction motor 550 may be varied. For example, the power may be supplied to the suction motor 550 using pulse width modulation. Altering the power level of the suction motor 550 may change the suction force acting on dirt within the air treatment chamber 340 of the surface cleaning apparatus 300. Varying the suction force may facilitate the dislodging of dirt and/or other debris, such as hair, that would otherwise remain stuck within the air treatment chamber 340 with a constant suction force.

In other modes of operation, the suction motor may be cycled on an off.

It will be appreciated that the suction motor may be a suction motor in the docking unit and/or a suction motor in the surface cleaning apparatus.

Accordingly, the suction motor 550 may be repeatedly cycled on and off during the dirt emptying mode of operation. Cycling the suction motor 550 on and off may provide a variation in the suction force acting on dirt within the air treatment chamber 340 of the surface cleaning apparatus. The time between cycles may vary. For example, the suction motor 550 may be deenergized for up to three seconds prior to being re-energized. The period of being deenergized and/or reenergized may vary. In other words, the suction motor 550 may be used to pulse the air flow through the emptying air flow path 516 on and off.

In any mode of operation, part or all of an air flow path may be periodically closed or partially closed, which may produce a pulsed air flow. Partially or fully closing the air flow path and then opening the air flow path (e.g., opening and closing a valve) may also produce a high pressure wave.

Accordingly, the air flow through the emptying air flow path 516 may be varied using mechanical means, such as by cycling the emptying air flow path 516 between at least a partially closed position and an open position. For example, there may be a valve, such as the emptying port valve 410, that is provided in the emptying air flow path 516 that is repeatedly at least partially closed during the dirt emptying mode of operation.

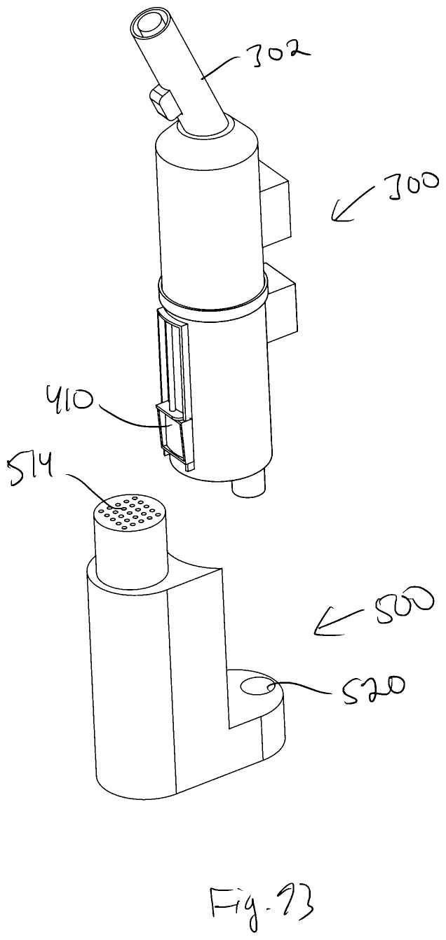

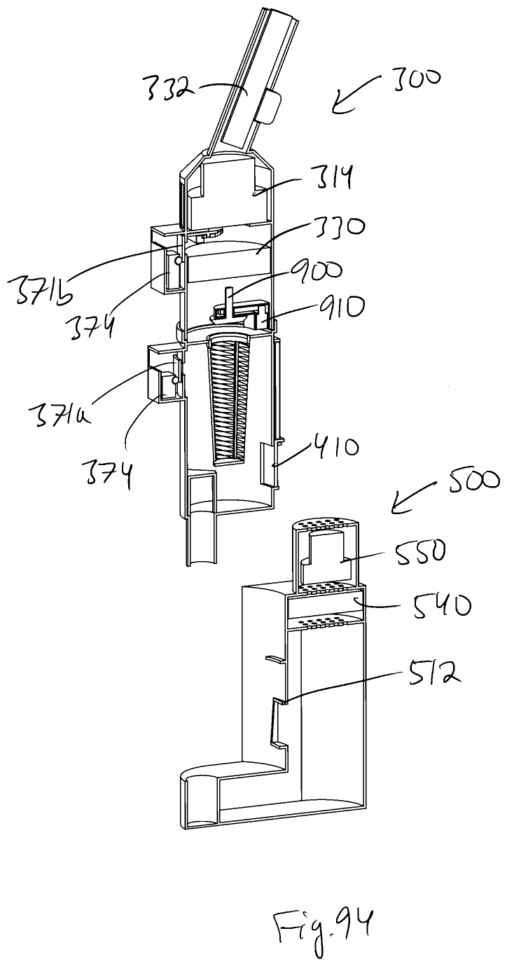

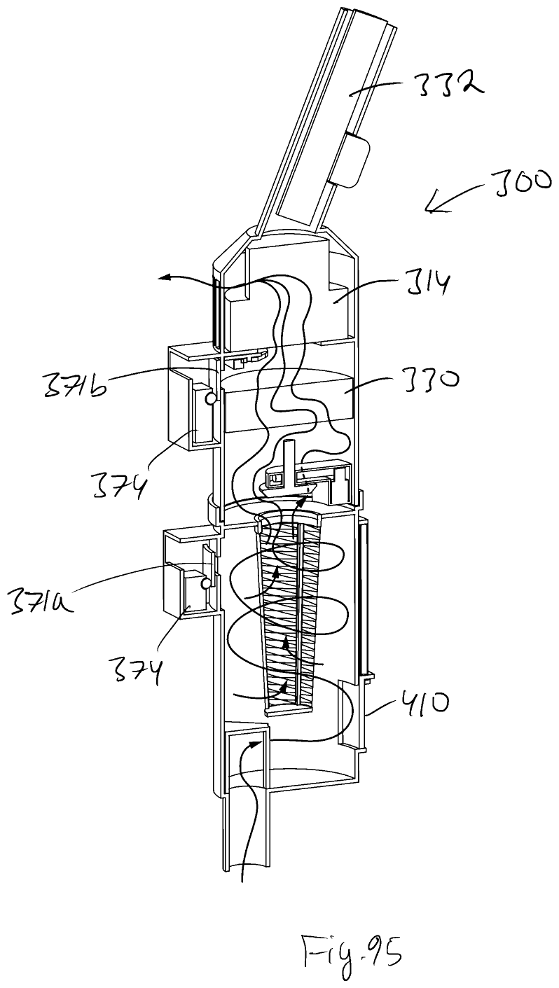

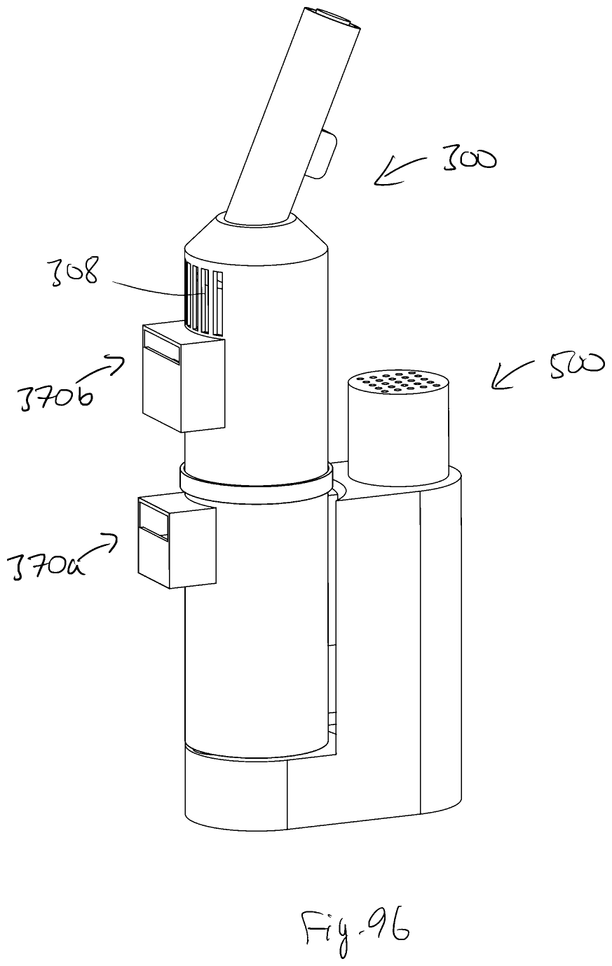

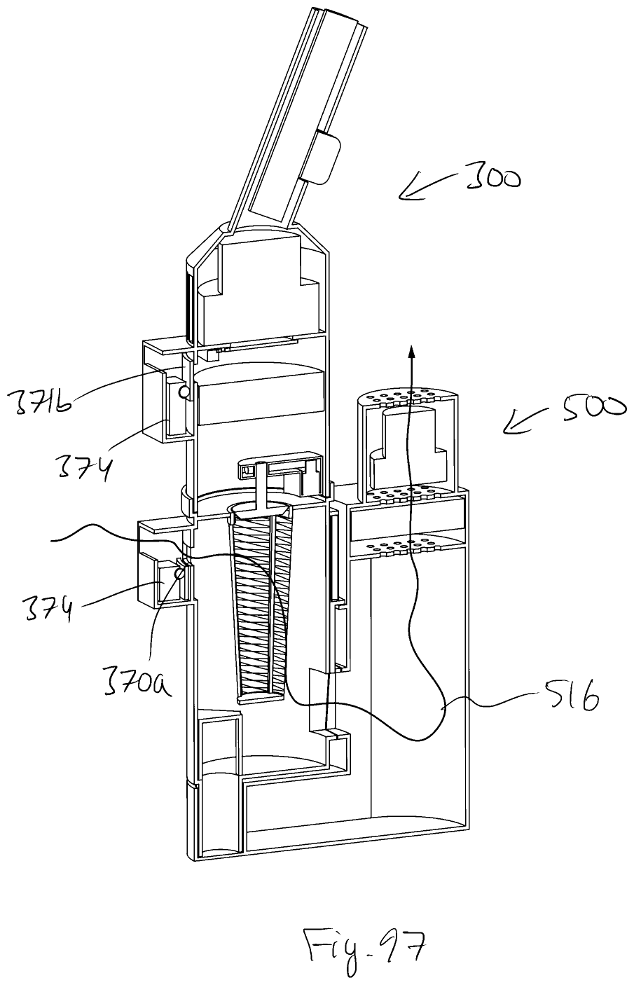

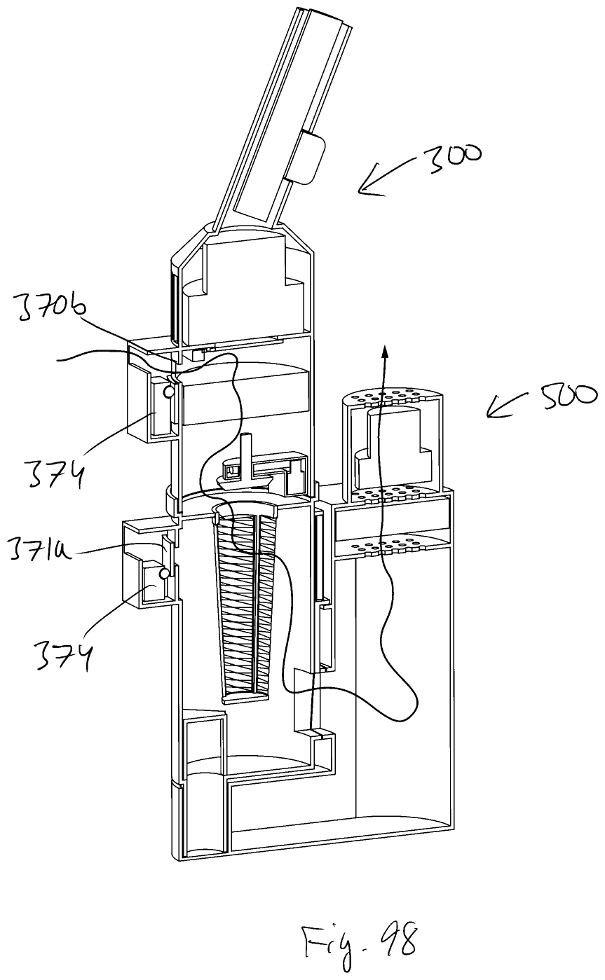

In some embodiments, there may be a plurality of valves used to vary the air flow in the emptying air flow path 516. For example, as exemplified in FIGS. 93-98, there may be a first valve 410a and a second valve 410b, the first valve 371a provided at a first location in the surface cleaning apparatus 300 and the second valve 371b provided at a second location in the surface cleaning apparatus. The first valve 371a and the second valve 371b may be opened and closed to vary the air flow in the emptying air flow path 516. For example, during the dirt emptying mode of operation, the first valve 371a may be opened and the second valve 371b may be repeatedly at least partially closed. As described previously, the valves 371a and 371b may be positioned at various locations in the surface cleaning apparatus 300. For example, they may both provide openings into the air treatment chamber 340. In some embodiments, the first valve 371a may be associated with an inlet 370a to the air treatment chamber 340 and the second valve 371b may be associated with a valve 371b to the pre-motor filter housing 331.

In one mode of operation, all of the valves may be closed initially when the suction motor 314 is activated, thereby building suction within the surface cleaning apparatus 300. The valve 371a may then be opened for, e.g., 1-2 seconds and subsequently valve 371b may be opened. The duration that each valve is opened may vary. For example, the valves may be opened for 1-2 seconds before alternating to the next valve.

### Inlet Port Actuator

In accordance with this aspect, which may be used by itself or in combination with one or more other aspects, there is provided a docking unit for a surface cleaning apparatus. The docking unit has an inlet port actuator that is drivingly connected to an air inlet port valve on the surface cleaning apparatus. During the dirt emptying mode of operation, when the surface cleaning apparatus is docked at the docking unit, a suction motor is drivingly connected to the inlet port actuator such that when the suction motor is actuated, the inlet port actuator is actuated, and the inlet port valve is moved to the open position. An advantage of this design is that a suction motor may be used to actuate one or more inlet port valves, allowing for a variation in the air flow path during the dirt emptying mode of operation. Varying the air flow path may improve the efficiency of the dirt emptying process by dislodging dirt and/or other debris that would otherwise remain stuck within the air treatment chamber of the surface cleaning apparatus.

In accordance with this aspect, the surface cleaning apparatus 300 has a first air inlet port 370a and first air inlet port valve 371a, the first air inlet port valve 371a being moveable between an open position in which the first air inlet port 370a is open and a closed position in which the first air inlet port 370a is closed.

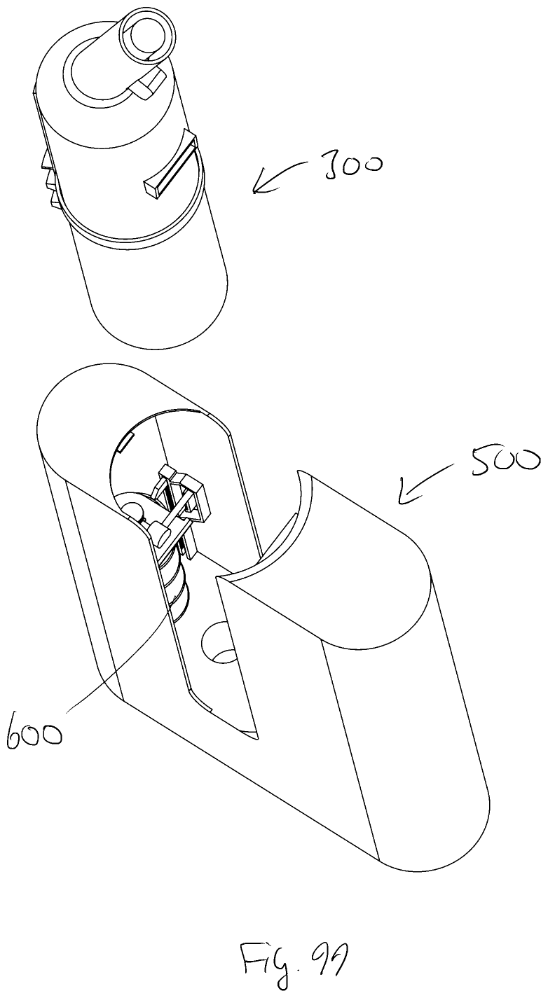

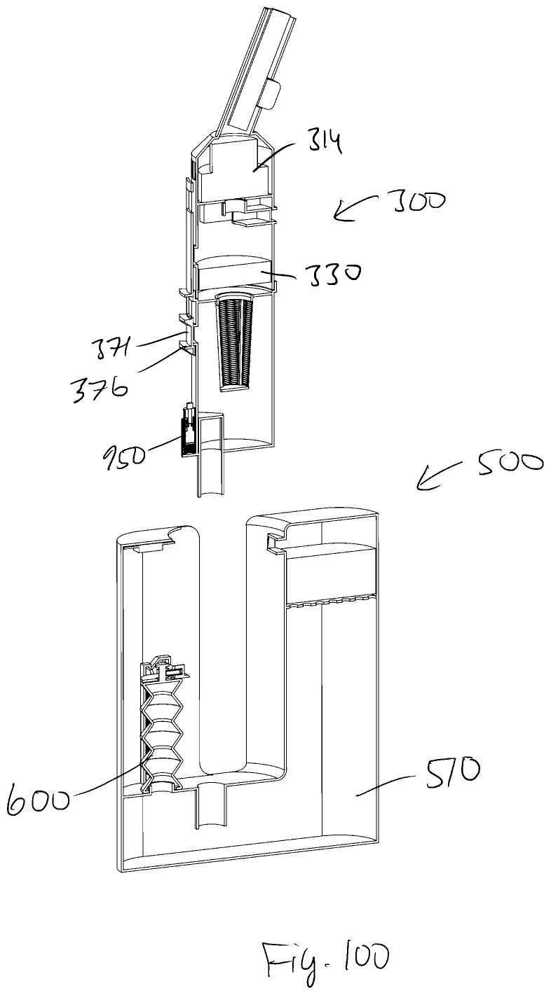

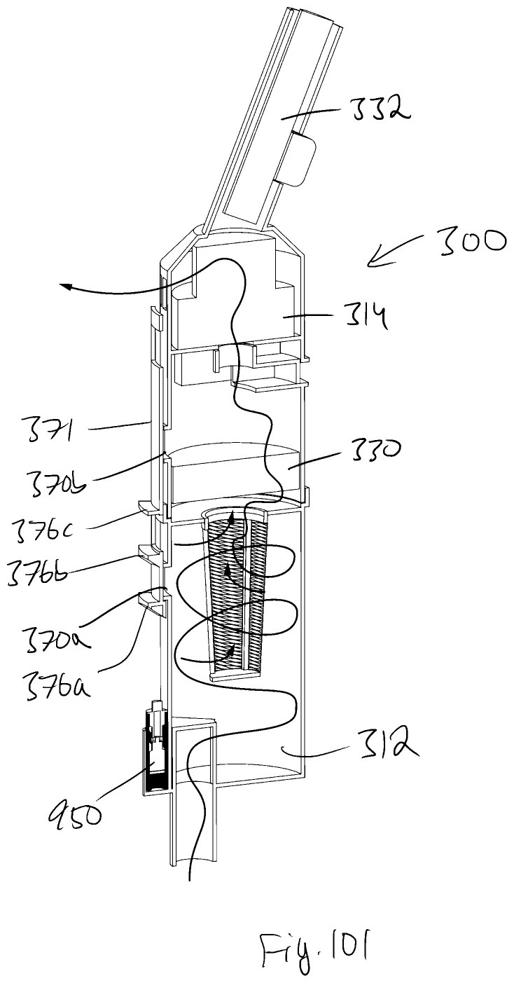

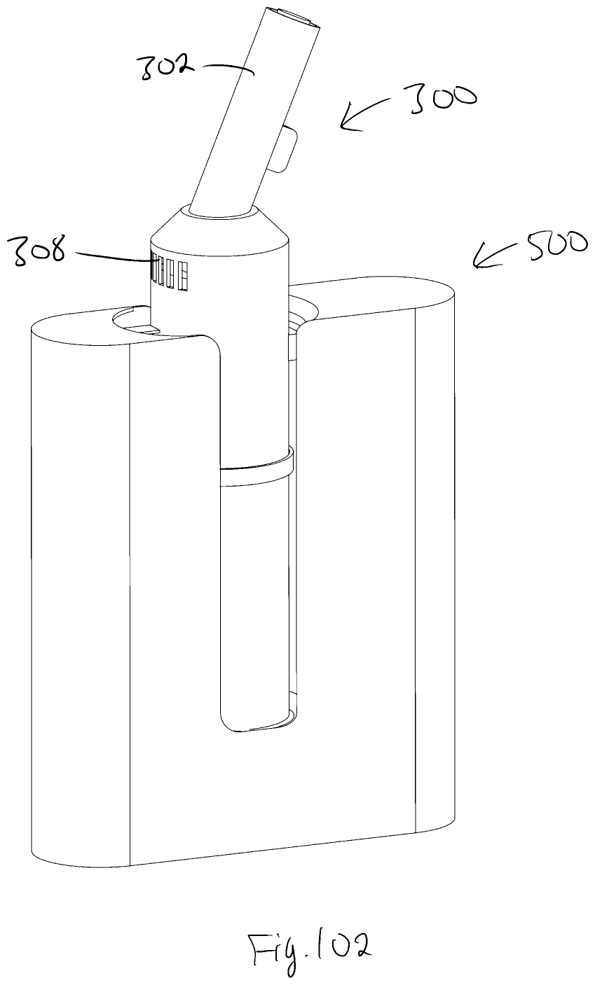

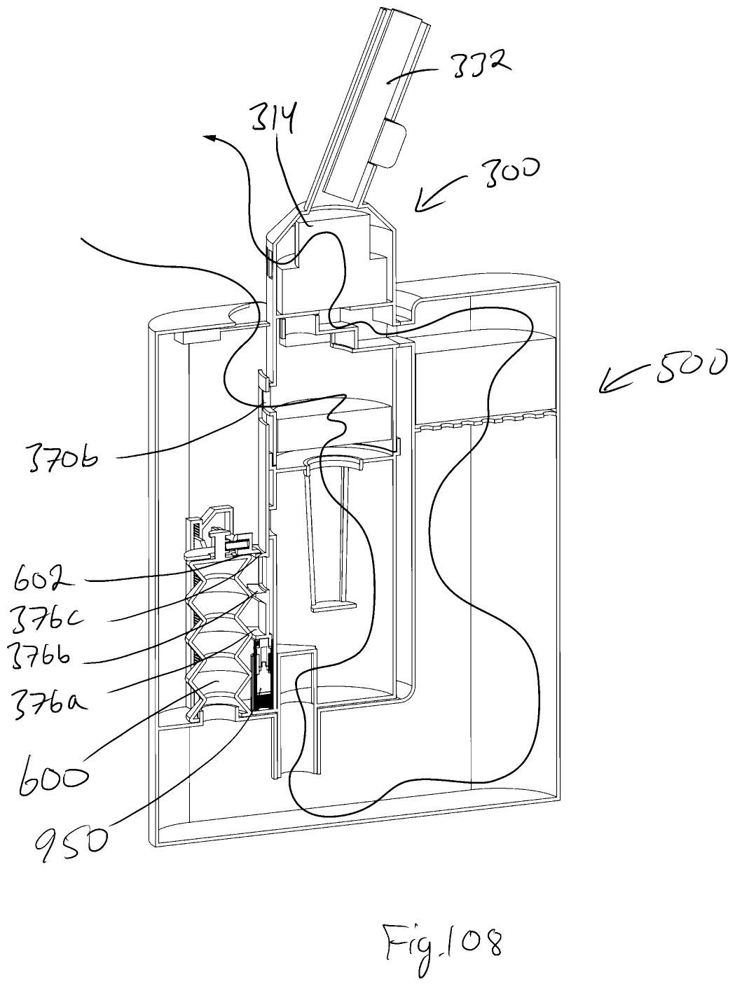

The docking unit 500 has an emptying air flow path 516 that extends from the docking unit air inlet 512, which is connectable with the surface cleaning apparatus 300 by way of the emptying port 350, to the docking unit air outlet port 514. The docking unit 500 includes an inlet port actuator 600. When the surface cleaning apparatus 300 is docked at the docking unit 500, the inlet port actuator 600 is drivingly connected to the first inlet port valve 371a. A suction motor is positioned in the air flow path. The suction motor may be the suction motor 314 and/or the suction motor 550. Accordingly, when the surface cleaning apparatus 300 is in the dirt emptying mode of operation is docked with the docking unit 500 and is in the dirt emptying mode of operation, the suction motor may be actuated such that the inlet port actuator 600 is actuated to move the first inlet port valve 371a to the open position. For example, as exemplified in FIGS. 99-110, the first inlet port valve 371a is slideably moveable between the open position and the closed position. As shown, the first inlet port valve 371a may be a gate valve.

Optionally, when the suction motor is deenergized, the first inlet port valve 371a may be moved to the closed position. For example, the first inlet port valve 371a may be biased to the closed position. Accordingly, when the suction motor is deenergized, the biased first inlet port valve 371a moves back to the closed position.

It will be appreciated that the suction motor may actuate the inlet port actuator 600 by any means. For example, the suction motor may be pneumatically connected to the inlet port actuator 600. The inlet port actuator 600 may be, for example, a bellows.

The surface cleaning apparatus 300 may include a plurality of inlet ports. For example, the surface cleaning apparatus 300 has a second air inlet port 370b and a second air inlet port valve 371b. The second air inlet port valve 371b may be moveable between an open position in which the second air inlet port 370b is open and a closed position in which the second air inlet port 370b is closed. When the surface cleaning apparatus 300 is docked at the docking unit 500 and is in the dirt emptying mode of operation, the suction motor is drivingly connected to the second inlet port valve 371b such that when the suction motor is actuated the second inlet port valve 371b is moved to the open position. The inlet port actuator 600 may be drivingly connected to the second air inlet port valve 371b. In some embodiments, the docking unit 500 may include a second inlet port actuator, which may also be pneumatically driven, that is drivingly connected to the second air inlet port valve 371b.

The inlet port valves may be opened concurrently or sequentially. The inlet port actuator 600 may open the first air inlet port 370a and then the second air inlet port 370b. For example, during the dirt emptying mode of operation, the suction motor may be actuated a first time such that the inlet port actuator 600 opens the first air inlet port 370a. The suction motor may be deenergized and then actuated a second time, which causes the inlet port actuator 600 to open the second air inlet port 370b. In some embodiments, when the suction motor is actuated a second time, the first air inlet port 370a is closed by the inlet port actuator 600.

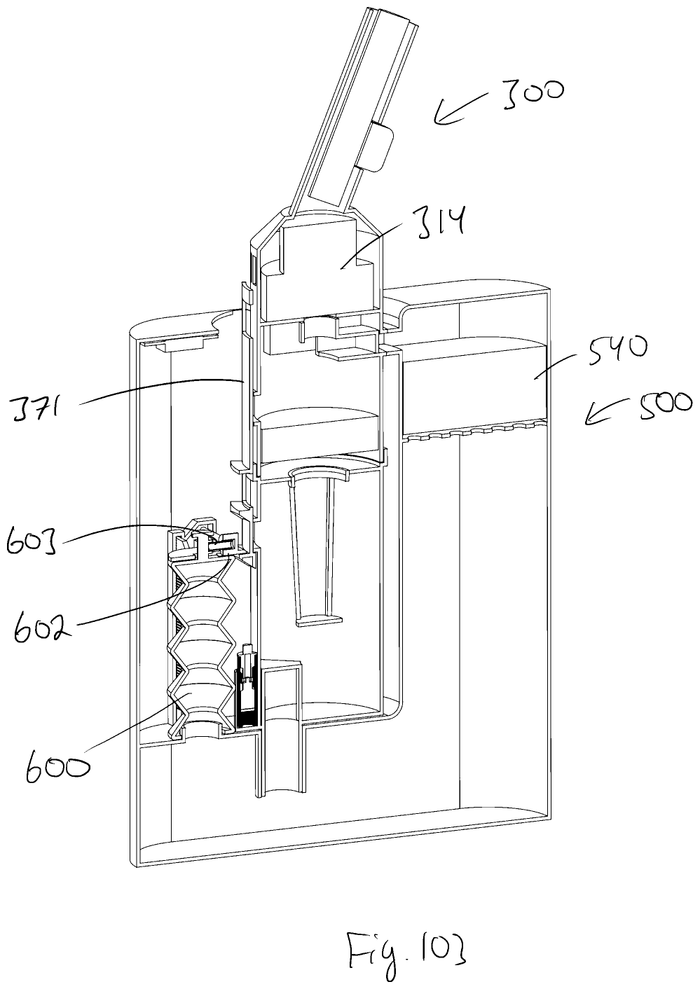

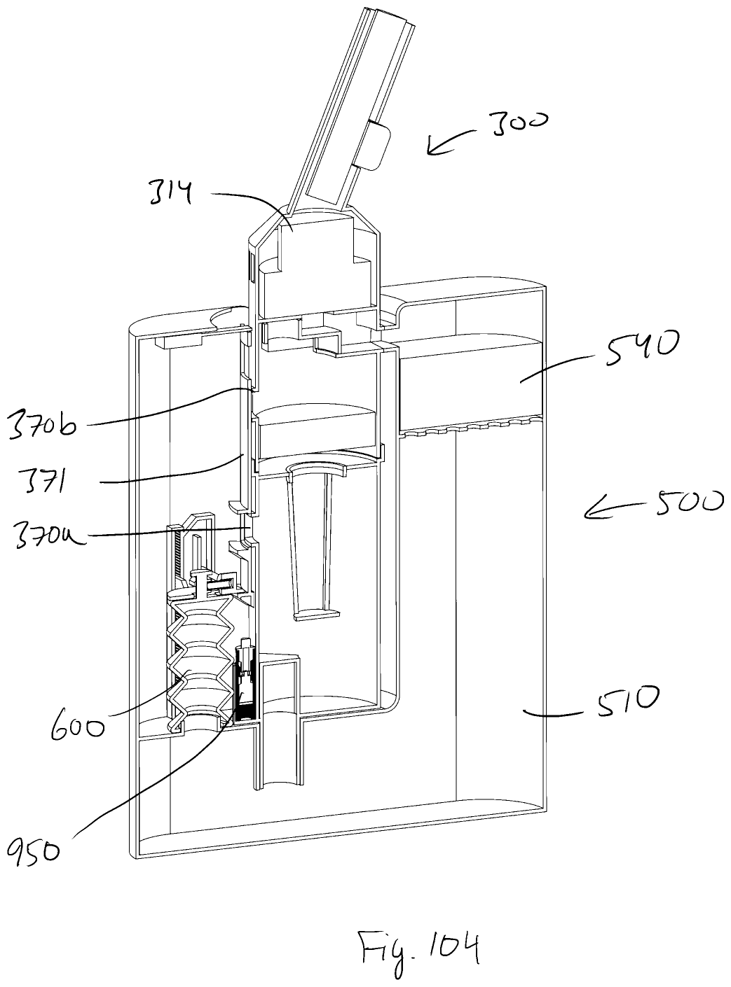

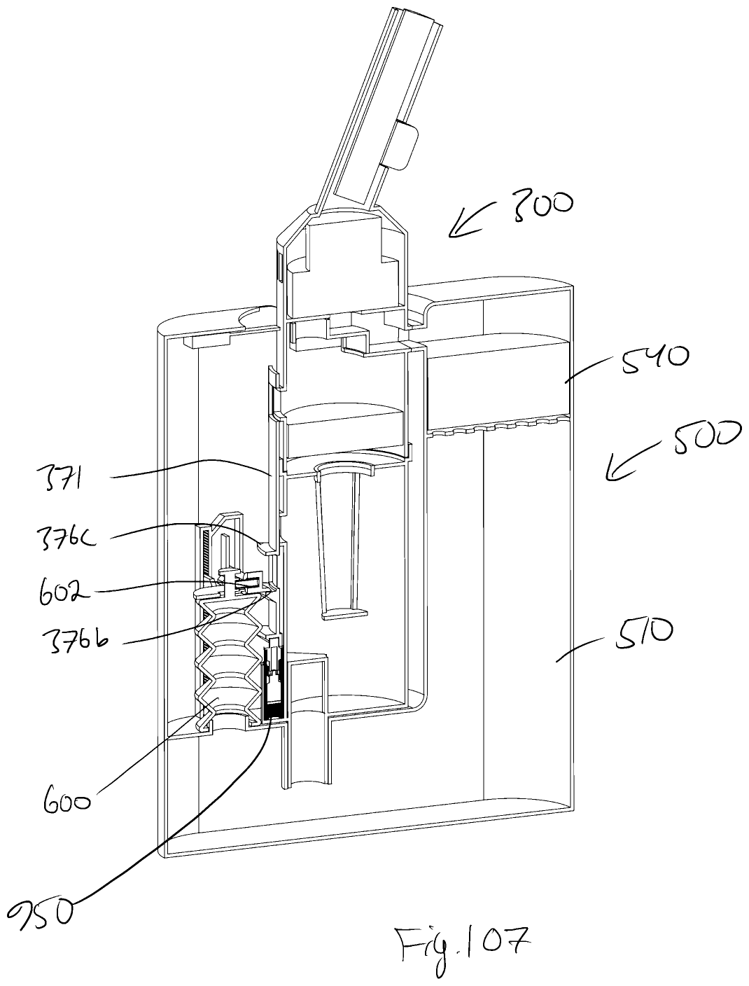

The valves actuated by the inlet port actuator 600 may be one or more sliding valves. As exemplified in FIG. 103-110, the inlet port actuator 600 is a single common actuator that engages with a common valve 371. When the surface cleaning apparatus 300 is docked at the docking unit 500, the common actuator 600 is drivingly connected to the sliding valve 371 and is moveable between a first position (e.g., FIG. 103) in which the first and second inlet ports are closed, a second position (e.g., FIG. 104) in which the first inlet port 370a is open and the second inlet port 370b is closed, and a third position (e.g., FIG. 107) in which the first inlet port 370a is closed and the second inlet port 370b is open. Optionally, the third position may have each of the first inlet port 370a and the second inlet port 370b open.

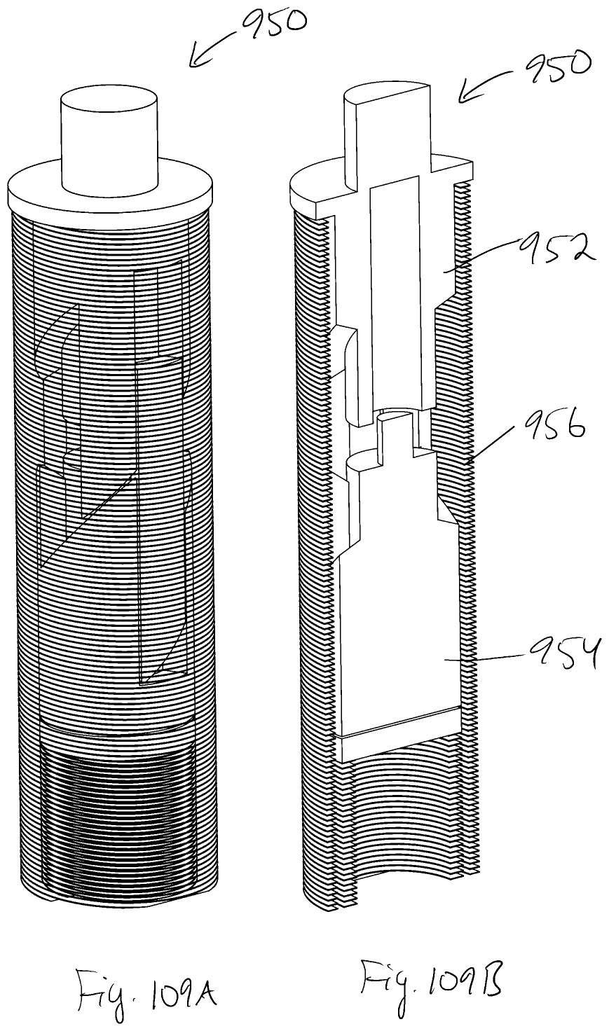

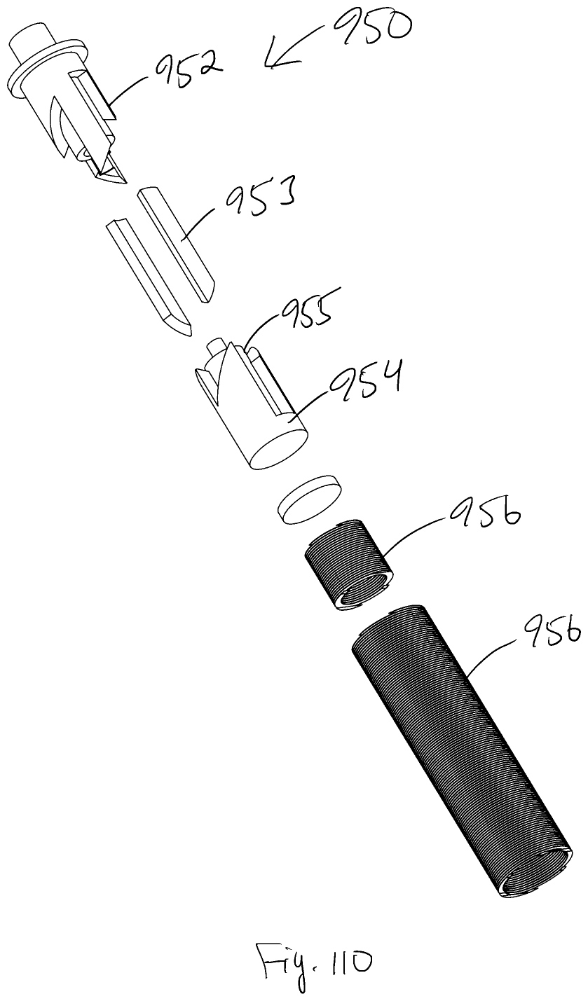

The valve 371 may engage with a release mechanism 950. The release mechanism 950 may operate in a similar manner to that of a spring-released pen, enabling the valve 371 to ratchet between positions before being biased back to the original position. Accordingly, the valve 371 may move from the first position to the second position, the second position to the third position, and may be released by activating the release mechanism 950 to move back to the first position. As exemplified in FIGS. 109A-110, the release mechanism 950 includes an upper portion 952, a lower portion 954, and a biasing member 956. The upper portion 952 may be moveable relative to the lower portion 954, with each compression moving the upper portion 952 to a new position that compresses the biasing member 956. When the upper portion 952 has completed a full rotation around the lower portion 954, the biasing member 956 may be released, biasing the upper portion 952 back to the original position. In other words, the upper portion 952 may rotated between a plurality of positions before being released back to the original position by the biasing member 956. As exemplified in FIGS. 109A-110, the upper portion 952 has first engagement member 953 that engage with a second engagement member 955 on the lower portion 954.

In some embodiments, the common actuator 600 may include a first engagement member 602 and the sliding valve of each inlet valve may have one or more second engagement member 376. During operation, the common actuator 600 may ratchet between the valve engagement member(s) to move the valve 371 to its open or closed position. For example, referring to FIG. 103-108, the valve 371 moves between the three positions as the suction motor 314 is energized and deenergized. As shown in FIG. 103, the valve 371 is in the first position with the first engagement member 602 engaged with the second engagement member 376a. When the suction motor 314 is activated, the bellows 600 are compressed, pulling the valve 371 to the second position (e.g., FIG. 104), thereby opening the first inlet port 370a.

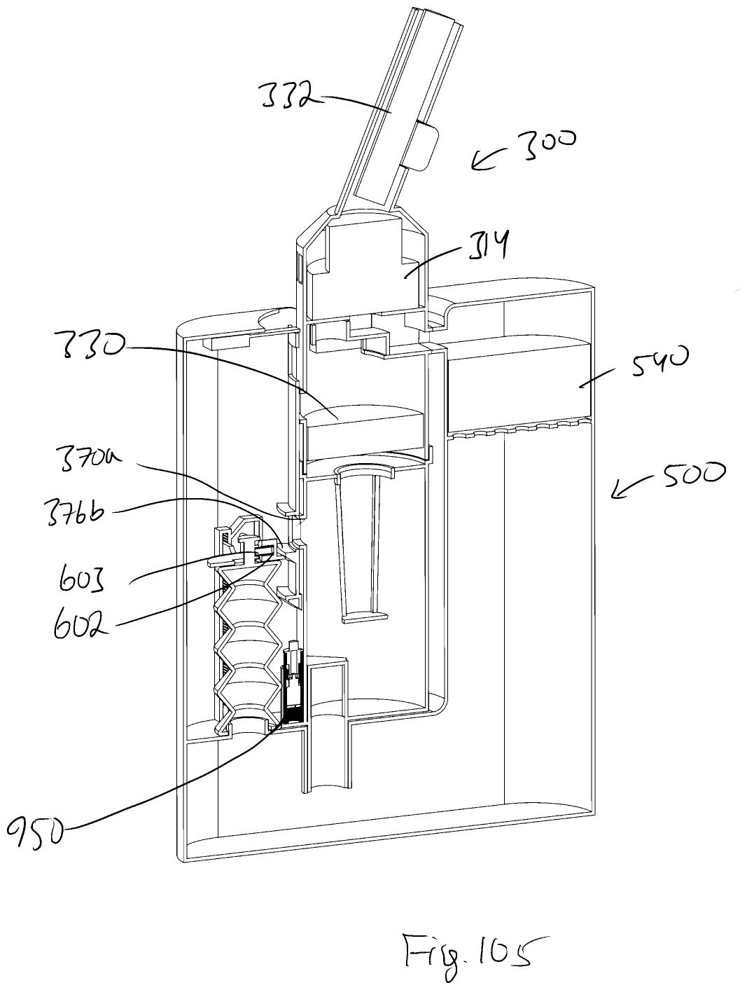

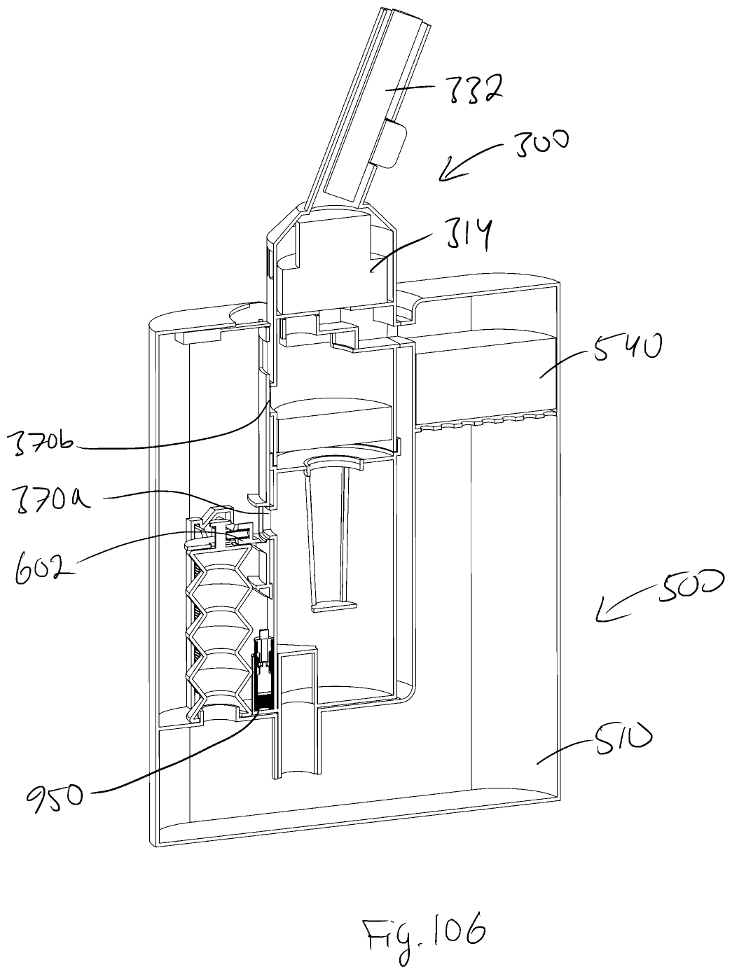

When the suction motor is deactivated, the bellows 600 expands, e.g., it may be made of a resilient material, moving back to the uncompressed position (e.g., FIG. 106) to engage the second engagement member 376b. For example, as exemplified in FIG. 105, the first engagement member 602 may be biased to the engagement position by a biasing member 603. Additionally, the first engagement member 602 is cammed to engaged with a cam engagement surface on the first engagement member 376a. Accordingly, when the suction motor 314 is deactivated and the bellows 600 moves to the uncompressed position, the first engagement member 602 is compressed when it contacts the second engagement member 376a such that the first engagement member 602 travels upwardly along the valve 371, allowing the valve 371 to remain in the second position, as exemplified in FIG. 105. The first engagement member 602 is then biased to engage with the second engagement member 376b in the uncompressed position.

When the suction motor 314 is activated again, the bellows 600 compress, engaging the first engagement member 602 with the second engagement member 376b, moving the valve 371 to the third position, opening the second inlet port 370b and closing the first inlet port 370a. When the suction motor 314 is deactivated, the bellows 600 moves upwardly to the uncompressed position, again travelling upwardly along the valve 371 to allow the valve 371 to remain in the second position. The first engagement member 602 then engages with the third engagement member 376c in the uncompressed position.

When the suction motor 314 is activated again, the bellows 600 compress, pulling the valve 371 downward again. At this point, the release mechanism 950 is activated to release the biasing force on the valve 371, moving the valve 371 back to the first position, closing each of the first inlet port 370a and the second inlet port 370b.

### Disinfection

In accordance with this aspect, which may be used by itself or in combination with one or more other aspects, there is provided a docking unit for receiving at least a portion of a surface cleaning apparatus and the docking unit is operable to disinfect a portion of the surface cleaning apparatus, such as the dirt collection region of the surface cleaning apparatus when the surface cleaning apparatus is docked at the docking unit. An advantage of this design is that biological contaminants may be denatured and/or killed on or within the surface cleaning apparatus, thereby reducing the likelihood of a user getting ill from cleaning the surface cleaning apparatus.

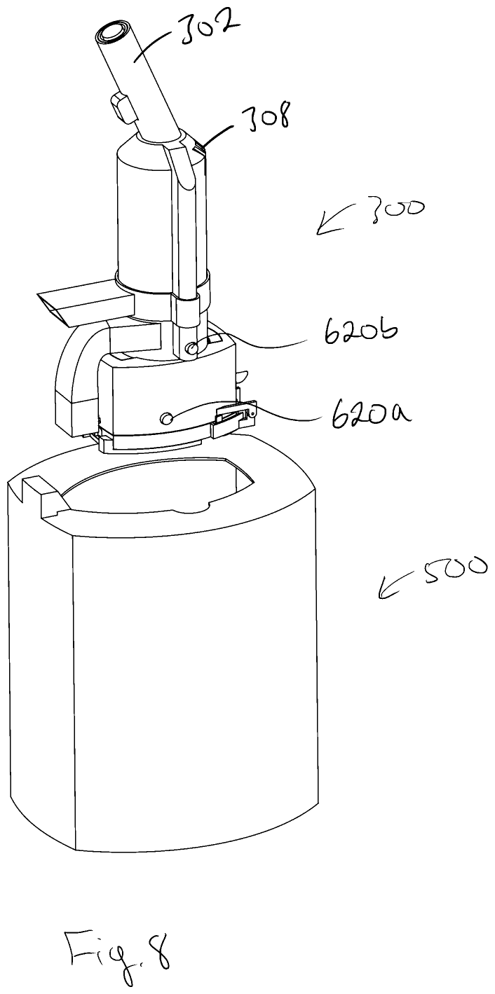

As exemplified in FIGS. 8-13, the docking unit 500 uses a disinfection agent 610 to disinfect at least a portion of the surface cleaning apparatus 300. The docking unit 500 may disinfect the surface cleaning apparatus 300, such as the dirt collection region 312, after the dirt collection region 312 has been emptied. The disinfection agent 610 may use any means to disinfect the surface cleaning apparatus 300. For example, the disinfection agent may be a defecting member, including, but not limited to, UV light, or a chemical, such as ozone.

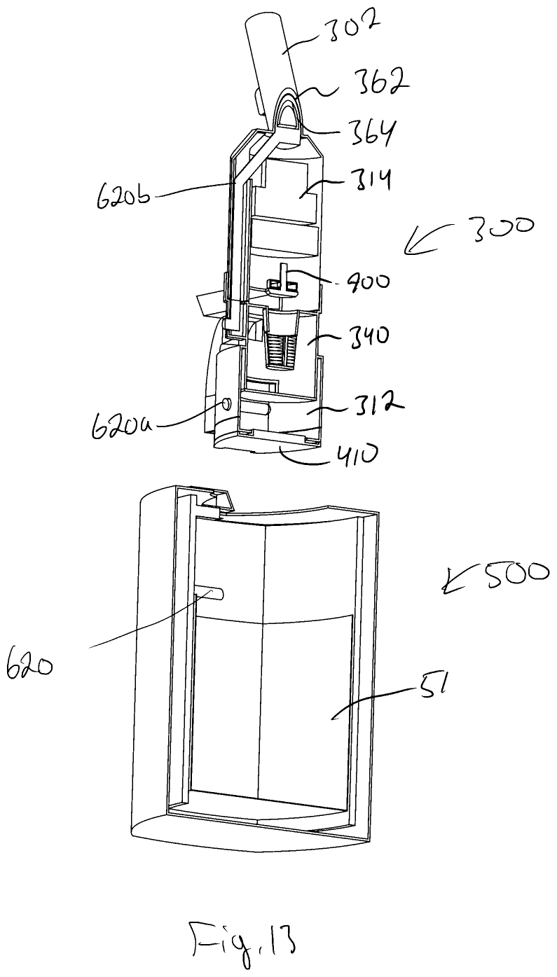

The docking unit 500 may be operable to disinfect an exterior surface of the surface cleaning apparatus 300 by providing the disinfection agent 610 to an interior of the surface cleaning apparatus 300. For example, at least a section 362 of the surface cleaning apparatus 300 may be transparent to UV light. UV light 610 projected by the docking unit 500 may pass through the section 362 to disinfect the interior and/or the exterior of the portion 362. For example, UV light 610 may be directed into the interior 364 of the section 362 such that the exterior of the section 362 may be disinfected. The section 362 may be any portion of the surface cleaning apparatus 300. For example, as exemplified in FIG. 13, the section 362 is the handle 302 and the handle 302 is transparent to UV light. During the disinfecting of the surface cleaning apparatus 300, UV light 610 is directed into the handle 302 and the transparent section 362 of the handle 302 allows UV light 610 to disinfect the exterior of the handle 302.

If the disinfection agent is UV light, then one or more light pipes may be provided to convey the UV light to a desired location or locations in the surface cleaning apparatus and/or the docking station.

For example, the portion of the surface cleaning apparatus 300 that is dockable at the docking unit 500 may include at least one light pipe 620 for UV light 610. During the disinfecting mode of operation, UV light 610 may be directed into the light pipe 620 for disinfecting one or more regions of the surface cleaning apparatus 300. For example, as exemplified in FIG. 13, the surface cleaning apparatus has a first light pipe 620a for directing light interior of the dirt collection region 312 and a second light pipe 620b for directing light interior of the handle 302.

The docking unit 500 may inhibit the disinfection agent 610 from travelling outwardly of the docking unit 500. For example, when the disinfection agent 610 is UV light, it may be desirable to prevent UV light from projecting exterior of the docking unit 500, thereby protecting the user and objects within range of the UV light.

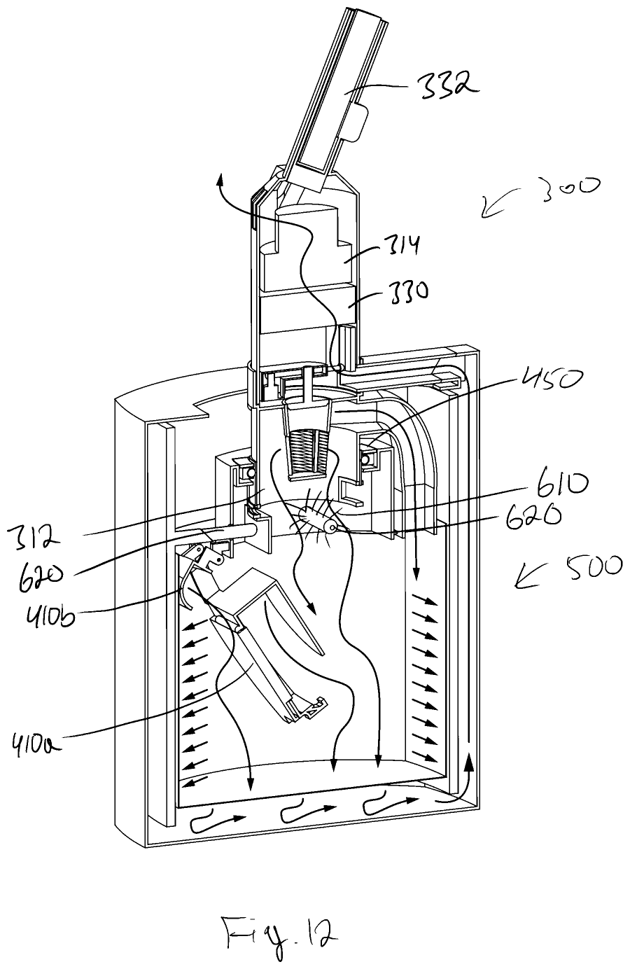

As exemplified in FIG. 12, the surface cleaning apparatus 300 may include a plurality of dirt collection regions. The docking unit 500 may be operable to disinfect each dirt collection region with the disinfection agent 610 when the surface cleaning apparatus 300 is docked at the docking unit 500. The plurality of dirt collection regions may be disinfected after the dirt emptying mode of operation occurs.

It will be appreciated that the disinfection agent may be applied during an evacuation process and/or subsequent to the completion of an evacuation process, while the surface cleaning apparatus is still docked at the docking unit.

It will be appreciated that the production of the disinfection agent may be terminated upon the surface cleaning apparatus being removed from the docking unit. For example, a circuit may be opened, termination the production of UV light, when the surface cleaning apparatus is undocked.

### UV Light Emitting Member

In accordance with this aspect, which may be used by itself or in combination with one or more other aspects, there is provided a UV light emitting member within the surface cleaning apparatus that is operable to disinfect at least a portion of the interior and/or the exterior of the surface cleaning apparatus while docked at a docking unit. An advantage of this design is that the UV light emitting member may disinfect the exterior of the surface cleaning apparatus without being positioned exterior of the surface cleaning apparatus, thereby improving the safety of the user and objects positioned near the surface cleaning apparatus. Further, a disinfection cycle may be actuated, optionally automatically actuated, when the surface cleaning apparatus is emptied.

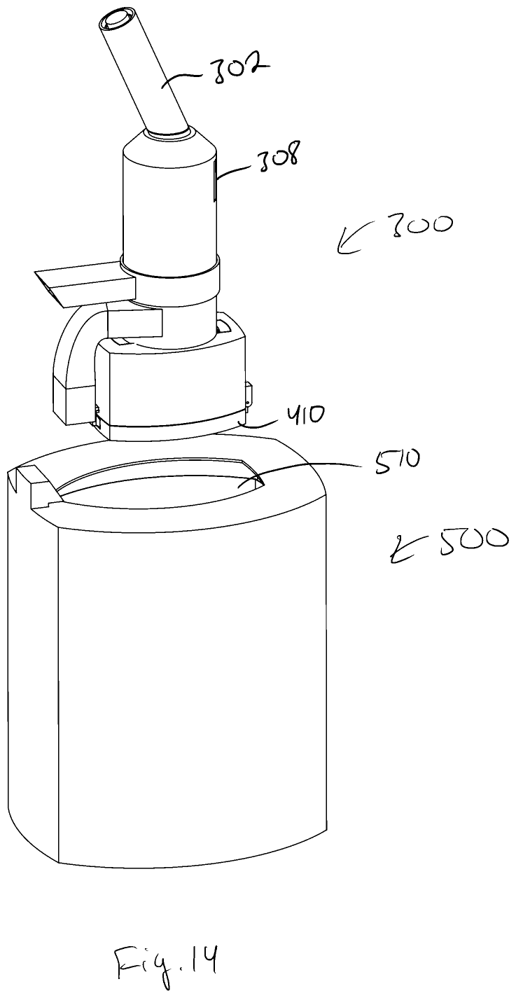

In accordance with this aspect, as exemplified in FIGS. 14-19, the surface cleaning apparatus 300 includes a UV light emitting member 630 that is located interior of the surface cleaning apparatus 300. The UV light emitting member 630 is operable to disinfect a portion 362 of an exterior surface of the surface cleaning apparatus 300 when the surface cleaning apparatus 300 is docked at the docking unit 500. In other words, the UV light emitting member 630 may be activated while the surface cleaning apparatus 300 is docked at the docking unit 500. The portion 362 may be the handle 302 of the surface cleaning apparatus 300.

In some embodiments, the surface cleaning apparatus 300 may include at least one light pipe such that the light pipe may receive UV light from the UV light emitting member 630 and transmit the UV light to a location that is interior 364 of the exterior surface 362 of the surface cleaning apparatus 300. For example, as discussed previously, the section 362 may be UV light transparent such that when UV light is emitted on the interior 364, the exterior section 362 may be treated with UV light to disinfect the surface.

The portion 362 may be positionable within the docking unit 500 such that when the UV light emitting member 630 is activated, the docking unit 500 may inhibit the UV light radiating outwardly of the docking unit 500. This configuration may protect the user and/or nearby objects from UV light exposure.

The UV light emitting member 630 may be activated after the surface cleaning apparatus 300 is emptied. Waiting until after the surface cleaning apparatus 300 has been emptied may allow the interior of the surface cleaning apparatus 300 to be disinfected more easily without having regions of the interior blocked by dirt and/or debris.

In some embodiments, one or more UV light emitting members 630 may be positioned within the docking unit 500.

It will be appreciated that the light emitting member 630 may be actuated during an evacuation process and/or subsequent to the completion of an evacuation process, while the surface cleaning apparatus is still docked at the docking unit.

It will be appreciated that the light emitting member 630 may be deactuated upon the surface cleaning apparatus being removed from the docking unit. For example, a circuit may be opened, termination the production of UV light, when the surface cleaning apparatus is undocked.

### Energy Storage Member

In accordance with this aspect, which may be used by itself or in combination with one or more other aspects, a surface cleaning apparatus has an energy storage member. When the surface cleaning apparatus is docked at the docking unit and the docking unit is in a dirt emptying mode of operation, the energy storage member powers a motor and fan assembly, which provides air flow that transfers dirt from the dirt collection region into the docking unit. An advantage of this design is that the docking unit does not need to have a suction motor and therefore, need not have an electrical plug. Accordingly, the docking unit may be manufactured more simply and at lower cost.

The suction motor may be provided in the surface cleaning apparatus 300, in the docking unit 500, or both. When at least a portion of the surface cleaning apparatus 300 is docked at the docking unit 500 and the docking unit is in the dirt emptying mode of operation, the suction motor 314, 550 provides an air flow that transfers dirt from the dirt collection region 312 into the docking unit dirt collection chamber 510. The portion of the surface cleaning apparatus that is docked at the docking unit 500 may include the dirt collection region 312 and the energy storage member 332.

Accordingly, the energy storage member(s) of the surface cleaning apparatus may be used to power a suction motor of the docking unit to produce the air flow during an evacuation process. Alternately, the suction motor of the surface cleaning apparatus may be used to produce the air flow during an evacuation process and may be powered by the energy storage member(s) of the surface cleaning apparatus.

Optionally, the surface cleaning apparatus 300 may be recharged while docked at the docking unit 500. For example, the docking unit 500 may recharge the energy storage member 332.

The docking unit 500 may recharge the energy storage member 332 while the energy storage member 332 is used to power the suction motor or subsequent to powering the suction motor during an evacuation process.

To recharge the energy storage member 332, the surface cleaning apparatus 300 may include a power cord that has a plug connectable to a household power outlet and a power supply. The plug may be part of an AC adapter. In some embodiments, the power cord may include an AC adaptor (power supply) that may be provided proximate the plug. A low voltage conductor may extend between the AC adapter and the docking unit 500.

If the docking unit recharges the energy storage member(s), then the power supplied from the household mains may only be used to charge the energy storage member(s) and not to power the suction motor directly. In such a case, the docking unit 500 may recharge the energy storage member 332 at a rate that is lower than, equal to, or greater than, the rate at which the energy storage member 332 may be discharged to power the suction motor. For example, the energy storage member 332 may be discharged at a first rate when used to power the suction motor during the dirt emptying mode of operation of the docking unit 500 and the docking unit 500 may recharge the energy storage member 332 at a second rate which is lower than the first rate. The variation in rate may change depending on the design of the surface cleaning apparatus 300. For example, the second rate may be, including, but not limited to, up to 4C, optionally from 1/24 to 4C, optionally 1/12 to 2C, optionally, 1/8 to 1C. The first rate may be much larger than the second rate. For example, the first rate may be, including, but not limited to, at least 5C, optionally at least 10C.

If the energy storage member 332 does not have enough charge to operate the dirt emptying mode of operation, the energy storage member 332 may be charged by the docking unit 500. Once sufficient charge is reached, the dirt emptying mode of operation may be automatically actuated.

### Docking Unit for an Upright Surface Cleaning Apparatus

In accordance with this aspect, which may be used by itself or in combination with one or more other aspects, an upright surface cleaning apparatus includes an emptying port for interfacing with a docking unit during a dirt emptying mode of operation. An advantage of this design is that the surface cleaning apparatus may be quickly and easily docked at the docking unit for emptying without removing additional components from the surface cleaning apparatus such as a dirt collection chamber. Another advantage is that the upright surface cleaning apparatus, is it has an on board energy storage member, may be simultaneously emptied and charged while docked at the docking unit.

In accordance with this aspect, a surface cleaning apparatus 300 has an upright section 390 and a surface cleaning head 380. The surface cleaning head 380 has a dirty air inlet 382. The upright section 390 is moveable between an upright storage position and a reclined floor cleaning position. The air flow path extends from the dirty air inlet 382 to the clean air outlet 308. Any upright surface cleaning apparatus may be used.

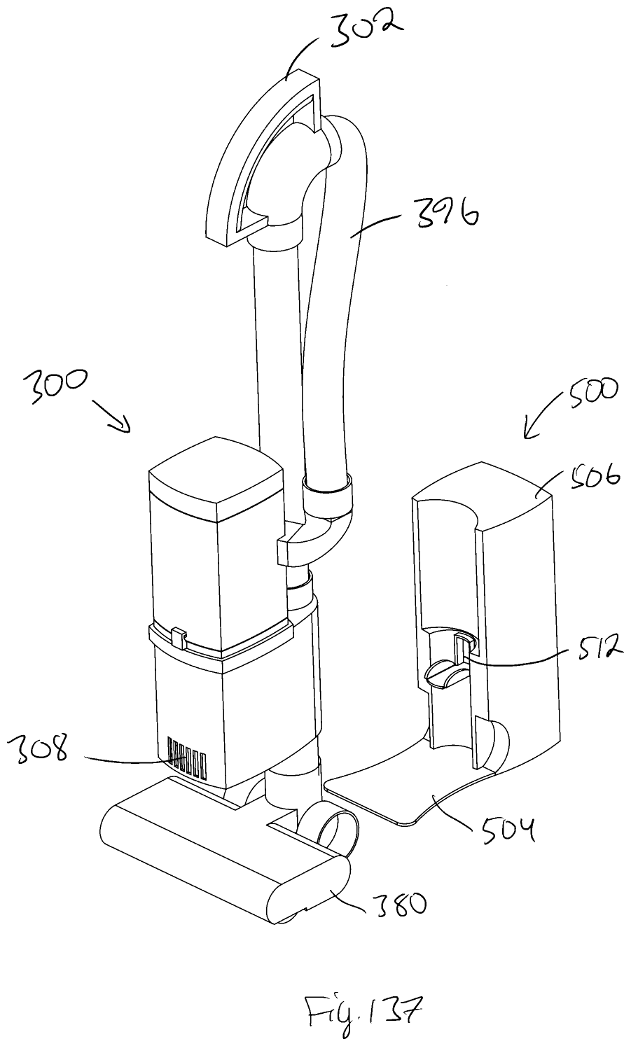

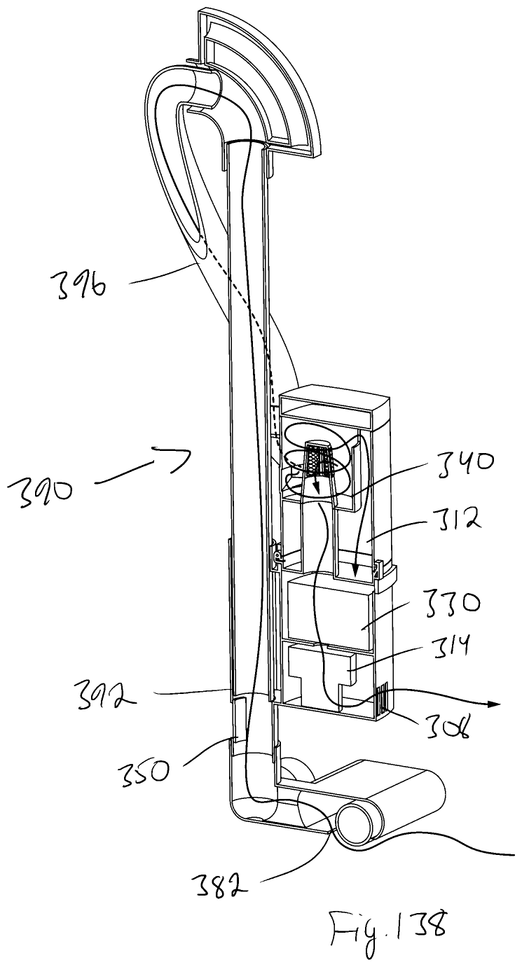

As exemplified in FIGS. 137-140, the surface cleaning apparatus 300 includes the emptying port 350. When the surface cleaning apparatus 300 is docked at the docking unit 500 and is in the dirt emptying mode of operation, the emptying port 350 is in flow communication with the dirt collection region 510 of the docking unit 500. As described previously, a suction motor may be operable to provide a dirt emptying air flow that passes through the air treatment chamber 340 to the emptying port 350, facilitating the emptying of the surface cleaning apparatus 300. The suction motor may be the suction motor 314 positioned within the surface cleaning apparatus 300, the suction motor 550 positioned within the docking unit 500, or both.

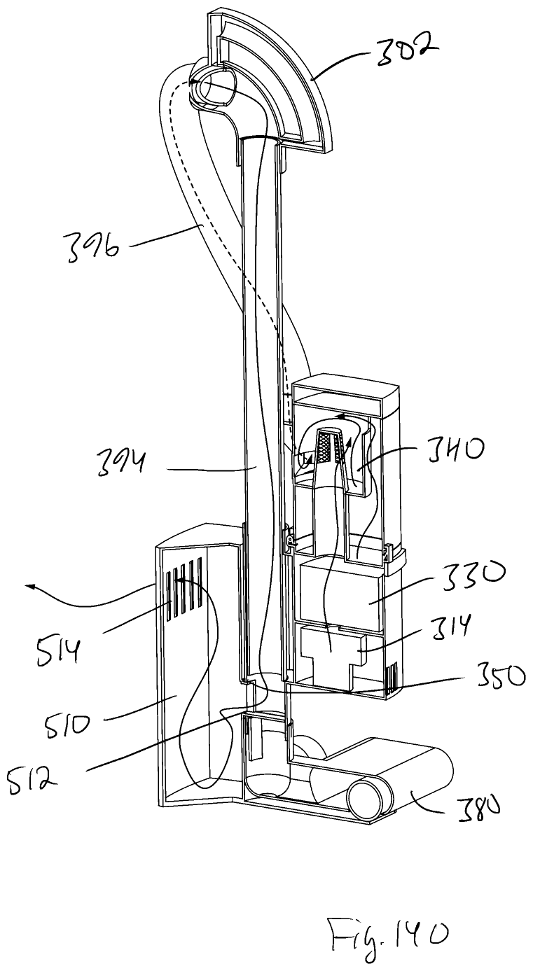

The emptying port 350 may be positioned anywhere on the surface cleaning apparatus 300. As exemplified in FIG. 140, the emptying port 350 may be positioned in a lower end 392 of the upright section 390. As shown, the upright section 390 includes an upflow duct 394 and the emptying port 350 is positioned in the upflow duct 394. Alternately, the emptying port 350 may be positioned in the surface cleaning head 380.

The upright surface cleaning apparatus may use any air treatment chamber or chambers known in the art. Optionally, as exemplified, the air treatment chamber may comprise one or more cyclone chambers. The cyclone chamber may have a tangential air inlet at a lower end and an air outlet also at a lower end (see, e.g., FIG. 140). An external dirt chamber may be provided and the dirt outlet may be at an upper end of the cyclone chamber.

Alternately, the tangential air inlet and air outlet may be at an upper end of the cyclone chamber and the separated dirt may accumulate in a lower end of the cyclone chamber and/or a lower dirt outlet may be provided that communicates with an external dirt collection chamber.

Alternately, the tangential air inlet may be provided at one end and a dirt outlet and an air outlet may be provided at an axially opposed end of the cyclone chamber.

In any such embodiment, the emptying port 350 may be provided at any location or locations as discussed herein and may be provided at an upper end of the air treatment chamber 340 and/or at the lower end of the air treatment chamber 340.

Optionally, the emptying port 350 is located at a lower end of the upright section 390 and may not be in a wall of the air treatment chamber for example, as exemplified in FIG. 140, the surface cleaning apparatus 300 may include a flexible hose 396 with a removable above floor cleaning wand that forms part of the air flow path. During the dirt emptying mode of operation, air may flow through the flexible hose 396 into the docking unit 500. The emptying port 350 may be provided in the above floor cleaning wand such that during the dirt emptying mode of operation, air flows through the flexible hose 396 and the wand 398 into the docking unit 500. Alternately, such as if an above floor cleaning wand is not provided, the emptying port 350 may be provided in an upflow duct, optionally at or proximate the pivot mount for the upright section 390, e.g., at a similar position as exemplified in FIG. 140. Accordingly, in any such case, the emptying port may be at or below a lower end of the air treatment assembly and/or the suction motor housing.

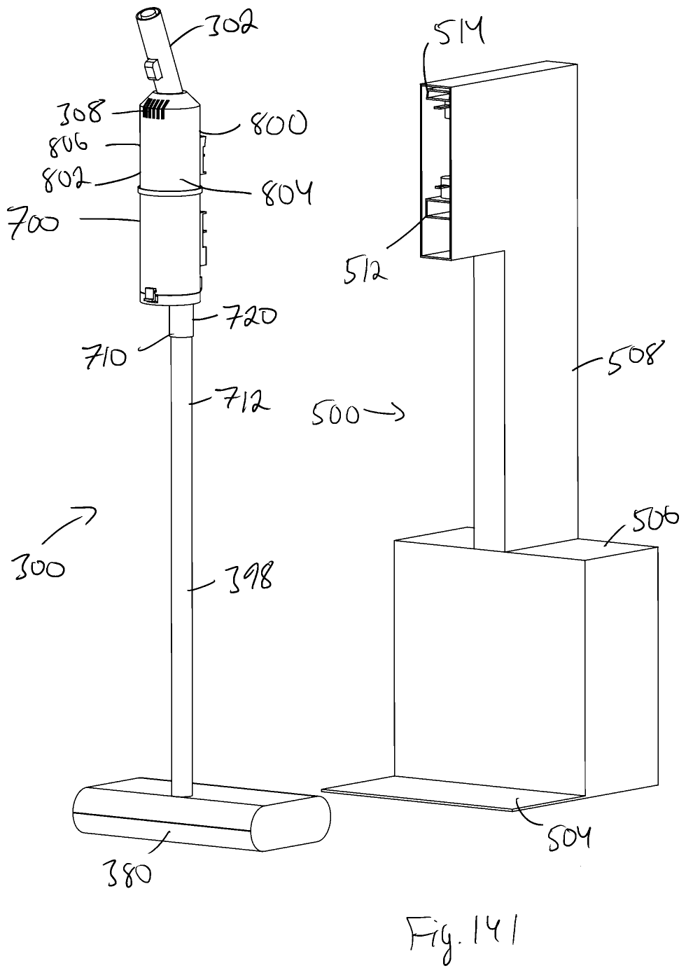

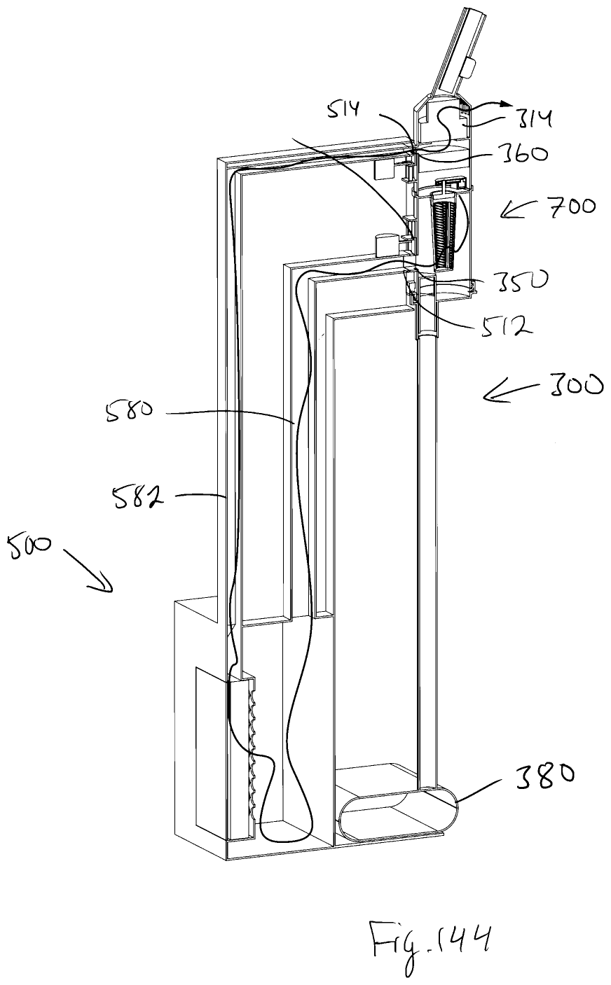

As exemplified in FIGS. 141-144, the surface cleaning apparatus 300 may include a portable cleaning unit 700 that contains the air treatment chamber 340 and the suction motor 314. The portable cleaning unit 700 may be mounted to a mount 710 such that the portable cleaning unit 700 is removable from a remainder 720 of the surface cleaning apparatus 300. The mount 710 may include an upflow duct 712 that is moveable between the upright storage position and the reclined floor cleaning position. The upflow duct 712 may be removably receivable by the mount 710. In some embodiments, the mount 710 may include the emptying port 350.

The above floor cleaning wand 398 may be removably connectable to the mount 710 while the portable cleaning unit 700 remains mounted to the mount 710, such that the portable cleaning unit 700 is removable from the mount while the wand 398 remains connected to the mount 710. In some embodiments, the portable cleaning unit 700 may be removable from the mount 710 with the wand 398.

### Docking Unit for a Stick Vac or a Hand Vacuum Cleaner

In accordance with this aspect, which may be used by itself or in combination with one or more other aspects, a docking unit has a floor base standing unit with a dirt collection chamber and up and down flow ducts that extend upwardly to dock with a surface cleaning unit, such as a hand vacuum cleaner. Accordingly, the docking unit has an inlet port in flow communication with the dirt collection region of a surface cleaning apparatus, connected by a downflow duct and an outlet port in flow communication with the suction motor of the surface cleaning apparatus, connected by an upflow duct. An advantage of this design is that the suction motor of the surface cleaning apparatus may be used to provide the motive force to empty the surface cleaning apparatus into the docking unit.

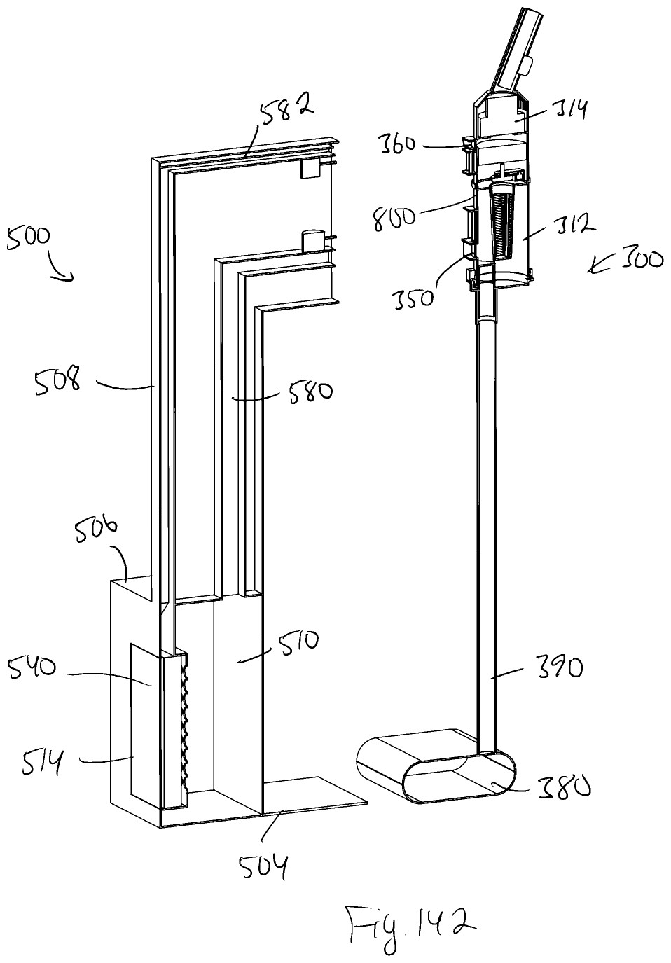

In accordance with this aspect, the docking unit 500 includes a docking unit body 502 and a floor standing base unit 504. The base unit 504 includes the dirt collection region 510. As exemplified in FIG. 142, the docking unit 500 includes a docking unit inlet port 512 that is connectable in flow communication with the dirt collection region 312 of the surface cleaning apparatus 300 and a docking unit outlet port 514 in flow communication with the suction motor 314 of the surface cleaning apparatus 300.

As exemplified in FIGS. 141-144, a downflow duct 580 extends from the docking unit inlet port 512 to the base unit 504 and an upflow duct 582 extends from the base unit 504 to the docking unit outlet port 514. The docking unit air flow path 516 extends from the docking unit inlet port 512 to the docking unit outlet port 514 with the docking unit dirt collection region 510 positioned in the air flow path 516.

When the surface cleaning apparatus 300 is docked at the docking unit 500 and is in the dirt emptying mode of operation, the suction motor 314 may provide the motive force to draw dirt from the dirt collection region 312, through the inlet port 512, down the downflow duct 580 and into the dirt collection region 510. The air then continues through the upflow duct 582, out the outlet port 514, and into the suction motor 314. An advantage of this design is that the docking unit 500 does not need a suction motor to facilitate the dirt emptying mode of operation, thereby simplifying and reducing the cost of manufacturing the docking unit.

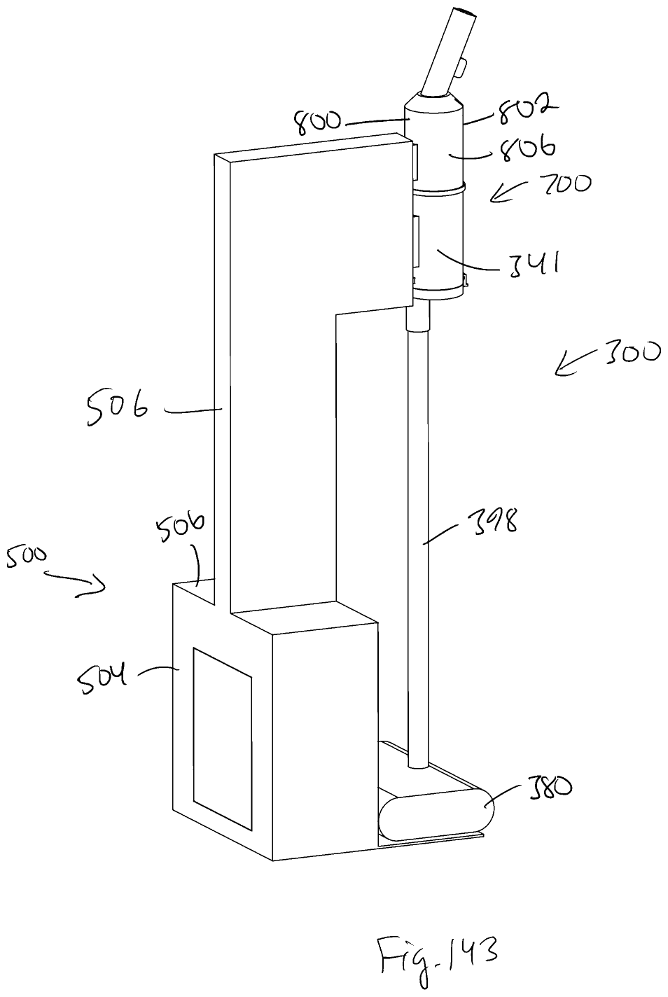

Optionally, as exemplified in FIG. 143, the floor standing base unit 504 may have an upper surface 506. The upper surface 506 may be exposed when the surface cleaning apparatus 300 is docked at the docking unit 500. The downflow duct 580 and the upflow duct 582 may extend above the upper surface 506. For example, the downflow duct 580 and the upflow duct 582 may be located at a periphery of the upper surface 506. As exemplified, the docking unit 500 may include an upper section 508, containing the downflow duct 580 and the upflow duct 582. The upper section 508 may consist essentially of the downflow duct 580 and the upflow duct 582.

Optionally, the docking unit 500 may include a charging unit for the surface cleaning apparatus 300. The charging unit may be positioned in the upper section 508 to facilitate an electronic connection with the energy storage member 332 in the surface cleaning apparatus 300. In such an embodiment, the docking unit may include a plug and a power supply as discussed previously so as to provide DC power to charge the energy storage member(s) of a docked surface cleaning apparatus.

optionally, the upper surface 506 may be openable. For example, the base unit 504 may be used as a garbage can with the openable upper surface 506. When the upper surface 506 is opened, a user may deposit trash in the base unit 504. Accordingly, the docking unit 500 may be used both to empty the surface cleaning apparatus 300 and to contain other waste, simplifying the waste removal process.

In any embodiment, the docking unit 500 may be used to receive a plurality of surface cleaning apparatuses. For example, in some embodiments, the base unit 504 may include a robotic docking unit for a robotic vacuum cleaner. The suction motor 314 may be used to empty both the surface cleaning apparatus 300 and the robotic vacuum cleaner. For example, when both the surface cleaning apparatus 300 and the robotic vacuum cleaner are docked at the docking unit 500, during a dirt emptying mode of operation, a dirt collection region of the robotic vacuum cleaner may be in flow communication with the docking unit dirt collection region 510 and the docking unit dirt collection region 510 may be in flow communication with the suction motor 314 such that the suction motor 314 is operable to empty the robotic vacuum cleaner.

### Evacuation Port in a Sidewall of the Surface Cleaning Apparatus

In accordance with this aspect, which may be used by itself or in combination with one or more other aspects, there is provided a surface cleaning apparatus having an upper side, a lower side, and a right side, with an evacuation port provided in one of the sides for docking with a docking unit. An advantage of this design is that the surface cleaning apparatus may be docked at the docking unit without inserting the surface cleaning apparatus into the docking unit, thereby simplifying the docking and dirt emptying processes.

In accordance with this aspect, a surface cleaning apparatus 300, when the surface cleaning apparatus is oriented horizontally (i.e., rotated 90°) from the docked orientation shown in FIG. 141, has an upper side 800, a lower side 802, a right side 804, and a laterally opposed left side 806 (see FIG. 141). As exemplified in FIG. 142, the dirty air inlet 304 may be positioned at the front end 322 of the surface cleaning apparatus 300. As shown, the surface cleaning apparatus 300 may be a hand vacuum cleaner having a handle 302. The handle 302 may be provided proximate the lower side 802 of the surface cleaning apparatus 300. The handle 302 may be a pistol grip handle.

As exemplified in FIG. 143, the surface cleaning apparatus 300 is dockable with the docking unit 500. To facilitate the dirt emptying mode of operation, the surface cleaning apparatus 300 has at least one dirt evacuation port 350 provided on one of the upper side 800, lower side 802, and the right side 804. Positioning the dirt evacuation port 350 on one of these sides of the surface cleaning apparatus 300 may allow for the surface cleaning apparatus 300 to be more easily docked at the docking unit 500. Optionally, the dirt evacuation port 350 is provided on the upper side 800. An advantage of this positioning is that a user may push the surface cleaning apparatus into the docking unit using the handle without having to turn the surface cleaning apparatus around and backing it into the docking unit.

The surface cleaning apparatus 300 may include a plurality of dirt evacuation ports 350. For example, the surface cleaning apparatus 300 may include a first dirt evacuation port 350a and a second dirt evacuation port 350b. Each dirt evacuation port may be positioned on the upper side 800 of the surface cleaning apparatus 300, such that the surface cleaning apparatus 300 may be docked at the docking unit 500 by moving the surface cleaning apparatus 300 in a forward direction. Accordingly, a user may not need to turn or otherwise manipulate the surface cleaning apparatus 300 to dock at the docking unit 500, thereby simplifying the docking process.

Optionally, one dirt evacuation port 350 may be positioned on one side and another dirt evacuation port 350 may be positioned on another. The variable position of the dirt evacuation ports 350 may allow for more versatile dock designs.

The evacuation port 350 may be any size and/or shape for emptying dirt from the dirt collection region 312 of the surface cleaning apparatus 300. As exemplified in FIG. 143, the air treatment chamber 340 has a longitudinally extending sidewall 341 that is at least partially curved. The dirt evacuation port 350 is also curved and provided in the curved portion of the sidewall.

Optionally, as discussed previously herein, the evacuation port 350 may include an openable door 410 associated with the port 350. The door 410 may be curved and may slide angularly to an open position.

It will be appreciated that the docking unit may include a downflow duct 580 and an upflow duct 582 as previously discussed. In such a case, the surface cleaning apparatus may also have the inlet port 360 that is connectable in flow communication with the upflow duct 582 of the docking unit 500. In such a case, the inlet port 360 may be on the same side as the evacuation port 350.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Clause Set A:

1. A docking unit for emptying first and second dirt collection regions of a surface cleaning apparatus, the surface cleaning apparatus having a motor and fan assembly, the docking unit comprising:
   a) a docking unit dirt collection chamber; and,
   b) a docking unit air flow path extending from a docking unit inlet port to a docking unit outlet port, wherein a docking unit dirt collection chamber is provided in the docking unit dirt air flow path,
      wherein, when at least a portion of the surface cleaning apparatus comprising the first and second dirt collection regions is docked at the docking unit and the docking unit is in a dirt emptying mode of operation, dirt is transferred from the first dirt collection region into the docking unit dirt collection chamber prior to dirt being transferred from the second dirt collection region into the docking unit dirt collection chamber.
2. The docking unit of clause 1 wherein a motor and fan assembly draws air from the first dirt collection region of the surface cleaning apparatus into the docking unit dirt collection chamber prior to drawing air from the second dirt collection region of the surface cleaning apparatus into the docking unit dirt collection chamber.
3. The docking unit of clause 1 wherein the second dirt collection region collects finer dirt than dirt collected in the first dirt collection region.
4. The docking unit of clause 3 wherein the first dirt collection region is part of a first air treatment stage, and the second dirt collection region is part of a downstream second air treatment stage.
5. The docking unit of clause 4 wherein the first air treatment stage comprises a first air treatment chamber and the second air treatment stage comprises a second air treatment chamber.
6. The docking unit of clause 4 wherein the first air treatment stage comprises a first cyclone chamber and the second air treatment stage comprises a second cyclone chamber.
7. The docking unit of clause 3 wherein the first and second dirt collection regions are part of a first air treatment stage.
8. The docking unit of clause 7 wherein the first air treatment stage comprises a first air treatment chamber and the first and second dirt collection regions are in communication with the first air treatment chamber.
9. The docking unit of clause 7 wherein the first air treatment stage comprises a first cyclone chamber and the first and second dirt collection regions are in communication with the first cyclone chamber.
10. The docking unit of clause 1 wherein the docking unit dirt collection chamber comprises a removably filter bag.
11. The docking unit of clause 1 further comprising a filter media positioned downstream of the docking unit dirt collection chamber.
12. The docking unit of clause 1 wherein the docking unit is operable to disinfect the first and second dirt collection regions with a disinfection agent when the at least a portion of the surface cleaning apparatus is docked at the docking unit.
13. The docking unit of clause 12 wherein the docking unit is operable to disinfect the first and second dirt collection regions after the dirt emptying mode of operation.
14. The docking unit of clause 12 wherein the disinfection agent comprises UV light.
15. The docking unit of clause 1 wherein the docking unit outlet port is in air flow communication with the motor and fan assembly of the surface cleaning apparatus whereby the motor and fan assembly of the surface cleaning apparatus is used during the dirt emptying mode of operation.
16. The docking unit of clause 15 wherein the docking unit outlet port is in air flow communication with the surface cleaning apparatus at a location upstream of the motor and fan assembly and downstream of a pre-motor filter of the surface cleaning apparatus.

### Clause Set B:

1. A docking unit for at least a portion of a surface cleaning apparatus comprising a first dirt collection region of the surface cleaning apparatus, wherein the docking unit is operable to disinfect the dirt collection region with a disinfection agent when the at least a portion of the surface cleaning apparatus is docked at the docking unit.
2. The docking unit of clause 1 wherein the docking unit is operable to disinfect the dirt collection region after the dirt collection region has been emptied.
3. The docking unit of clause 1 wherein the disinfection agent comprises UV light.
4. The docking unit of clause 3 wherein the at least a portion of the surface cleaning apparatus has a handle which is transparent to UV light and the UV light is directed into the handle
5. The docking unit of clause 3 wherein the at least a portion of the surface cleaning apparatus comprises a section that is transparent to UV light and the UV light is directed into the interior of the section that is transparent to UV light.
6. The docking unit of clause 3 wherein the section comprises a handle.
7. The docking unit of clause 3 wherein the at least a portion of the surface cleaning apparatus comprises a light pipe for UV light and a section that is transparent to UV light, whereby UV light is projected from the docking unit into the interior of the section that is transparent to UV light.
8. The docking unit of clause 7 wherein the section comprises a handle.
9. The docking unit of clause 3 wherein the docking unit comprises a light pipe for UV light and the at least a portion of the surface cleaning apparatus comprises a section that is transparent to UV light, whereby UV light is projected from the docking unit into the interior of the section that is transparent to UV light.
10. The docking unit of clause 9 wherein the section comprises a handle.
11. The docking unit of clause 2 wherein the docking unit is operable to empty the dirt collection region.
12. The docking unit of clause 11 wherein the disinfection agent comprises UV light.
13. The docking unit of clause 12 wherein the at least a portion of the surface cleaning apparatus has a handle which is transparent to UV light and the UV light is directed into the handle
14. The docking unit of clause 12 wherein the at least a portion of the surface cleaning apparatus comprises a section that is transparent to UV light and the UV light is directed into the interior of the section that is transparent to UV light.
15. The docking unit of clause 12 wherein the section comprises a handle.
16. The docking unit of clause 12 wherein the at least a portion of the surface cleaning apparatus comprises a light pipe for UV light and a section that is transparent to UV light, whereby UV light is projected from the docking unit into the interior of the section that is transparent to UV light.
17. The docking unit of clause 16 wherein the section comprises a handle.
18. The docking unit of clause 12 wherein the docking unit comprises a light pipe for UV light and the at least a portion of the surface cleaning apparatus comprises a section that is transparent to UV light, whereby UV light is projected from the docking unit into the interior of the section that is transparent to UV light.
19. The docking unit of clause 18 wherein the section comprises a handle.
20. The docking unit of clause 1 wherein the docking unit is operable to disinfect an exterior surface of the at least a portion of a surface cleaning apparatus by providing a disinfection agent to an interior of the at least a portion of a surface cleaning apparatus.
21. A docking unit for at least a portion of a surface cleaning apparatus wherein the docking unit is operable to disinfect a portion of the surface cleaning apparatus with a disinfection agent when the portion of the surface cleaning apparatus is docked at the docking unit.
22. The docking unit of clause 21 wherein the portion of a surface cleaning apparatus comprises an exterior surface of the portion of a surface cleaning apparatus.
23. The docking unit of clause 22 wherein the docking unit is operable to disinfect the exterior surface by providing a disinfection agent to an interior of the surface cleaning apparatus.
24. The docking unit of clause 22 wherein the portion of an exterior surface is positionable within the docking unit whereby, when the disinfection agent is provided, the docking unit inhibits the disinfection agent travelling outwardly of the docking unit.
25. The docking unit of clause 24 wherein the disinfection agent is UV light.

### Clause Set C:

1. A surface cleaning apparatus comprising a UV light emitting member that is located interior of the surface cleaning apparatus and is operable to disinfect a portion of an exterior surface of the surface cleaning apparatus wherein the UV light emitting member is activated while the surface cleaning apparatus is docked at a docking unit.
2. The surface cleaning apparatus of clause 1 wherein the portion of an exterior surface comprises a handle of the surface cleaning apparatus.
3. The surface cleaning apparatus of clause 3 wherein the portion of an exterior surface is positionable within a docking unit whereby, when the UV light emitting member is activated, the docking unit inhibits the UV light radiating outwardly of the docking unit.
4. The surface cleaning apparatus of clause 1 further comprising a light pipe whereby the light pipe transmits UV light from the UV light emitting member to a location that is interior of the exterior surface of the surface cleaning apparatus
5. The surface cleaning apparatus of clause 4 wherein the portion of an exterior surface comprises a handle of the surface cleaning apparatus.
6. A surface cleaning apparatus comprising a UV light emitting member and a portion of an exterior surface of the surface cleaning apparatus that is transparent to UV light wherein the UV light emitting member is operable to emit UV light at a location interior of the surface cleaning apparatus whereby, when the UV light emitting member is operated and the portion of an exterior surface is positioned within a docking unit, the portion of an exterior surface of the surface cleaning apparatus is treated with UV light and the docking unit inhibits the UV light radiating outwardly of the docking unit.
7. The surface cleaning apparatus of clause 6 wherein the portion of an exterior surface comprises a handle of the surface cleaning apparatus.
8. The surface cleaning apparatus of clause 6 wherein the UV light emitting member is activated after the surface cleaning apparatus is emptied.
9. The surface cleaning apparatus of clause 6 further comprising a light pipe whereby the light pipe transmits UV light from the UV light emitting member to a location that is interior of the exterior surface of the surface cleaning apparatus.
10. An apparatus comprising a portion of an exterior surface of a surface cleaning apparatus that is transparent to UV light, a UV light emitting member and a light pipe whereby, when the UV light emitting member is activated, the light pipe transmits UV light from the UV light emitting member to a location that is interior of the exterior surface of the surface cleaning apparatus whereby, when the UV light emitting member is operated, the portion of an exterior surface of the surface cleaning apparatus is treated with UV light.
11. The apparatus of clause 10 wherein the portion of an exterior surface comprises a handle of the surface cleaning apparatus.
12. The apparatus of clause 10 wherein the UV light emitting member is located in the surface cleaning apparatus.
13. The apparatus of clause 10 wherein the UV light emitting member is located in a docking unit for the surface cleaning apparatus.

### Clause Set D:

1. A surface cleaning apparatus comprising:
   a) an air flow path from a dirty air inlet to a clean air outlet; and,
   b) an air treatment chamber positioned in the air flow path, the air treatment chamber having a first end, an opposed second end, an air treatment chamber air inlet and an air treatment chamber air outlet, the air treatment chamber air outlet is provided at the outlet end,
   c) a suction motor positioned in the air flow path downstream of the air treatment chamber air outlet and upstream of the clean air outlet wherein a downstream part of the air flow path extends between the air treatment chamber air outlet and a suction motor air inlet,
      wherein the surface cleaning apparatus is operable in a cleaning mode in which air to be treated enters the surface cleaning apparatus from the dirty air inlet, the air then enters the air treatment chamber and exits the air treatment chamber though the air treatment chamber air outlet, passes through the downstream part of the air flow path to the suction motor and subsequently exits the surface cleaning apparatus by the clean air outlet and
      wherein, during a dirt emptying mode of operation, at least a portion of the downstream part of the air flow path is closed and an evacuation air inlet port is opened whereby air is inhibited from travelling to the suction motor air inlet and an evacuation air inlet port is opened whereby air travels from the evacuation air inlet port through a dirt evacuation port to a docking unit.
2. The surface cleaning apparatus of clause 1 wherein, during a dirt emptying mode of operation, air travels from the opposed second end to the dirt evacuation port.
3. The surface cleaning apparatus of clause 1 wherein, during a dirt emptying mode of operation, air travels through all of the air treatment chamber to the dirt evacuation port.
4. The surface cleaning apparatus of clause 2 wherein the dirt evacuation port is provided at the first end of the air treatment chamber.
5. The surface cleaning apparatus of clause 2 wherein the first end comprises a first end wall and the dirt evacuation port is provided in the first end wall.
6. The surface cleaning apparatus of clause 2 wherein the dirt evacuation port is provided in a sidewall of the air treatment chamber at the first end.
7. The surface cleaning apparatus of clause 2 wherein the first end comprises a first end wall and the dirt evacuation port is provided in a sidewall of the air treatment chamber at the first end wall.
8. The surface cleaning apparatus of clause 4 wherein the evacuation air inlet port is provided at the opposed second end.
9. The surface cleaning apparatus of clause 4 wherein the second opposed end comprises a second end wall and the evacuation air inlet port is provided in a sidewall of the air treatment chamber at the second end wall.
10. The surface cleaning apparatus of clause 9 wherein the evacuation air inlet port, when open, communicates directly with the ambient.
11. The surface cleaning apparatus of clause 4 further comprising a pre-motor filter having a pre-motor filter header and the evacuation air inlet port is provided in the pre-motor filter header.
12. The surface cleaning apparatus of clause 1 further comprising a pre-motor filter having a pre-motor filter header and the evacuation air inlet port is provided in the pre-motor filter header.
13. The surface cleaning apparatus of clause 12 wherein the dirt evacuation port is provided at the first end of the air treatment chamber.
14. The surface cleaning apparatus of clause 1 wherein the second opposed end comprises a second end wall and the evacuation air inlet port is provided in a sidewall of the air treatment chamber at the second end wall.
15. The surface cleaning apparatus of clause 14 wherein the evacuation air inlet port, when open, communicates directly with the ambient.
16. The surface cleaning apparatus of clause 1 wherein the evacuation air inlet port, when open, communicates directly with the ambient.
17. The surface cleaning apparatus of clause 1 wherein the suction motor provides air flow during the dirt emptying mode of operation.
18. The surface cleaning apparatus of clause 17 wherein the suction motor is operated in a first direction in the cleaning mode and in a reverse direction during the dirt emptying mode of operation.
19. The surface cleaning apparatus of clause 17 wherein exhaust air from the suction motor provides air flow during the dirt emptying mode of operation.
20. The surface cleaning apparatus of clause 19 wherein, a when the surface cleaning apparatus is docked at a docking unit, air passes through a conduit from the clean air outlet to the evacuation air inlet port.

### Clause Set E:

1. A surface cleaning apparatus comprising:
   a) an air flow path from a dirty air inlet to a clean air outlet; and,
   b) an air treatment chamber positioned in the air flow path, the air treatment chamber having an air treatment chamber air inlet and an air treatment chamber air outlet, the air treatment chamber air outlet comprises a porous member, that extends into the air treatment chamber from a wall of the air treatment chamber, the porous member has an outlet end that is located at the wall, an opposed inner end and a porous section, the porous member has a moveable portion that is moveable to an open position,
      wherein the surface cleaning apparatus is operable in a cleaning mode in which air to be treated enters the surface cleaning apparatus from the dirty air inlet, the air then enters the air treatment chamber and exits the air treatment chamber though the porous member and subsequently exits the surface cleaning apparatus by the clean air outlet and
      wherein, during a dirt emptying mode of operation, a flow of air enters the air treatment chamber through the porous member and, during at least a portion of the dirt emptying mode of operation, the moveable portion is in the open position whereby at least some of the flow of air exits the porous member without passing through the porous section of the porous member.
2. The surface cleaning apparatus of clause 1 wherein the porous member comprises a screen.
3. The surface cleaning apparatus of clause 1 wherein the moveable portion comprises the opposed inner end of the porous member.
4. The surface cleaning apparatus of clause 1 wherein, during all of the dirt emptying mode of operation, the moveable portion is in the open position.
5. The surface cleaning apparatus of clause 1 wherein the air treatment chamber is opened during the dirt emptying mode of operation and the moveable portion is moved to the open position concurrently when the air treatment chamber is opened.
6. The surface cleaning apparatus of clause 5 wherein the air treatment chamber has an openable end that faces towards the porous member.
7. The surface cleaning apparatus of clause 6 wherein the openable end is mechanically linked to the porous member.
8. The surface cleaning apparatus of clause 1 wherein the air treatment chamber has an openable end that faces towards the porous member.
9. The surface cleaning apparatus of clause 1 wherein during a first part of the dirt emptying mode of operation, the moveable portion is in a closed position and during a subsequent part of the dirt emptying mode of operation, the moveable portion is in the open position.
10. The surface cleaning apparatus of clause 9 wherein during the first part of the dirt emptying mode of operation, a first level of power is provided to a motor and fan assembly that produces the flow of air and during the subsequent part of the dirt emptying mode of operation a second level of power is provided to a motor and fan assembly, wherein the second level of power is lower than the first level of power.
11. The surface cleaning apparatus of clause 9 wherein during the first part of the dirt emptying mode of operation, a first level of power is provided to a motor and fan assembly that produces the flow of air and during the subsequent part of the dirt emptying mode of operation a second level of power is provided to a motor and fan assembly, wherein the second level of power is higher than the first level of power.
12. The surface cleaning apparatus of clause 1 wherein during the dirt emptying mode of operation, a first level of power is provided to a motor and fan assembly that produces the flow of air when the moveable portion is in a closed position and a second level of power is provided to a motor and fan assembly when the moveable portion is in the open position, wherein the second level of power is lower than the first level of power.
13. The surface cleaning apparatus of clause 1 wherein during the dirt emptying mode of operation, a first level of power is provided to a motor and fan assembly that produces the flow of air when the moveable portion is in a closed position and a second level of power is provided to a motor and fan assembly when the moveable portion is in the open position, wherein the second level of power is higher than the first level of power.
14. The surface cleaning apparatus of clause 1 wherein, during at least a portion of the dirt emptying mode of operation, an agitator engages the porous member.
15. The surface cleaning apparatus of clause 1 wherein the air treatment chamber air inlet is provided at a first end of the air treatment chamber and the wall is at an axially opposed end of the air treatment chamber and the porous member extends axially into the air treatment chamber.
16. The surface cleaning apparatus of clause 15 wherein the first end of the air treatment chamber is openable, and a linking rod extends between the first end of the air treatment chamber and the moveable portion whereby the moveable portion is moved to the open position concurrently when the air treatment chamber is opened.
17. The surface cleaning apparatus of clause 16 wherein the moveable portion is the axial inner end of the porous member.
18. The surface cleaning apparatus of clause 1 wherein a front end wall of the air treatment chamber is opened when the surface cleaning apparatus is docked at a docking unit.
19. The surface cleaning apparatus of clause 1 wherein a sidewall of the air treatment chamber is opened when the surface cleaning apparatus is docked at a docking unit.

### Clause Set F:

1. A surface cleaning apparatus comprising:
   a) a surface cleaning head having a dirty air inlet;
   b) an upright section that is mounted to the surface cleaning head and is moveable between an upright storage position and a reclines floor cleaning position;
   c) an air flow path extending from the dirty air inlet to a clean air outlet;
   d) an air treatment chamber positioned in the air flow path, the air treatment chamber having an air treatment chamber air inlet, an air treatment chamber air outlet and an emptying port; and,
   e) a suction motor provided in the air flow path,
      wherein, when the surface cleaning apparatus is docked at a docking unit and is in a dirt emptying mode of operation, the emptying port is in flow communication with a dirt collection region of the docking unit and a flow of air enters the air treatment chamber through the dirty air inlet and exits through the emptying port.
2. The surface cleaning apparatus of clause 1 wherein the emptying port is provided in a sidewall of the air treatment chamber.
3. The surface cleaning apparatus of clause 1 wherein, when the upright section is in the upright storage position, the air treatment chamber air inlet is provided at a lower end of the air treatment chamber and the emptying port is provided at an upper end of the air treatment chamber.
4. The surface cleaning apparatus of clause 1 wherein, when the upright section is in the upright storage position, the air treatment chamber air inlet is provided at a lower end of the air treatment chamber and the emptying port is provided at the lower end of the air treatment chamber.
5. The surface cleaning apparatus of clause 1 wherein, when the upright section is in the upright storage position, the air treatment chamber air inlet is provided at a lower end of the air treatment chamber and the emptying port comprises a first port that is provided at the lower end of the air treatment chamber and a second port that is provided at an upper end of the air treatment chamber.
6. The surface cleaning apparatus of clause 1 wherein, when the surface cleaning apparatus is docked at a docking unit and is in the dirt emptying mode of operation, an air outlet of the docking unit is in fluid flow communication with the surface cleaning apparatus at a location that is upstream of the suction motor whereby the suction motor is operated during the dirt emptying mode of operation.
7. The surface cleaning apparatus of clause 6 further comprising a pre-motor filter and, when the surface cleaning apparatus is docked at a docking unit and is in the dirt emptying mode of operation, an air outlet of the docking unit is in fluid flow communication with the surface cleaning apparatus at a location that is upstream of the pre-motor filter.
8. The surface cleaning apparatus of clause 1 wherein, when the surface cleaning apparatus is docked at a docking unit and is in the dirt emptying mode of operation, an air outlet of the docking unit is in fluid flow communication with the surface cleaning apparatus at a location that is upstream of the suction motor whereby the suction motor is operable to produce the flow of air.
9. The surface cleaning apparatus of clause 9 further comprising a pre-motor filter and, when the surface cleaning apparatus is docked at a docking unit and is in the dirt emptying mode of operation, an air outlet of the docking unit is in fluid flow communication with the surface cleaning apparatus at a location that is upstream of the pre-motor filter.

### Clause Set G:

1. A surface cleaning apparatus comprising:
   a) an air flow path extending from a dirty air inlet to a clean air outlet;
   b) an air treatment chamber positioned in the air flow path, the air treatment chamber having an air treatment chamber air inlet, an air treatment chamber air outlet and a closure flap associated with the air treatment chamber air inlet, the closure flap is moveable between a closed position in which the air treatment chamber air inlet is closed and an open position wherein, during a surface cleaning mode of operation, the closure flap is open; and,
   c) a suction motor provided in the air flow path,
   d) wherein, when the surface cleaning apparatus is docked at a docking unit and is in a dirt emptying mode of operation, the air treatment chamber air inlet is in flow communication with a dirt collection region of the docking unit and the closure flap is in the open position whereby a flow of air enters travels through the air treatment chamber air inlet to the docking unit.
2. The surface cleaning apparatus of clause 1 wherein the closure flap is moved to the open position as the surface cleaning apparatus is docked at the docking unit.
3. The surface cleaning apparatus of clause 1 wherein the docking unit has a drive member that mechanically engages the surface cleaning apparatus when the surface cleaning apparatus is docked at the docking unit whereby the closure flap is driven to the open position.
4. The surface cleaning apparatus of clause 1 wherein the docking unit has a drive member that mechanically engages the closure flap when the surface cleaning apparatus is docked at the docking unit whereby the closure flap is driven to the open position.
5. The surface cleaning apparatus of clause 1 wherein the docking unit has a drive member that engages the surface cleaning apparatus when the surface cleaning apparatus is docked at the docking unit whereby the closure flap is driven to the open position.
6. The surface cleaning apparatus of clause 1 wherein the closure flap is moved to the open position when the dirt emptying mode of operation is actuated.
7. The surface cleaning apparatus of clause 1 wherein an actuator actuates the dirt emptying mode of operation and the actuator is operatively connected to the closure flap whereby the closure flap is driven to the open position when the actuator actuates the dirt emptying mode of operation.
8. The surface cleaning apparatus of clause 7 wherein the actuator is operatively connected to a solenoid that is operatively connected to the closure flap and the solenoid is actuated to move the closure flap to the open position when the actuator actuates the dirt emptying mode of operation.
9. The surface cleaning apparatus of clause 1 wherein an actuator actuates the dirt emptying mode of operation and the actuator is drivingly connected to the closure flap whereby the closure flap is driven to the open position when the actuator actuates the dirt emptying mode of operation.
10. The surface cleaning apparatus of clause 9 wherein a mechanical linkage extends between the actuator and the closure flap.
11. The surface cleaning apparatus of clause 1 wherein, when the surface cleaning apparatus is docked at the docking unit, the air treatment chamber air inlet is provided at a lower end of the air treatment chamber.

### Clause Set H:

1. A surface cleaning apparatus comprising:
   a) an air flow path extending from a dirty air inlet to a clean air outlet;
   b) an air treatment chamber positioned in the air flow path, the air treatment chamber having an air treatment chamber air inlet, an air treatment chamber air outlet, a first end, an axially opposed second end, a sidewall extending between the first and second ends, a dirt evacuation port and a first evacuation air inlet port, wherein each of the evacuation port and the first evacuation air inlet port has an openable door and the openable door of the first evacuation air inlet port is part of the sidewall; and,
   c) a suction motor provided in the air flow path,
      wherein, when the surface cleaning apparatus is docked at a docking unit and is in a dirt emptying mode of operation, the openable door of the first evacuation air inlet port is opened, and the dirt evacuation port is in flow communication with a dirt collection region of the docking unit whereby air enters the air treatment chamber via the first evacuation air inlet port and exits the air treatment chamber via the dirt evacuation port.
2. The surface cleaning apparatus of clause 1 further comprising a closure flap associated with the air treatment chamber air inlet, the closure flap is moveable between a closed position in which the air treatment chamber air inlet is closed and an open position wherein, during a surface cleaning mode of operation, the closure flap is open and during at least a portion of the dirt emptying mode of operation, the closure flap is closed.
3. The surface cleaning apparatus of clause 2 wherein, during at least a portion of the dirt emptying mode of operation, the closure flap is open.
4. The surface cleaning apparatus of clause 1 wherein, during at least a portion of the dirt emptying mode of operation, the air treatment chamber air outlet is at least partially closed.
5. The surface cleaning apparatus of clause 2 wherein, during at least a portion of the dirt emptying mode of operation, the air treatment chamber air outlet is closed.
6. The surface cleaning apparatus of clause 3 wherein, during at least a portion of the dirt emptying mode of operation when the closure flap is open, the first evacuation air inlet port is closed.
7. The surface cleaning apparatus of clause 2 wherein the first evacuation air inlet port is located distal to the air treatment chamber air inlet.
8. The surface cleaning apparatus of clause 2 wherein the air treatment chamber air inlet is located at the first end of the air treatment chamber and the first evacuation air inlet port is located at the second end of the air treatment chamber.
9. The surface cleaning apparatus of clause 1 wherein the air treatment chamber further comprises a second evacuation air inlet port.
10. The surface cleaning apparatus of clause 9 wherein the second evacuation air inlet port is openable while the first evacuation air inlet port is closed.
11. The surface cleaning apparatus of clause 2 wherein, during a first portion of the dirt emptying mode of operation, the closure flap is closed and the first evacuation air inlet port is open and, during a second portion of the dirt emptying mode of operation, the closure flap is open and the first evacuation air inlet port is closed.
12. The surface cleaning apparatus of clause 2 wherein, during the dirt emptying mode of operation, at least one of the closure flap and the first evacuation air inlet port cycles open and closed more than once.
13. The surface cleaning apparatus of clause 1 wherein, during a first portion of the dirt emptying mode of operation, the air treatment chamber air outlet is closed and the first evacuation air inlet port is open and, during a second portion of the dirt emptying mode of operation, the air treatment chamber air outlet is open and the first evacuation air inlet port is closed.
14. A surface cleaning apparatus comprising:
   a) an air flow path extending from a dirty air inlet to a clean air outlet;
   b) an air treatment chamber positioned in the air flow path, the air treatment chamber having an air treatment chamber air inlet, an air treatment chamber air outlet, a first end, an axially opposed second end, a sidewall extending between the first and second ends and a dirt evacuation port; and,
   c) a suction motor provided in the air flow path,
      wherein, when the surface cleaning apparatus is docked at a docking unit, the surface cleaning apparatus is operable in a dirt emptying mode of operation, and
      wherein, during a first portion of the dirt emptying mode of operation, the air treatment chamber air outlet is closed and the air treatment chamber air inlet is open whereby air enters the air treatment chamber via the air treatment chamber air inlet and exits the air treatment chamber via the dirt evacuation port and, during a second portion of the dirt emptying mode of operation, the air treatment chamber air outlet is open and the air treatment chamber air inlet is closed whereby air enters the air treatment chamber via the air treatment chamber air outlet and exits the air treatment chamber via the dirt evacuation port.
15. The surface cleaning apparatus of clause 14 wherein, during the dirt emptying mode of operation, at least one of the air treatment chamber air inlet and the air treatment chamber air outlet cycles open and closed more than once.
16. A surface cleaning apparatus comprising:
   a) an air flow path extending from a dirty air inlet to a clean air outlet;
   b) an air treatment chamber positioned in the air flow path, the air treatment chamber having an air treatment chamber air inlet, an air treatment chamber air outlet, a first end, an axially opposed second end, a sidewall extending between the first and second ends, a dirt evacuation port and a first evacuation air inlet port; and,
   c) a suction motor provided in the air flow path,
      wherein, when the surface cleaning apparatus is docked at a docking unit, the surface cleaning apparatus is operable in a dirt emptying mode of operation, and
      wherein at least two of the air treatment chamber air inlet, the air treatment chamber air outlet and the first evacuation air inlet port are operable to vary a direction of air flow through the air treatment chamber during the dirt emptying mode of operation.
17. The surface cleaning apparatus of clause 16 wherein, during the dirt emptying mode of operation, at least one of the air treatment chamber air inlet, the air treatment chamber air outlet and the first evacuation air inlet port cycles open and closed more than once.
18. The surface cleaning apparatus of clause 16 wherein, during a first portion of the dirt emptying mode of operation, the air treatment chamber air outlet is closed and the air treatment chamber air inlet is open whereby air enters the air treatment chamber via the air treatment chamber air inlet and exits the air treatment chamber via the dirt evacuation port and, during a second portion of the dirt emptying mode of operation, the air treatment chamber air outlet is open and the air treatment chamber air inlet is closed whereby air enters the air treatment chamber via the air treatment chamber air outlet and exits the air treatment chamber via the dirt evacuation port.
19. A surface cleaning apparatus comprising:
   a) an air flow path extending from a dirty air inlet to a clean air outlet;
   b) an air treatment chamber positioned in the air flow path, the air treatment chamber having an air treatment chamber air inlet, an air treatment chamber air outlet, a first end, an axially opposed second end, a sidewall extending between the first and second ends, a dirt evacuation port a first evacuation air inlet port and a second evacuation air inlet port; and,
   c) a suction motor provided in the air flow path,
      wherein, when the surface cleaning apparatus is docked at a docking unit, the surface cleaning apparatus is operable in a dirt emptying mode of operation, and
      wherein the first and second evacuation air inlet ports are operable to vary a direction of air flow through the air treatment chamber during the dirt emptying mode of operation.
20. The surface cleaning apparatus of clause 18 wherein, during the dirt emptying mode of operation, the second evacuation air inlet port is openable while the first evacuation air inlet port is closed.
21. The surface cleaning apparatus of clause 19 wherein, during the dirt emptying mode of operation, the air treatment chamber air inlet and the air treatment chamber air outlet are closed.

### Clause Set I:

1. A docking unit for a surface cleaning apparatus, the docking unit comprising an emptying air flow path that extends from an inlet port that is connectable with a surface cleaning apparatus emptying port to an air outlet port, wherein a suction motor is positioned in the air flow path wherein, during a surface cleaning apparatus emptying operation, air flow through the emptying air flow path is varied.
2. The docking unit of clause 1 wherein, during the surface cleaning apparatus emptying operation, a power level provided to the suction motor is varied.
3. The docking unit of clause 2 wherein, during the surface cleaning apparatus emptying operation, the suction motor is repeated cycled on and off.
4. The docking unit of clause 3 wherein the suction motor is deenergized for up to three second prior to being re-energized.
5. The docking unit of clause 2 wherein, during the surface cleaning apparatus emptying operation, power is supplied to the suction motor using pulse width modulation.
6. The docking unit of clause 1 wherein, during the surface cleaning apparatus emptying operation, air flow through the emptying air flow path is pulsed on and off.
7. The docking unit of clause 1 wherein, during the surface cleaning apparatus emptying operation, the emptying air flow path is cycled between at least a partially closed position and an open position.
8. The docking unit of clause 1 wherein, a valve is provided in the emptying air flow path and the valve is repeated at least partially closed during the surface cleaning apparatus emptying operation.
9. The docking unit of clause 1 wherein the valve is associated with the inlet port.
10. A surface cleaning apparatus that is dockable with a docking unit wherein, when the surface cleaning apparatus is docked with the docking unit, an emptying air flow path is provided whereby air flow through the emptying air flow path during a surface cleaning apparatus emptying operation empties a dirt collection region of the surface cleaning apparatus, wherein, during the surface cleaning apparatus emptying operation, air flow through the emptying air flow path is varied
11. The surface cleaning apparatus of clause 10 wherein, during the surface cleaning apparatus emptying operation, a power level provided to the suction motor is varied.
12. The surface cleaning apparatus of clause 11 wherein, during the surface cleaning apparatus emptying operation, the suction motor is repeated cycled on and off.
13. The surface cleaning apparatus of clause 12 wherein the suction motor is deenergized for up to three second prior to being re-energized.
14. The surface cleaning apparatus of clause 11 wherein, during the surface cleaning apparatus emptying operation, power is supplied to the suction motor using pulse width modulation.
15. The surface cleaning apparatus of clause 10 wherein, during the surface cleaning apparatus emptying operation, air flow through the emptying air flow path is pulsed on and off.
16. The surface cleaning apparatus of clause 10 wherein, during the surface cleaning apparatus emptying operation, the emptying air flow path is cycled between at least a partially closed position and an open position.
17. The surface cleaning apparatus of clause 10 wherein a valve is provided in the emptying air flow path and the valve is repeated at least partially closed during the surface cleaning apparatus emptying operation.
18. The surface cleaning apparatus of clause 10 wherein the valve is associated with the inlet port.
19. The surface cleaning apparatus of clause 10 wherein first and second valves are provided in the emptying air flow path, the first valve is provided at a first location in the surface cleaning apparatus and the second valve is provided at a second location in the surface cleaning apparatus wherein, during the surface cleaning apparatus emptying operation the first valve is opened and the second valve is repeatedly at least partially closed.
20. The surface cleaning apparatus of clause 10 wherein the first valve is associated with an inlet to a pre-motor filter housing and the second valve is associated with an inlet to an air treatment chamber.

### Clause Set J:

1. A docking unit for a surface cleaning apparatus, the surface cleaning apparatus comprising a first air inlet port and a first air inlet port valve, the first air inlet port valve is moveable between an open position in which the first air inlet port is open and a closed position in which the first air inlet port is closed, the docking unit comprising:
   a) an emptying air flow path that extends from a docking unit air inlet port, which is connectable with a surface cleaning apparatus emptying port, to a docking unit air outlet port; and,
   b) a first inlet port actuator wherein, when the surface cleaning apparatus is docked with the docking unit, the first inlet port actuator is driving connected to the first inlet port valve,
      wherein, during a surface cleaning apparatus emptying operation when the surface cleaning apparatus is docked with the docking unit, a suction motor is positioned in the air flow path and the suction motor is drivingly connected to the first inlet port actuator whereby, when the suction motor is actuated, the first inlet port actuator is actuated and the first inlet port valve is moved to the open position.
2. The docking unit of clause 1 wherein the suction motor is pneumatically connected to the first inlet port actuator.
3. The docking unit of clause 2 wherein the first inlet port actuator comprises a bellows.
4. The docking unit of clause 1 wherein the suction motor is provided in the docking unit.
5. The docking unit of clause 1 wherein the suction motor is provided in the surface cleaning apparatus.
6. The docking unit of clause 2 wherein the first inlet port valve is slideably moveable between the open position and the closed position.
7. The docking unit of clause 6 wherein the first inlet port valve is a gate valve.
8. The docking unit of clause 1 wherein, when the suction motor is deenergized, the first inlet port valve is moved to the closed position.
9. The docking unit of clause 8 wherein the first inlet port valve is biased to the closed position.
10. The docking unit of clause 8 wherein the first inlet port actuator drives the first inlet port valve and is moved to the closed position when the suction motor is deenergized.
11. The docking unit of clause 1 wherein the surface cleaning apparatus further comprises a second air inlet port and a second air inlet port valve, the second air inlet port valve is moveable between an open position in which the second air inlet port is open and a closed position in which the second air inlet port is closed and during the surface cleaning apparatus emptying operation when the surface cleaning apparatus is docked with the docking unit, the suction motor is drivingly connected to the second inlet port valve whereby, when the suction motor is actuated, the second inlet port valve is moved to the open position.
12. The docking unit of clause 11 wherein the docking unit further comprises a second inlet port actuator that is driving connected to the second air inlet port valve.
13. The docking unit of clause 11 wherein the first inlet port actuator is also driving connected to the second air inlet port valve.
14. The docking unit of clause 13 wherein the first inlet port actuator sequentially opens the first air inlet port and then the second air inlet port.
15. The docking unit of clause 14 wherein, during the surface cleaning apparatus emptying operation:
   a) the suction motor is actuated a first time and the first inlet port actuator opens the first air inlet port;
   b) the suction motor is deenergized; and
   c) the suction motor is actuated a second time and the first inlet port actuator opens the second air inlet port.
16. The docking unit of clause 15 wherein, when the suction motor is actuated the second time, the first inlet port actuator closes the first air inlet port.
17. The docking unit of clause 15 wherein, the first inlet port valve comprises a first sliding valve, the second inlet port valve comprises a second sliding valve and the first and second inlet port actuators comprise a single common actuator and, when the surface cleaning apparatus is docked with the docking unit, the common actuator is driving connected to the first sliding valve and the second sliding valve, the common actuator is moveable between a first position in which the first and second air inlet ports are closed, a second position in which the first air inlet port is open and the second air inlet port is closed and a third position in which the first air inlet port is closed and the second air inlet port is open.
18. The docking unit of clause 15 wherein, the first inlet port valve comprises a first sliding valve, the second inlet port valve comprises a second sliding valve and the first and second inlet port actuators comprise a single common actuator and, when the surface cleaning apparatus is docked with the docking unit, the common actuator is driving connected to the first sliding valve and the second sliding valve, the common actuator is moveable between a first position in which the first and second air inlet ports are closed, a second position in which the first air inlet port is open and the second air inlet port is closed and a third position in which the first and second air inlet ports are open.
19. The docking unit of clause 15 wherein the first air inlet port valve and the second air inlet port valve are part of a sliding valve, the sliding valve has a ratchet thereon, the first and second inlet port actuators comprise a single common actuator, and the common actuator comprises a ratchet engaging member.
20. The docking unit of clause 19 wherein the common actuator comprises a bellows.

### Clause Set K:

1. A surface cleaning apparatus comprising:
   a) an air treatment assembly comprising an air treatment chamber and a dirt collection chamber external to the air treatment chamber, the air treatment assembly having a first end comprising a first end wall and a second end comprising a second end wall with a longitudinal axis that extends between the first and second end walls, wherein the first end of the air treatment assembly is openable;
   b) the air treatment chamber having a dirt outlet in communication with the dirt collection chamber, a first end and a second end wherein the longitudinal axis extends between the first and second ends of the air treatment chamber;
   c) a plate provided at the first end of the air treatment chamber, the plate is spaced from and faces the first end wall of the air treatment assembly whereby at least a portion of the dirt collection chamber is positioned between the first end wall of the air treatment assembly and the plate, the plate having a first portion and a second portion that is moveable with respect to the first portion; and,
   d) the dirt outlet comprises a space between the plate and a sidewall of the air treatment chamber,
   wherein the second portion of the plate is openable while the first portion of the plate remains stationary.
2. The surface cleaning apparatus of clause 1 wherein the second portion of the plate is openable when the first end of the air treatment assembly is opened.
3. The surface cleaning apparatus of clause 1 wherein the second portion of the plate and the first end of the air treatment assembly are concurrently openable.
4. The surface cleaning apparatus of clause 1 wherein the first end of the air treatment assembly has a larger cross-sectional area in a plane transverse to the longitudinal axis than a cross-sectional area of the second portion of the plate in the plane transverse to the longitudinal axis.
5. The surface cleaning apparatus of clause 1 wherein the first portion of the plate has an open portion, and the second portion of the plate closes the open portion when the second portion of the plate is in a closed position.
6. The surface cleaning apparatus of clause 5 wherein the open portion comprises an interior opening.
7. The surface cleaning apparatus of clause 5 wherein the first and second portions of the plate define a generally continuous planer surface when the plate second portion of the plate is in the closed position.
8. The surface cleaning apparatus of clause 7 wherein the first portion of the plate has a dirt chamber face, and the second portion of the plate abuts the dirt chamber face when the second portion of the plate is in the closed position.
9. The surface cleaning apparatus of clause 1 wherein the first portion of the plate is also openable.
10. The surface cleaning apparatus of clause 9 wherein the first and second portions of the plate are concurrently openable.
11. The surface cleaning apparatus of clause 1 wherein the air treatment chamber has an air treatment chamber air outlet at the second end of the air treatment chamber.
12. A surface cleaning apparatus comprising:
   a) an air treatment assembly comprising an air treatment chamber and a dirt collection chamber external to the air treatment chamber, the air treatment chamber having a first end comprising a first end wall and a second end comprising a second end wall with a longitudinal axis that extends between the first and second end walls, wherein the first end of the air treatment assembly is moveably mounted between a closed position and an open position;
   b) the air treatment chamber having a dirt outlet in communication with the dirt collection chamber, a first end and a second end wherein the longitudinal axis extends between the first and second ends of the air treatment chamber;
   c) a plate provided at the first end of the air treatment chamber, the plate is spaced from and faces the first end wall of the air treatment assembly whereby at least a portion of the dirt collection chamber is positioned between the first end wall of the air treatment assembly and the plate, wherein the plate is moveably mounted between a closed position and an open position; and,
   d) the dirt outlet comprises a space between the plate and a sidewall of the air treatment chamber,
   wherein a mount for the plate is positioned radially inwardly in a direction transverse to the longitudinal axis than a mount for the first end of the air treatment assembly.
13. The surface cleaning apparatus of clause 12 wherein the first end of the air treatment assembly has a larger cross-sectional area in a plane transverse to the longitudinal axis than a cross-sectional area of the plate in the plane transverse to the longitudinal axis.
14. A docking unit and a surface cleaning apparatus dockable with the docking unit, the surface cleaning apparatus comprising:
   a) an air treatment assembly comprising an air treatment chamber and a dirt collection chamber external to the air treatment chamber, the air treatment chamber having a first end comprising a first end wall and a second end comprising a second end wall with a longitudinal axis that extends between the first and second end walls, wherein the first end of the air treatment assembly is moveably mounted between a closed position and an open position;
   b) the air treatment chamber having a dirt outlet in communication with the dirt collection chamber, a first end and a second end wherein the longitudinal axis extends between the first and second ends of the air treatment chamber;
   c) a plate provided at the first end of the air treatment chamber, the plate is spaced from and faces the first end wall of the air treatment assembly whereby at least a portion of the dirt collection chamber is positioned between the first end wall of the air treatment assembly and the plate, wherein the plate is moveably mounted between a closed position and an open position;
   d) the dirt outlet comprises a space between the plate and a sidewall of the air treatment chamber,
   wherein the docking unit has a docking port and the first end of the air treatment assembly interfaces with the docking port when the air treatment assembly docks with the docking unit, and
      wherein at least one of the first end of the air treatment assembly and the docking port has a first flexible sealing member, the first flexible sealing member has a diameter in a plane transverse to the longitudinal axis that is greater than a diameter of the first end wall in the plane transverse to the longitudinal axis whereby the first end wall of the air treatment assembly is positioned inwardly of the first flexible sealing member when the air treatment assembly is docked with the docking unit.
15. The surface cleaning apparatus of clause 14 wherein the docking port has the first flexible sealing member.
16. The surface cleaning apparatus of clause 14 wherein the docking port has the first flexible sealing member, and the first end of the air treatment assembly has a second flexible sealing member.
17. The surface cleaning apparatus of clause 16 wherein the first flexible sealing member and the second flexible sealing member comprise male and female inter-engageable sealing members.

### Clause Set L:

1. A docking unit and a surface cleaning apparatus dockable with the docking unit, the surface cleaning apparatus comprising:
   a) an air treatment assembly comprising an air treatment chamber and a dirt collection chamber external to the air treatment chamber, the air treatment chamber having a first end comprising a first end wall and a second end comprising a second end wall with a longitudinal axis that extends between the first and second end walls, wherein the first end of the air treatment assembly is openable;
   b) the air treatment chamber having a dirt outlet in communication with the dirt collection chamber, a first end and a second end wherein the longitudinal axis extends between the first and second ends of the air treatment chamber;
   c) a plate provided at the first end of the air treatment chamber, the plate is spaced from and faces the first end wall of the air treatment assembly whereby at least a portion of the dirt collection chamber is positioned between the first end wall of the air treatment assembly and the plate; and,
   d) the dirt outlet comprises a space between the plate and a sidewall of the air treatment chamber,
   wherein the docking unit has a docking port and, when the air treatment assembly is docked with the docking unit, the air treatment chamber and the dirt collection chamber are each openable whereby the air treatment chamber and the dirt collection chamber are each in communication with a dirt collection region of the docking unit.
2. The surface cleaning apparatus of clause 1 wherein the plate is moveable between an open position and a closed position and, when the plate is in the open position, the first end of the air treatment chamber is opened.
3. The surface cleaning apparatus of clause 2 wherein the first end wall of the air treatment assembly is openable.
4. The surface cleaning apparatus of clause 3 wherein the first end of the air treatment assembly is positioned in the docking unit when the air treatment assembly is opened.
5. The surface cleaning apparatus of clause 3 wherein, when the first end of the air treatment assembly is positioned in the docking unit and the air treatment assembly is opened, at least a portion of the plate is positioned in the docking unit.
6. The surface cleaning apparatus of clause 2 wherein, when the air treatment assembly docks with the docking unit and the plate is in the open position, dirt passes into the docking unit from each of the air treatment chamber and the dirt collection chamber due to gravity.
7. The surface cleaning apparatus of clause 1 wherein when the air treatment assembly is docked with the docking unit and each of the air treatment chamber and the dirt collection chamber are opened, dirt passes into the docking unit from each of the air treatment chamber and the dirt collection chamber due to gravity.
8. The surface cleaning apparatus of clause 7 wherein the air treatment assembly has a sidewall that extends between the first and second ends of the air treatment assembly, wherein at least a portion of the sidewall is moveable whereby each of the air treatment chamber and the dirt collection chamber are opened.
9. The surface cleaning apparatus of clause 8 wherein the plate is moveable between an open position and a closed position.
10. The surface cleaning apparatus of clause 9 wherein the plate is moveable mounted to the portion of the sidewall.
11. The surface cleaning apparatus of clause 8 wherein a first plane that is transverse to the longitudinal axis extends through the at least a portion of the dirt collection chamber and the portion of the sidewall and a second plane that is transverse to the longitudinal axis extends through the air treatment chamber and the portion of the sidewall.
12. The surface cleaning apparatus of clause 8 wherein the longitudinal axis extends horizontally when the air treatment assembly is docked with the docking unit.
13. The surface cleaning apparatus of clause 1 wherein the air treatment chamber and the dirt collection chamber are each concurrently opened.

### Clause Set M:

1. An upright surface cleaning apparatus comprising:
   a) a surface cleaning head having a dirty air inlet;
   b) an upper section that is mounted to the surface cleaning head and is moveable between an upright storage position and a reclined floor cleaning position;
   c) an air flow path extending from the dirty air inlet to a clean air outlet;
   d) an air treatment chamber positioned in the air flow path, the air treatment chamber having an air treatment chamber air inlet, an air treatment chamber air outlet;
   e) a suction motor provided in the air flow path; and,
   f) an emptying port provided in at least one of the surface cleaning head or a lower end of the upper section,
   wherein, when the surface cleaning apparatus is docked at a docking unit and is in a dirt emptying mode of operation, the emptying port is in flow communication with a dirt collection region of the docking unit.
2. The upright surface cleaning apparatus of clause 1 wherein the emptying port provided in the surface cleaning head.
3. The upright surface cleaning apparatus of clause 1 wherein the emptying port provided in the lower end of the upper section.
4. The upright surface cleaning apparatus of clause 3 wherein the upper section comprises an upflow duct having the emptying port.
5. The upright surface cleaning apparatus of clause 1 wherein, during the dirt emptying mode of operation, the suction motor is operable to provide a dirt emptying air flow that passes through the air treatment chamber to the emptying port.
6. The upright surface cleaning apparatus of clause 5 wherein the air flow path comprises a flexible hose and a removeable above floor cleaning wand and, during the dirt emptying mode of operation, air flows through the flexible hose and the above floor cleaning wand to the docking unit.
7. The upright surface cleaning apparatus of clause 6 wherein the emptying port provided in the above floor cleaning wand.
8. The upright surface cleaning apparatus of clause 6 wherein the upper section comprises a portable cleaning unit comprising the air treatment chamber and the suction motor, and the surface cleaning apparatus includes a portable cleaning unit mount whereby the portable cleaning unit is removable from a remainder of the surface cleaning apparatus.
9. The upright surface cleaning apparatus of clause 8 wherein the mount comprises an upflow duct that is moveable between the upright storage position and the reclined floor cleaning position, and the mount comprises the emptying port.
10. The upright surface cleaning apparatus of clause 9 wherein the above floor cleaning wand is removable connectable to the mount while the portable cleaning unit remains mounted to the mount and the portable cleaning unit is removable from the mount while the above floor cleaning wand remains connected to the mount.
11. The upright surface cleaning apparatus of clause 8 wherein the portable cleaning unit further comprises the mount, the upper section further comprises an upflow duct that is moveable between the upright storage position and the reclined floor cleaning position, and the mount removable receives the upflow duct.
12. The upright surface cleaning apparatus of clause 11 wherein the above floor cleaning wand is removable connectable to the mount and the portable cleaning unit is removable from the mount with the above floor cleaning wand.
13. The surface cleaning apparatus of clause 12 wherein the mount comprises the emptying port.
14. The upright surface cleaning apparatus of clause 1 wherein the docking unit comprises a docking unit suction motor and, during the dirt emptying mode of operation, the docking unit suction motor is operable to provide a dirt emptying air flow that passes through the air treatment chamber to the emptying port.
15. The upright surface cleaning apparatus of clause 14 wherein the air flow path comprises a flexible hose and a removeable above floor cleaning wand and, during the dirt emptying mode of operation, air flows through the flexible hose and the above floor cleaning wand to the docking unit.
16. The upright surface cleaning apparatus of clause 15 wherein the upper section comprises a portable cleaning unit comprising the air treatment chamber and the suction motor, and the surface cleaning apparatus includes a portable cleaning unit mount whereby the portable cleaning unit is removable from a remainder of the surface cleaning apparatus.
17. The upright surface cleaning apparatus of clause 16 wherein the mount comprises an upflow duct that is moveable between the upright storage position and the reclined floor cleaning position, the above floor cleaning wand is removable connectable to the mount while the portable cleaning unit remains mounted to the mount and the portable cleaning unit is removable from the mount while the above floor cleaning wand remains connected to the mount.
18. The upright surface cleaning apparatus of clause 16 wherein the portable cleaning unit further comprises the mount, the upper section further comprises an upflow duct that is moveable between the upright storage position and the reclined floor cleaning position, the mount removable receives the upflow duct, the above floor cleaning wand is removable connectable to the mount and the portable cleaning unit is removable from the mount with the above floor cleaning wand.

### Clause Set N:

1. A surface cleaning apparatus comprising an emptying air flow path extending from an air inlet port to a first emptying port, and a first emptying port valve that is moveable between an open position in which the first emptying port is open and a closed position in which the first emptying port is closed, the first emptying port valve is slideably moveable between the open position and the closed position.
2. The surface cleaning apparatus of clause 1 wherein the first emptying port valve is a gate valve.
3. The surface cleaning apparatus of clause 1 wherein the surface cleaning apparatus is a hand vacuum cleaner having a cleaning air flow path that extends from a dirty air inlet to a clean air outlet, the dirty air inlet is provided at a front end of the hand vacuum cleaner, the hand vacuum cleaner has a longitudinal axis that extends between the front end of the hand vacuum cleaner and a rear end of the hand vacuum cleaner, and the first emptying port valve is axially slideably moveable.
4. The surface cleaning apparatus of clause 1 wherein the first emptying port valve is moved to the open position as the surface cleaning apparatus is docked with a docking unit.
5. The surface cleaning apparatus of clause 4 wherein the surface cleaning apparatus is moved in a mounting direction as the surface cleaning apparatus is docked with the docking unit and the first emptying port valve is moved in the mounting direction as the first emptying port valve is moved to the open position.
6. The surface cleaning apparatus of clause 1 wherein a mating docking unit has a valve actuator and, when the surface cleaning apparatus is docked at the docking unit, the valve actuator is drivingly connected to the first emptying port valve.
7. The surface cleaning apparatus of clause 6 wherein the valve actuator is slidably moveably and is pneumatically driven.
8. The surface cleaning apparatus of clause 1 wherein a mating docking unit has a valve actuator and, as the surface cleaning apparatus is docked at the docking unit, the valve actuator drives the first emptying port valve to the open position.
9. The surface cleaning apparatus of clause 1 wherein the emptying air flow path also extends from the air inlet port to a second emptying port, and the surface cleaning apparatus further comprises a second emptying port valve that is moveable between an open position in which the second emptying port is open and a closed position in which the second emptying port is closed, the second emptying port valve is slideably moveable between the open position and the closed position.
10. The surface cleaning apparatus of clause 9 wherein the first emptying port valve and the second emptying port valve are a single common sliding valve.
11. The surface cleaning apparatus of clause 10 wherein the common sliding valve is moveable between a first position in which the first and second emptying ports are closed, a second position in which the first emptying port is open and the second emptying port is closed and a third position in which the first emptying port is closed and the second emptying port is open.
12. The surface cleaning apparatus of clause 10 wherein the common sliding valve is moveable between a first position in which the first and second emptying ports are closed, a second position in which the first emptying port is open and the second emptying port is closed and a third position in which the first and second emptying ports are open.
13. The surface cleaning apparatus of clause 1 wherein the surface cleaning apparatus comprises a pre-motor filter housing and, when the first emptying port is in the open position, an opening is provided to the pre-motor filter housing.
14. The surface cleaning apparatus of clause 1 wherein the surface cleaning apparatus comprises an air treatment chamber and, when the first emptying port is in the open position, an opening is provided to the air treatment chamber.
15. The surface cleaning apparatus of clause 9 wherein the surface cleaning apparatus comprises a pre-motor filter housing and an air treatment chamber and, when the first emptying port is in the open position, an opening is provided to the pre-motor filter housing and, when the second emptying port is in the open position, an opening is provided to the air treatment chamber.
16. The surface cleaning apparatus of clause 15 wherein the first emptying port valve and the second emptying port valve are a single common sliding valve and the common sliding valve is moveable between a first position in which the first and second emptying ports are closed, a second position in which the first emptying port is open and the second emptying port is closed and a third position in which the first emptying port is closed and the second emptying port is open.
17. The surface cleaning apparatus of clause 15 wherein the first emptying port valve and the second emptying port valve are a single common sliding valve and the common sliding valve is moveable between a first position in which the first and second emptying ports are closed, a second position in which the first emptying port is open and the second emptying port is closed and a third position in which the first and second emptying ports are open.
18. The surface cleaning apparatus of clause 9 wherein the surface cleaning apparatus comprises an air treatment chamber and, when the first emptying port is in the open position, an opening is provided to at a first location of the air treatment chamber and, when the second emptying port is in the open position, an opening is provided at a second location of the air treatment chamber.
19. The surface cleaning apparatus of clause 18 wherein the first emptying port valve and the second emptying port valve are a single common sliding valve and the common sliding valve is moveable between a first position in which the first and second emptying ports are closed, a second position in which the first emptying port is open and the second air emptying is closed and a third position in which the first emptying port is closed and the second emptying port is open.
20. The surface cleaning apparatus of clause 18 wherein the first emptying port valve and the second emptying port valve are a single common sliding valve and the common sliding valve is moveable between a first position in which the first and second emptying ports are closed, a second position in which the first emptying port is open and the second emptying port is closed and a third position in which the first and second emptying ports are open.

### Clause Set O:

1. A hand vacuum cleaner that is dockable with a docking unit, the hand vacuum cleaner having an upper side, a lower side, a right side and a laterally opposed left side, the hand vacuum cleaner comprising:
   a) a cleaning air flow path that extends from a dirty air inlet to a clean air outlet, the dirty air inlet is provided at a front end of the hand vacuum cleaner, the hand vacuum cleaner has a longitudinal axis that extends between the front end of the hand vacuum cleaner and a rear end of the hand vacuum cleaner;
   b) an air treatment chamber provided in the air flow path, the air treatment chamber comprising a dirt collection region;
   c) a handle provided on a lower side of the hand vacuum cleaner; and,
   d) a first dirt evacuation port provided on one of the upper side, the lower side and the right side.
2. The hand vacuum cleaner of clause 1 wherein the handle comprises a pistol grip handle.
3. The hand vacuum cleaner of clause 1 wherein a second dirt evacuation port is provided on one of the upper side, the lower side and the right side.
4. The hand vacuum cleaner of clause 1 wherein a front end of the air treatment chamber is openable.
5. The hand vacuum cleaner of clause 1 wherein the air treatment chamber has a longitudinally extending sidewall, at least a portion of the sidewall is curved and the first dirt evacuation port is curved and is provided in the portion of the sidewall.
6. The hand vacuum cleaner of clause 5 further comprising an openable door associated with the port wherein the openable door is also curved and slides angularly to an open position.
7. The hand vacuum cleaner of clause 1 wherein the air treatment chamber comprises a cyclone.
8. A hand vacuum cleaner that is dockable with a docking unit, the hand vacuum cleaner comprising:
   a) a cleaning air flow path that extends from a dirty air inlet to a clean air outlet, the dirty air inlet is provided at a front end of the hand vacuum cleaner, the hand vacuum cleaner has a longitudinal axis that extends between the front end of the hand vacuum cleaner and a rear end of the hand vacuum cleaner;
   b) an air treatment chamber provided in the air flow path, the air treatment chamber comprising a dirt collection region;
   c) a pistol grip handle; and,
   d) a first dirt evacuation port, wherein, when the hand vacuum cleaner is in use to clean a floor, the hand vacuum cleaner has an upper side, a lower side, a right side and a laterally opposed left side and the first dirt evacuation port is provided on one of the upper side, the lower side and the right side.
9. The hand vacuum cleaner of clause 8 wherein a second dirt evacuation port is provided on one of the upper side, the lower side and the right side.
10. The hand vacuum cleaner of clause 8 wherein a front end of the air treatment chamber is openable.
11. The hand vacuum cleaner of clause 8 wherein the air treatment chamber has a longitudinally extending sidewall, at least a portion of the sidewall is curved and the first dirt evacuation port is curved and is provided in the portion of the sidewall.
12. The hand vacuum cleaner of clause 12 further comprising an openable door associated with the port wherein the openable door is also curved and slides angularly to an open position.
13. The hand vacuum cleaner of clause 8 wherein the air treatment chamber comprises a cyclone.
14. A hand vacuum cleaner that is dockable with a docking unit, the hand vacuum cleaner comprising:
   a) a cleaning air flow path that extends from a dirty air inlet to a clean air outlet, the dirty air inlet is provided at a front end of the hand vacuum cleaner, the hand vacuum cleaner has a longitudinal axis that extends between the front end of the hand vacuum cleaner and a rear end of the hand vacuum cleaner;
   b) an air treatment chamber provided in the air flow path, the air treatment chamber comprising a dirt collection region;
   c) a handle;
   d) a first dirt evacuation port, wherein, when the hand vacuum cleaner is in use to clean a floor, the hand vacuum cleaner has an upper side, a lower side, a right side and a laterally opposed left side and the first dirt evacuation port is provided on one of the upper side, the lower side and the right side; and,
      a second dirt evacuation port.
15. The hand vacuum cleaner of clause 15 wherein the handle comprises a pistol grip handle.
16. The hand vacuum cleaner of clause 15 wherein the second dirt evacuation port is provided on one of the upper side, the lower side and the right side.
17. The hand vacuum cleaner of clause 15 wherein a front end of the air treatment chamber is openable.
18. The hand vacuum cleaner of clause 15 wherein the air treatment chamber has a longitudinally extending sidewall, at least a portion of the sidewall is curved and the first dirt evacuation port is curved and is provided in the portion of the sidewall.
19. The hand vacuum cleaner of clause 19 further comprising an openable door associated with the port wherein the openable door is also curved and slides angularly to an open position.

### Clause Set P:

1. A docking unit for emptying a surface cleaning apparatus, the surface cleaning apparatus having a dirt collection region and an energy storage member, the docking unit comprising:
   a) a docking unit dirt collection chamber; and,
   b) a docking unit air flow path extending from a docking unit inlet port to a docking unit outlet port, wherein a docking unit dirt collection chamber is provided in the docking unit dirt collection chamber,
   wherein, when at least a portion of the surface cleaning apparatus comprising the dirt collection region and the energy storage member is docked at the docking unit and the docking unit is in a dirt emptying mode of operation, the energy storage member powers a motor and fan assembly and the motor and fan assembly provide an air flow that transfers dirt from the dirt collection region into the docking unit dirt collection chamber.
2. The surface cleaning apparatus of clause 1 wherein the motor and fan assembly is provided in the surface cleaning apparatus.
3. The surface cleaning apparatus of clause 1 wherein the motor and fan assembly is provided in the docking unit.
4. The surface cleaning apparatus of clause 1 wherein the surface cleaning apparatus is recharged while docked at the docking unit.
5. The surface cleaning apparatus of clause 4 wherein the docking unit recharges the energy storage member while the energy storage member is used to power the motor and fan assembly.
6. The surface cleaning apparatus of clause 4 wherein the energy storage member is discharged at a first rate when used to power the motor and fan assembly during the dirt emptying mode of operation of the docking unit and the docking unit recharges the energy storage member at a second rate which is lower than the first rate.
7. The surface cleaning apparatus of clause 4 wherein the second rate is from 1/24 to 4C.
8. The surface cleaning apparatus of clause 4 wherein the second rate is from 1/12 to 2C.
9. The surface cleaning apparatus of clause 4 wherein the second rate is from 1/8 to 1C.
10. The surface cleaning apparatus of clause 4 wherein the second rate is up to 4C.
11. The surface cleaning apparatus of clause 7 wherein the first rate is at least 5 C.
12. The surface cleaning apparatus of clause 6 wherein the first rate is at least 5 C.
13. The surface cleaning apparatus of clause 7 wherein the first rate is at least 10 C.
14. The surface cleaning apparatus of clause 4 further comprising a power cord, the power cord comprising a plug that is connectable to a household power outlet and the plug is part of an AC adaptor.
15. The surface cleaning apparatus of clause 4 further comprising a power cord, the power cord comprising a plug that is connectable to a household power outlet and an AC adaptor that is provided proximate the plug.
16. The surface cleaning apparatus of clause 15 wherein the power cord comprises a low voltage conductor extending between the AC adaptor and the docking unit.

1. A docking unit for emptying a dirt collection region of a surface cleaning apparatus, the surface cleaning apparatus having a motor and fan assembly, the docking unit comprising:
a) a floor standing base unit comprising a docking unit dirt collection chamber; and,
b) a docking unit inlet port connectable in flow communication with the dirt collection region of the surface cleaning apparatus;
c) a docking unit outlet port connectable in flow communication with the suction motor of the surface cleaning apparatus;
d) a down flow duct extending from the docking unit inlet port to the floor standing base;
e) an up flow duct extending from the floor standing base to the docking unit outlet port; and,
f) a docking unit air flow path extending from the docking unit inlet port to the docking unit outlet port, wherein the docking unit dirt collection chamber is provided in the docking unit air flow path.

2. The docking unit of claim 1 wherein the floor standing base unit has an upper surface and the down flow and up flow ducts extend above the upper surface.

3. The docking unit of claim 1 wherein the upper surface is openable.

4. The docking unit of claim 1 wherein the floor standing base unit is useable as a garbage can.

5. The docking unit of claim 4 wherein the upper surface is openable whereby a user can deposit trash in the floor standing base unit when the upper surface is opened.

6. The docking unit of claim 1 further comprising an upper section which consists essentially of the up flow and the down flow ducts.

7. The docking unit of claim 6 wherein the upper section further comprising a charging unit for the surface cleaning apparatus.

8. The docking unit of claim 1 wherein the floor standing base unit further comprises a docking unit for a robotic vacuum cleaner.

9. The docking unit of claim 8 wherein, when the surface cleaning apparatus and the robot vacuum cleaner are each docked at the docking unit, during a dirt emptying operation of the robotic vacuum cleaner, a dirt collection region of the robotic vacuum cleaner is in flow communication with the docking unit dirt collection chamber and the docking unit dirt collection chamber is in flow communication with the suction motor whereby the suction motor of the surface cleaning apparatus is operable to empty the robotic vacuum cleaner.

10. The docking unit of claim 2 wherein the upper surface is exposed when the surface cleaning apparatus is docked at the docking unit.

11. The docking unit of claim 2 wherein the down flow and up flow ducts are located at a periphery of the upper surface.

12. A docking unit for emptying a dirt collection region of a surface cleaning apparatus, the surface cleaning apparatus having a motor and fan assembly, the docking unit comprising:
a) a base unit comprising a docking unit dirt collection chamber and an upper surface, wherein the upper surface is exposed when the surface cleaning apparatus is docked at the docking unit; and,
b) a docking unit inlet port connectable in flow communication with the dirt collection region of the surface cleaning apparatus;
c) a docking unit outlet port connectable in flow communication with the suction motor of the surface cleaning apparatus;
d) a down flow duct extending from the docking unit inlet port to the floor standing base;
e) an up flow duct extending from the floor standing base to the docking unit outlet port; and,
f) a docking unit air flow path extending from the docking unit inlet port to the docking unit outlet port, wherein the docking unit dirt collection chamber is provided in the docking unit air flow path.

13. The docking unit of claim 12 wherein the upper surface is openable.

14. The docking unit of claim 12 wherein the base unit is useable as a garbage can.

15. The docking unit of claim 14 wherein the upper surface is openable whereby a user can deposit trash in the base unit when the upper surface is opened.

16. The docking unit of claim 12 further comprising an upper section which consists essentially of the up flow and the down flow ducts.

17. The docking unit of claim 16 wherein the upper section further comprising a charging unit for the surface cleaning apparatus.

18. The docking unit of claim 12 wherein the base unit further comprises a docking unit for a robotic vacuum cleaner.

19. The docking unit of claim 13 wherein the down flow and up flow ducts are located at a periphery of the upper surface.
